(19) United States
(12) Patent Application Publication
(10) Pub. No.: US 2024/0106905 A1
(43) Pub. Date: Mar. 28, 2024

(54) APPARATUSES, SYSTEMS, INTERFACES, AND METHODS IMPLEMENTING THEM FOR COLLECTING, ANALYZING, PREDICTING, AND OUTPUTTING USER ACTIVITY METRICS

(71) Applicant: Quantum Interface, LLC, Austin, TX (US)

(72) Inventor: Jonathan Josephson, Austin, TX (US)

(73) Assignee: Quantum Interface, LLC, Austin, TX (US)

(21) Appl. No.: 18/220,105

(22) Filed: Jul. 10, 2023

Related U.S. Application Data
(60) Provisional application No. 63/359,498, filed on Jul. 8, 2022.

(51) Int. Cl. H04L 67/306

(52) U.S. Cl. CPC H04L 67/306

(57) ABSTRACT

Apparatuses and/or systems and/or interfaces and/or methods implementing them, including one or more processing systems; one or more monitoring subsystems; one or more data gathering/collection/capturing subsystems; one or more data analysis subsystems; and one or more data storage subsystems, wherein the apparatuses and/or systems and/or interfaces and/or methods implementing them to monitor user activities and interactions, gather/collect/capture user activity and interaction data, analyze the data, produce usable data outputs such as metrics, predictive rules, device, environment, behavioral, optimizers, real-time or near real-time device, environment, behavioral, optimizers, and store the usable data outputs.

### RELATED APPLICATIONS

The present disclosure claims priority to and the benefit of U.S. Provisional Patent Application Ser. No. 63/359,498 filed Jul. 8, 2022 (8 Jul. 2022).

United States Patent Published Application Nos. 20170139556 published May 18, 2017, 20190391729 published Dec. 26, 2019, WO2018237172 published Dec. 27, 2018, WO2021021328 published Feb. 4, 2021, and U.S. Pat. No. 7,831,932 issued Nov. 9, 2010, U.S. Pat. No. 7,861,188 issued Dec. 28, 2010, U.S. Pat. No. 8,788,966 issued Jul. 22, 2014, U.S. Pat. No. 9,746,935 issued Aug. 29, 2017, U.S. Pat. No. 9,703,388 issued Jul. 11, 2017, U.S. Pat. No. 11,256,337 issued Feb. 22, 2022, U.S. Pat. No. 10,289,204 issued May 14, 2019, U.S. Pat. No. 10,503,359 issued Dec. 10, 2019, U.S. Pat. No. 10,901,578 issued Jan. 26, 2021, U.S. Pat. No. 11,221,739 issued Jan. 11, 2022, U.S. Pat. No. 10,263,967 issued Apr. 16, 2019, U.S. Pat. No. 10,628,977 issued Apr. 21, 2020, U.S. Pat. No. 11,205,075 issued Dec. 21, 2021, U.S. Pat. No. 10,788,948 issued Sep. 29, 2020, and U.S. Pat. No. 11,226,714 issued Jan. 18, 2022, are incorporated by reference via the application of the Closing Paragraph.

### BACKGROUND OF THE INVENTION

### 1. Field of the Invention

Embodiments of the present disclosure relate to apparatuses and/or systems and/or interfaces and/or methods implementing them, the apparatuses and/or systems include: one or more processing systems comprising one or more electronic devices, one or more processing units, one or more processing systems, one or more distributed processing systems, one or more distributing processing environments, and/or any combination thereof; one or more monitoring subsystems; one or more data gathering/collection/capturing subsystem, one or more data analysis subsystems, and one or more data storage subsystems, wherein the apparatuses and/or systems and/or interfaces and/or methods implementing them to monitor user activities and interactions, gather/collect/capture user activity and interaction data, analyze the data, produce usable data outputs such as metrics, predictive rules, device, environment, behavioral, etc. optimizers, real-time or near real-time device, environment, behavioral, etc. optimizers, etc., and store the usable data outputs.

More particularly, embodiments of this disclosure relate to apparatuses and/or systems and/or interfaces and methods implementing them, the apparatuses and/or systems include: one or more processing systems comprising one or more electronic devices, one or more processing units, one or more processing systems, one or more distributed processing systems, one or more distributing processing environments, and/or any combination thereof; one or more monitoring subsystems; one or more data gathering/collection/capturing subsystem, one or more data analysis subsystems, and one or more data storage subsystems, wherein the apparatuses and/or systems and/or interfaces and methods implementing them to monitor user activities and interactions, gather/collect/capture user activity and interaction data, analyze the data, produce usable data outputs such as metrics, predictive rules, device, environment, behavioral, optimizers, real-time or near real-time device, environment, behavioral, optimizers, and/or any combination thereof, and store the usable data outputs. The apparatuses and/or systems and/or interfaces and/or methods implementing them are configured to: (1) gather real-time or near real-time activity and/or interaction data from humans, animals, devices under that control of humans and/or animals, and/or devices under control of artificial intelligent (AI) algorithms and or routines interacting with devices, real world environments, virtual environments, and/or mixed real world or virtual (computer generated—CG) environments, (2) analyze of the collected/capture data, (3) generate metrics based on the data, (4) generate predictive rules from the data, (5) generate classification behavioral patterns, (6) generate of data derived information from data analytics and/or data mining, or (7) any mixture or combination thereof.

### 2. Description of the Related Art

Numerous methodologies have been constructed for collecting human activity and/or interaction data, analyzing the collected data, and using the collected data for any purpose to which the data analysis may be utilized such as to produce data metrics, predictive rules, etc. and using the metrics, predictive rules, etc., and the data to improve human, animal, or device training, device optimization, etc.

### SUMMARY OF THE INVENTION

### Apparatuses/Systems/Interfaces for Producing Metrics

Embodiments of the disclosure provide apparatuses and/or systems and/or interfaces and/or methods implementing them, the apparatuses/systems include processing assembly/subsystem including an electronic device, a processing unit, a processing system, a distributed processing system, a distributing processing environment, and/or combinations thereof. The apparatuses/systems further include a real-time or near real-time data monitoring assembly/subsystem, a real-time or near real-time data gathering/collection/capturing assembly/subsystem, and a data analysis assembly/subsystem. The data analysis assembly/subsystem analyzes the gathered/collected/captured data and produces usable output data such as metrics, predictive rules, behavioral rules, forecasting rules, or any other type of informational rules derived from the collected/captured data; and produces optimized environments, real-time or near real-time environments, predictive environments, behavioral environments, forecasting environments, or any other type of environments derived from the collected/captured data and the metrics and rules, wherein the apparatuses/systems and/or interfaces and/or methods implementing them are configured to: (1) gather, collect, and/or capture real-time or near real-time activity and/or interaction data from humans, animals, devices under that control of humans and/or animals, and/or devices under control of artificial intelligent (AI) algorithms and/or routines interacting with devices, real world environments, virtual reality (VR) environments, and/or mixed real world or virtual reality (AR, MR, and/or XR) environments; (2) analyze of the gathered/collected/captured data; (3) generate metrics based on the gathered/collected/captured data; (4) generate predictive rules, behavioral rules, forecasting rules, or any other type of informational rules derived from the gathered/collected/captured; (5) generate classification predictive, behavioral, forecasting patterns derived from the gathered/collected/captured data and/or the predictive rules, behavioral rules, forecasting rules, or any other type of informational rules derived from the gathered/collected/captured; (6) generate optimized environments, real-time or near real-time environments, predictive environments, behavioral environments, forecasting environments, or any other type of environments derived from the gathered/collected/captured data and/or the predictive rules, behavioral rules, forecasting rules, or any other type of informational rules derived from the gathered/collected/captured; (7) generate of data analytics and/or data mining information derived from the gathered/collected/captured data, the predictive rules, behavioral rules, forecasting rules, or any other type of informational rules, and/or the optimized environments, real-time or near real-time environments, predictive environments, behavioral environments, forecasting environments, or any other type of environments derived from the gathered/collected/captured; and/or (8) any mixture or combination thereof. It should be recognized that all aspects of the apparatuses and/or systems may occur real-time or near real-time, wherein near real-time mean with a finite delay of any given duration.

Embodiments of the disclosure provide apparatuses and/or systems including: (1) a monitoring subsystem including one or more sensors such as cameras, motion sensors, biometric sensors, biokinetic sensors, environmental sensors, e.g., sensors monitoring temperature, pressure, humidity, weather, air quality, location, etc. in a temporal stamped format, (2) a processing subsystem including one or more processing units, one or more processing systems, one or more distributed processing systems, and/or one or more distributing processing environments, and (3) an interface subsystem including one or more user interfaces having one or more human, animal, and/or artificial intelligent (AI) cognizable output devices such as audio output devices, visual output devices, audiovisual output devices, haptic or touch sensitive output devices, other output devices, or any combination thereof. The monitoring subsystem is configured to: (a) monitor real-time or near real-time user activity and interaction data, gather, collect and/or real-time or near real-time capture real-time or near real-time monitored data from the sensors, (b) analyze of the data, (c) predict human, animal, and/or devices under that control of a human and/or animal activities and/or interactions based on the data, (d) produce metrics based on the data, (e) produce predictive metrics and/or behavioral patterns based on the data, and (f) output the metrics and/or behavioral patterns. It should be recognized that all aspects of the apparatuses and/or systems may occur real-time or near real-time, wherein near real-time mean with a finite delay of any given duration.

### Data

Embodiments of the present disclosure also provide collecting and/or capturing data from the monitoring subsystem comprising real-time or near real-time temporal correlated data of humans, animals, and/or devices under the control of humans, animals, artificial intelligent (AI) device control algorithms, etc. monitoring human, animal, human/animal/AI controlled device, etc. activities and/or interactions with: (1) real world items and/or features/elements/portions/parts thereof, (2) real world environments and/or features/elements/portions/parts thereof, (3) virtual items and/or features/elements/portions/parts thereof, (4) virtual environments and/or features/elements/portions/parts thereof, and/or 5 e) mixed items and/or environments comprising combinations of real world items and/or features/elements/portions/parts thereof and virtual items and/or features/elements/portions/parts thereof, real world environments and/or features/elements/portions/parts and virtual environments and/or features/elements/portions/parts.

The real world items and/or features/elements/portions/parts thereof and/or environments and/or features/elements/portions/parts thereof including stores, malls, shopping centers, consumer products, cars, sports arenas, houses, apartments, villages, cities, states, countries, rivers, streams, lakes, seas, oceans, skies, horizons, stars, planets, etc., commercial facilities, transportation systems such as roads, highways, interstate highways, rail roads, etc., humans, animals, plants, any other real world item and/or environment and/or element or part thereof.

The virtual items and/or features/elements/portions/parts thereof and/or environments and/or features/elements/portions/parts thereof including computer generated (CG) simulated real world objects and/or environments and/or CG imaginative objects and/or environments. The mixed items and/or features/elements/portions/parts thereof and/or environments and/or features/elements/portions/parts thereof including any combination of: (a) real world items and/or features/elements/portions/parts thereof and/or real world environments and/or features/elements/portions/parts thereof and GC items and/or features/elements/portions/parts thereof and (b) CG items and/or features/elements/portions/parts thereof and/or CG environments and/or features/elements/portions/parts thereof, i.e., mixed items comprise real world features/elements/portions/parts and CG features/elements/portions/parts.

The data comprises human, animal, and/or human/animal/AI controlled device movement or motion properties including: (1) direction, velocity, and/or acceleration, (2) changes of direction, velocity, and/or acceleration, (3) profiles of motion direction, velocity, and/or acceleration, (4) pauses, stops, hesitations, gitters, fluctuations, and/or any combination thereof, (5) changes of pauses, stops, hesitations, gitters, fluctuations, etc., (6) profiles of pauses, stops, hesitations, gitters, fluctuations, etc., (7) physical data, environmental data, astrological data, meteorological data, location data, etc., (8) changes of physical data, environmental data, astrological data, meteorological data, location data, etc., (9) profiles of physical data, environmental data, astrological data, meteorological data, location data, any other type of data, and/or any combination thererof, and/or (10) any mixture or combination of these data.

### Data Analyses, Predictions, Classification, and Manipulations

Embodiments of the disclosure provide systems and methods implementing them including analyzing the collected/captured data and determining patterns, classifications, predictions, etc. using data analytics and data mining and using the patterns, classifications, predictions, etc., to update, modify, optimize, and/or any combination thereof, the data collection/capture methodology and optimizing any feature that may be derived from the data analytics and data mining.

### Methods for Using the User Interface Apparatuses

Embodiments of the present disclosure provide methods implemented on a processing unit including the step of capturing biometric data via the biometric sensors and/or kinetic/motion data via the motion sensors and/or biokinetic data via the bio-kinetic sensors and creating a unique kinetic or biokinetic user identifier. One, some or all of the biometric sensors and/or the motion sensors may be the same or different.

### BRIEF DESCRIPTION OF THE DRAWINGS

The disclosure can be better understood with reference to the following detailed description together with the appended illustrative drawings in which like elements are numbered the same:

### Illustrations of Real-Time Data Gathering/Collection/Capturing

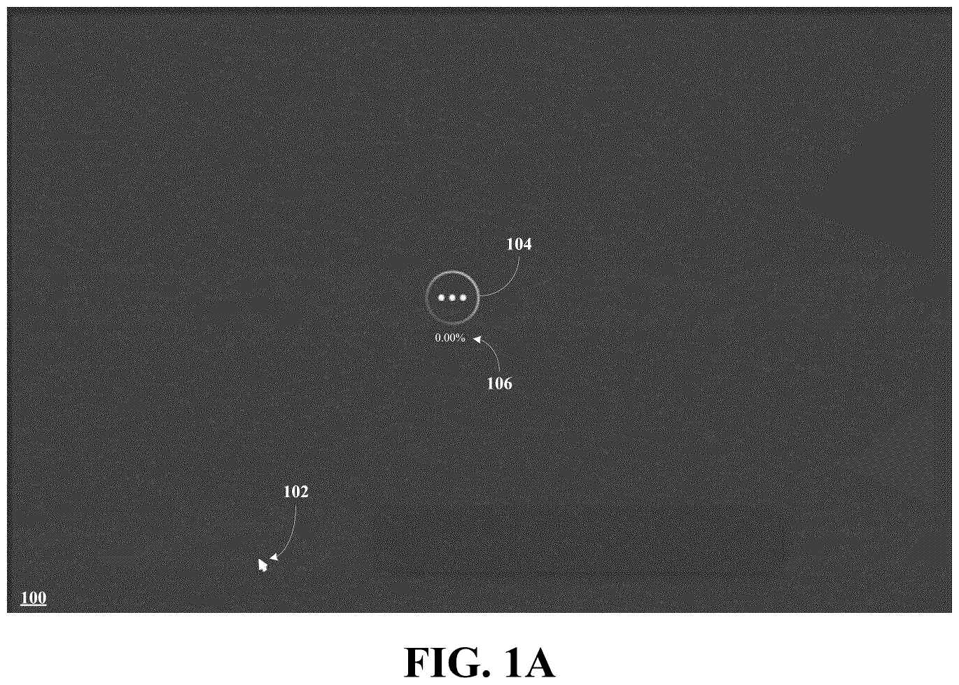

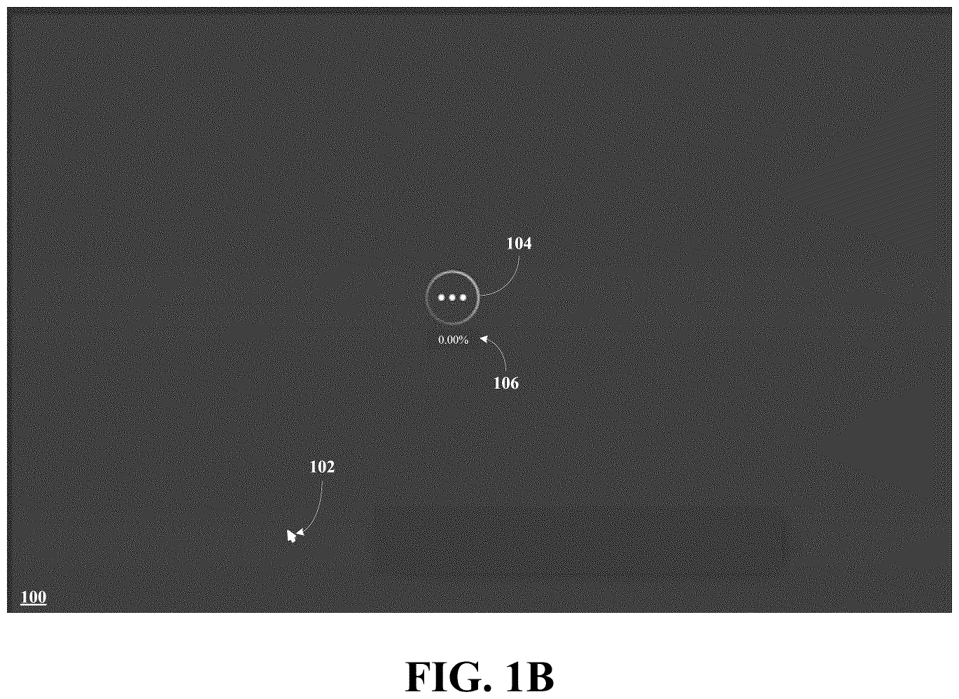

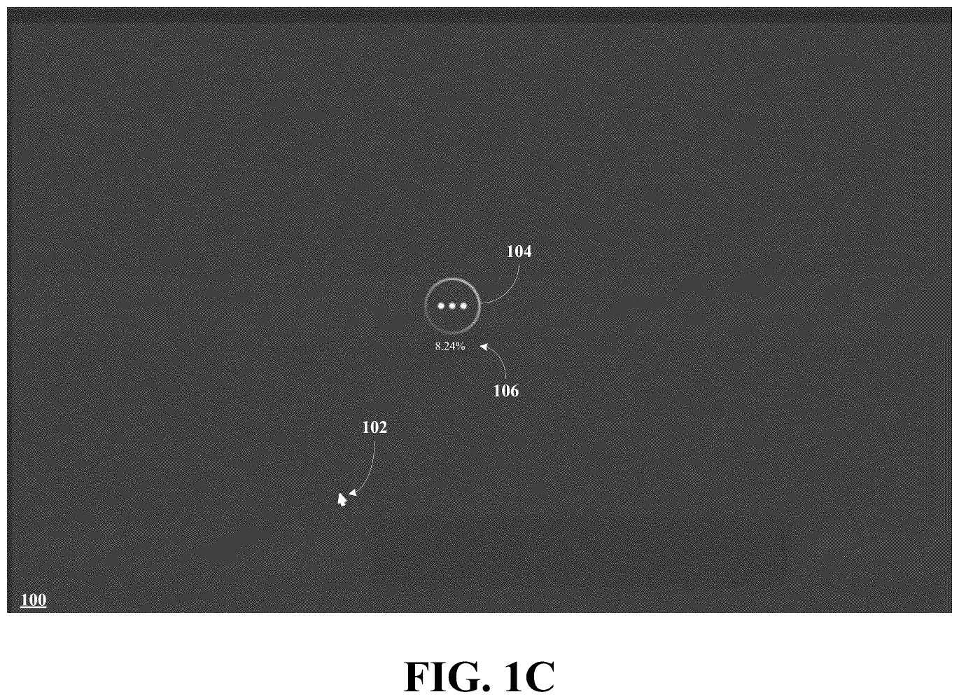

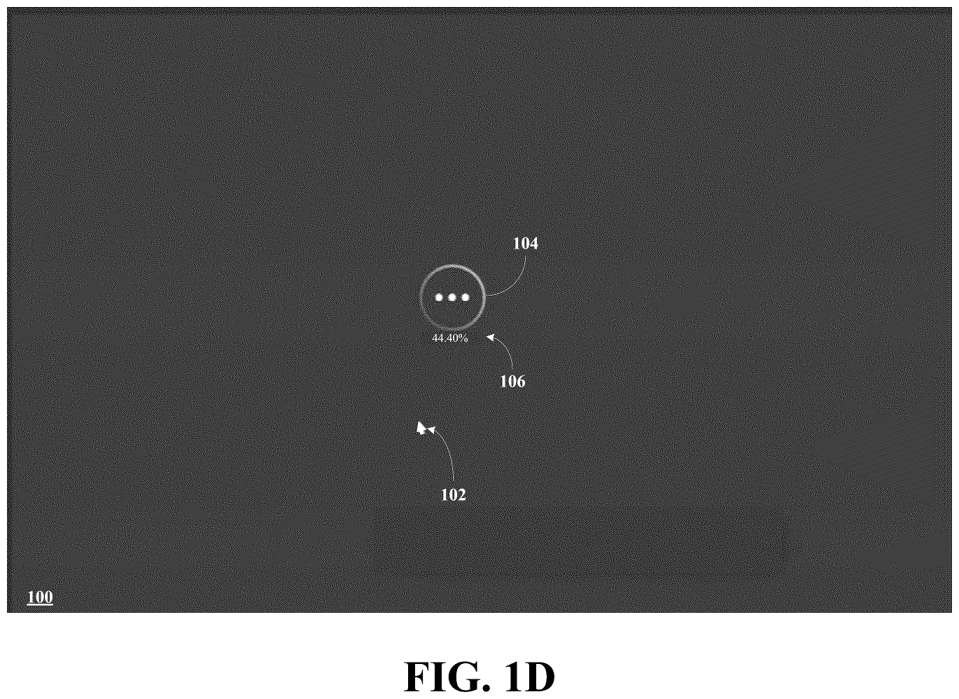

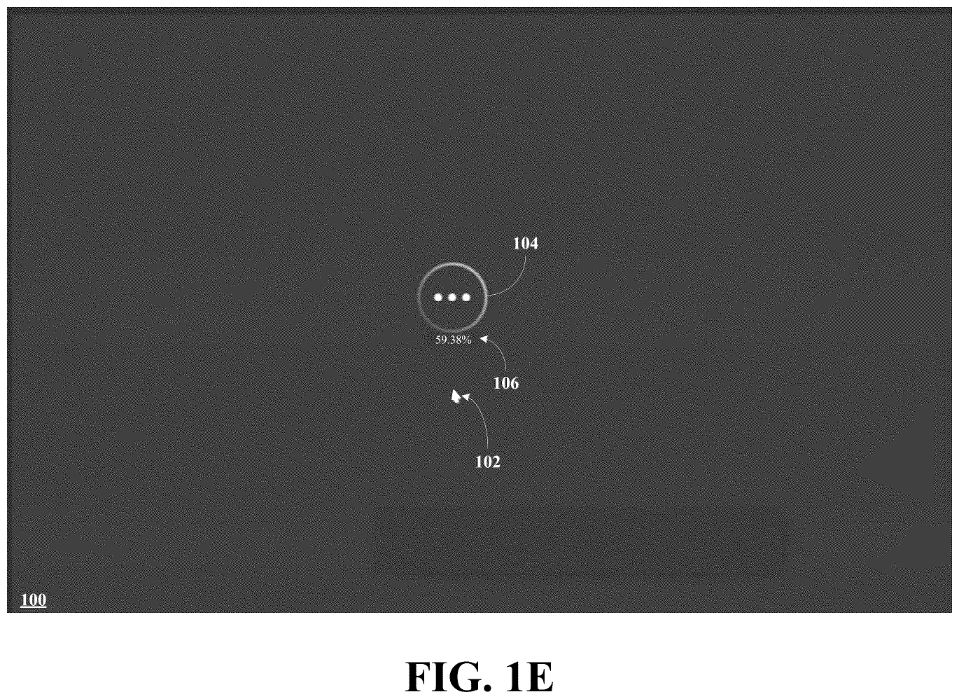

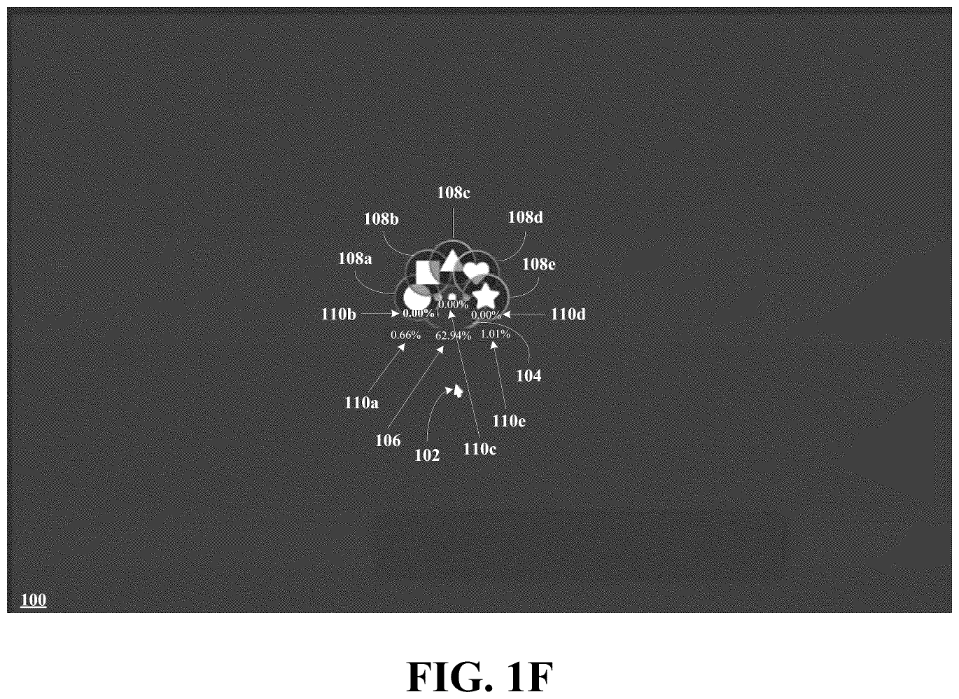

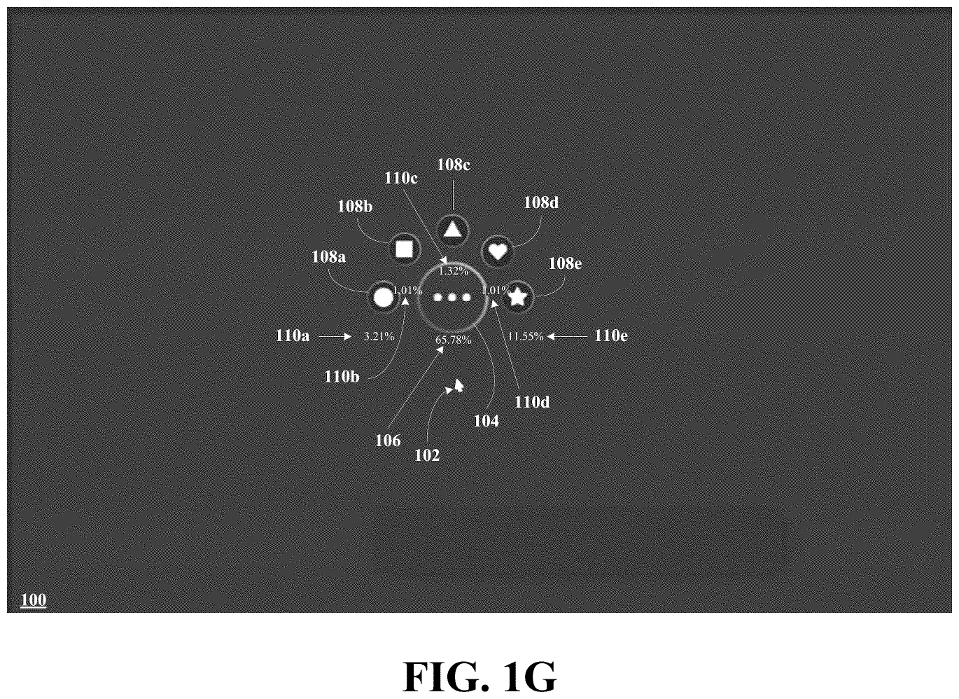

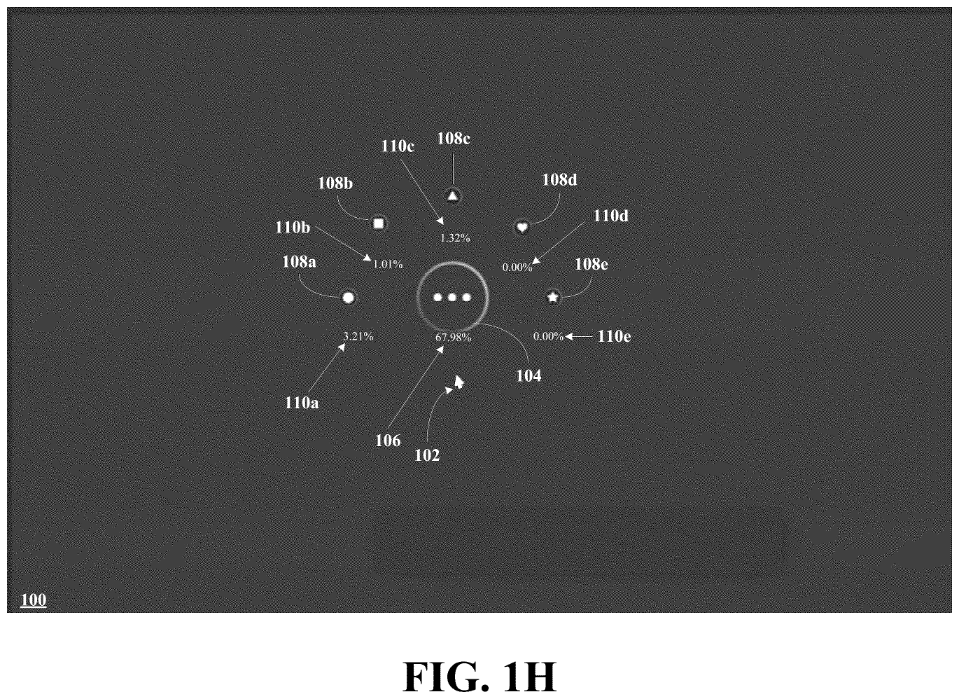

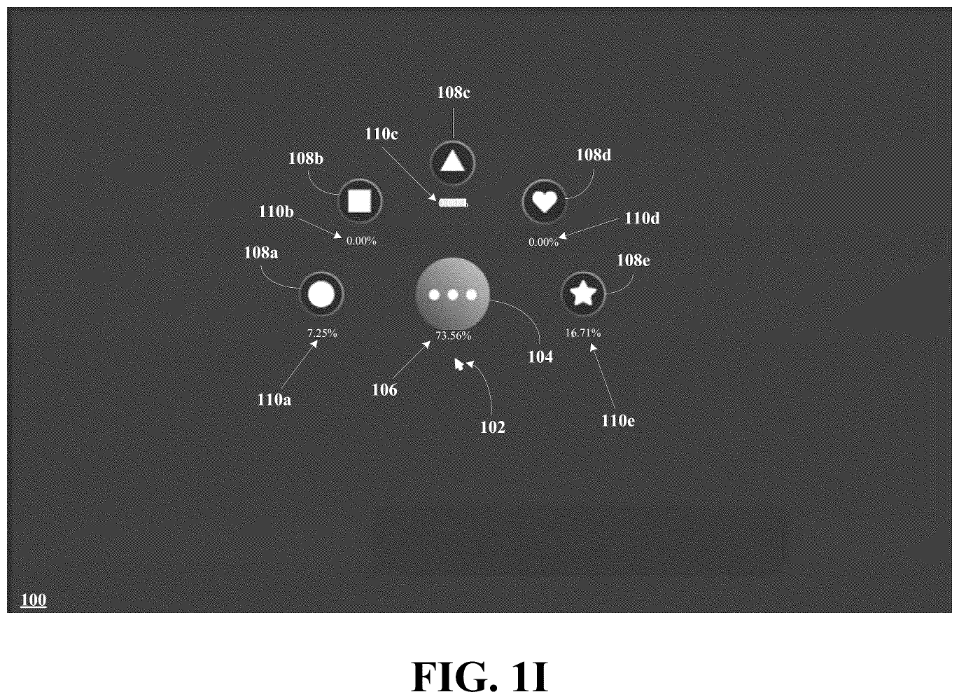

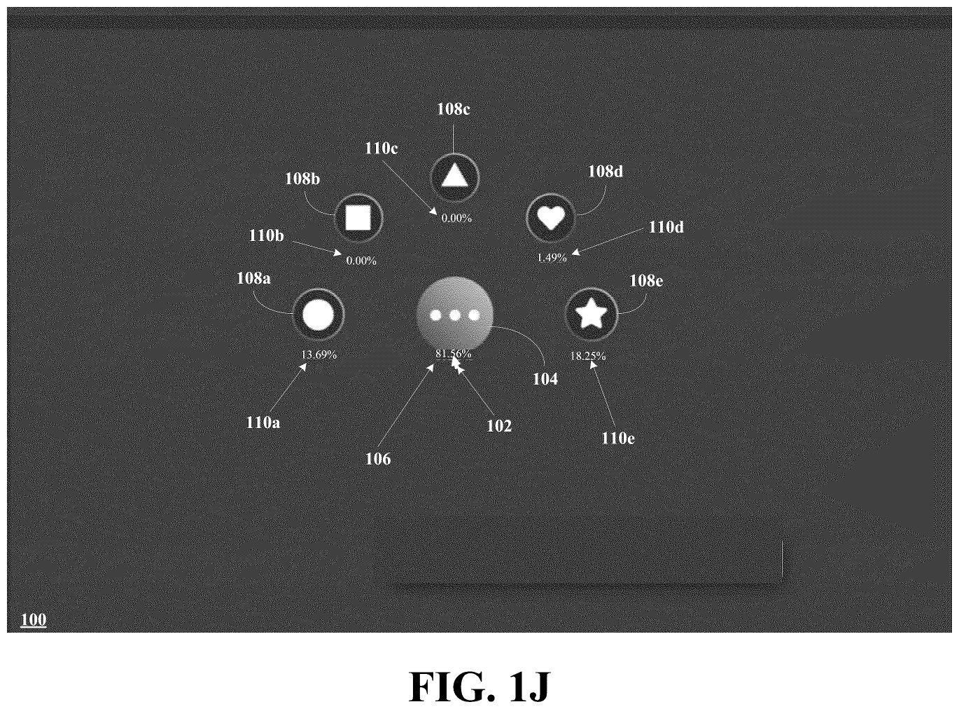

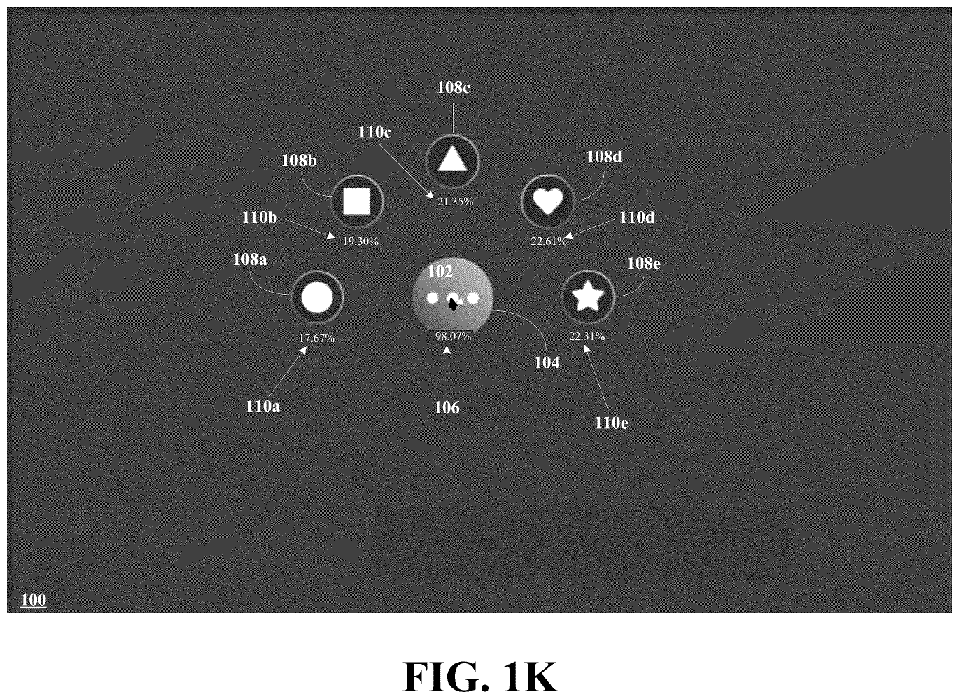

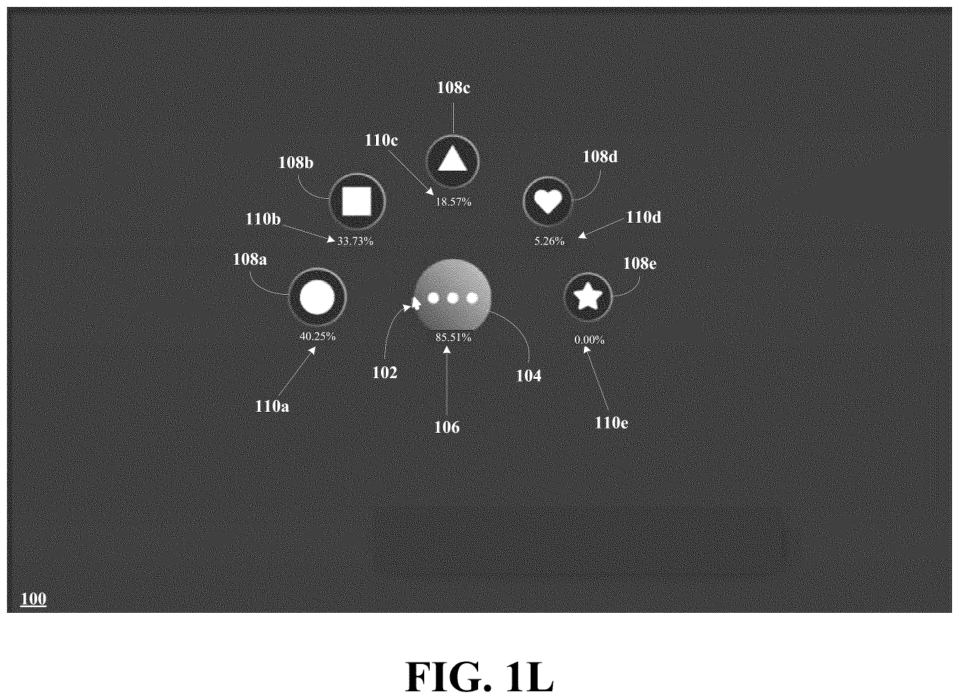

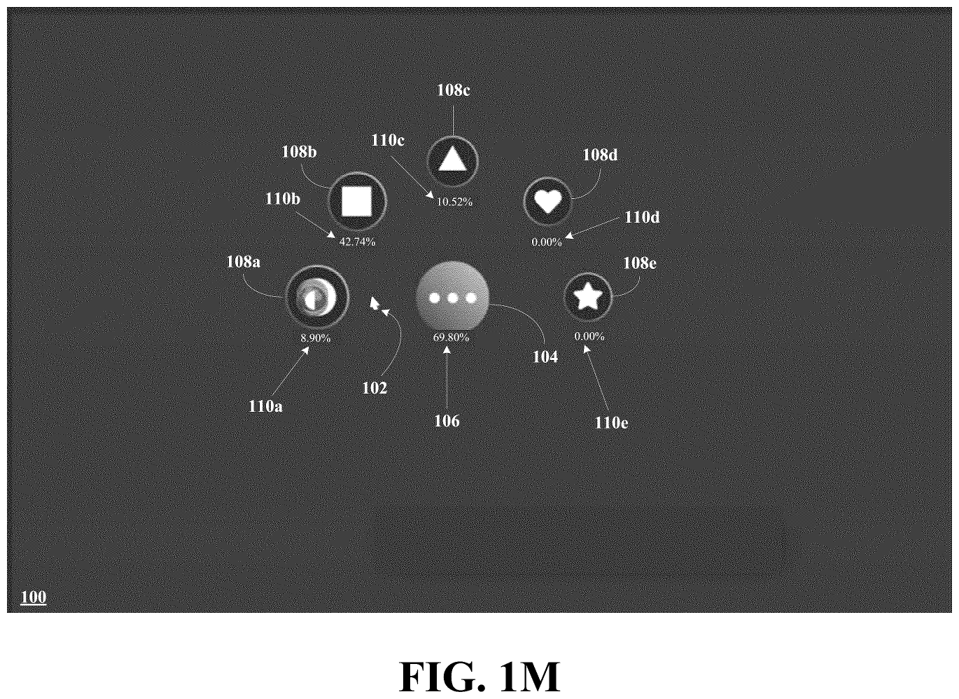

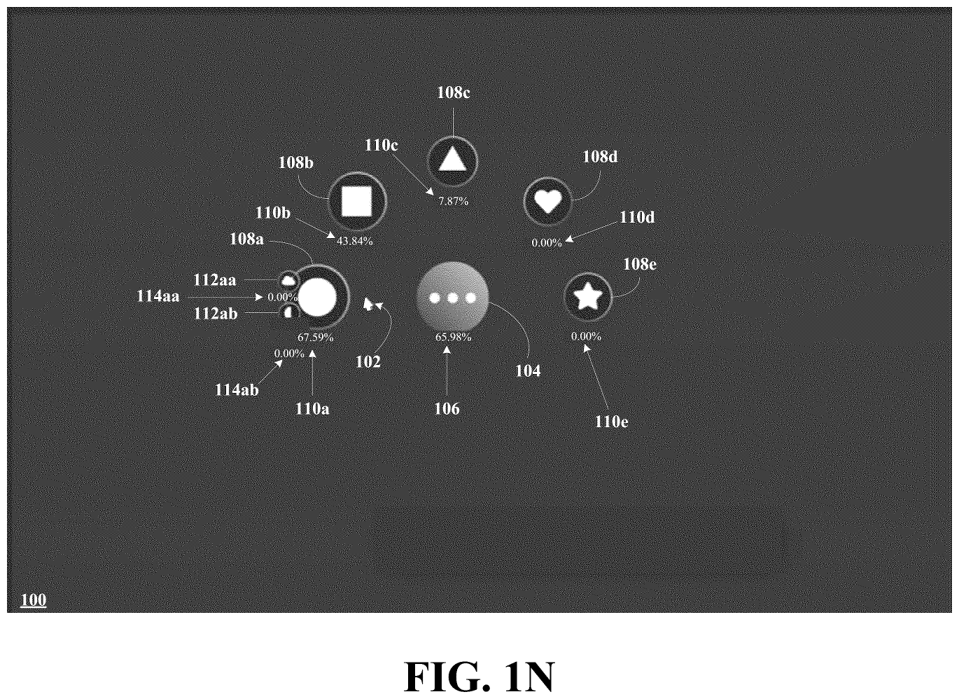

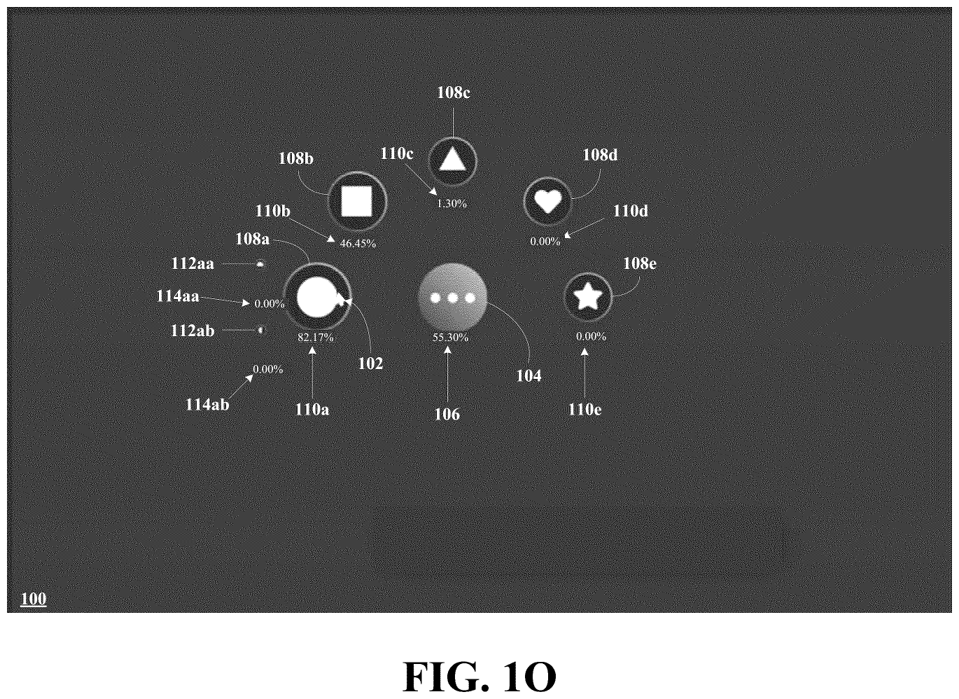

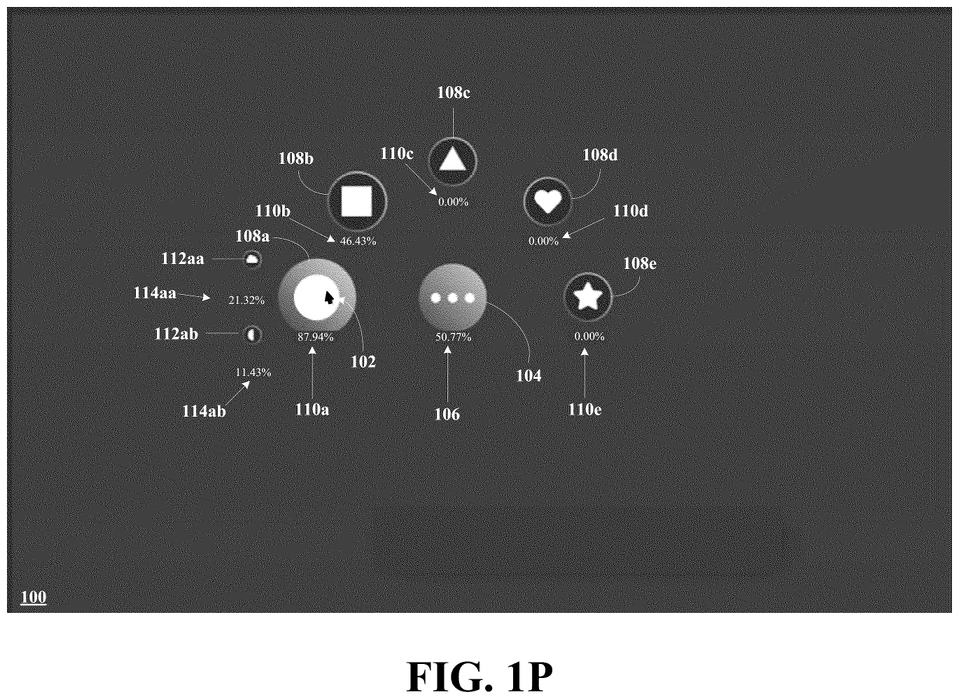

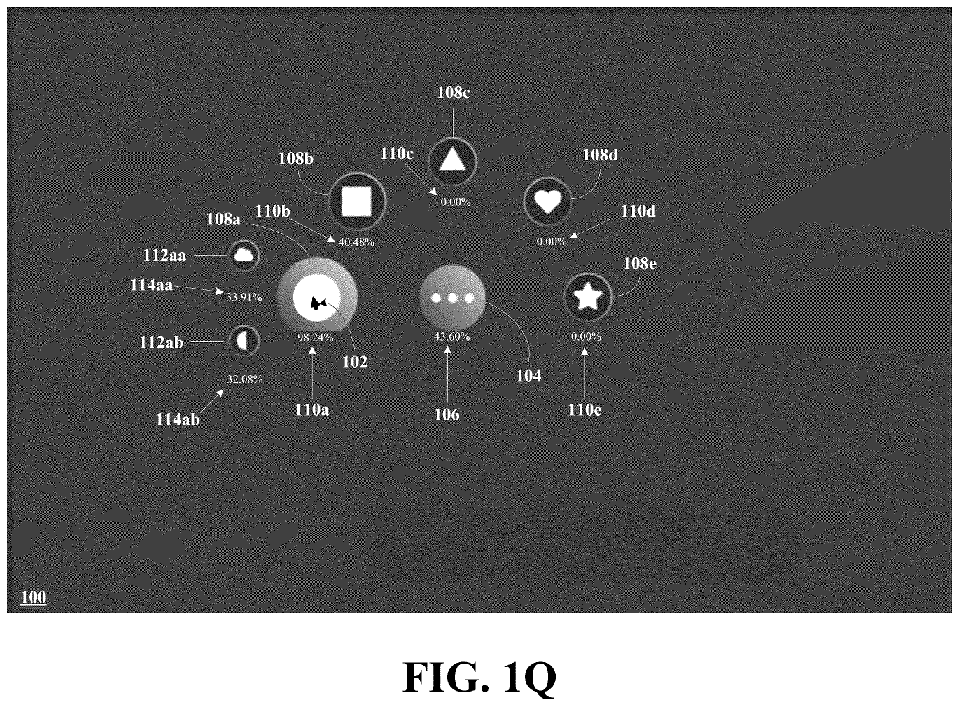

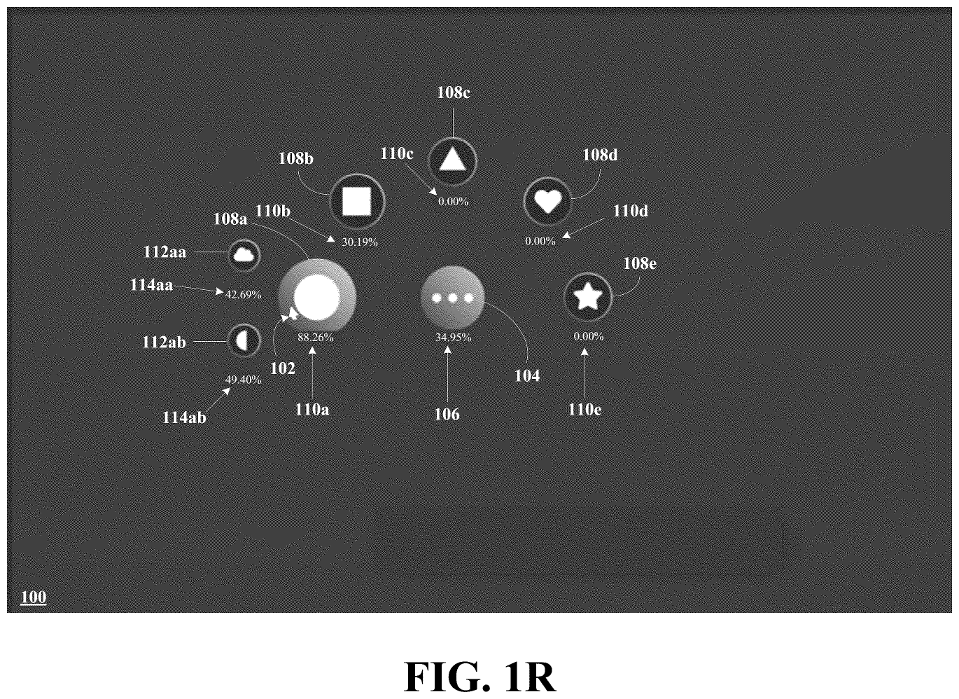

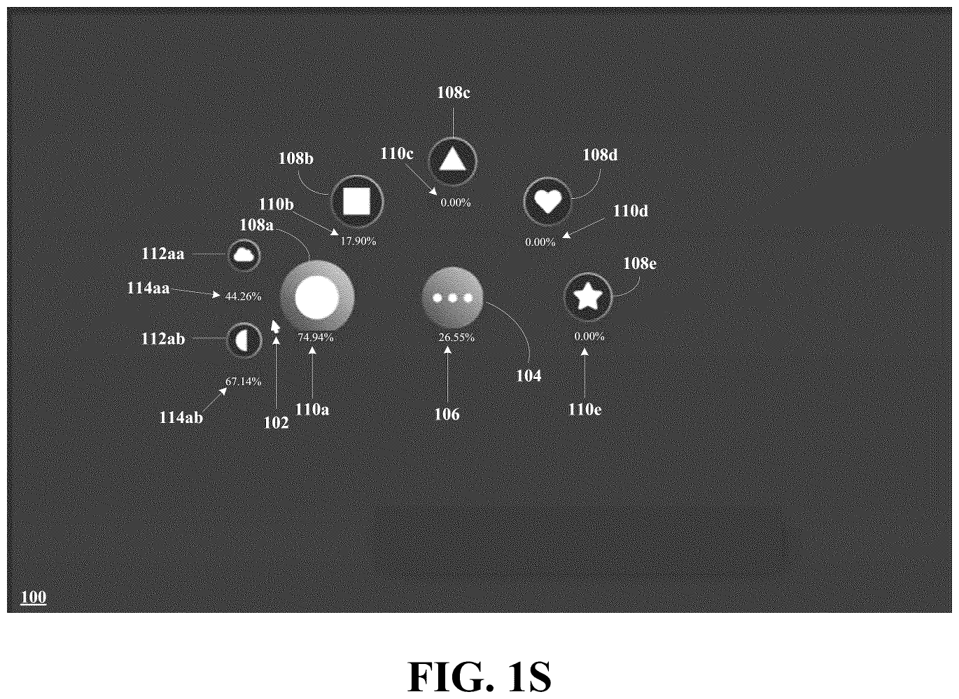

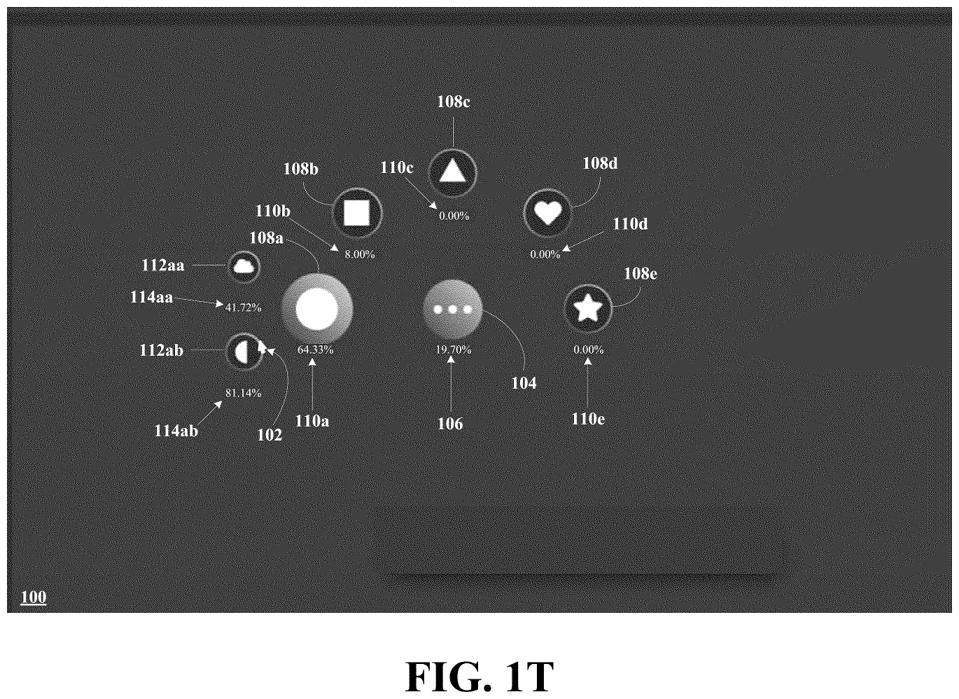

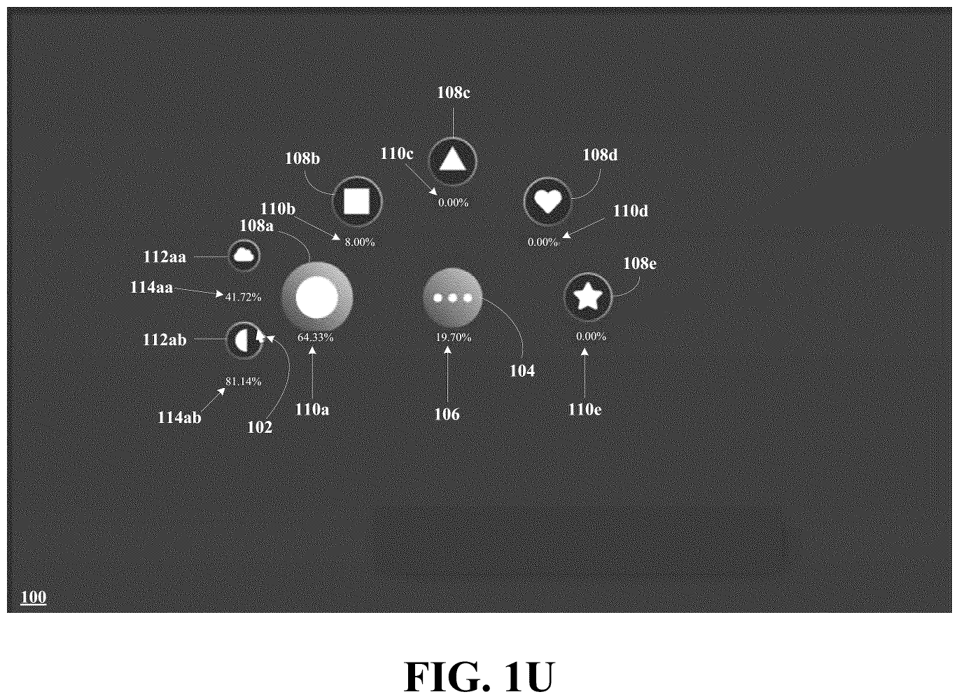

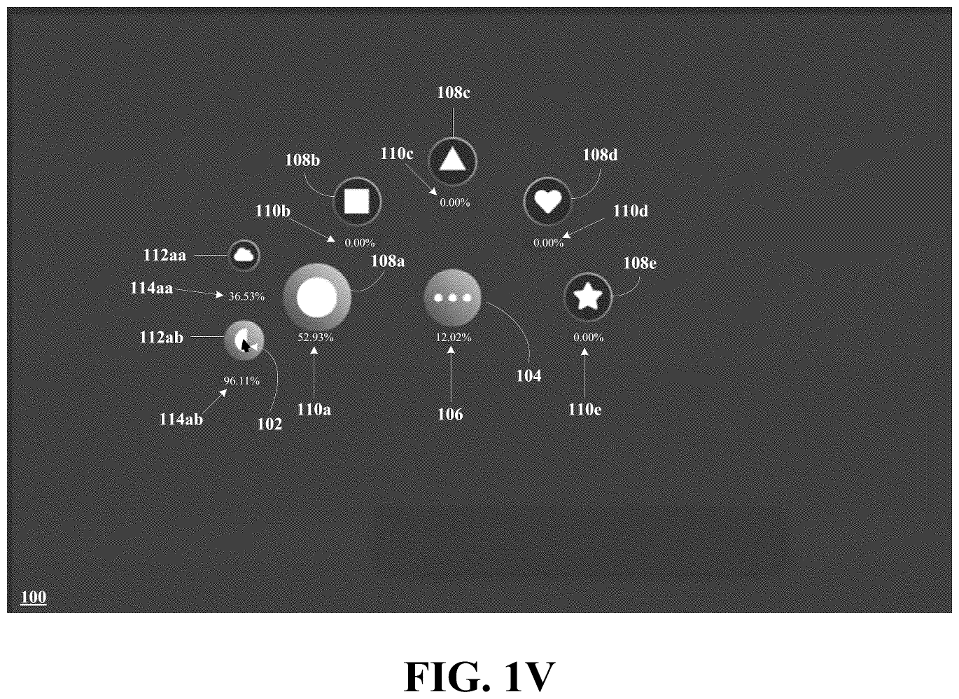

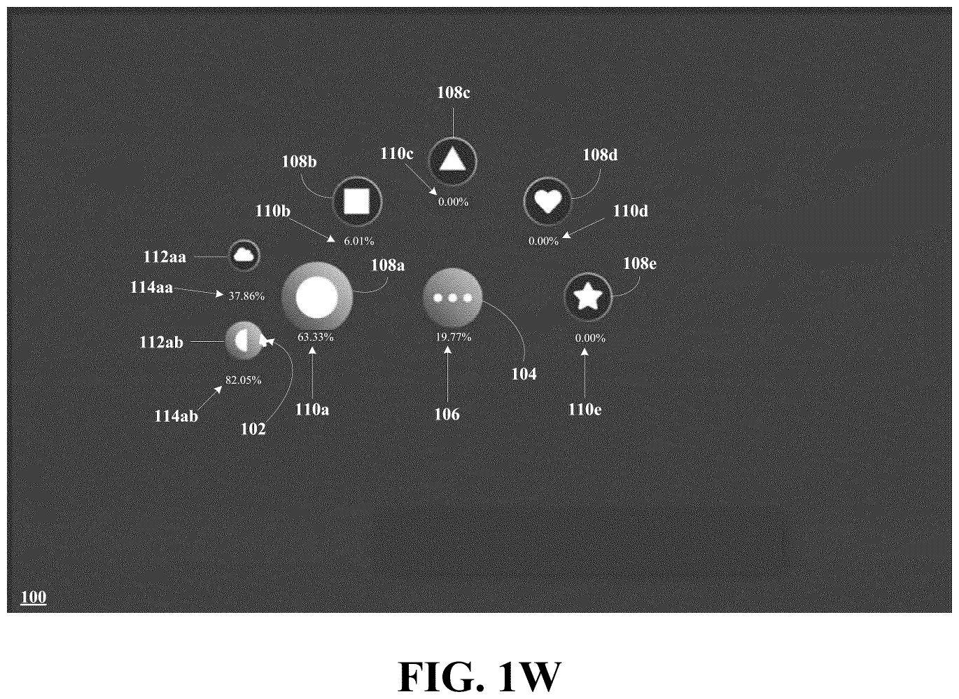

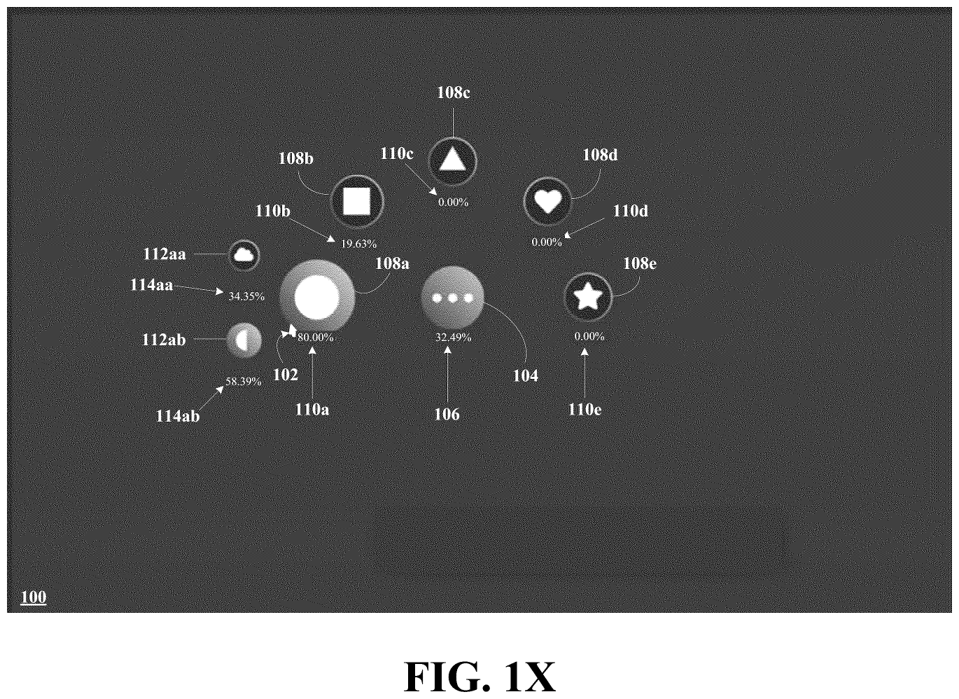

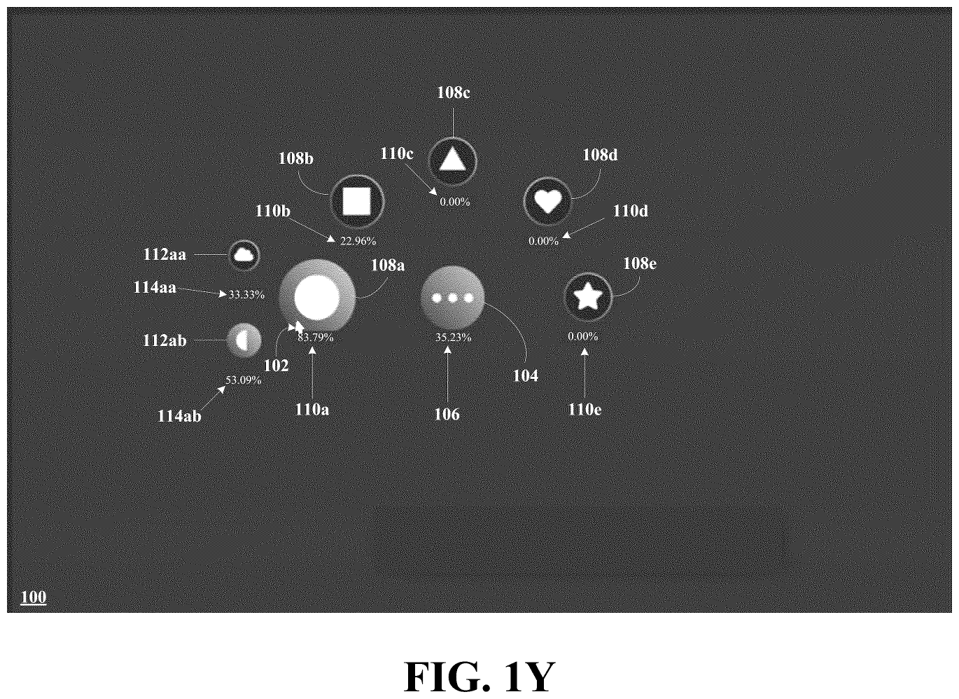

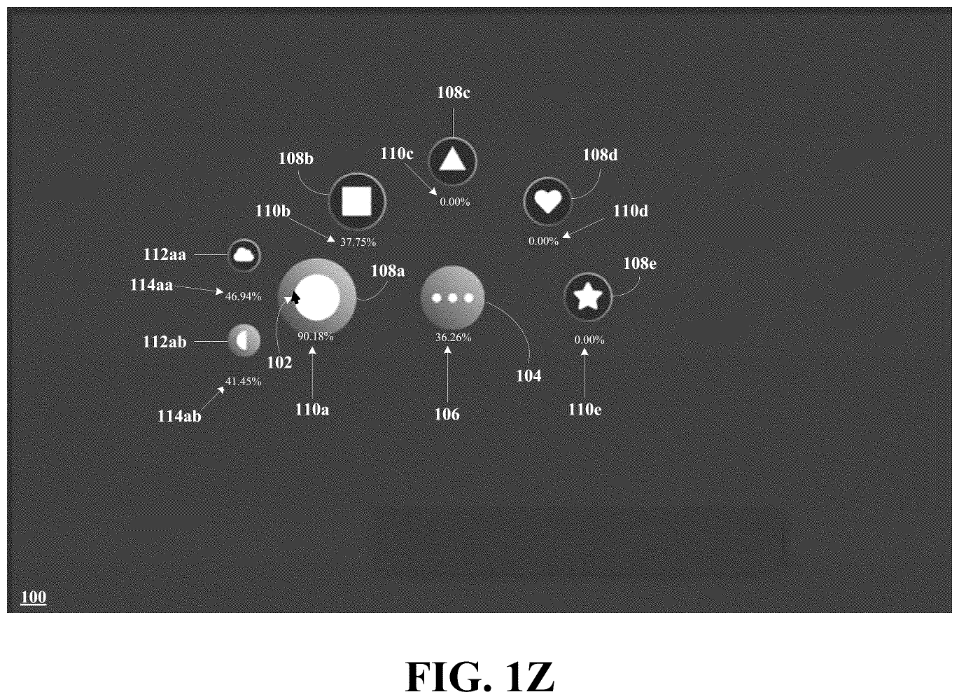

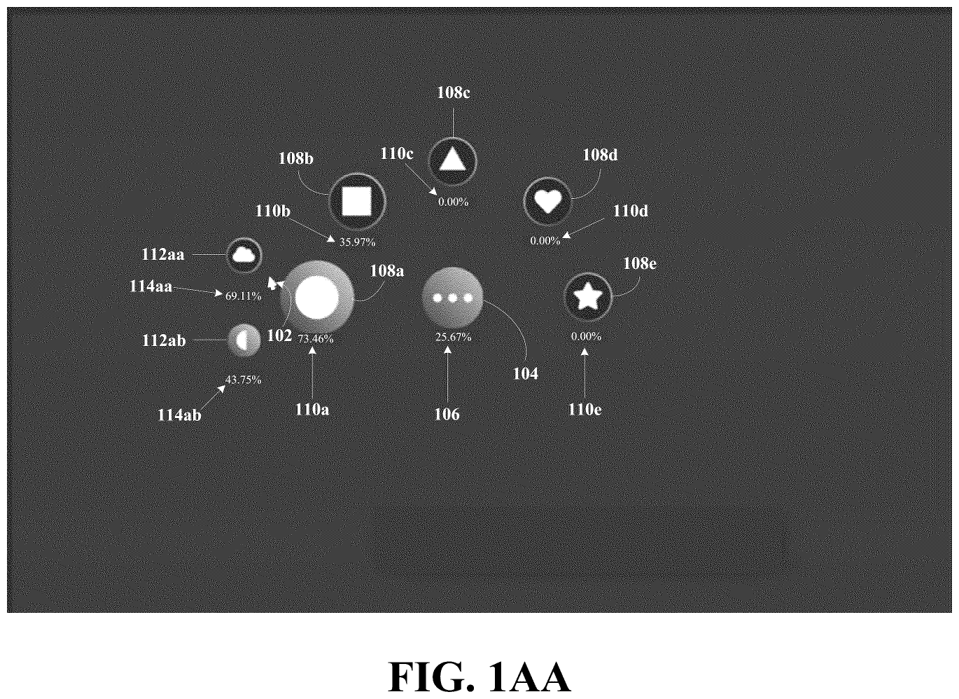

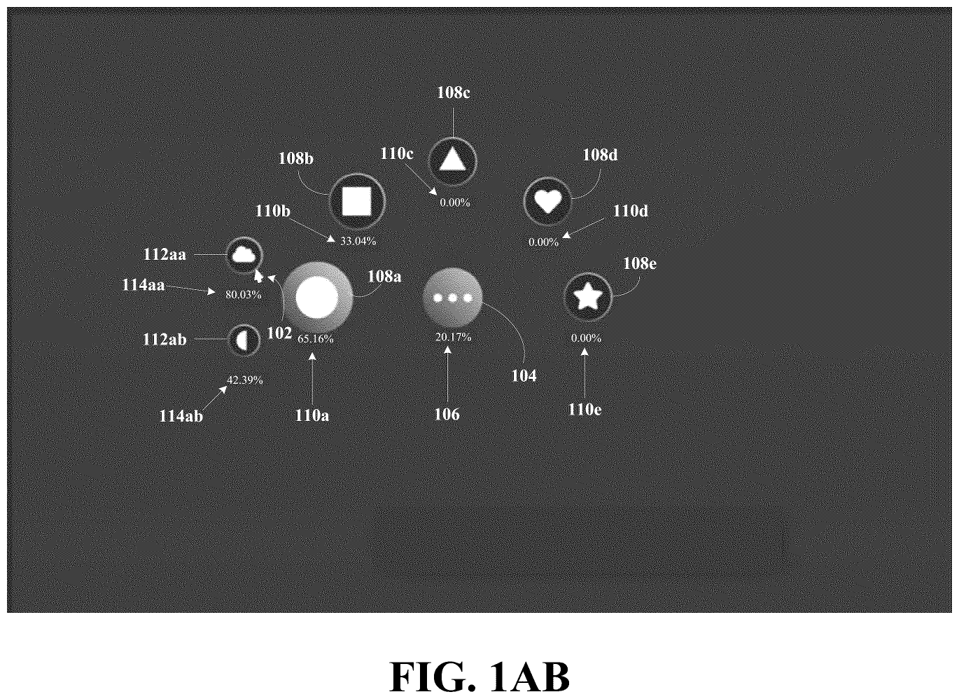

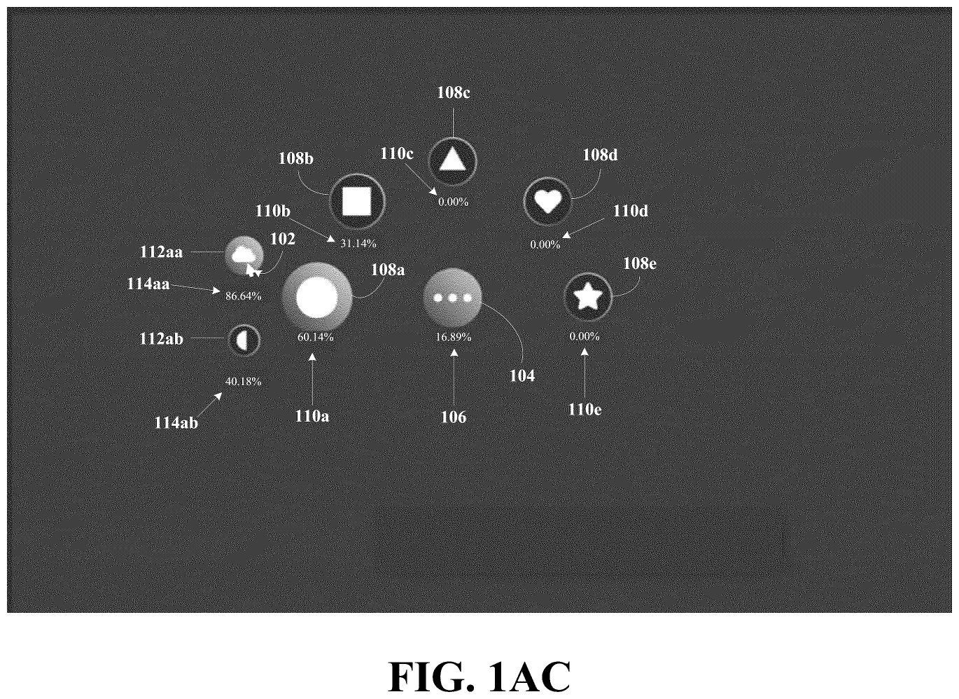

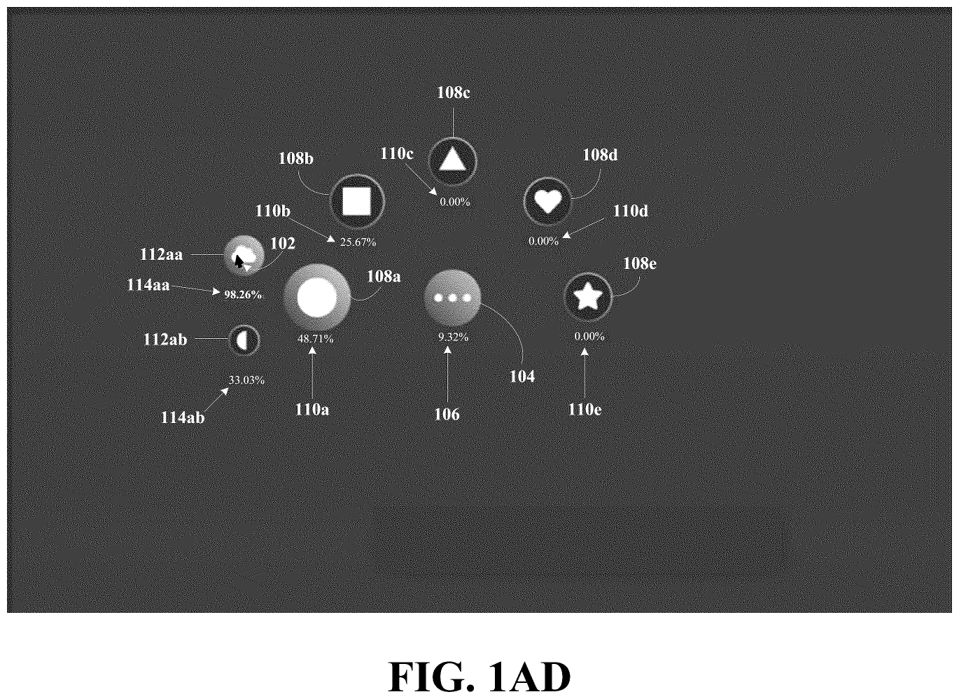

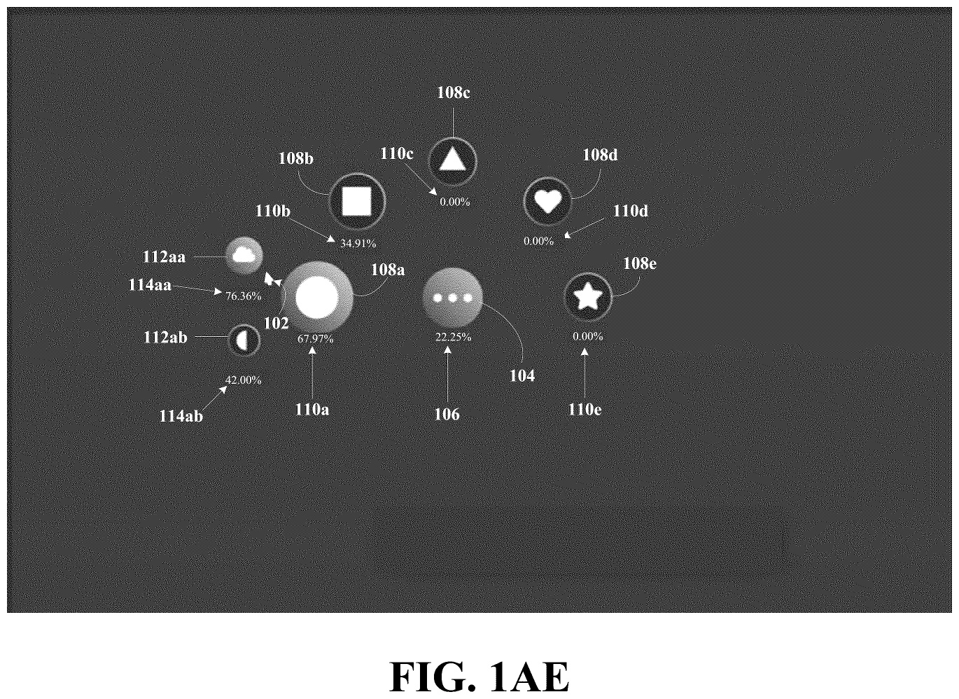

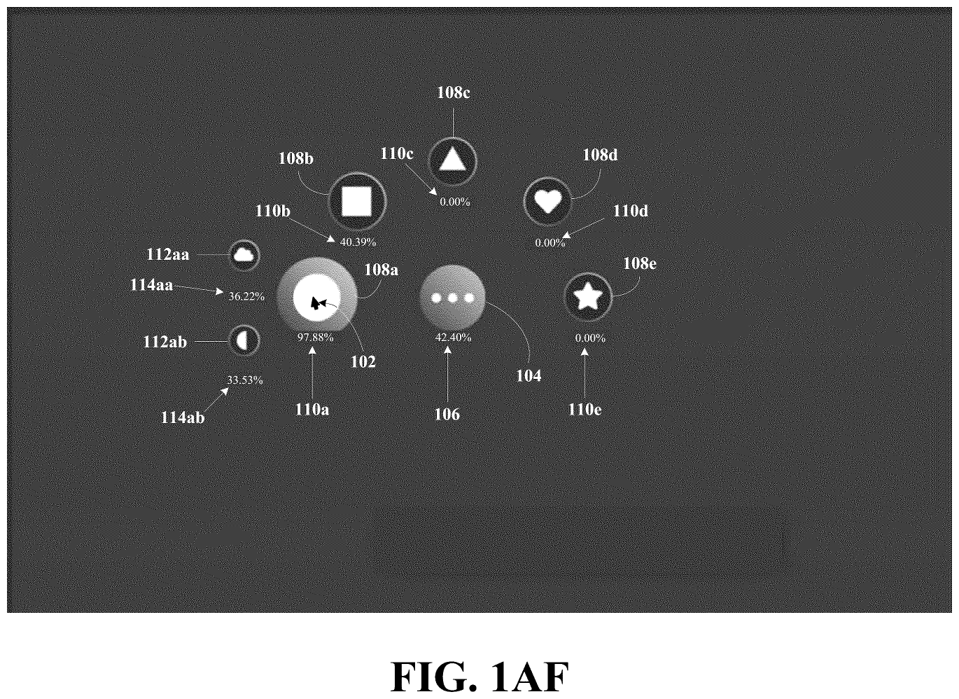

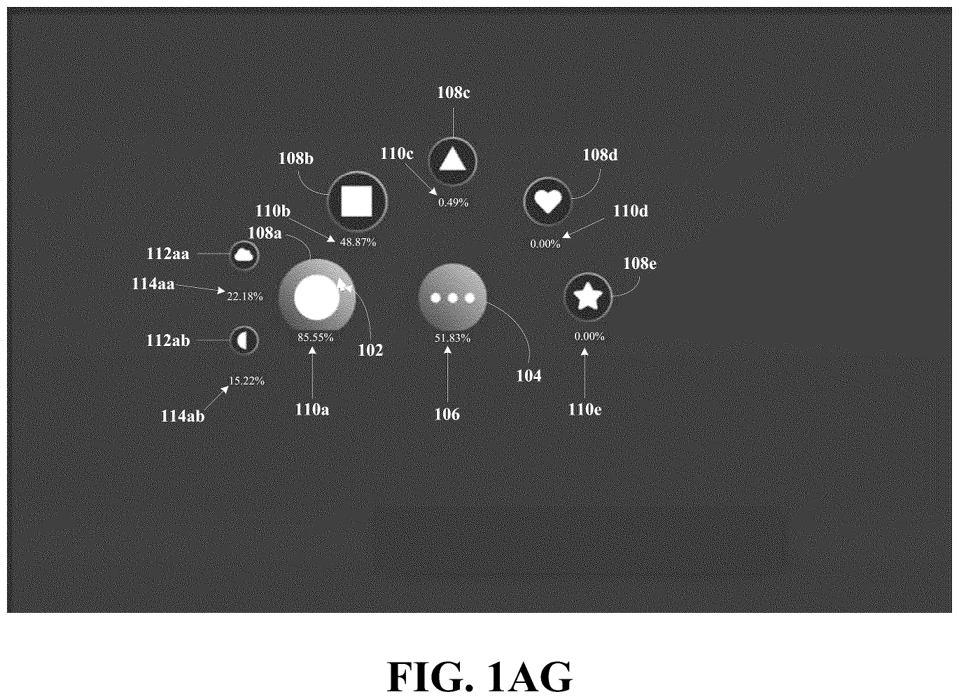

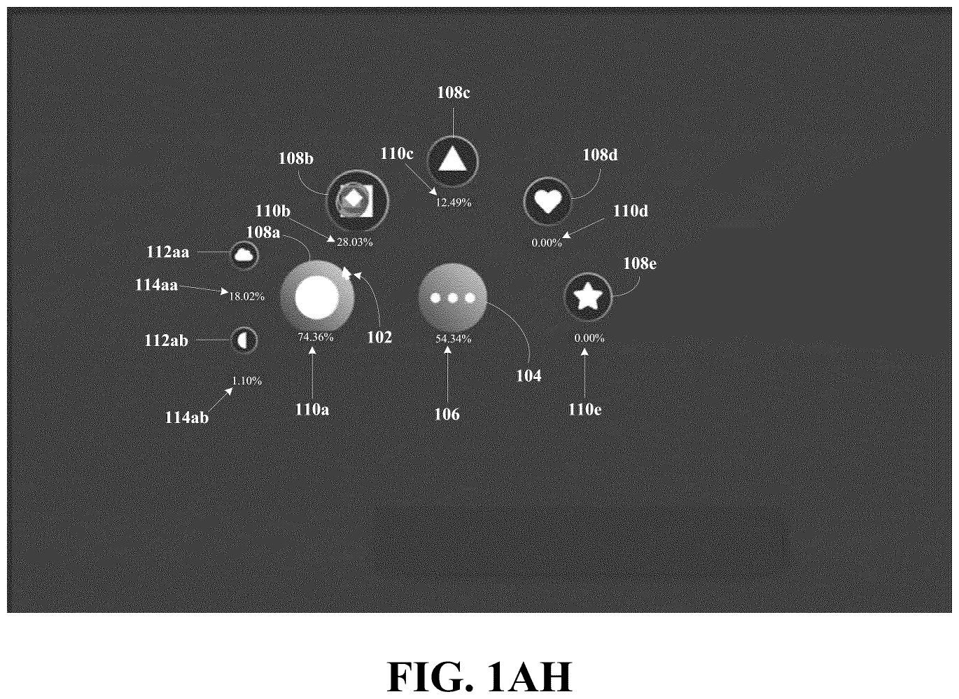

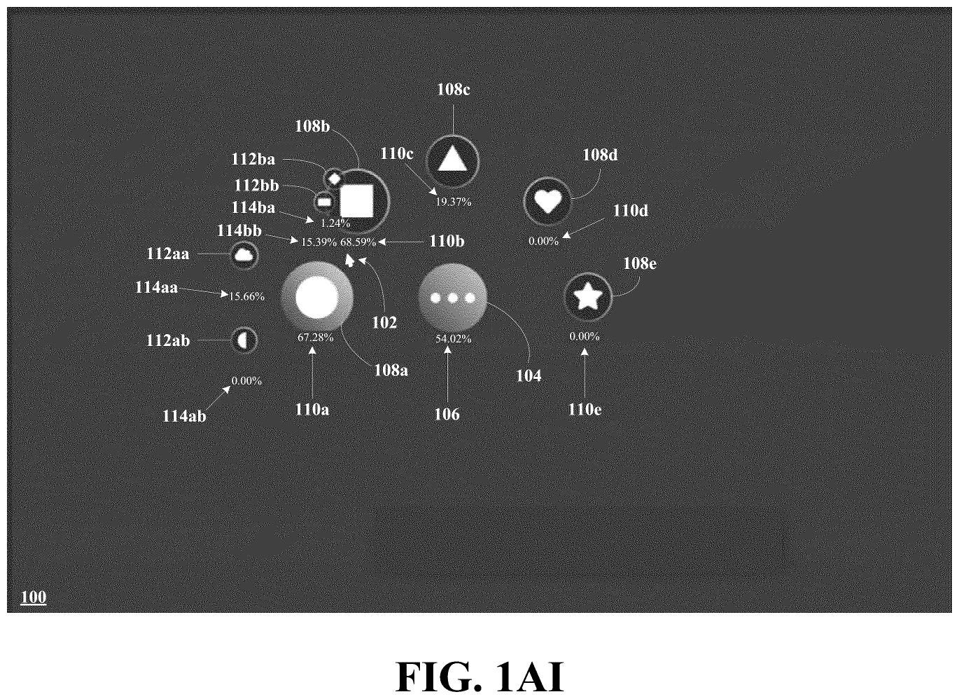

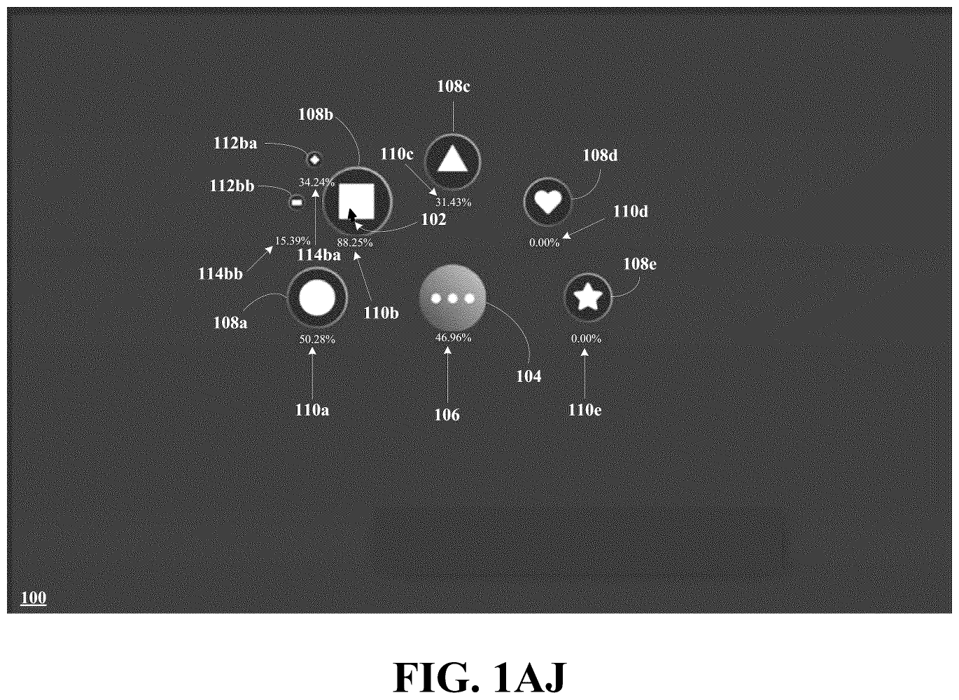

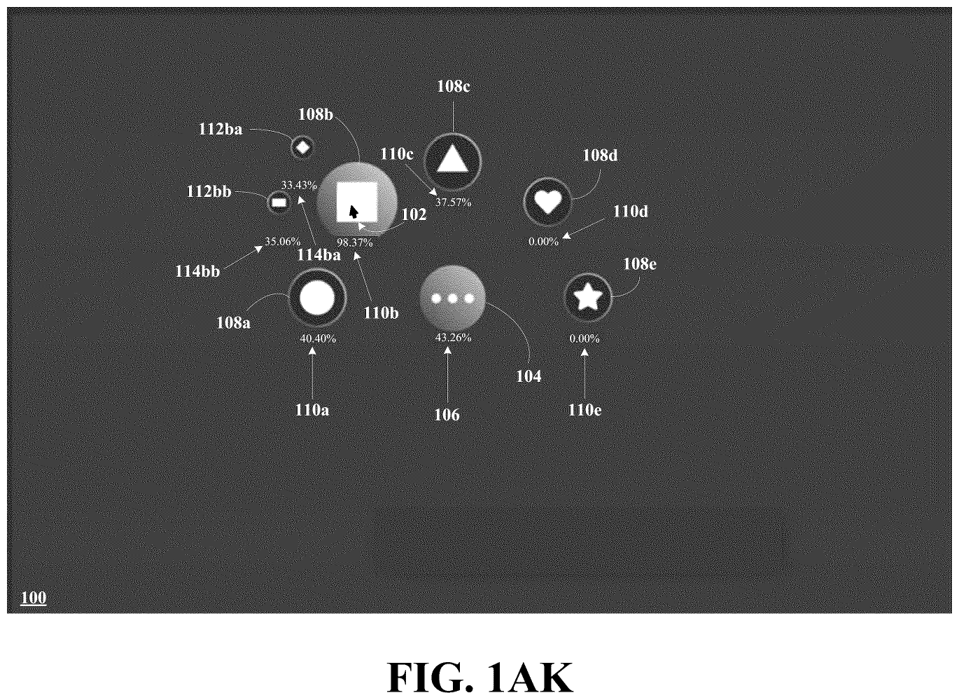

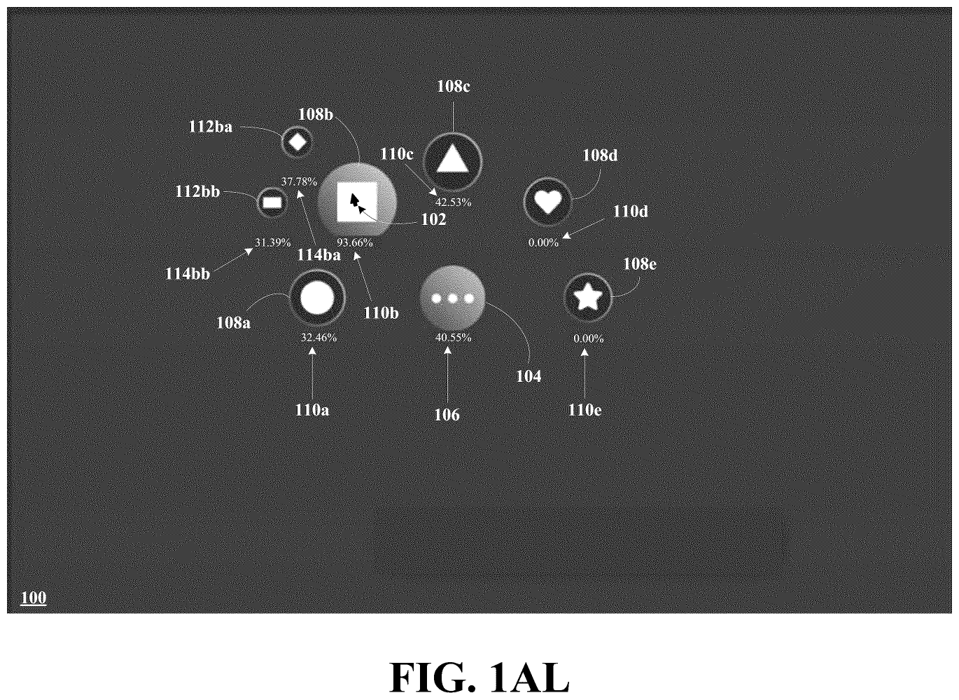

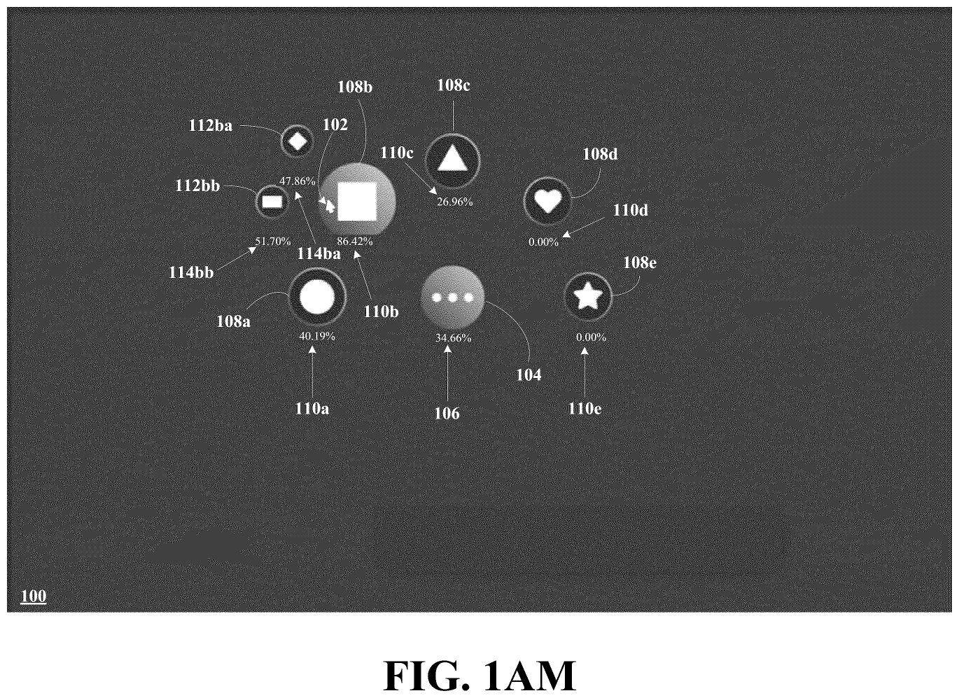

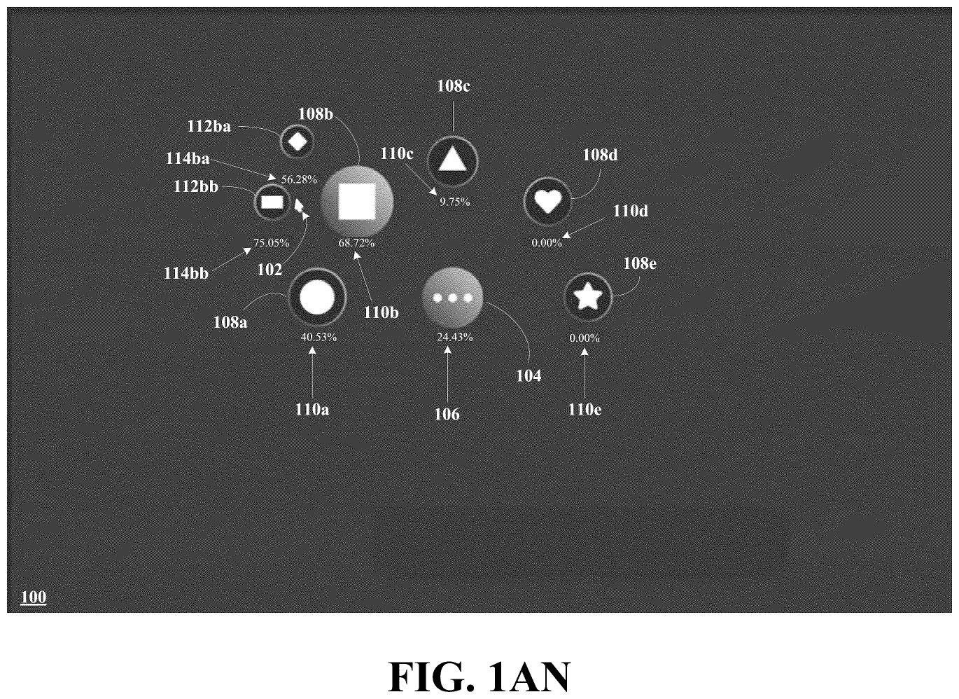

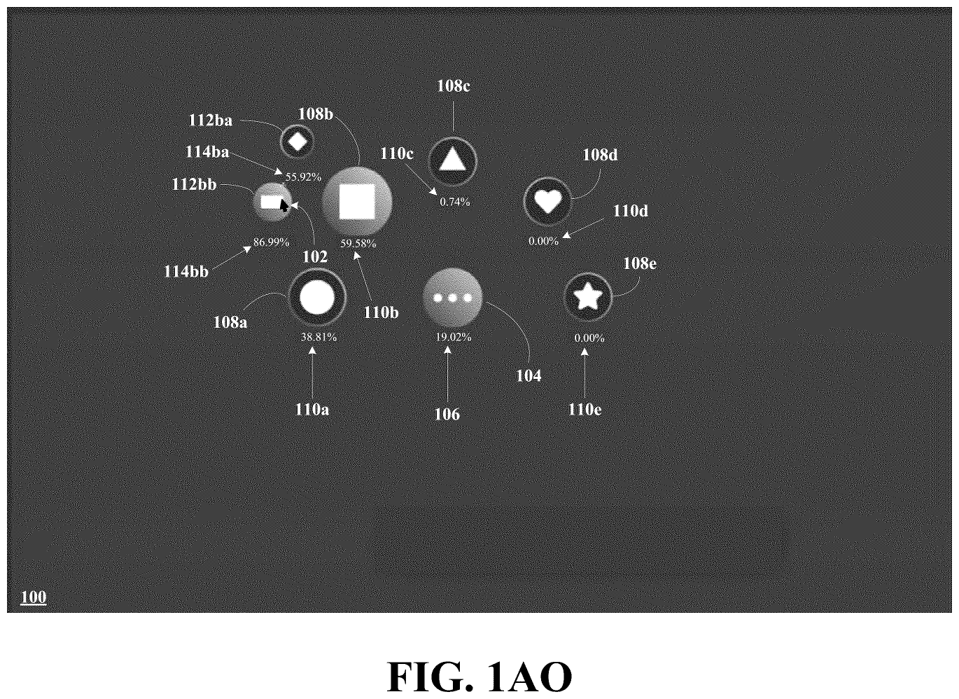

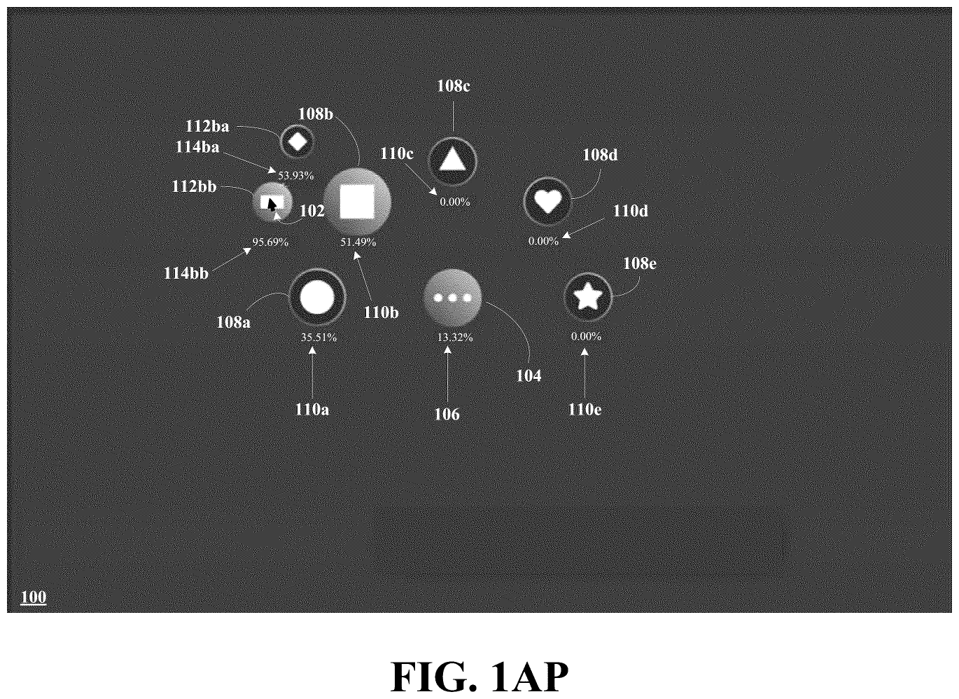

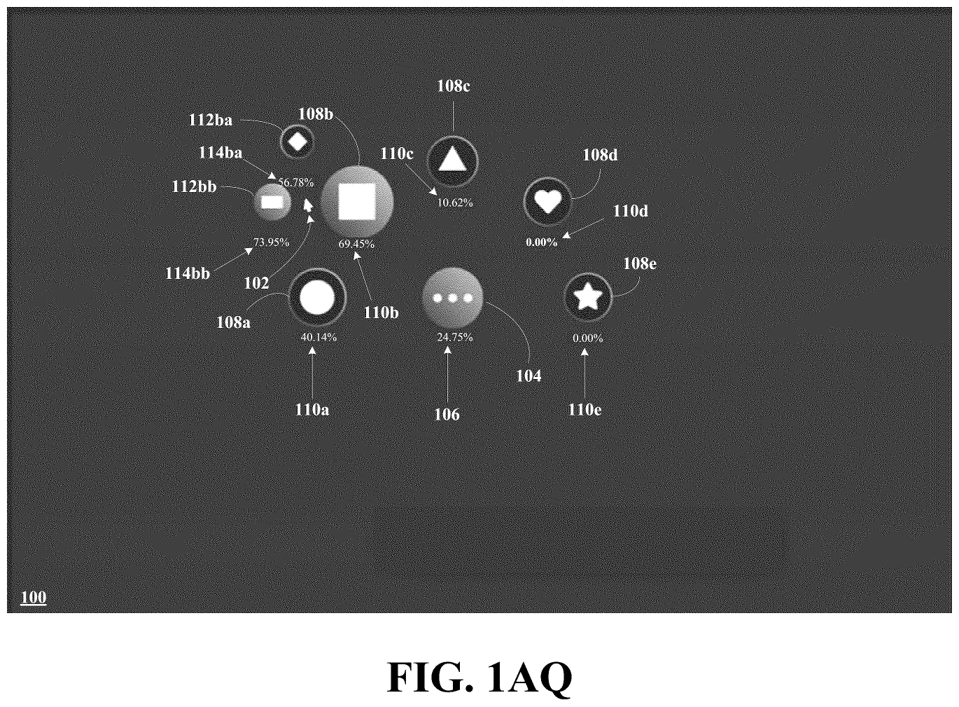

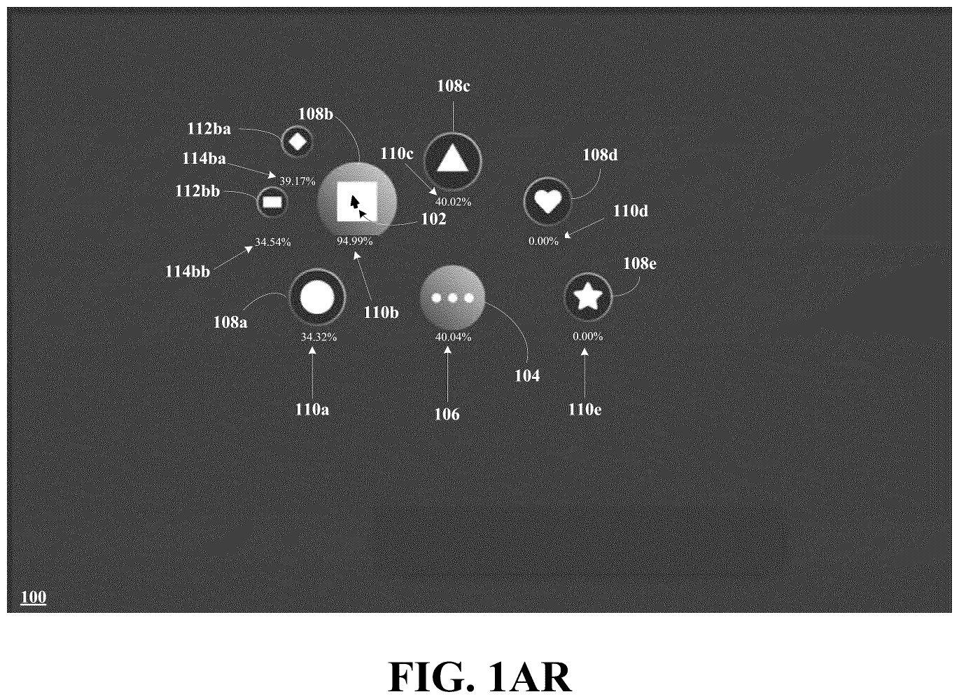

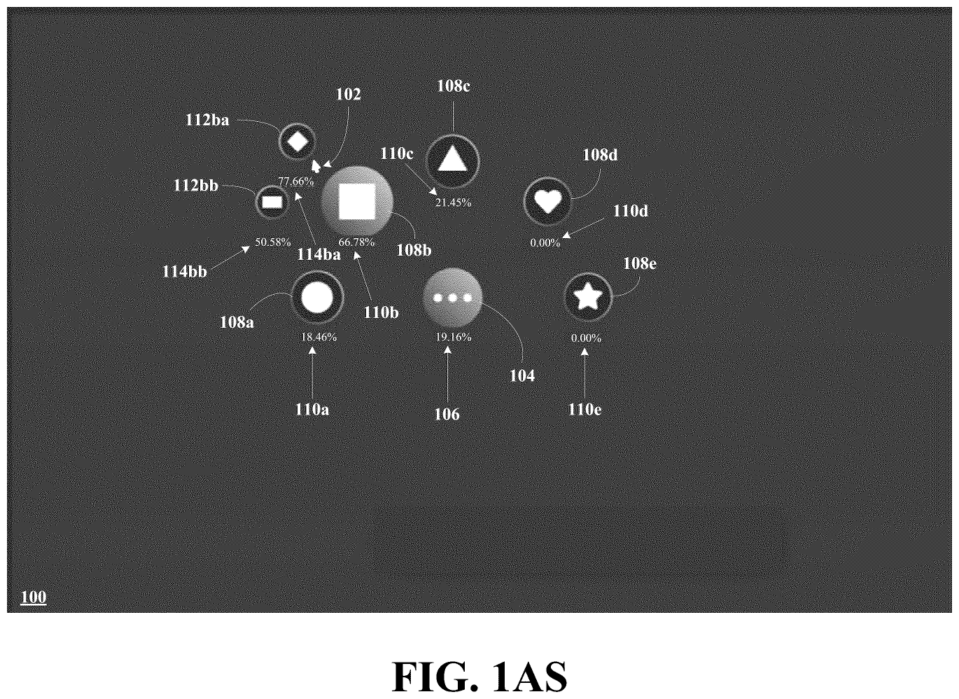

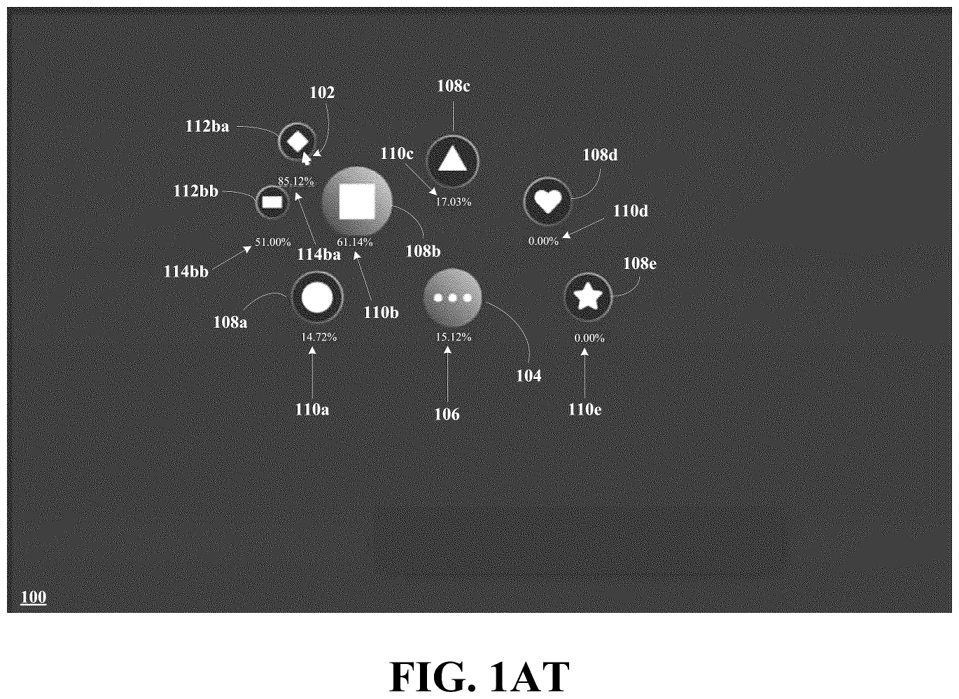

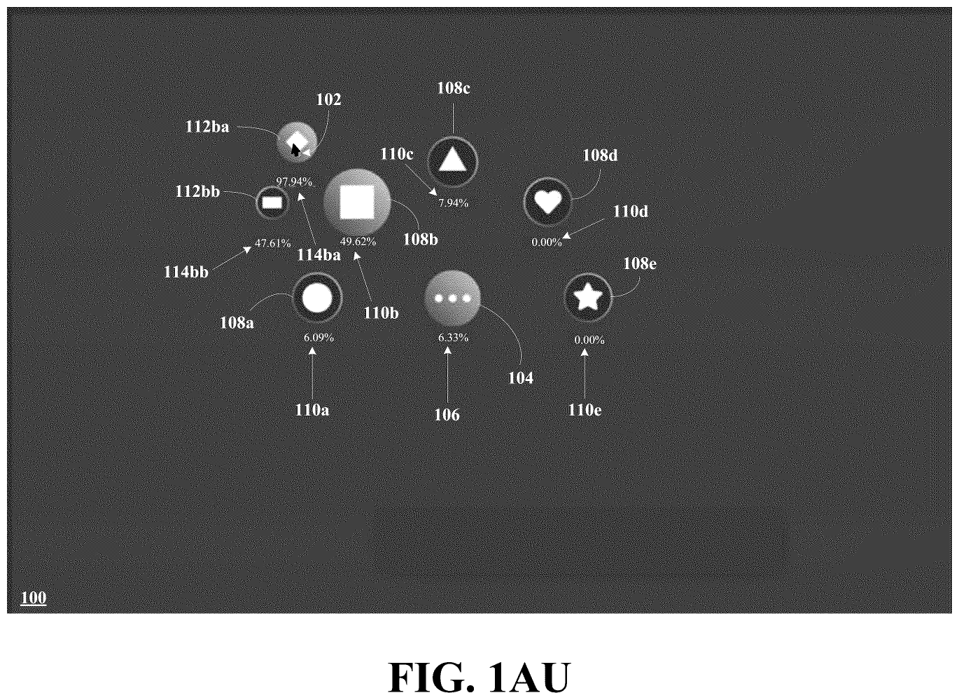

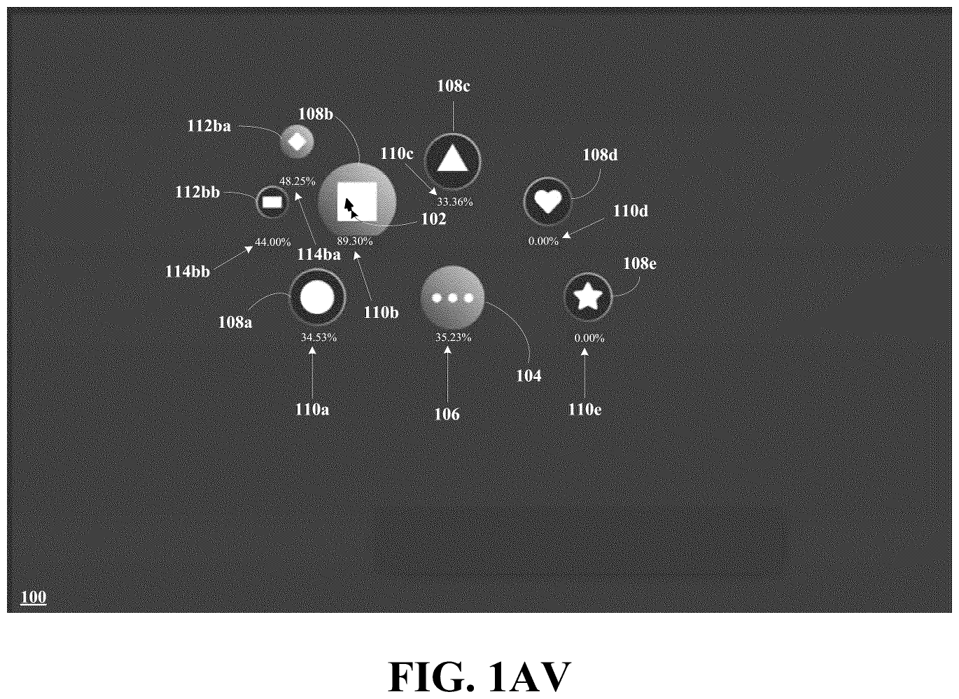

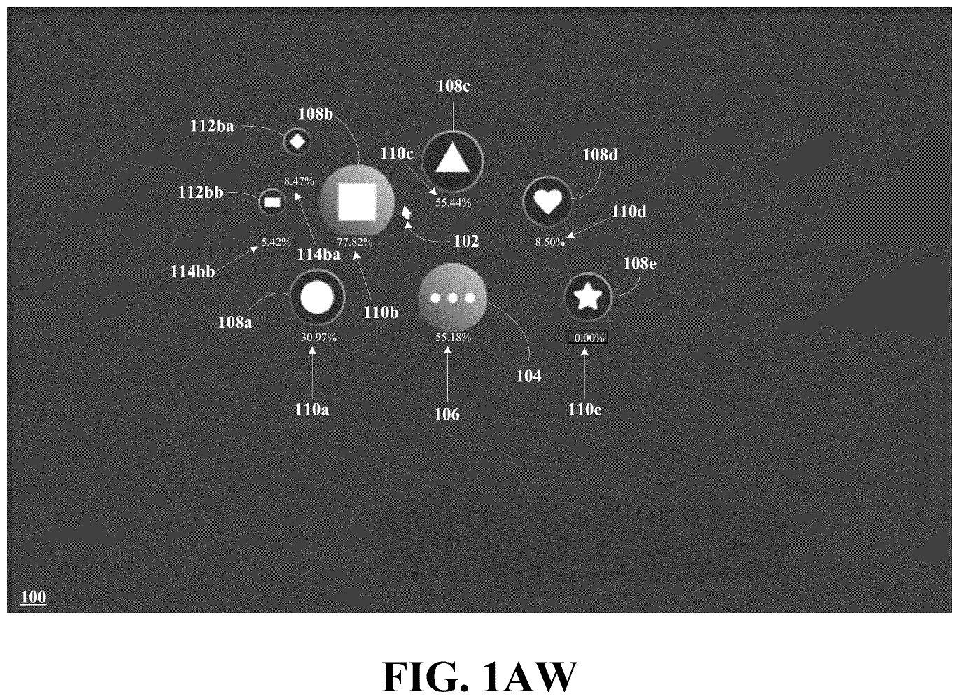

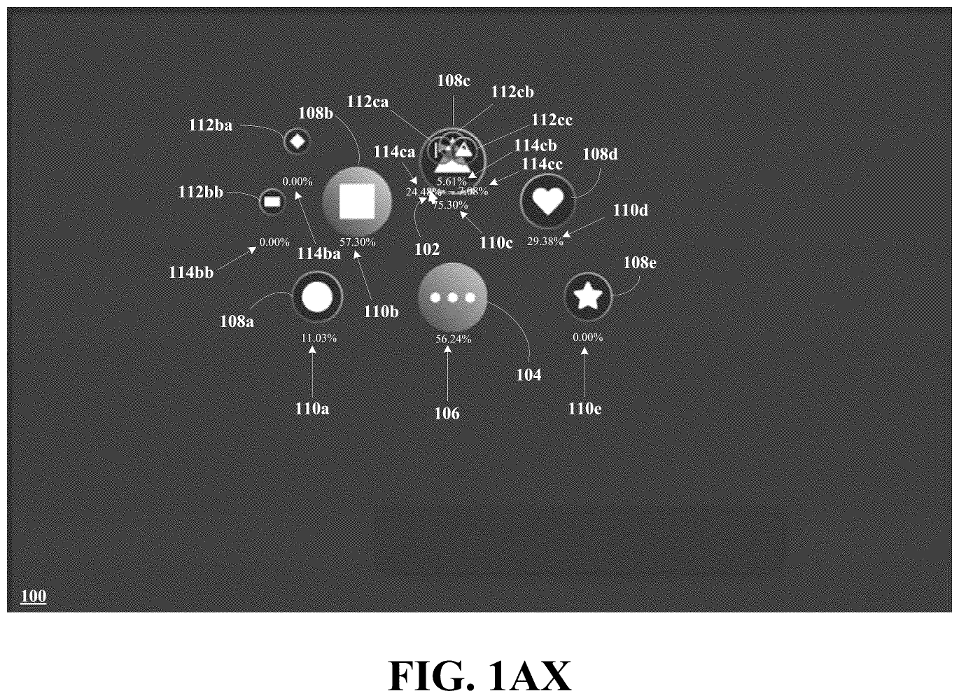

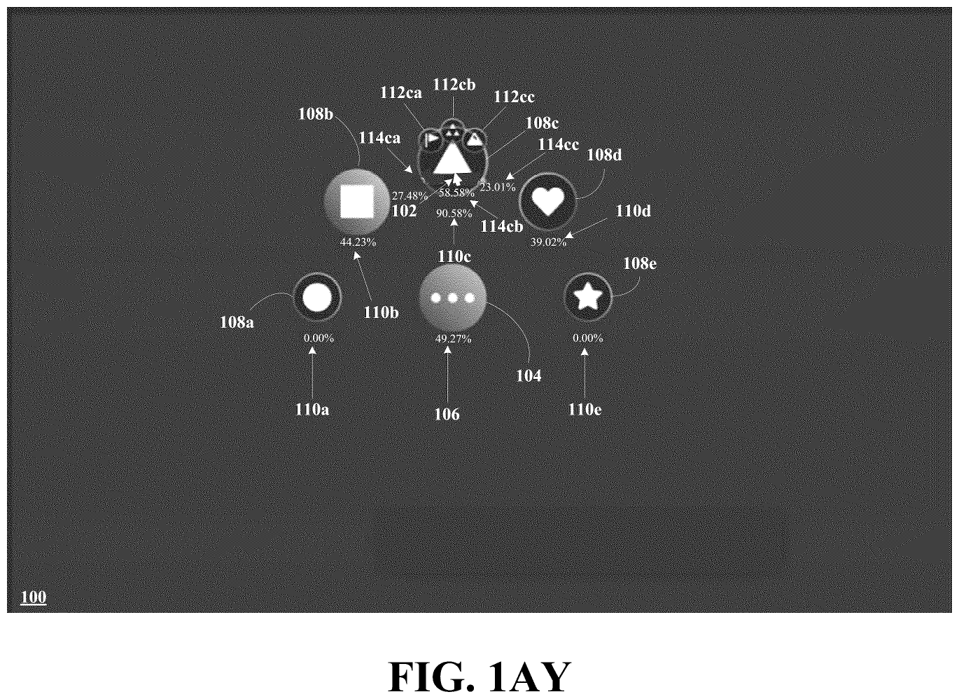

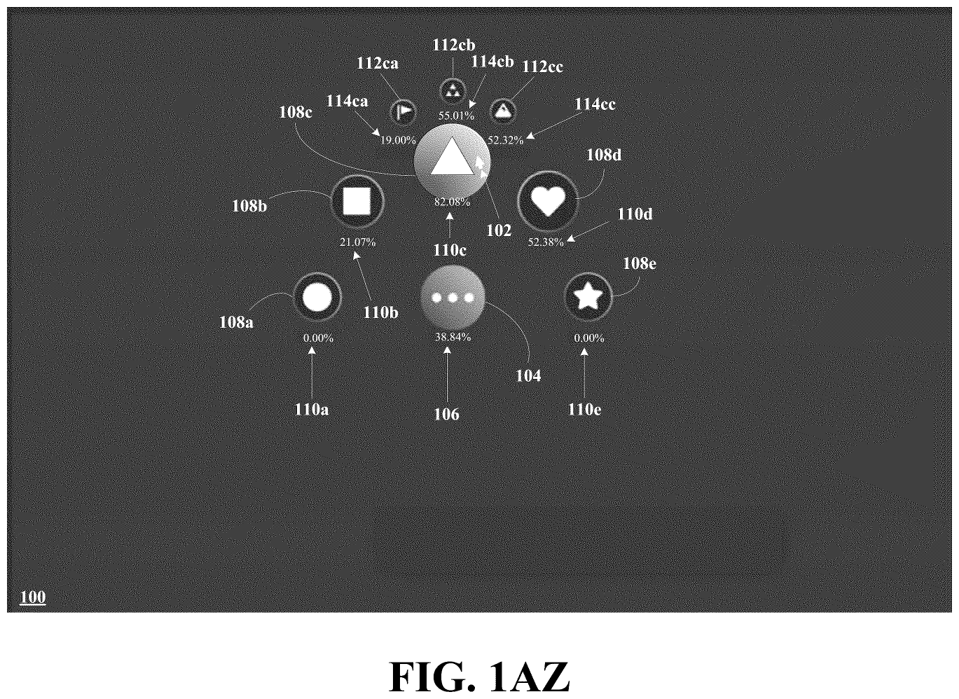

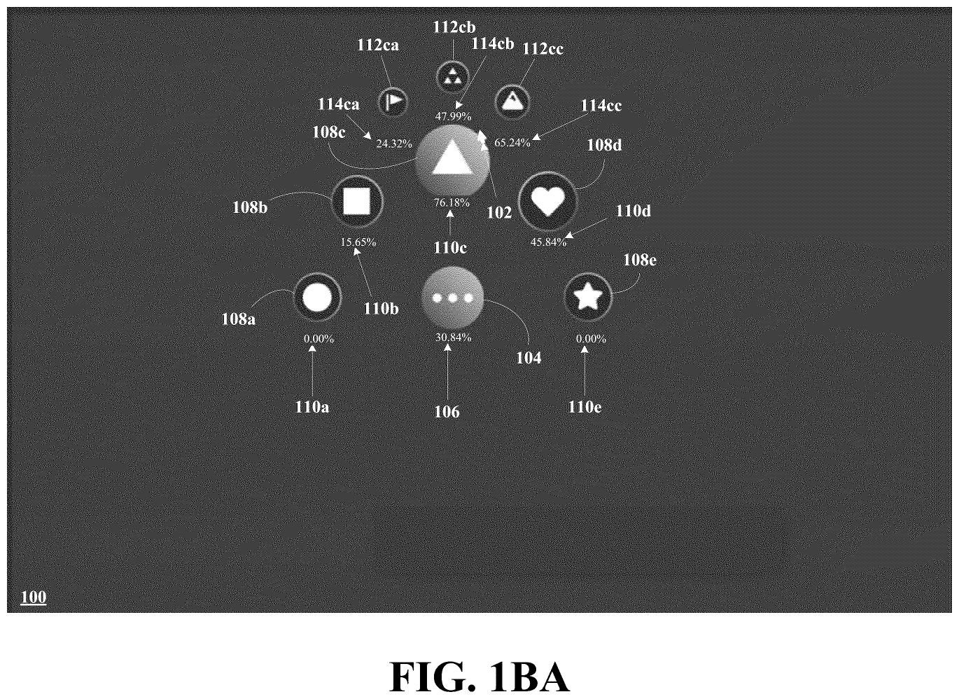

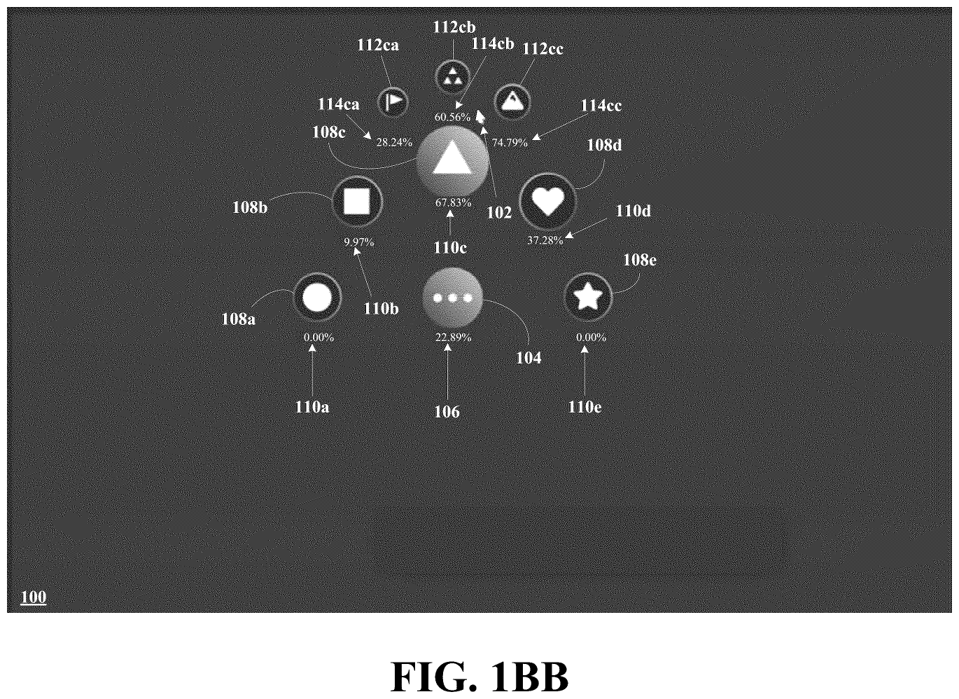

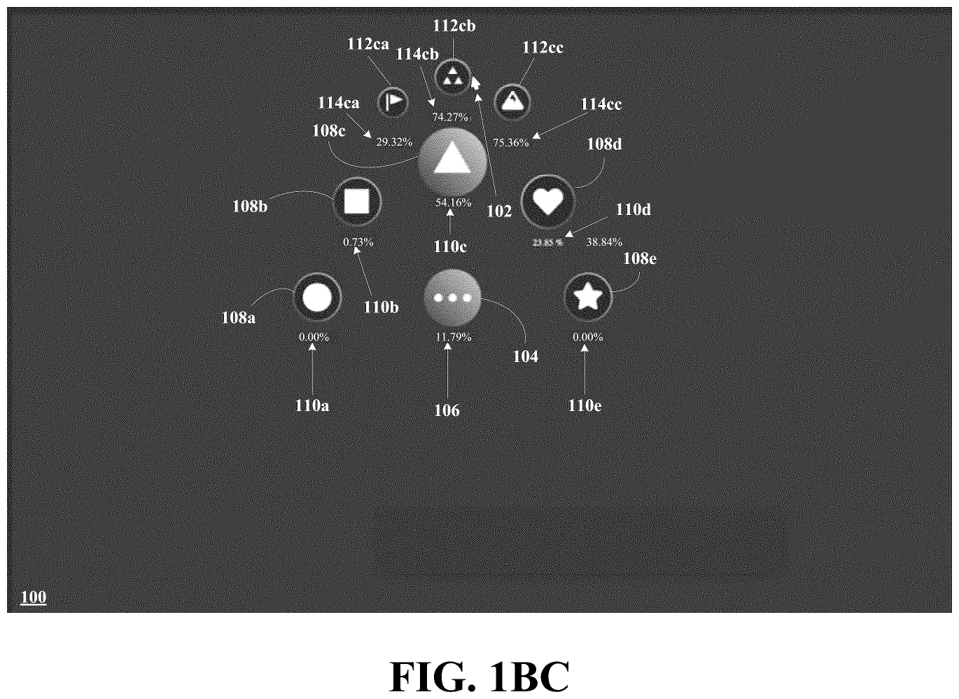

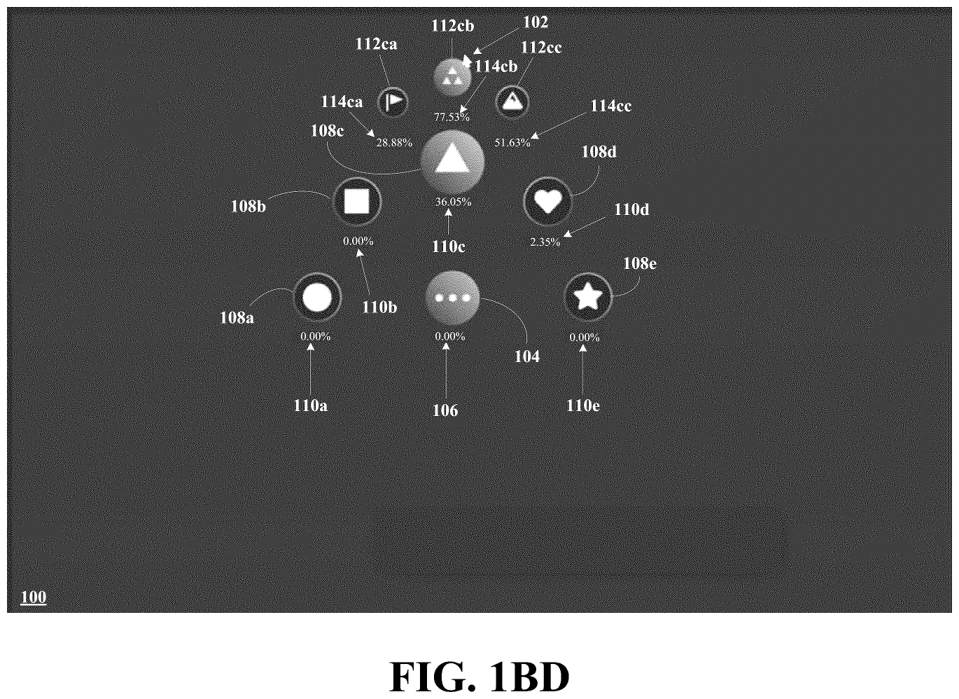

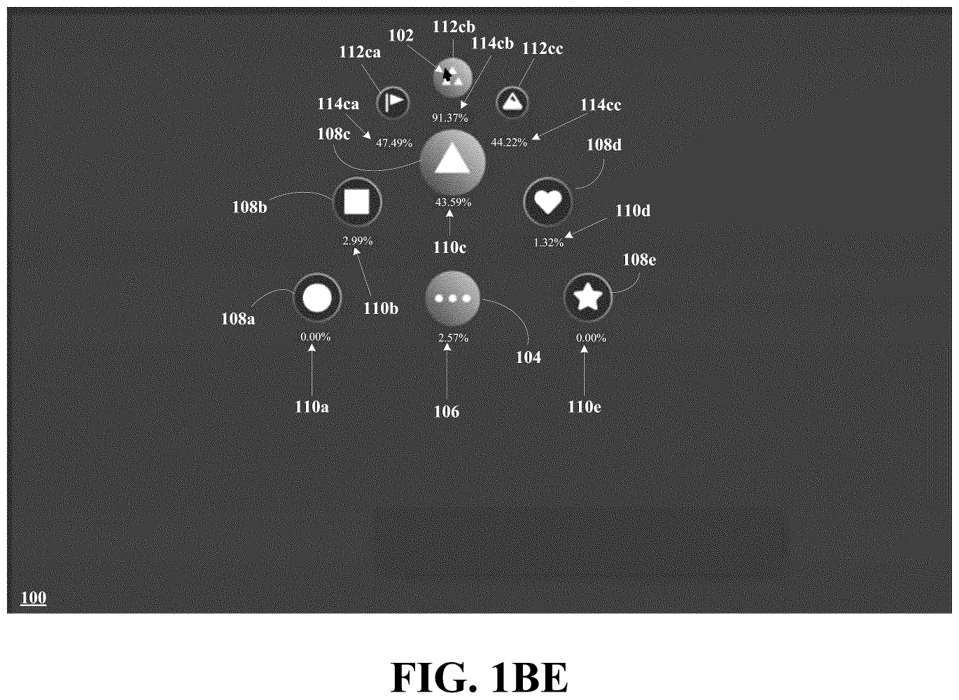

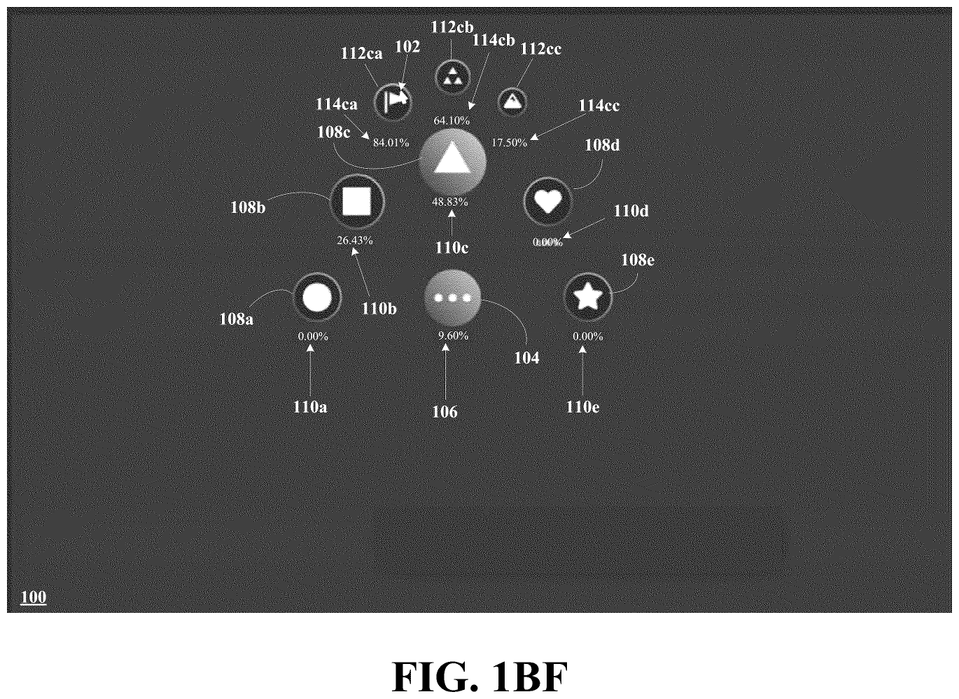

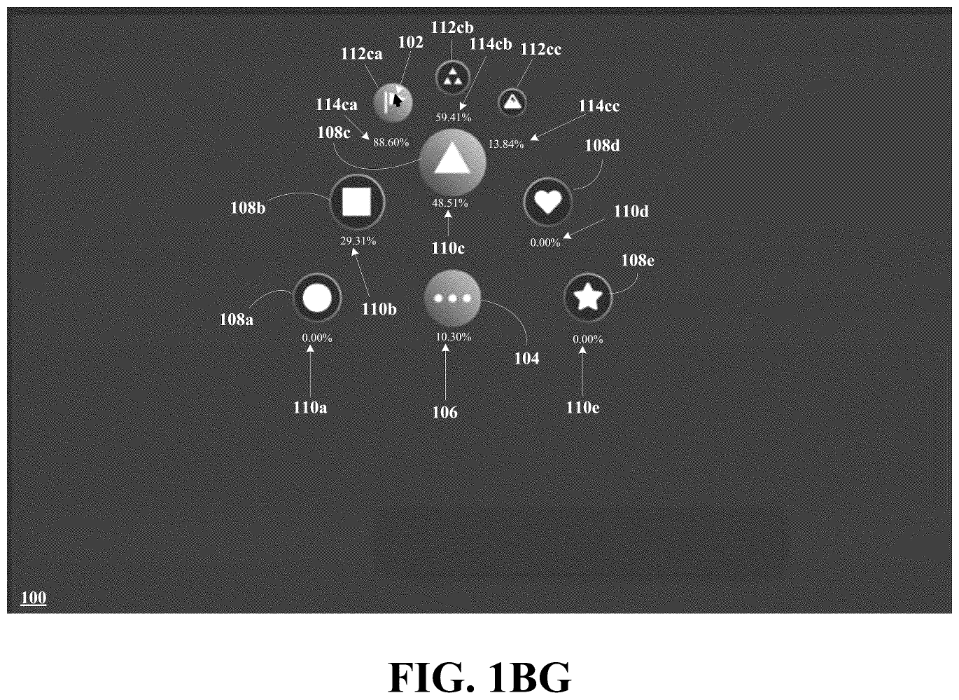

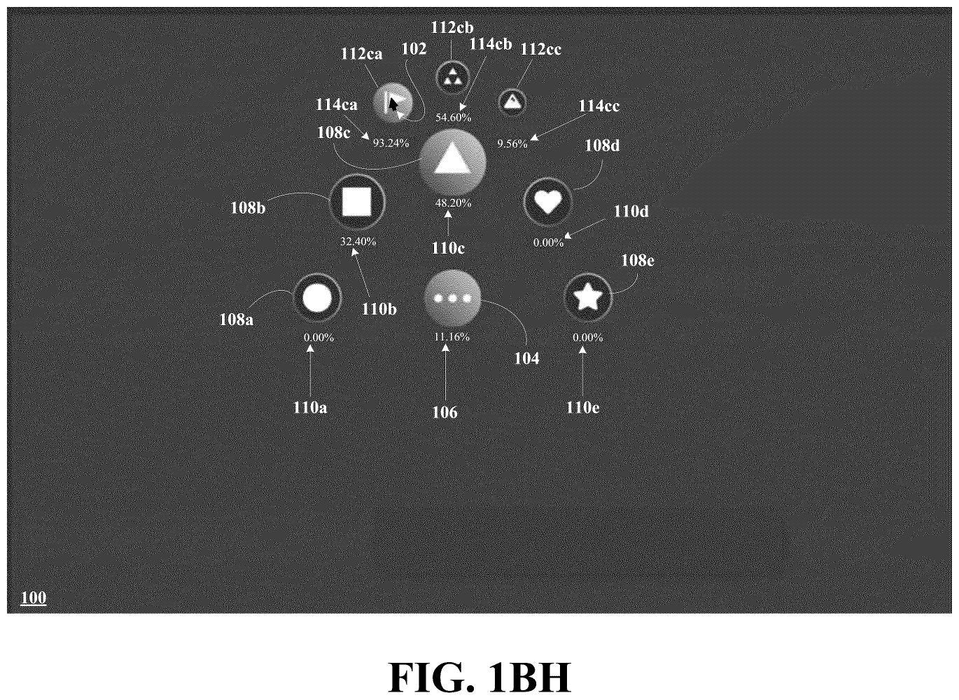

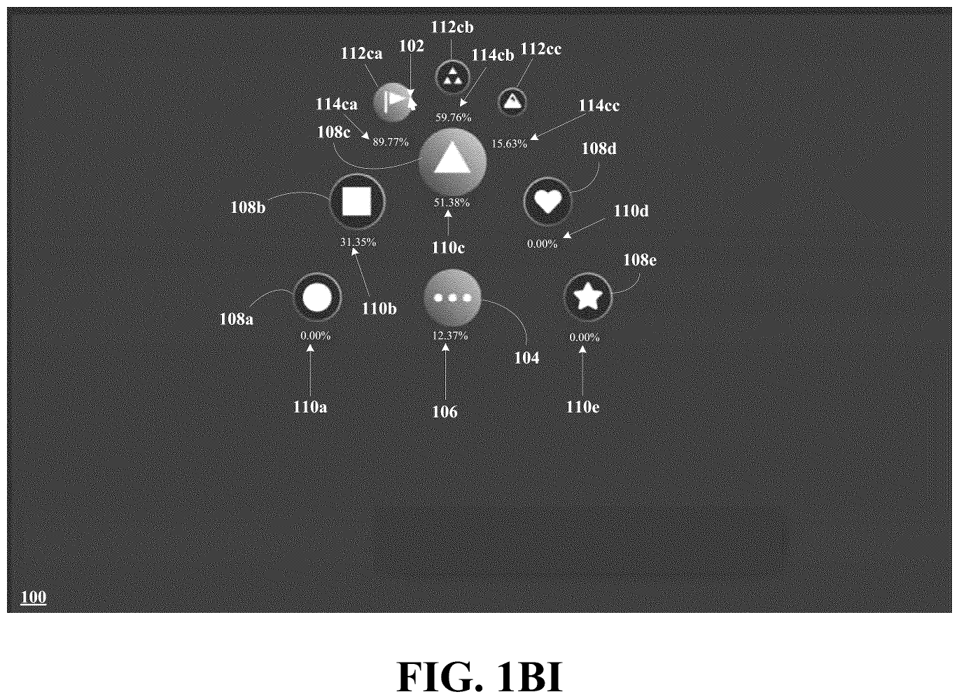

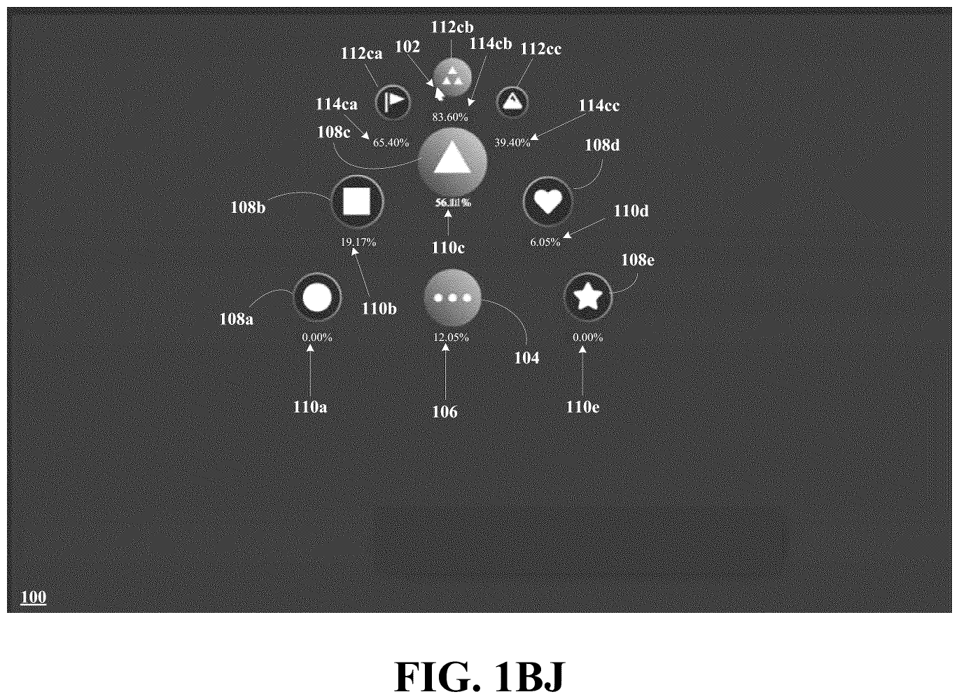

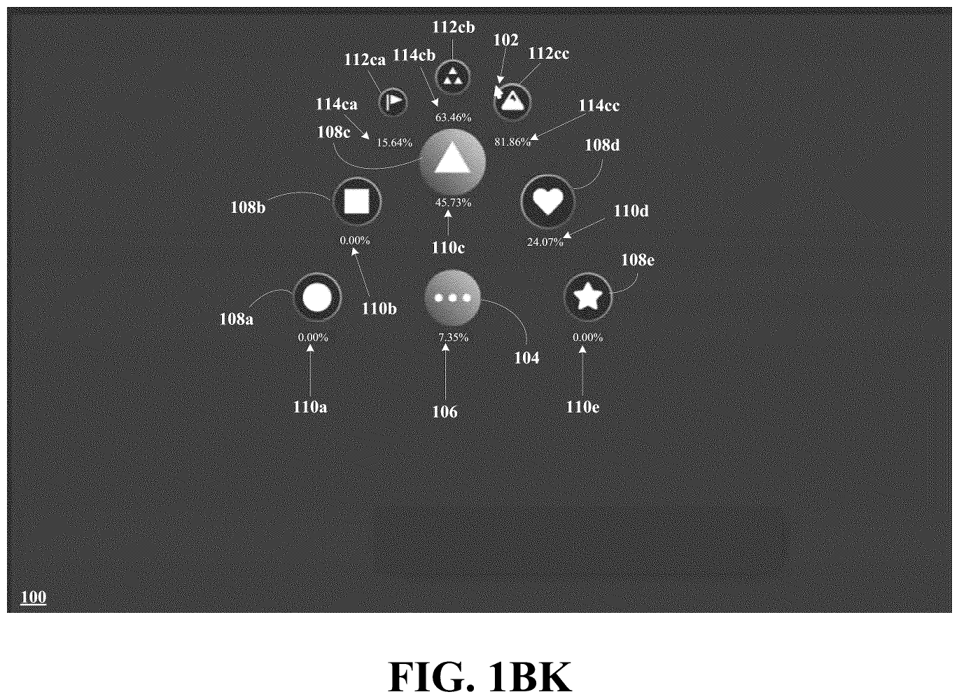

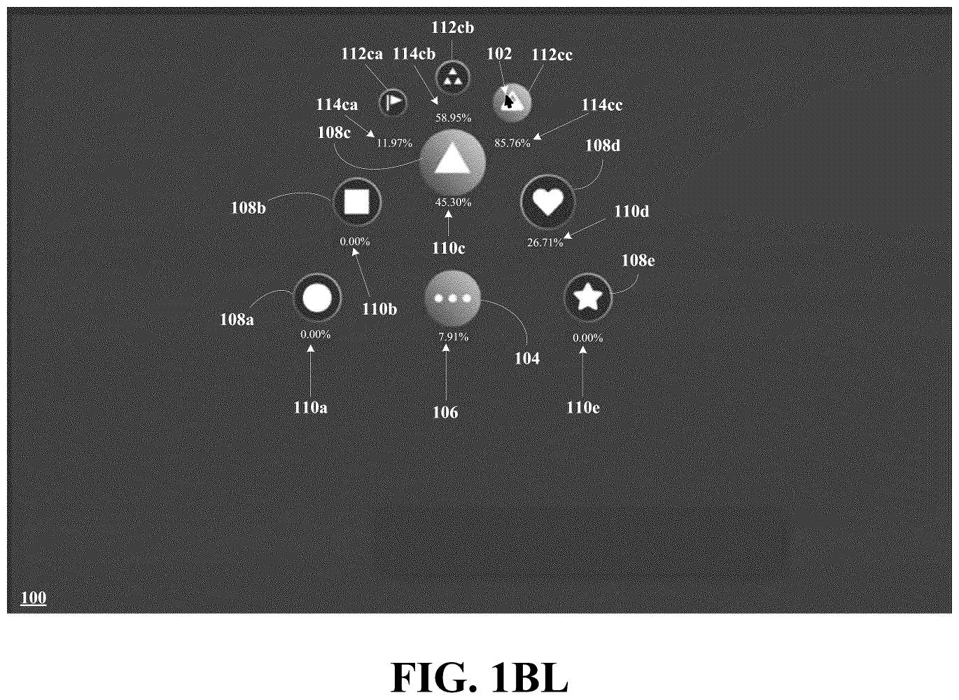

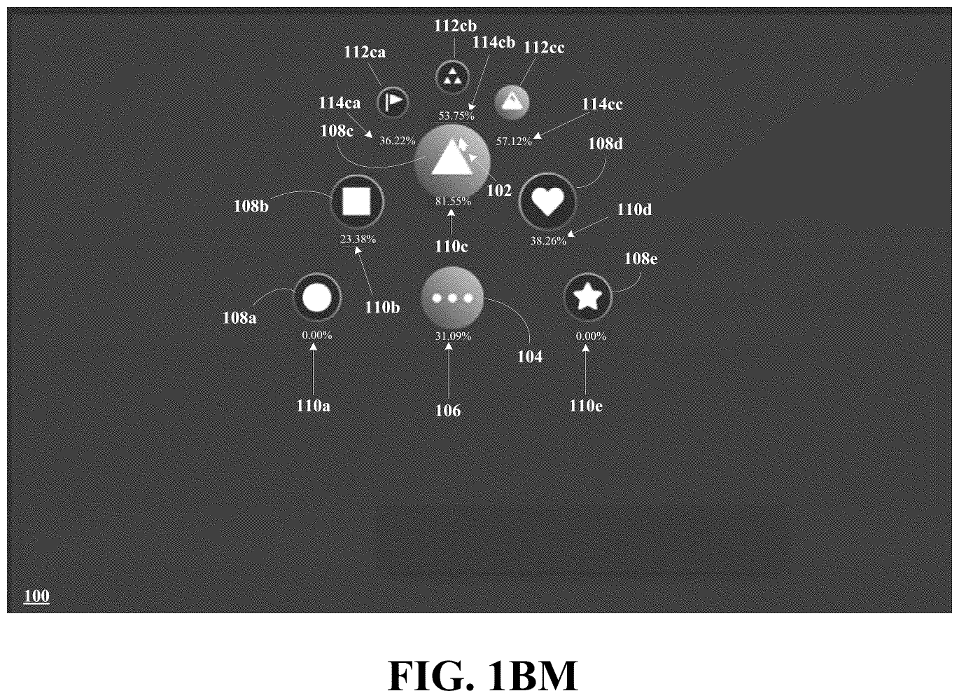

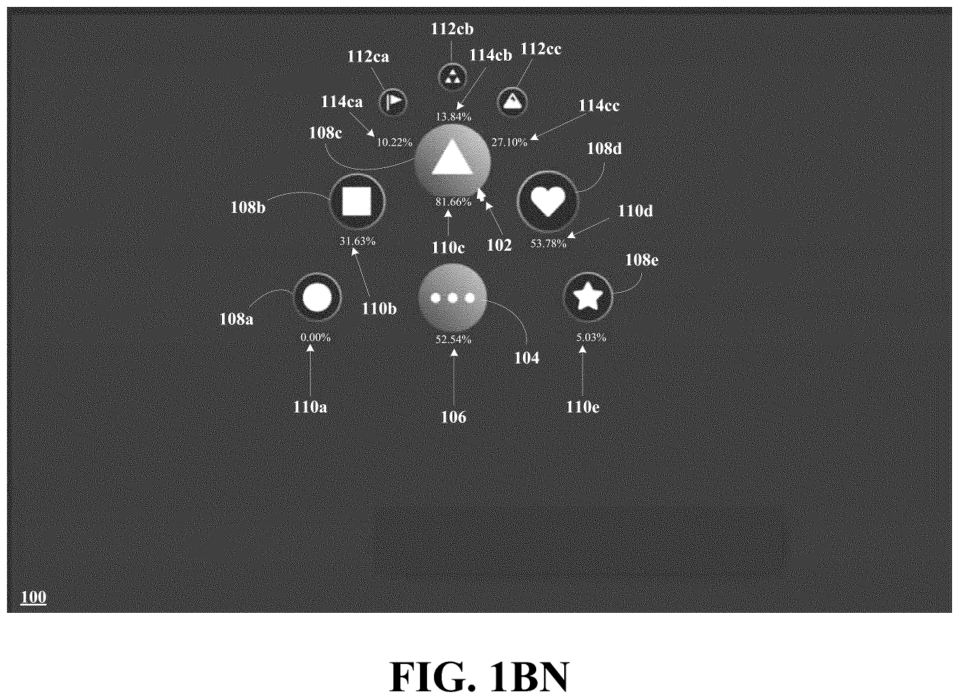

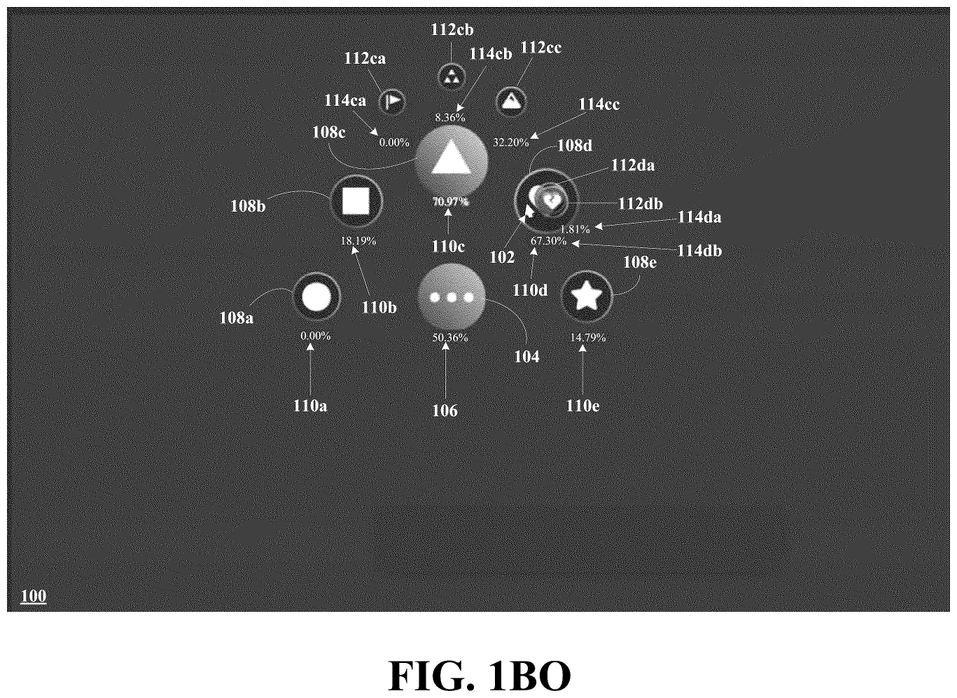

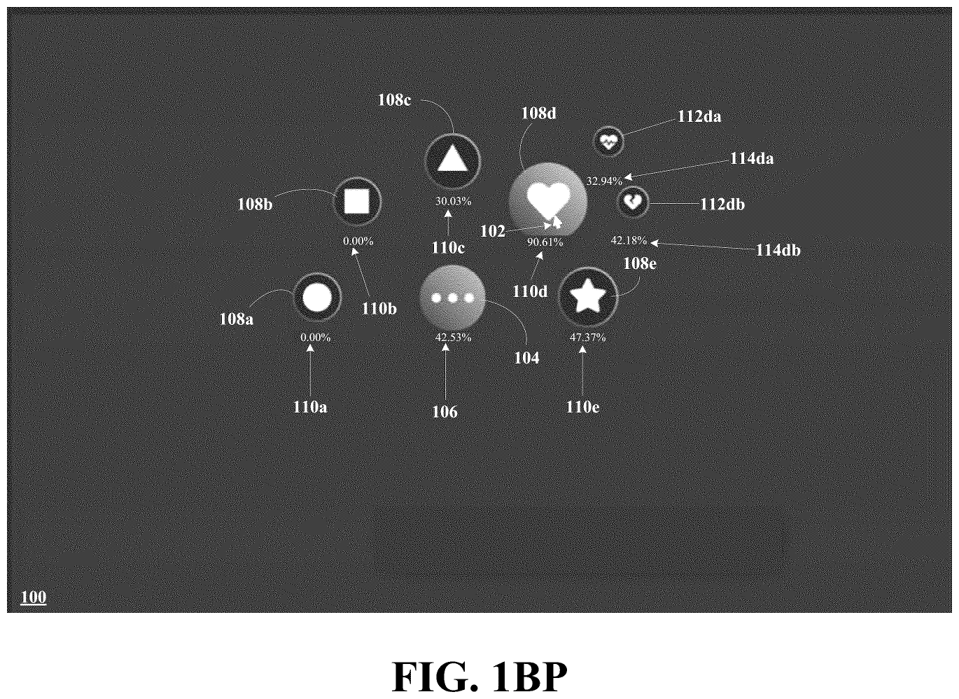

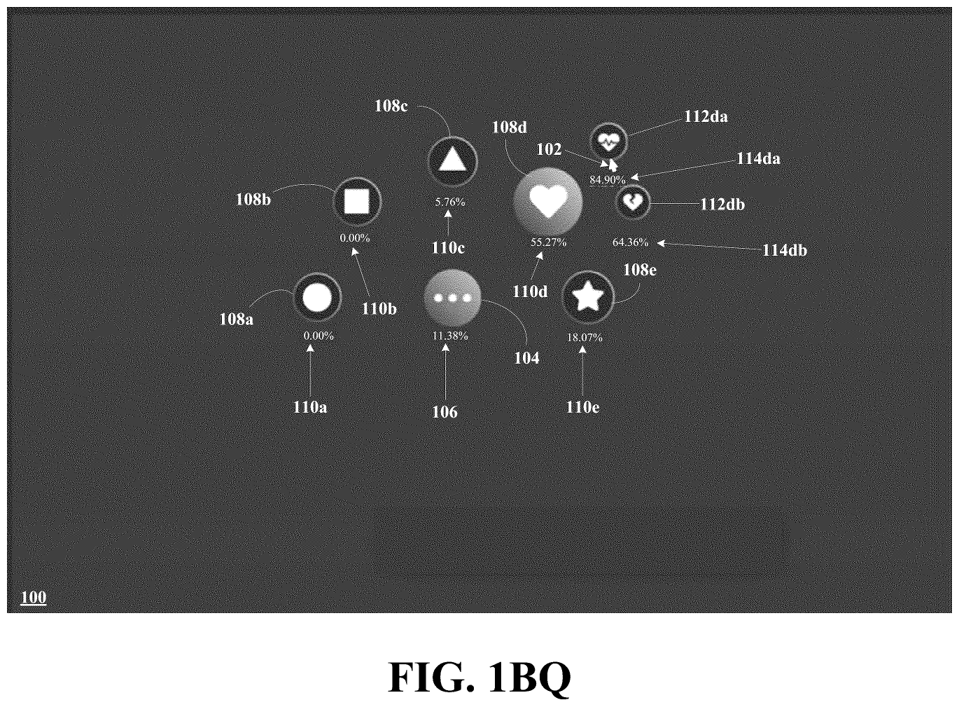

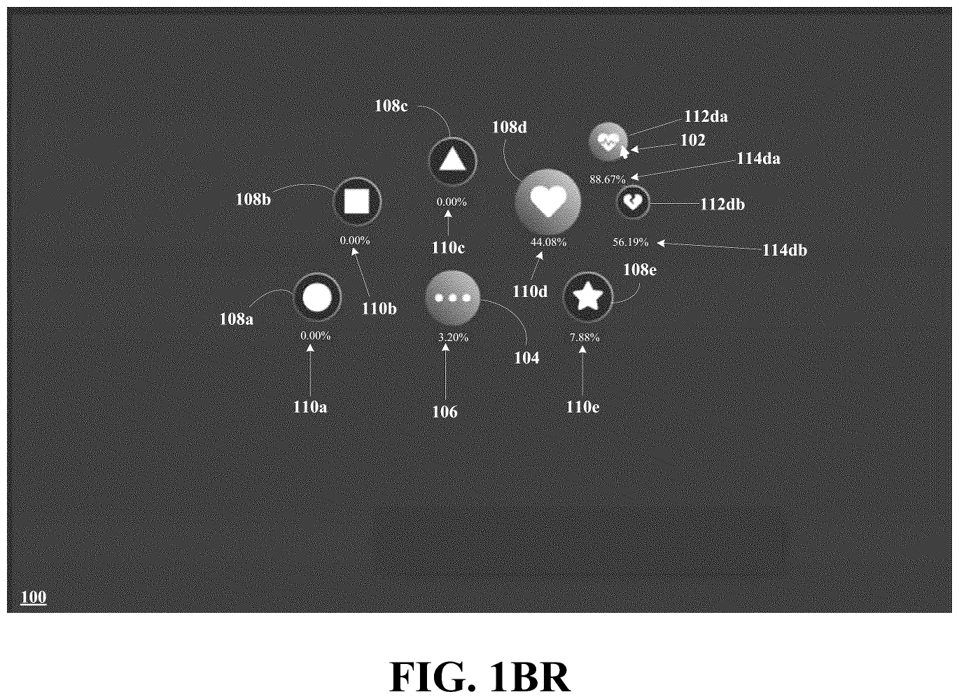

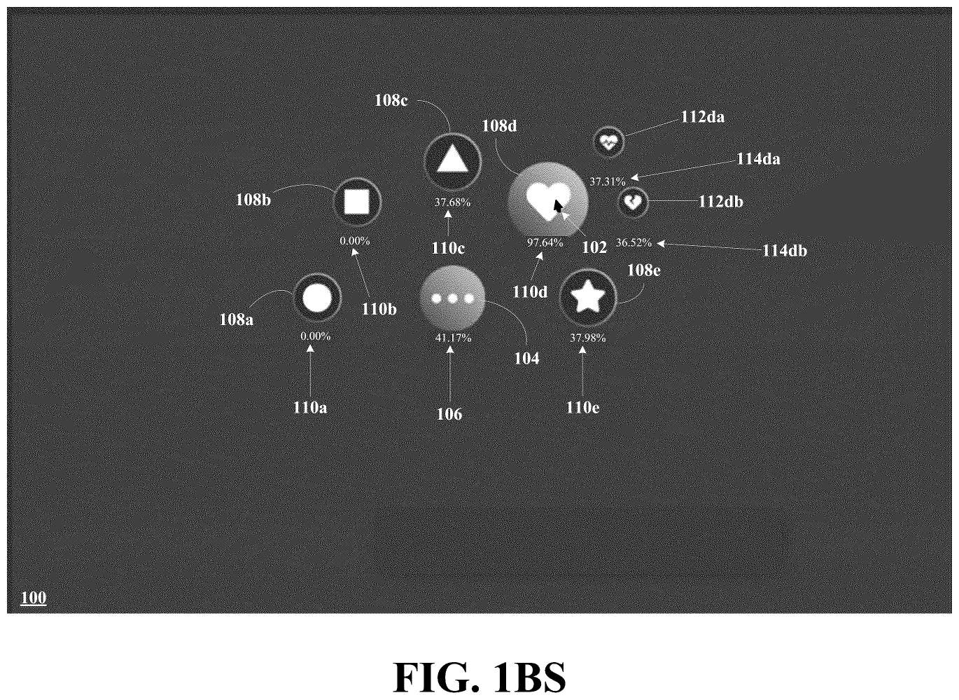

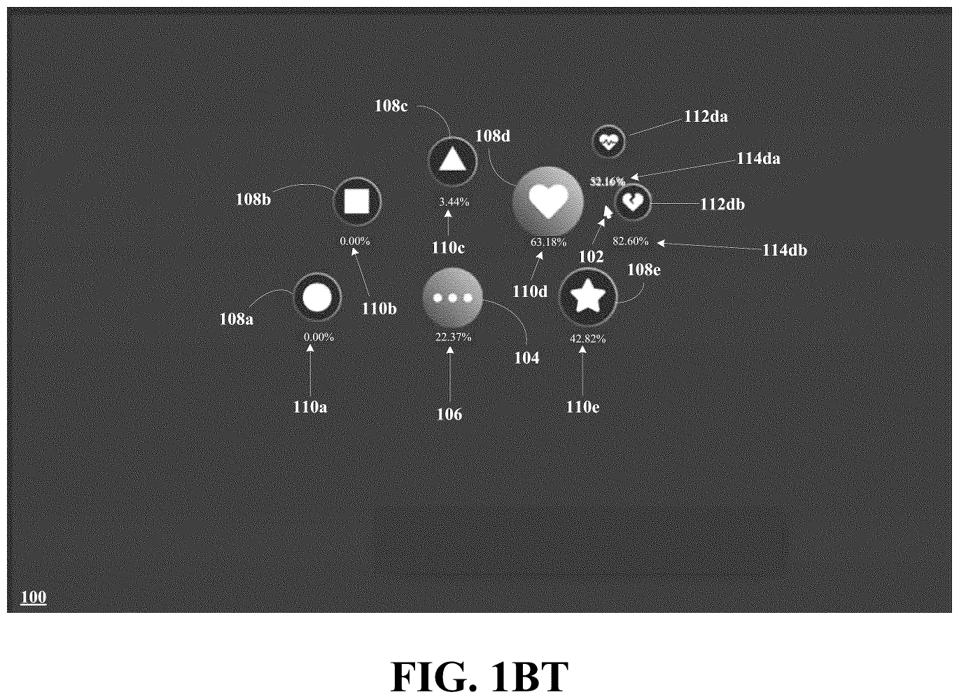

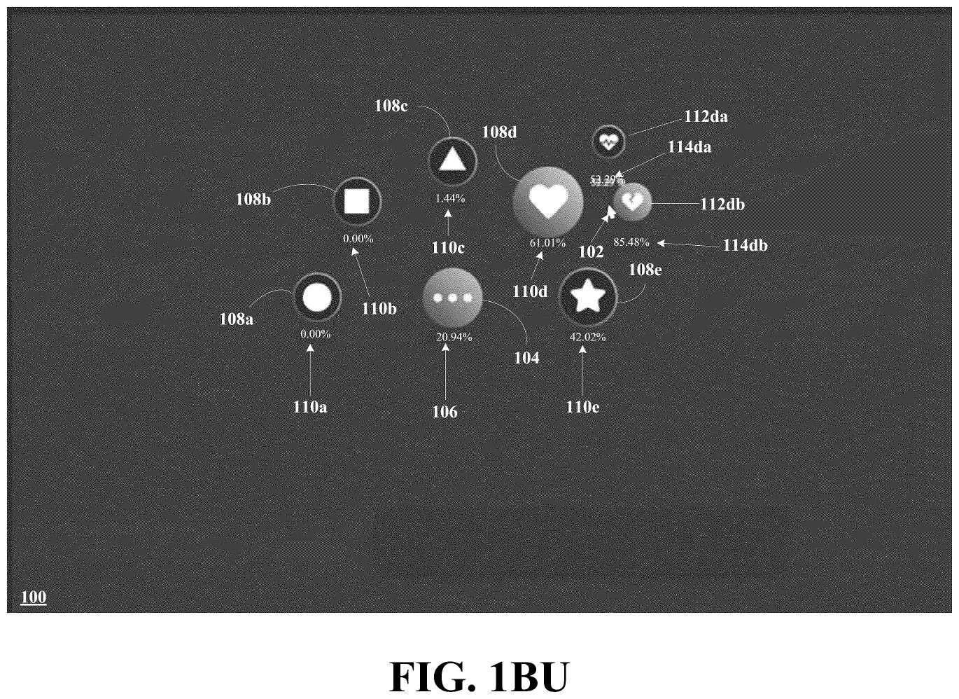

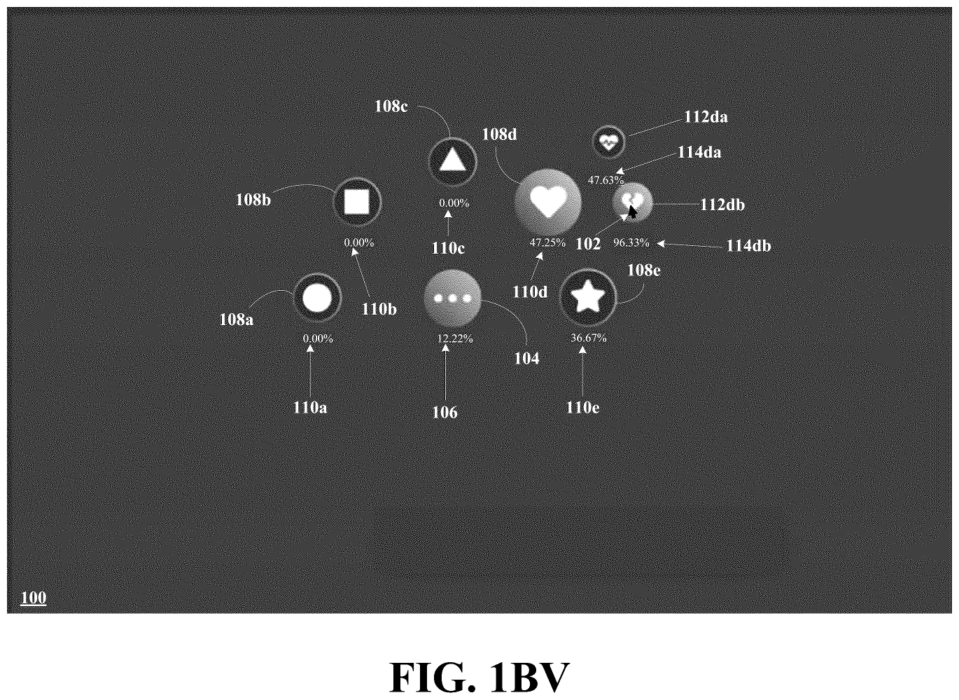

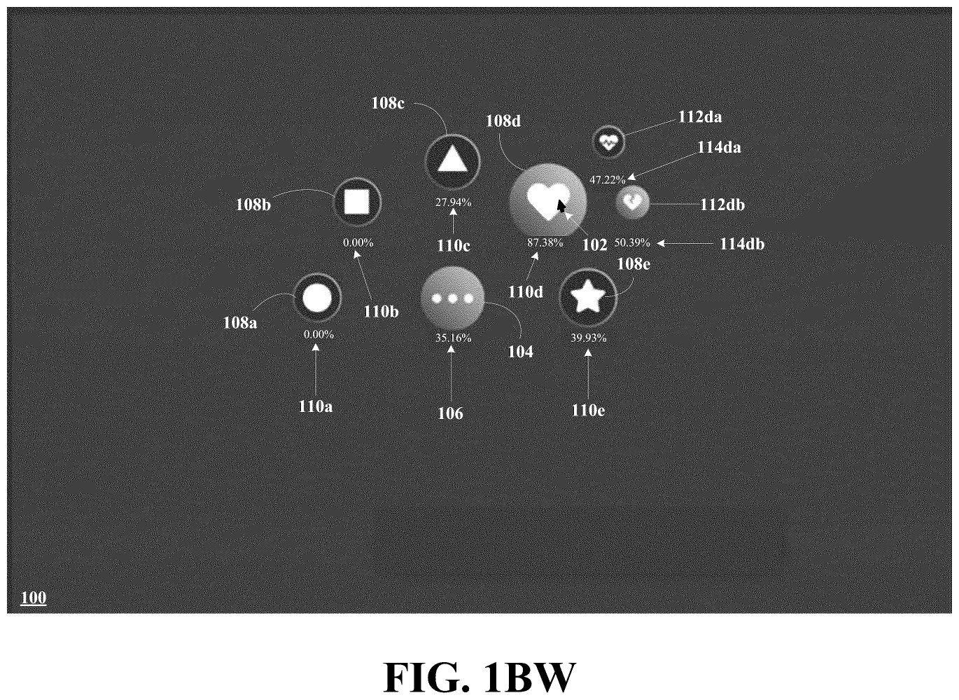

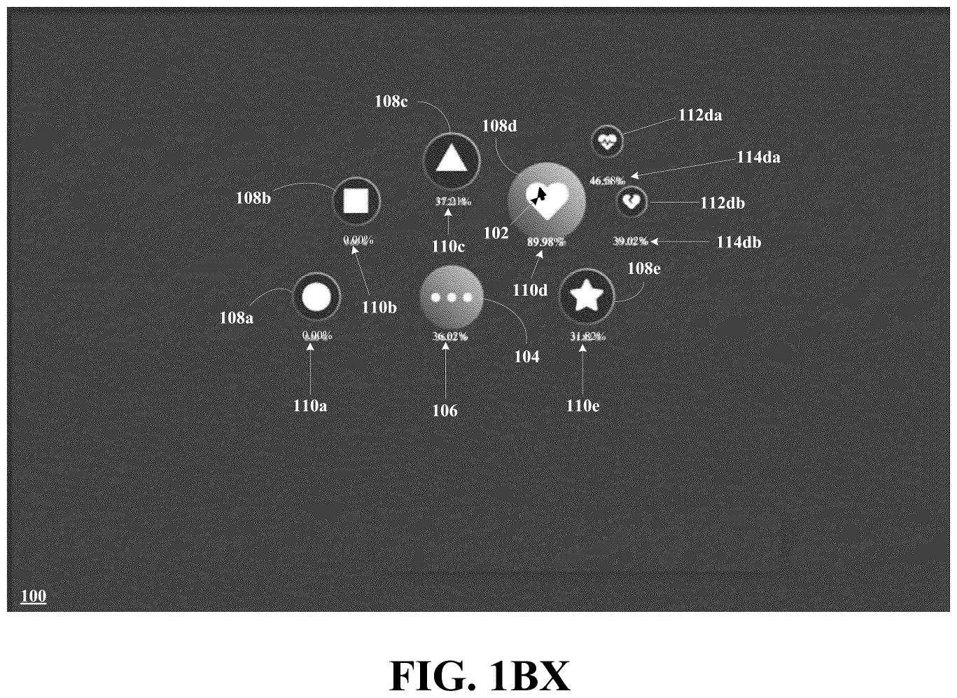

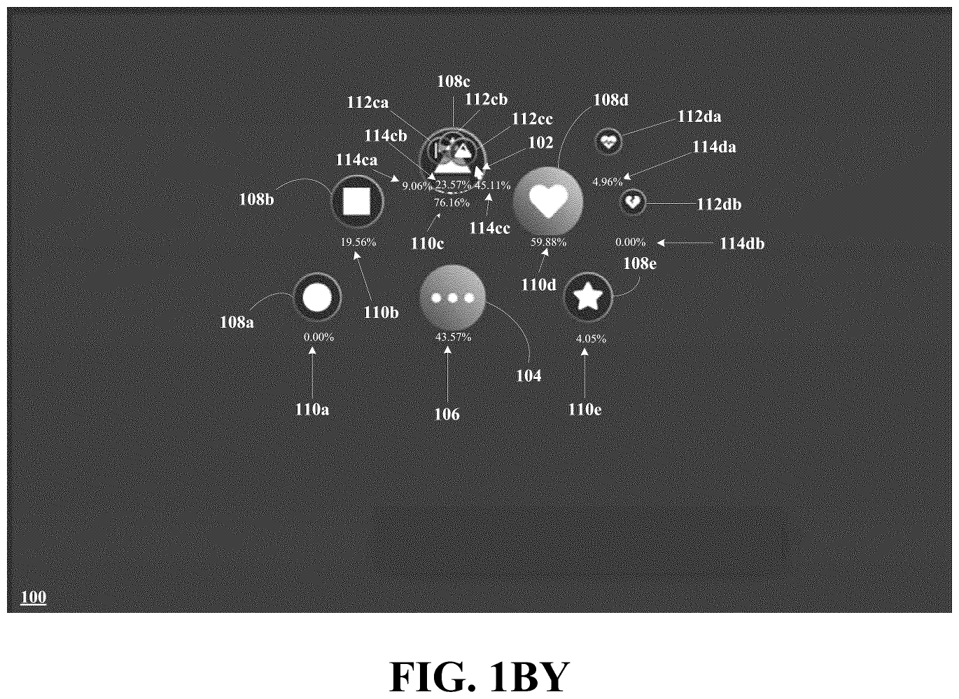

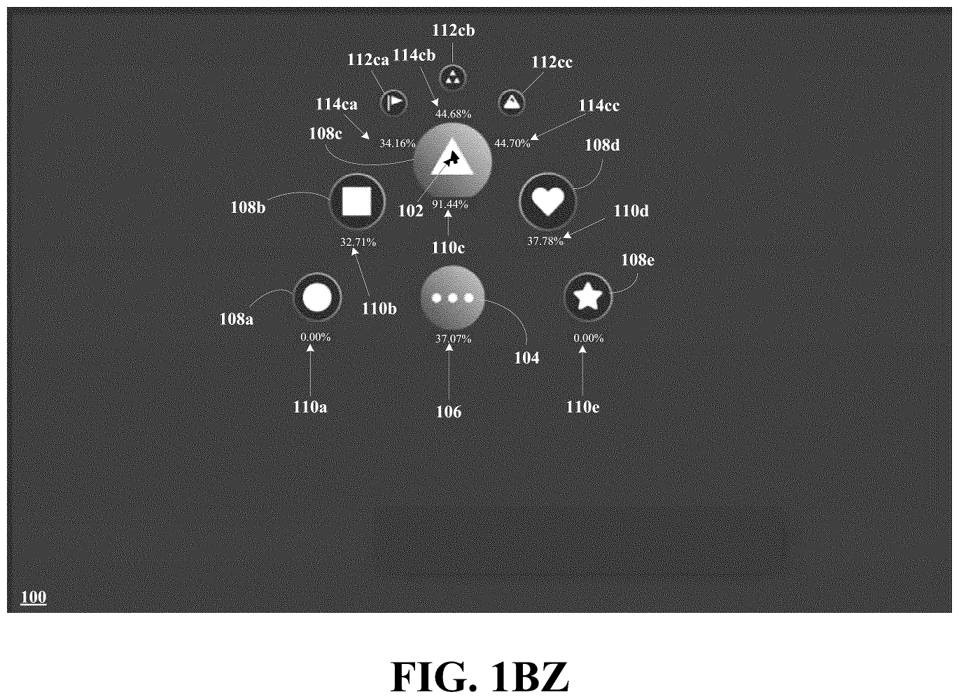

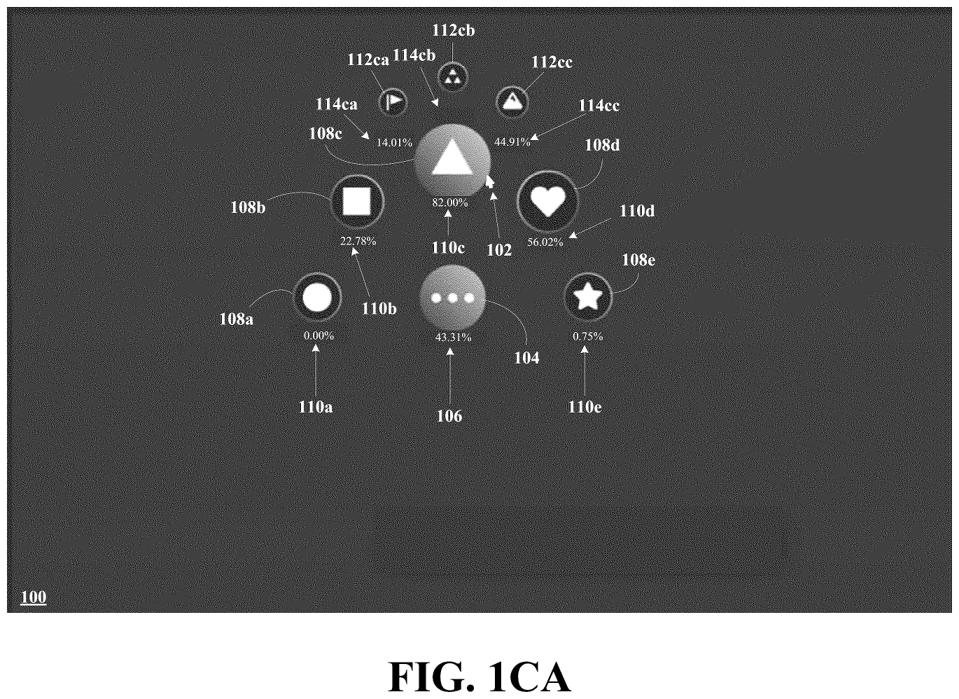

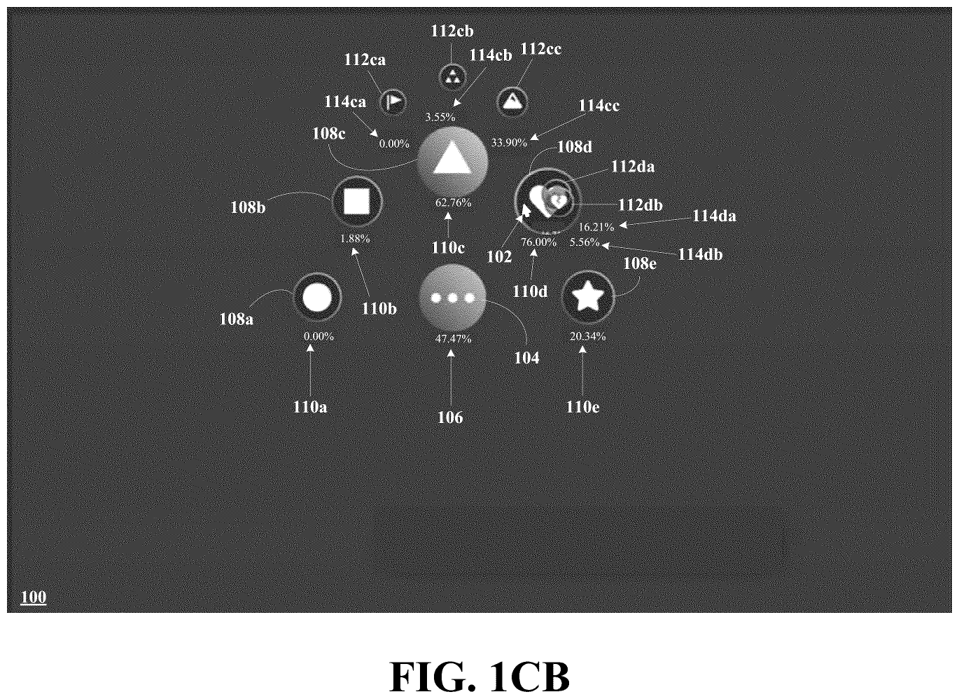

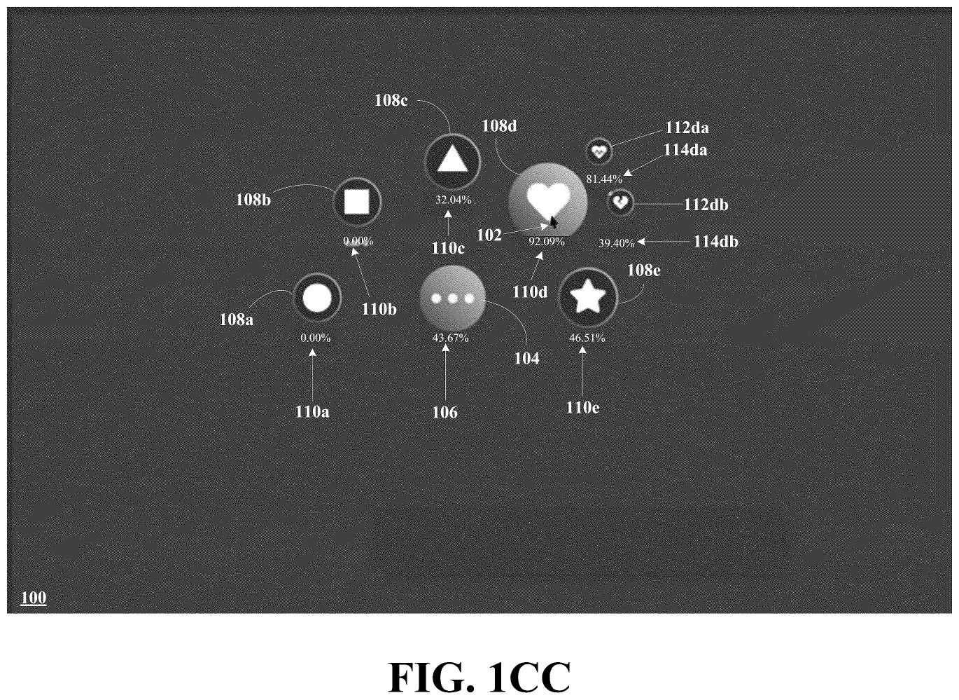

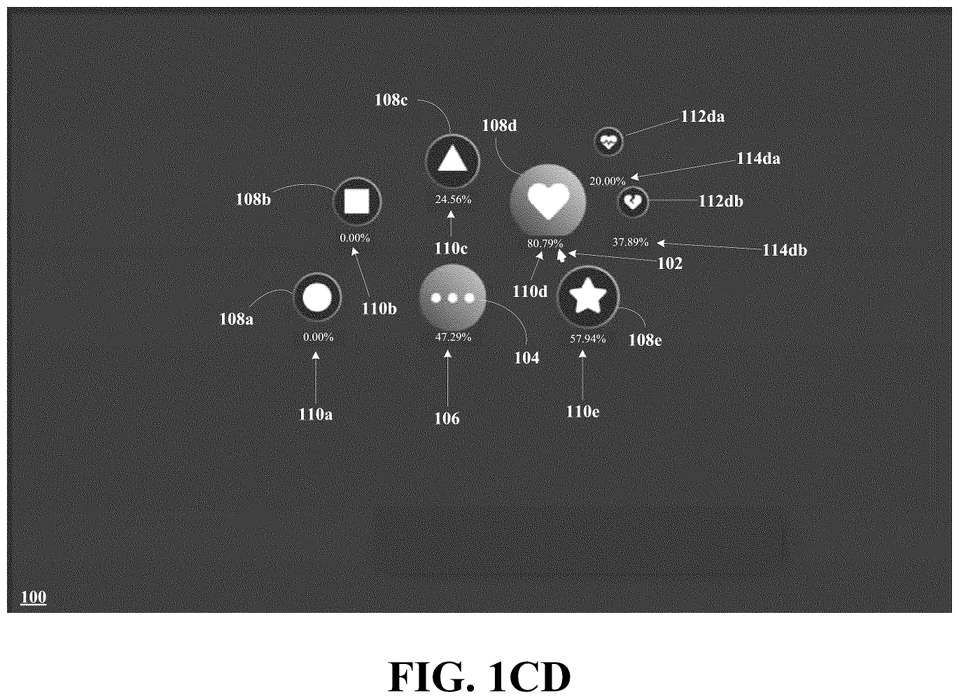

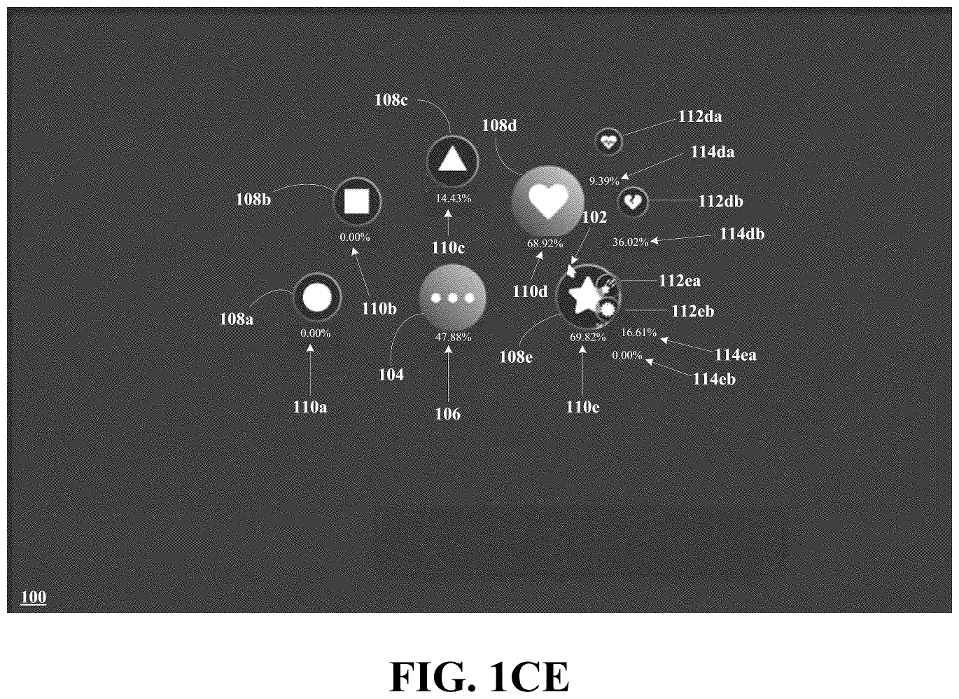

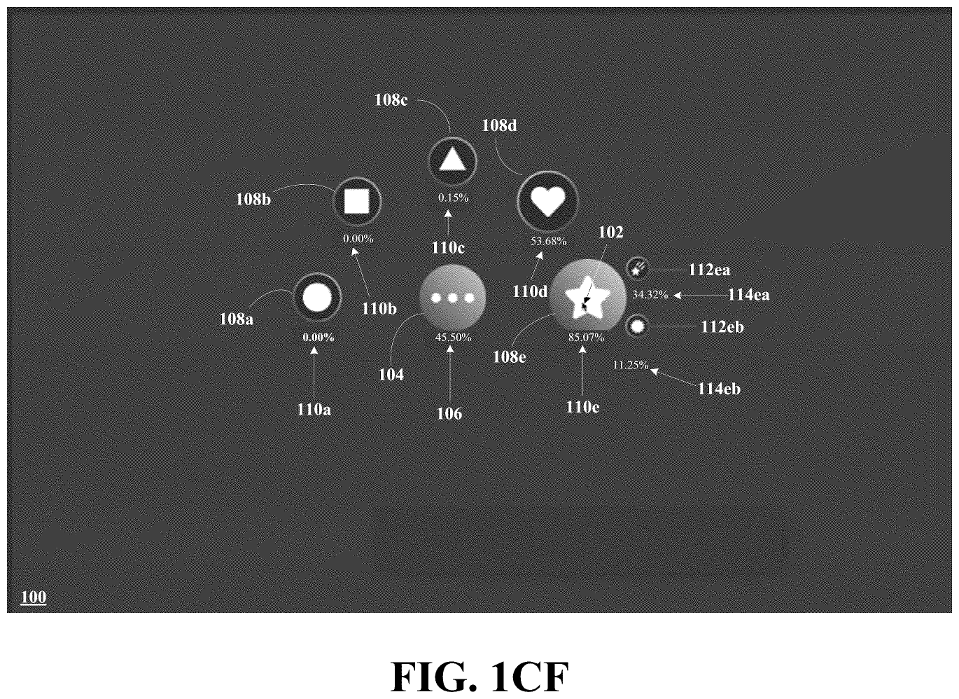

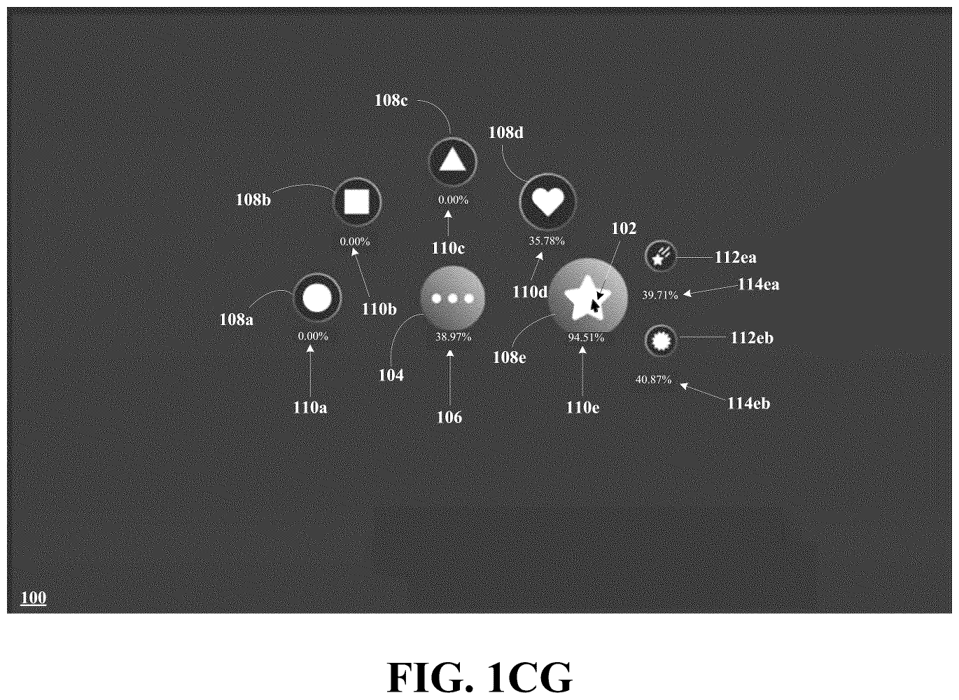

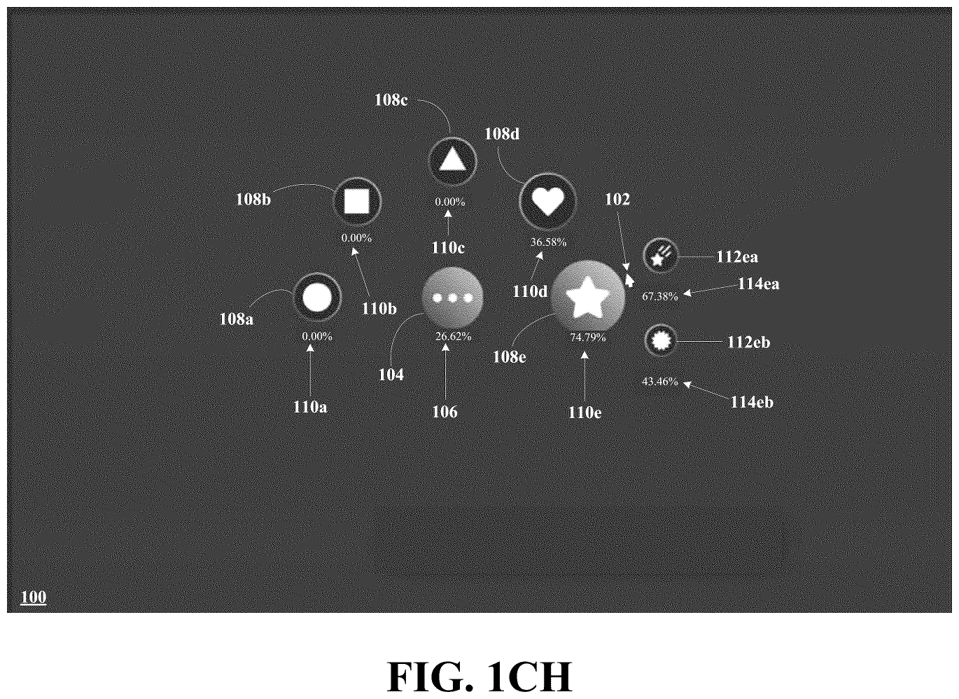

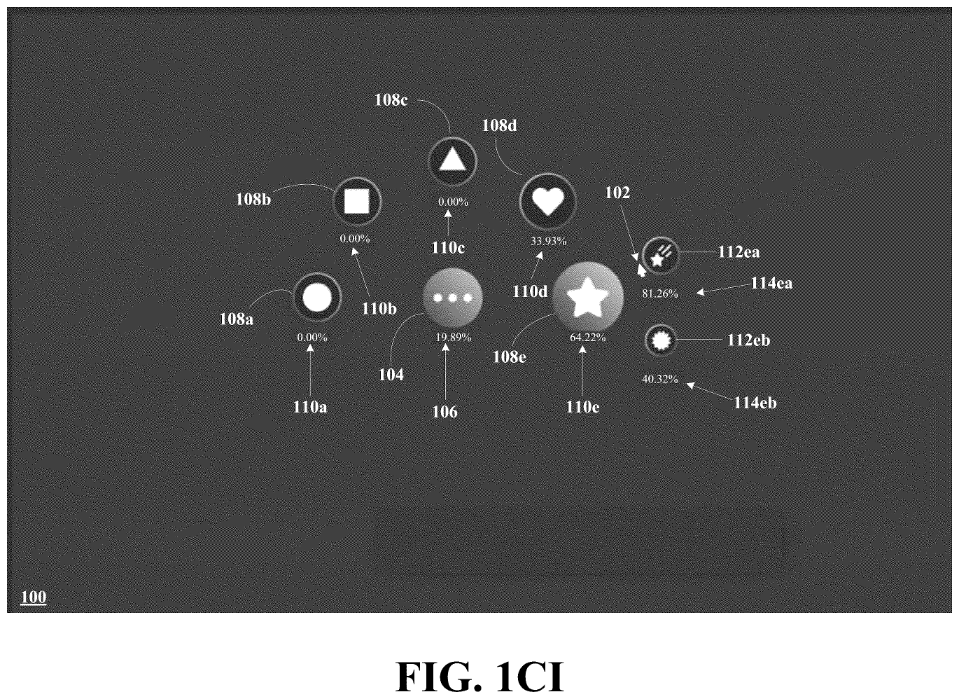

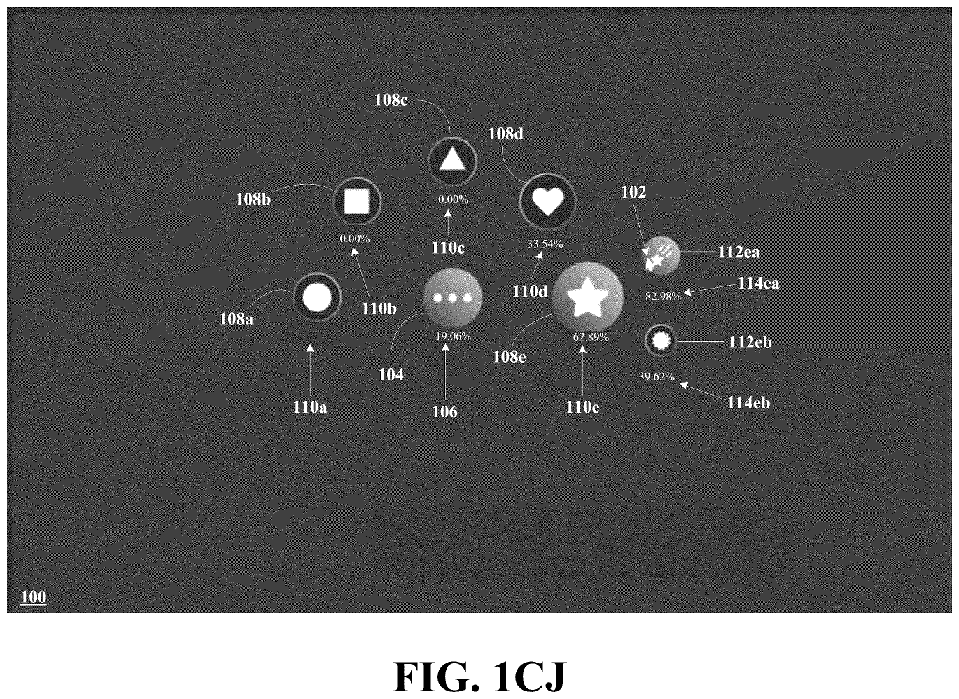

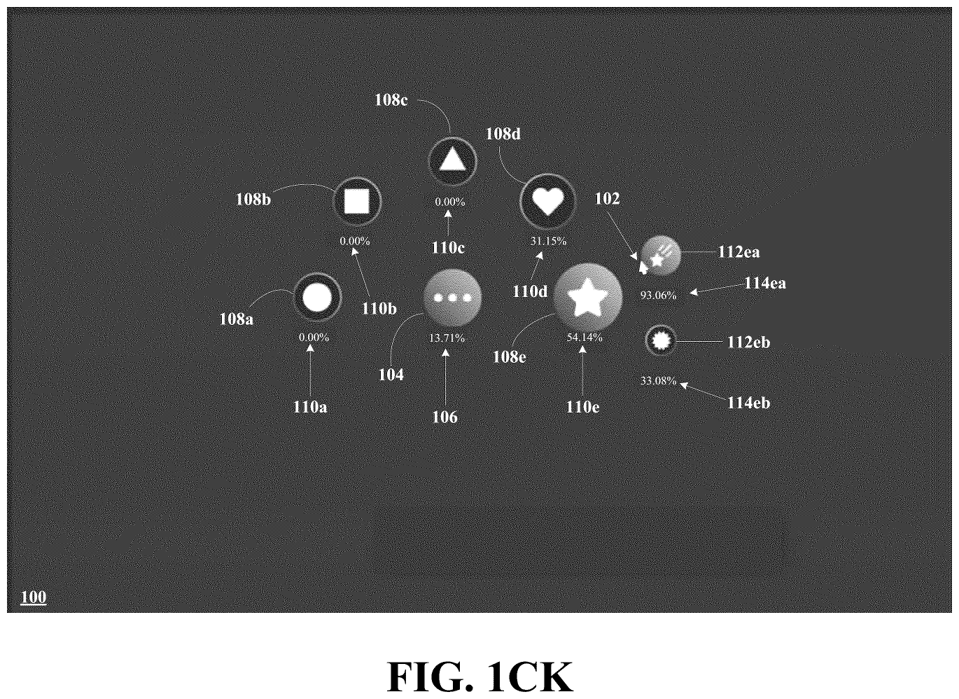

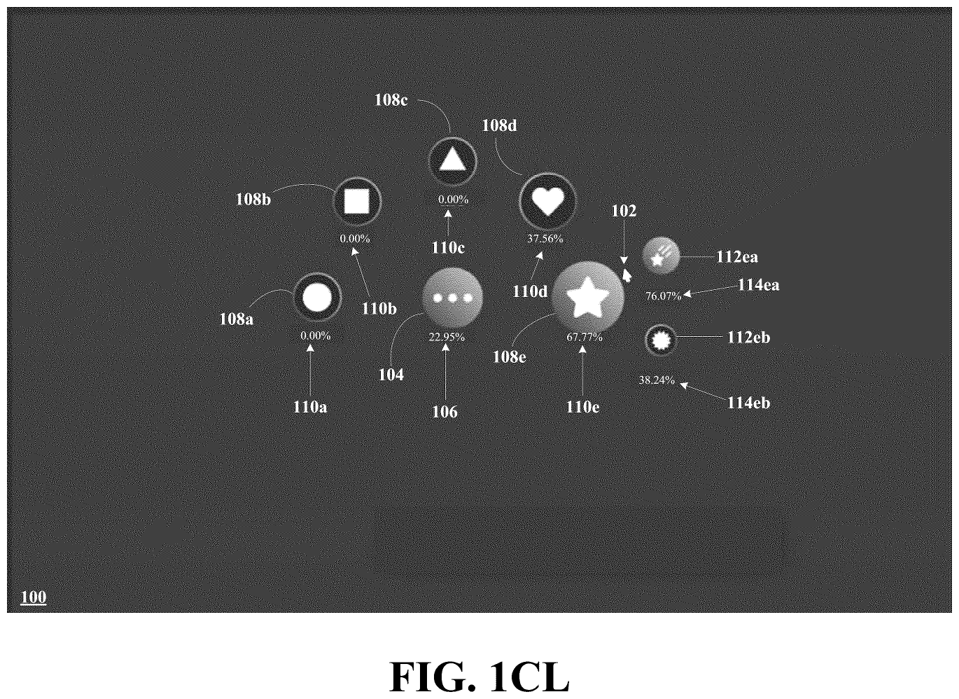

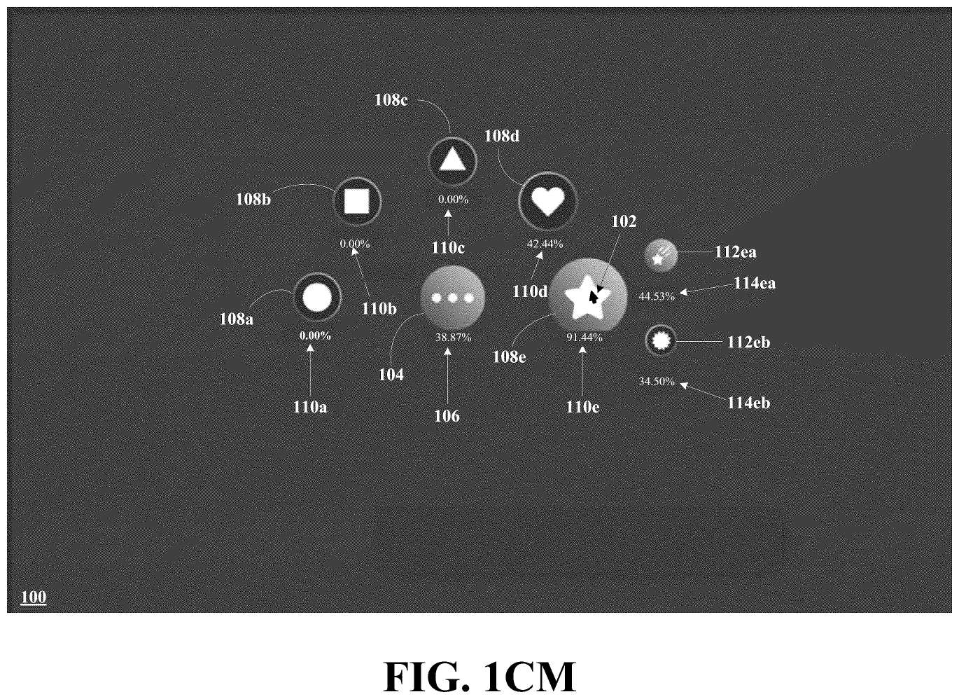

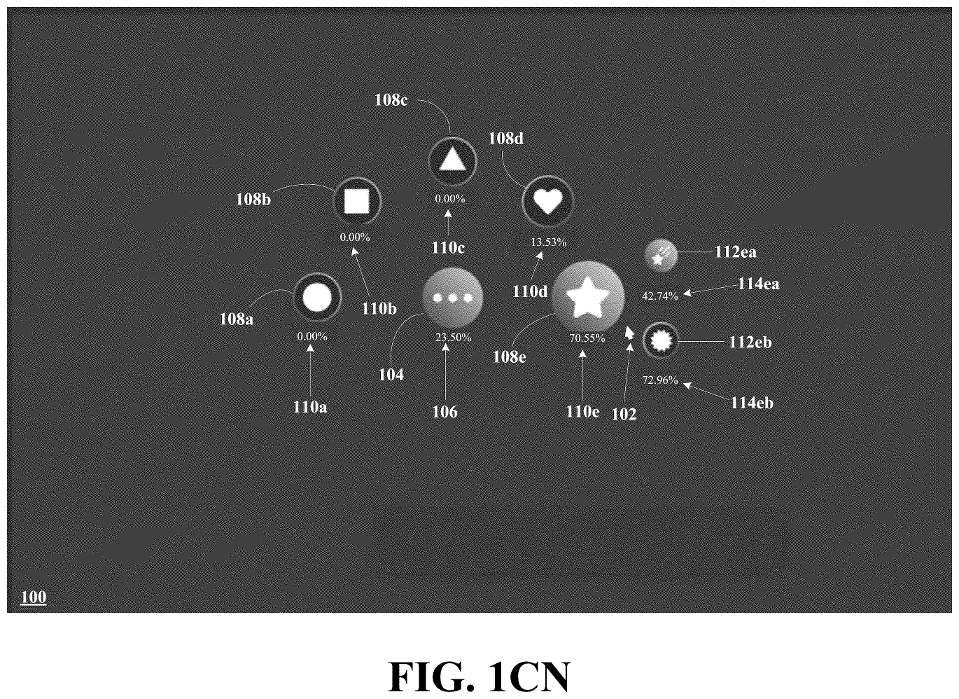

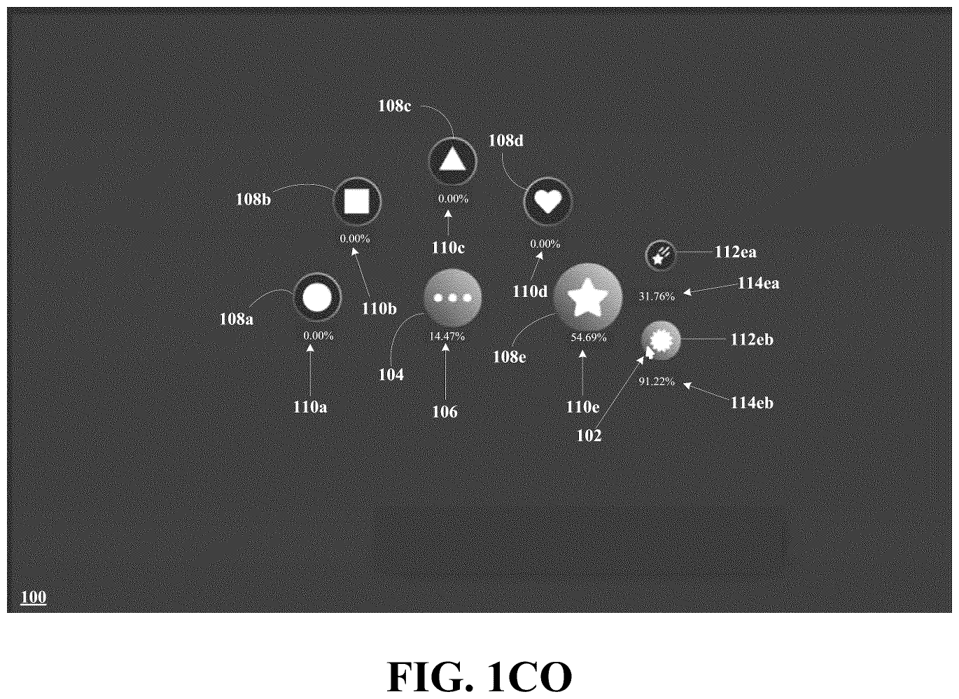

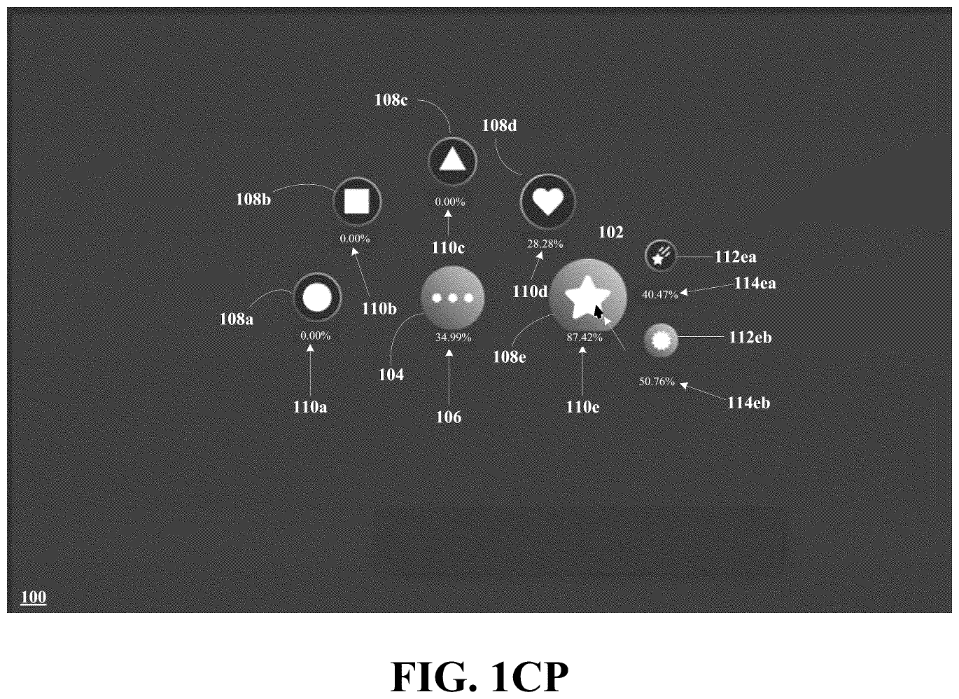

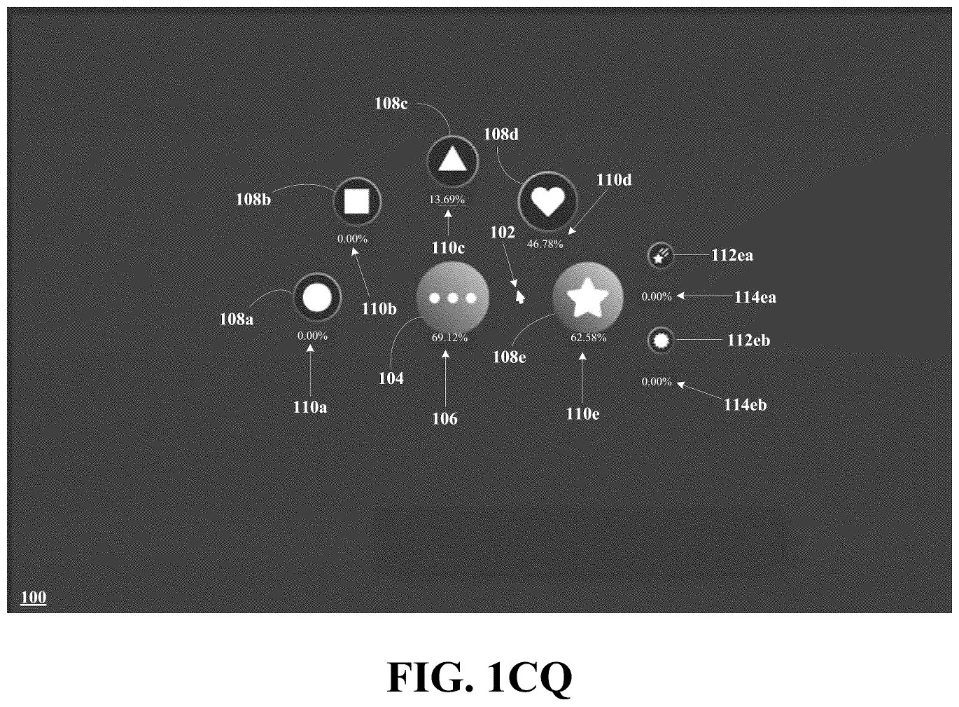

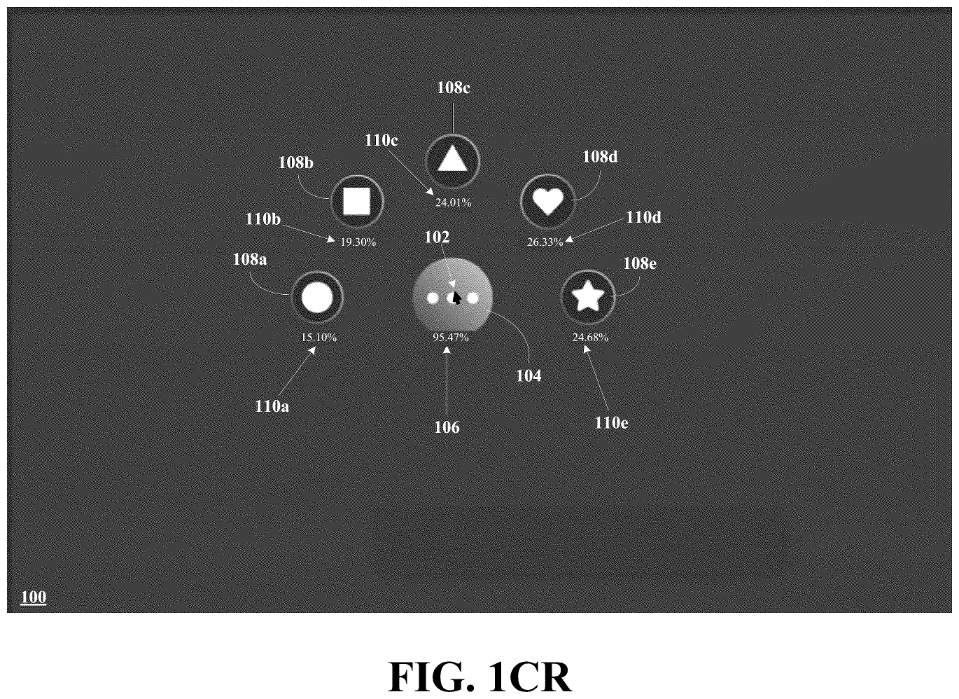

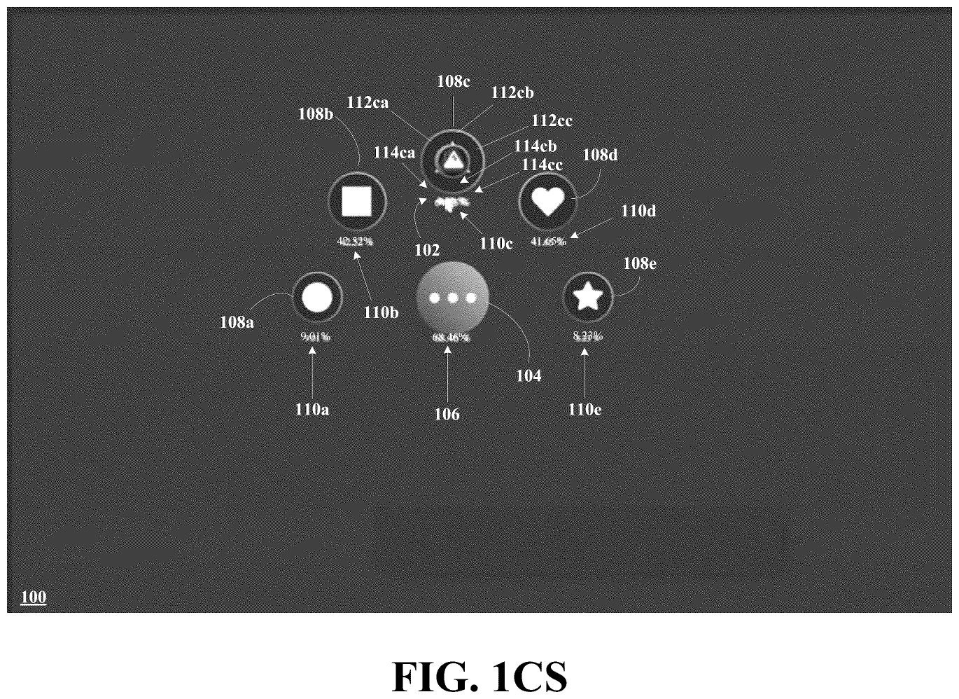

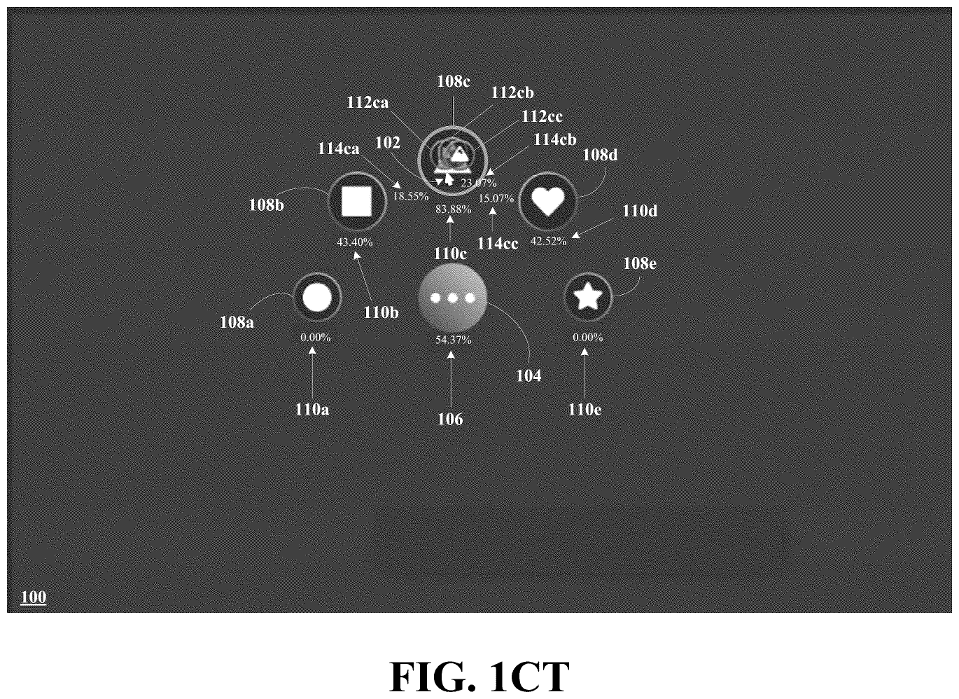

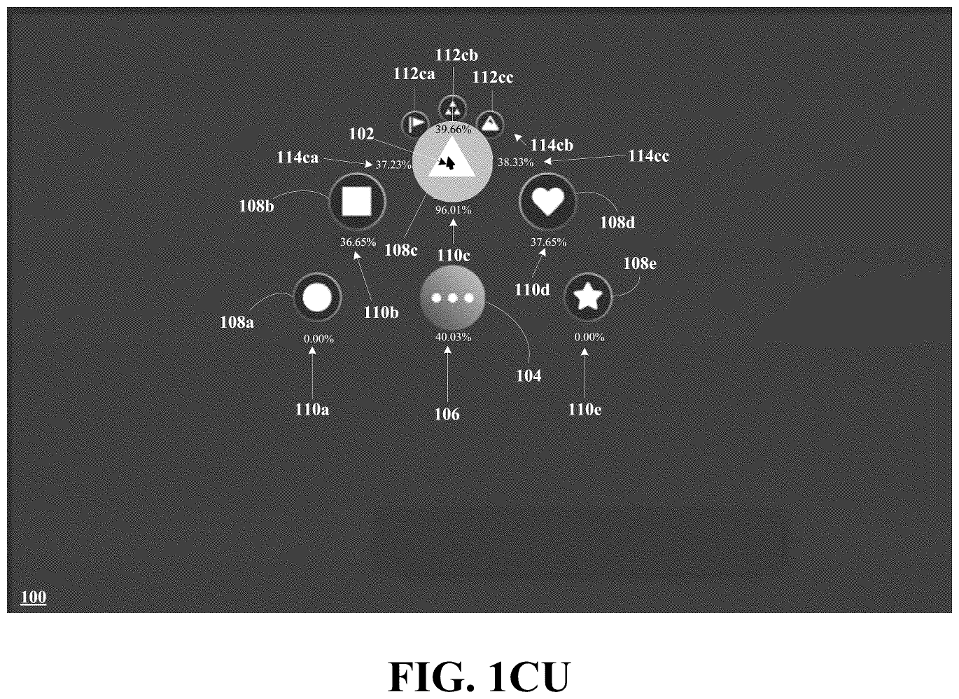

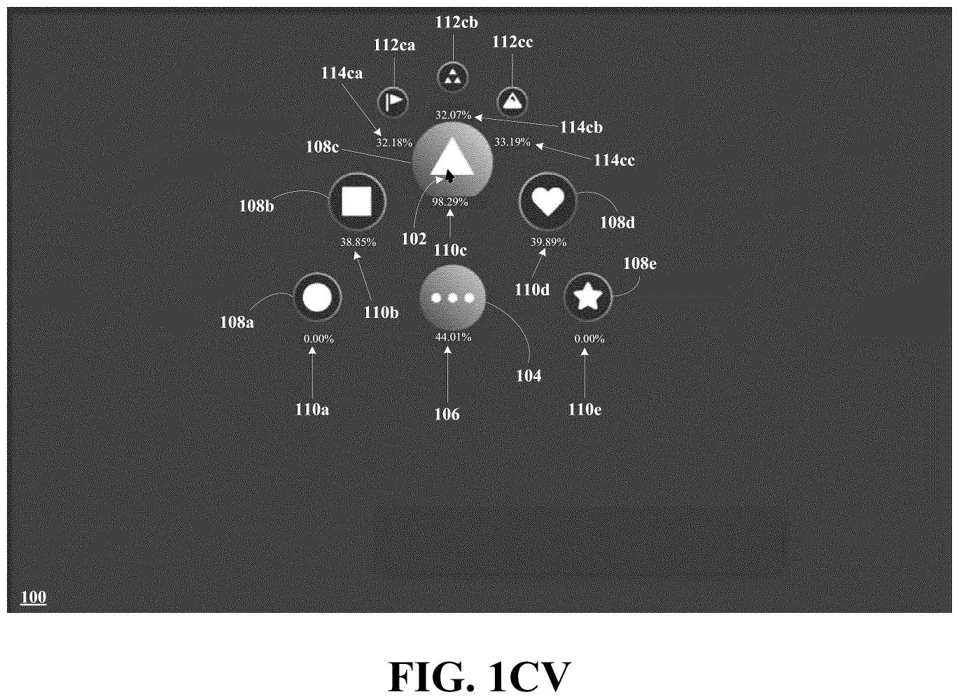

FIGS. 1A-CV depict an illustration of real-time data gathering/collection/capturing of users interacting with objects displayed on a display device by tracking movement of the users.

People Shopping in a Supermarket

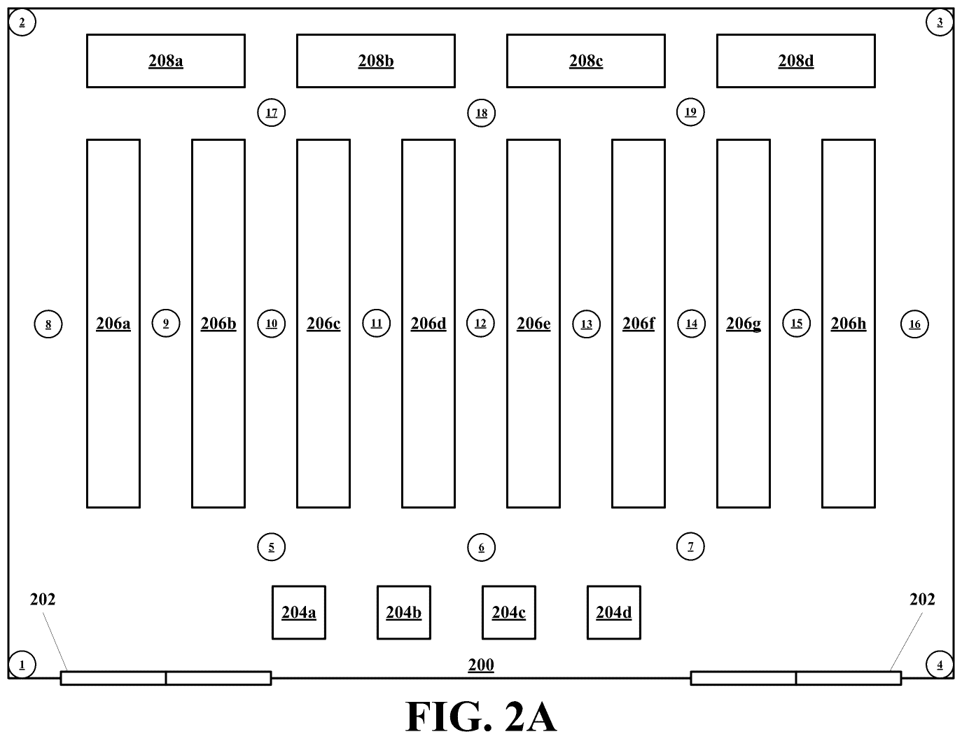

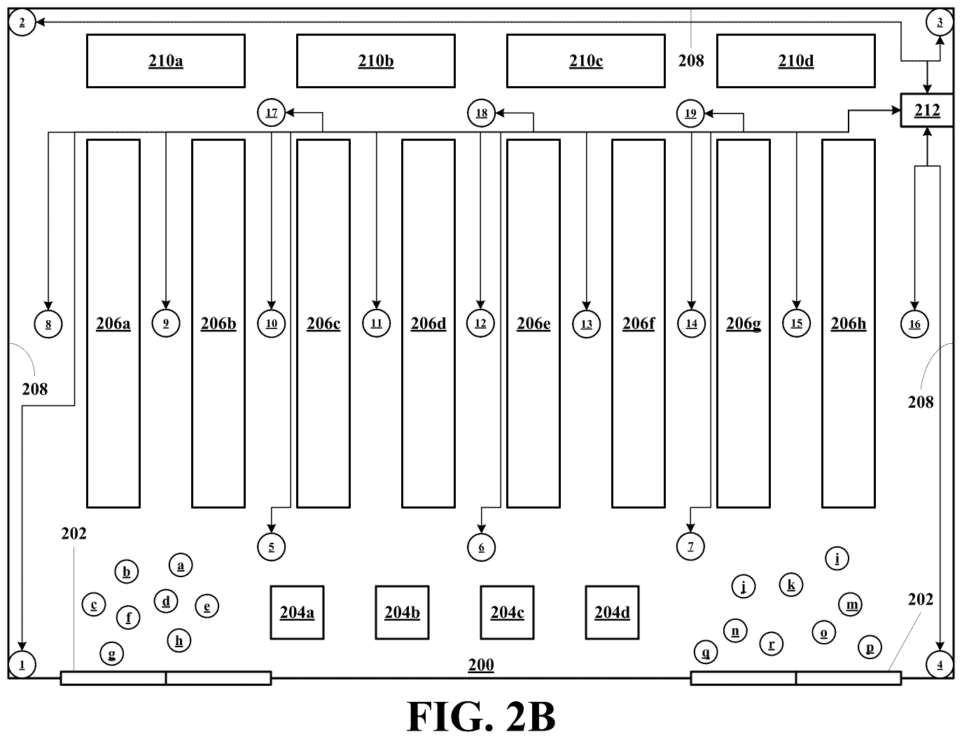

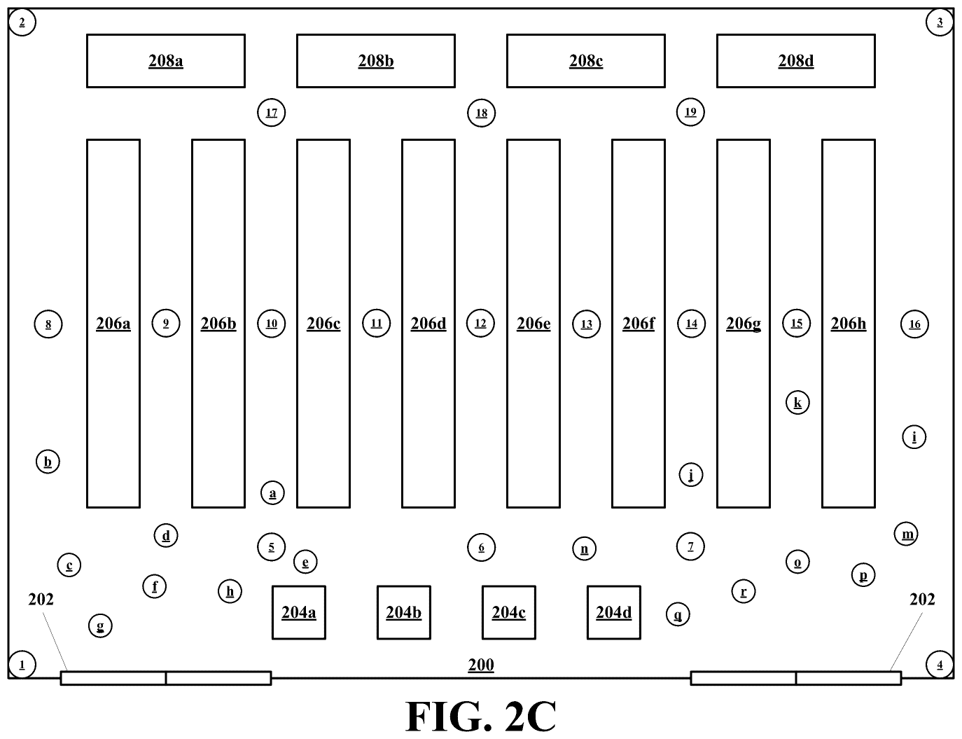

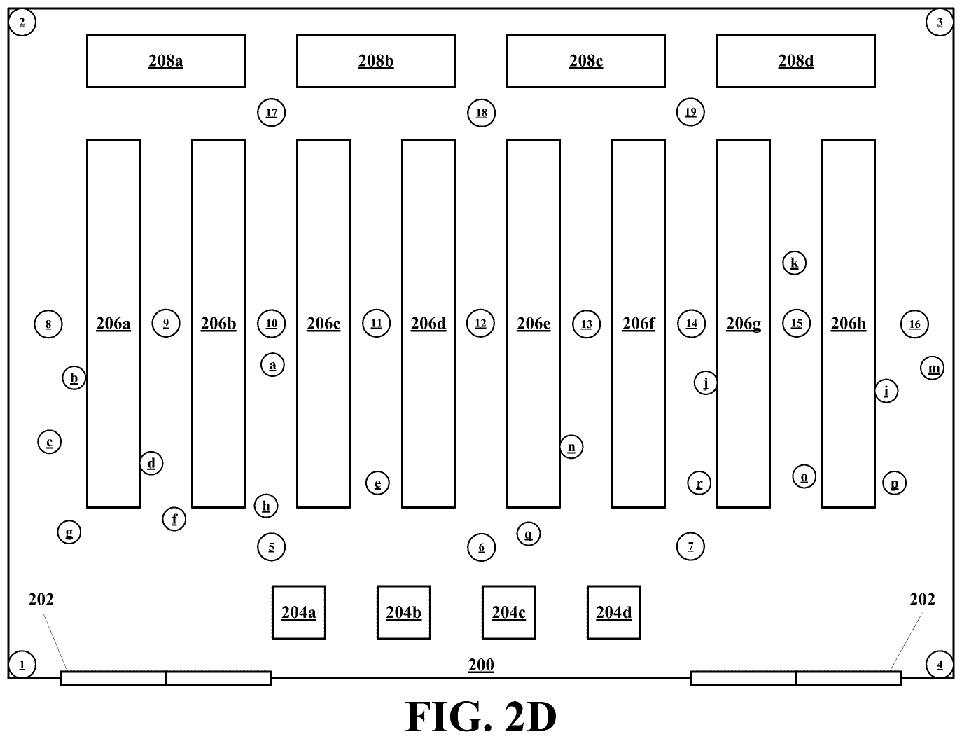

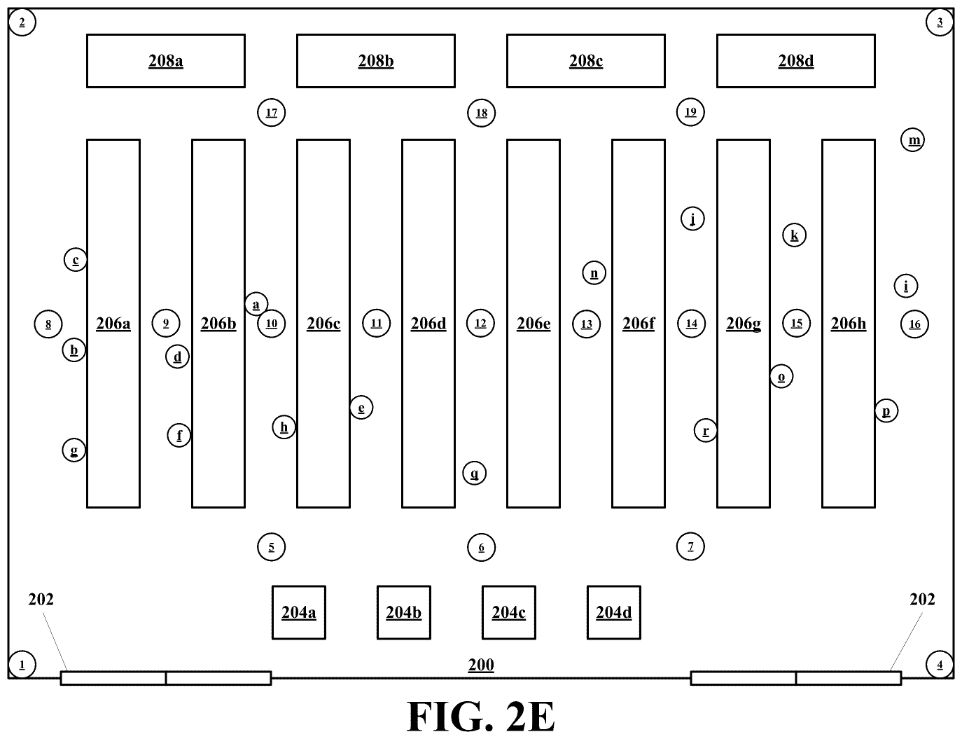

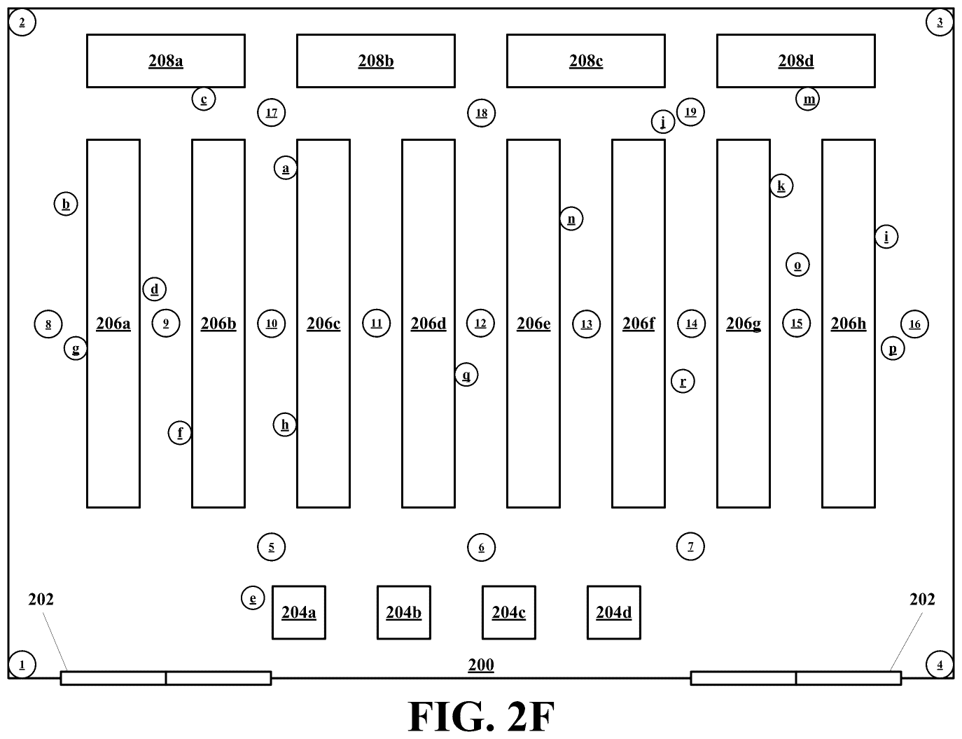

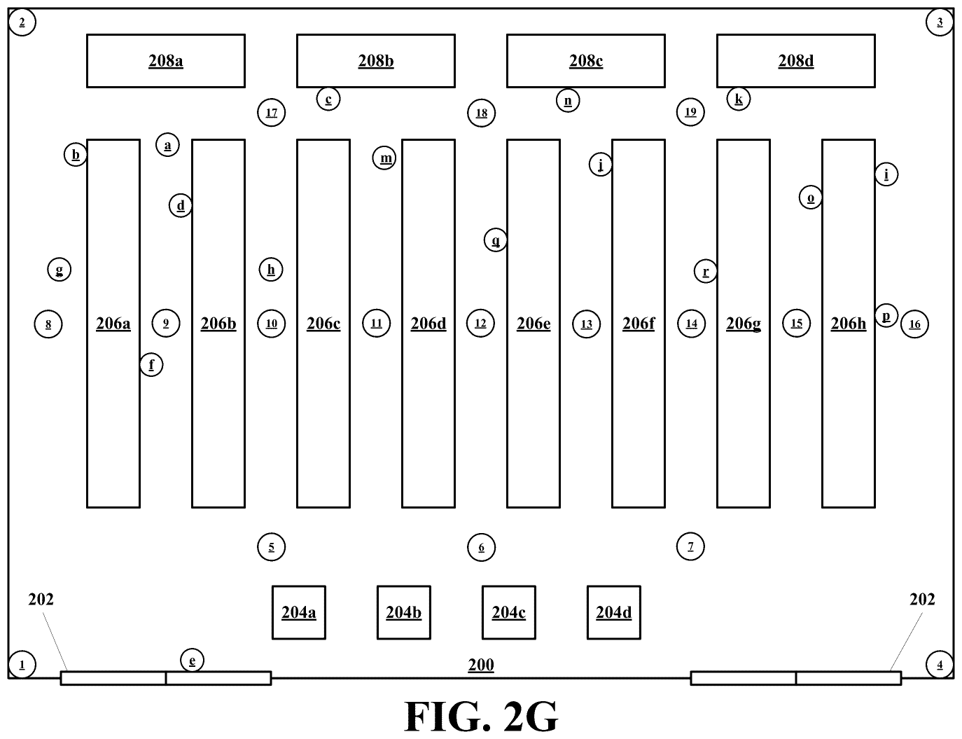

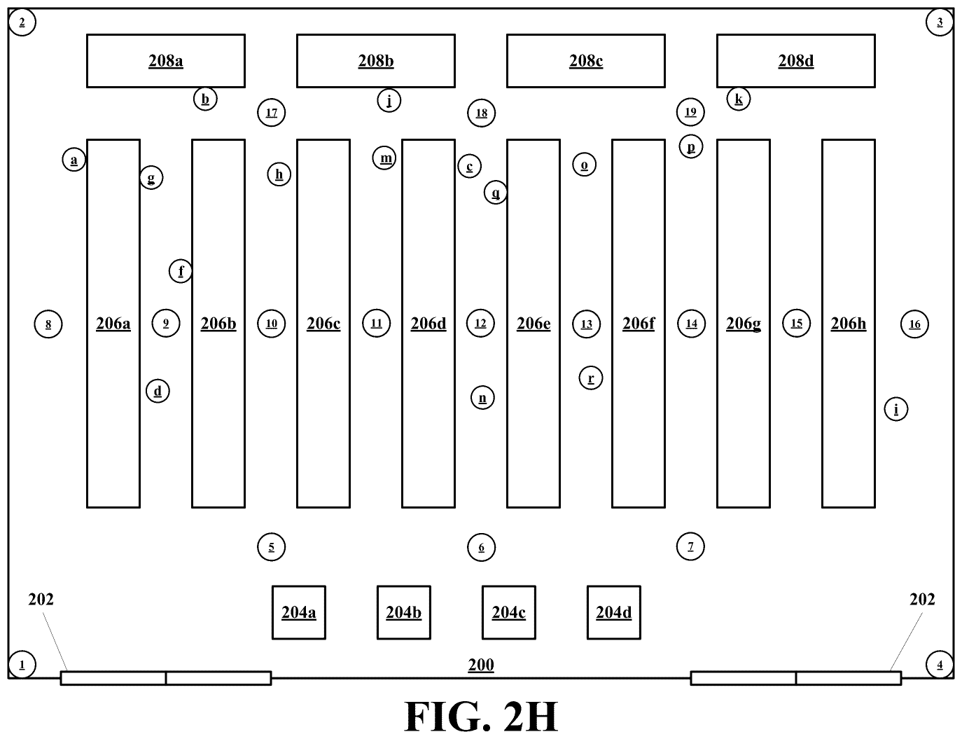

FIGS. 2A-H depict an illustration of real-time data hering/collection/capturing of people shopping in a supermarket.

### DEFINITIONS USED IN THE INVENTION

The term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

The term “substantially” means that a value of a given quantity is within ±5% of the stated value. In other embodiments, the value is within ±2.5% of the stated value. In other embodiments, the value is within ±1% of the stated value. In other embodiments, the value is within ±0.5% of the stated value. In other embodiments, the value is within ±0.1% of the stated value.

The term “kinetic”, “motion” or “movement” are often used interchangeably and mean motion or movement that is capable of being detected by a motion sensor or motion sensing component within an active zone of the sensor such as a sensing area or volume of a motion sensor or motion sensing component. “Kinetic” also includes “kinematic” elements, as included in the study of dynamics or dynamic motion. Thus, if the sensor is a forward viewing sensor and is capable of sensing motion within a forward extending conical active zone, then movement of anything within that active zone that meets certain threshold detection criteria, will result in a motion sensor output, where the output may include at least direction, velocity, and/or acceleration. Of course, the sensors does not need to have threshold detection criteria, but may simply generate output anytime motion or any nature is detected. The processing units can then determine whether the motion is an actionable motion or movement and a non-actionable motion or movement.

The term “physical sensor” means any sensor capable of sensing any physical property such as temperature, pressure, humidity, weight, geometrical properties, meteorological properties, astronomical properties, atmospheric properties, light properties, color properties, chemical properties, atomic properties, subatomic particle properties, or any other physical measurable property.

The term “motion sensor” or “motion sensing component” means any sensor or component capable of sensing motion of any kind by anything within an active zone—area or volume, regardless of whether the sensor's or component's primary function is motion sensing.

The term “biometric sensor” or “biometric sensing component” means any sensor or component capable of acquiring biometric data.

The term “bio-kinetic sensor” or “bio-kinetic sensing component” means any sensor or component capable of simultaneously or sequentially acquiring biometric data and kinetic data (i.e., sensed motion of any kind) by anything moving within an active zone of a motion sensor, sensors, array, and/or arrays—area or volume, regardless of whether the primary function of the sensor or component is motion sensing.

The term “real items” or “real world items” means any real world object such as humans, animals, plants, devices, articles, robots, drones, environments, physical devices, mechanical devices, electro-mechanical devices, magnetic devices, electro-magnetic devices, electrical devices, electronic devices or any other real world device, etc. that are capable of being controlled or observed by a monitoring subsystem and collected and analyzed by a processing subsystem.

The term “virtual item” means any computer generated (GC) items or any feature, element, portion, or part thereof capable of being controlled by a processing unit. Virtual items include items that have no real world presence, but are still controllable by a processing unit, or may include virtual representations of real world items. These items include elements within a software system, product or program such as icons, list elements, menu elements, generated graphic objects, 2D and 3D graphic images or objects, generated real world objects such as generated people, generated animals, generated devices, generated plants, generated landscapes and landscape objects, generate seascapes and seascape objects, generated skyscapes or skyscape objects, or any other generated real world or imaginary objects. Haptic, audible, and other attributes may be associated with these virtual objects in order to make them more like “real world” objects.

The term “at least one” means one or more or one or a plurality, additionally, these three terms may be used interchangeably within this application. For example, at least one device means one or more devices or one device and a plurality of devices.

The term “a mixture” or “mixtures” mean the items, data or anything else is mixed together, not segregated, but more or less collected randomly—uniform or homogeneous.

The term “combinations” mean the objects, data or anything else segregated into groups, packets, bundles, etc.,—non-uniform or inhomogeneous.

The term “sensor data” mean data derived from at least one sensor including user data, motion data, environment data, temporal data, contextual data, or other data derived from any kind of sensor or environment, in real-time of historically, or mixtures and combinations thereof.

The term “user data” mean user attributes, attributes of entities under the control of the user, attributes of members under the control of the user, information or contextual information associated with the user, or mixtures and combinations thereof.

The term “motion data” mean data evidencing one or a plurality of motion attributes.

The term “motion attributes” mean attributes associated with the motion data including motion direction (linear, curvilinear, circular, elliptical, etc.), motion velocity (linear, angular, etc.), motion acceleration (linear, angular, etc.), motion signature—manner of motion (motion characteristics associated with the user, users, objects, areas, zones, or combinations of thereof), motion as a product of distance traveled over time, dynamic motion attributes such as motion in a given situation, motion learned by the system based on user interaction with the system, motion characteristics based on the dynamics of the environment, changes in any of these attributes, and mixtures or combinations thereof.

The term “environment data” mean data associated with the user's surrounding or environment such as location (GPS, etc.), type of location (home, office, store, highway, road, etc.), extent of the location, context, frequency of use or reference, any data associated with any environment, and mixtures or combinations thereof.

The term “temporal data” mean data associated with time, time of day, day of month, month of year, any other temporal data, and mixtures or combinations thereof.

The term “contextual data” mean data associated with user activities, environment activities, environmental states, frequency of use or association, orientation of objects, devices or users, association with other devices and systems, temporal activities, and mixtures or combinations thereof.

The term “biometric data” means any data that relates to specific characteristics, features, aspects, attributes etc. of a primary entity, a secondary entity under the control of a primary entity, or a real world object under the control of a primary or secondary entity. For entities, the data include, without limitation, fingerprints, palm prints, foot prints, toe prints, retinal patterns, internal and/or external organ shapes, features, colorings, shadings, textures, attributes, etc., skeletal shapes, features, colorings, shadings, textures, attributes, etc., internal and/or external placements, ratio of organ dimensions, hair color, distribution, texture, etc., whole body shapes, features, colorings, shadings, textures, attributes, neural or chemical signatures, emf fields, etc., any other attribute, feature, etc. or mixtures and combinations thereof. For real world objects, the data include, without limitation, shape, texture, color, shade, composition, any other feature or attribute or mixtures and combinations thereof.

The term “entity” means a human or an animal.

The term “primary entity” means any living organism with independent volition, which in the present application is a human, but other animals may meet the independent volition test. or organic entities under the control of a living organism with independent volition. Living organisms with independent volition include human for this disclosure, while all other living organisms useful in this disclosure are living organisms that are controllable by a living organism with independent volition.

The term “secondary entity” means any living organism or non-living (robots) device that is capable of being controlled by a primary entity including, without limitation, mammals, robots, robotic hands, arms, etc. that respond to instruction by primary entities.

The term “entity object” means a human or a part of a human (fingers, hands, toes, feet, arms, legs, eyes, head, body, etc.), an animal or a port of an animal (fingers, hands, toes, feet, arms, legs, eyes, head, body, etc.), or a real world object under the control of a human or an animal, or robotics under the control of a system, computer or software system or systems, or autonomously controlled (including with artificial intelligence), and include such articles as pointers, sticks, mobile devices, or any other real world object or virtual object representing a real entity object that can be directly or indirectly controlled by a human or animal or robot or robotic system.

The term “user” means an entity in a generic sense.

The term “real world item” means any real world item that is under the control of a primary or secondary entity including, without limitation, robots, pointers, light pointers, laser pointers, canes, crutches, bats, batons, etc. or mixtures and combinations thereof.

The terms “user features”, “entity features”, and “member features” means features including: overall user, entity, make up, or member shape, texture, proportions, information, state, layer, size, surface, zone, area, any other overall feature, and mixtures or combinations thereof; specific user, entity, or member part shape, texture, proportions, any other part feature, and mixtures or combinations thereof; and particular user, entity, or member dynamic shape, texture, proportions, any other part feature, and mixtures or combinations thereof; and mixtures or combinations thereof.

The term a “short time frame” means a time duration between less than or equal to 1 ns and less than 1 μs.

The term a “medium time frame” means a time duration between less than or equal to 1 μs and less than 1 ms.

The term a “long time frame” means a time duration between less than or equal to about 1 ms and less than or equal to 1 s.

The term a “very long time frame” means a time duration greater than 1 s, but less than or equal to 1 minute.

The term “mobile device” means any smart device that may be carried by a user and is capable of interacting with wireless communication network such as a WIFI™ network, a cellular network, a satellite network, or any other type of wireless network.

The term “data mining” means is a useful techniques that help entrepreneurs, researchers, individuals, AI routines, and other software mining tools extract valuable information from huge sets of data. Data mining is also sometimes called Knowledge Discovery in Database (KDD). The knowledge discovery process includes data cleaning, data integration, data selection, data transformation, data mining, pattern evaluation, and knowledge presentation. Data mining may be directed to relational databases, data warehouses, data reprositories, object-relational databases, transactional databases, OLAP databases, and/or other types of databases, whether cloud based, servers based, or processor based. Data mining finds application in market basket analysis, healthcare, fraud detection, customer relationship management (CRM), financial banking, education, manufacturing, engineering, lie detection, and now in motion based analytics of humans, animals, devices under the control of humans, animals, devices under the control of artificial intelligent (AI) control algorithms.

The term “data analytics” means using information from data mining to evaluate data, find patterns, and generate statistics.

The term “data integration” means the discipline of data integration comprises the practices, architectural techniques and tools for achieving the consistent access and delivery of data across the spectrum of data subject areas and data structure types in the enterprise to meet the data consumption requirements of all applications and business processes. Data integration tools have traditionally been delivered via a set of related markets, with vendors in each market offering a specific style of data integration tool. In recent years, most of the activity has been within the ETL tool market. Markets for replication tools, data federation (EII) and other submarkets each included vendors offering tools optimized for a particular style of data integration, and periphery markets (such as data quality tools, adapters and data modeling tools) also overlapped with the data integration tool space. The result of all this historical fragmentation in the markets is the equally fragmented and complex way in which data integration is accomplished in large enterprises different teams using different tools, with little consistency, lots of overlap and redundancy, and no common management or leverage of metadata. Technology buyers have been forced to acquire a portfolio of tools from multiple vendors to amass the capabilities necessary to address the full range of their data integration requirements. This situation is now changing, with the separate and distinct data integration tool submarkets converging at the vendor and technology levels. This is being driven by buyer demands as organizations realize they need to think about data integration holistically and have a common set of data integration capabilities they can use across the enterprise. It is also being driven by the actions of vendors, such as those in individual data integration submarkets organically expanding their capabilities into neighboring areas, as well as by acquisition activity that brings vendors from multiple submarkets together. The result is a market for complete data integration tools that address a range of different data integration styles and are based on common design tooling, metadata and runtime architecture.

The term “metric” or “metrics” means measures of quantitative assessment commonly used for assessing, comparing, and tracking performance or production. Generally, a group of metrics will typically be used to build a dashboard that management or analysts review on a regular basis to maintain performance assessments, opinions, and business strategies.

The term “intelligent content delivery network” or “iCDN” means any network the delivers content viewable from a customer or user such as streaming services, which do not include applications for dynamically interacting with the content for improving user experience with the iCDN. For example, a user chooses a video in on a streaming service, e.g., a Sci-Fi, gaming, action thriller, etc. However, the selection methodology employed does not include dynamic features derived from user activity and interaction data and/or user-to-user activity and interaction data. As the user moves through the interface, results of movies are displayed, but with more drama, comedy and romance (and combinations of all) show so the user can search with variable amounts of attributes, resulting in a display of results that have never been before. This blend of attributes is really displaying variable relationships of attributes associated with Database (DB) data and content

The term “advertising metric” or “advertising metrics” means measuring user interest/intent/confidence of many items at once as the cursor is moved towards objects. No longer is the metric of a “hot spot” (time on an object), or selection (clicking on the selection) the primary metrics to gauge real consumer/user intent, but rather we can measure relative percentages of intent with multiple items at once. This can be with the objects responding with variable feedback to the user so the user has a visual/audible/haptic (etc.) response from the content before a selection is made, or there can be no feedback and the metrics still are produce. Uses Distance, Changes of Distance, Direction, Changes of Direction, Velocity, changes of Velocity (Acceleration), Changes of rates of Acceleration or Deceleration, Time in the interactions or space, Pressures (i.e.—touch systems), or any other measurable input parameter that can change the metrics of User intent, interest, confidence, or interactions of any type (Confidence Metrics). The data may be 2D, 3D, and/or nD data.

### DETAILED DESCRIPTION OF THE INVENTION

### Apparatuses and Systems

Embodiments of the disclosure provide apparatuses and systems and/or interfaces and methods implementing them on electronic systems comprising processing units, processing systems, distributed processing systems, and/or distributing processing environments including a data collection/capture subsystem and a data analysis subsystem to collect/capture user activity and interaction data and analyze the data and produce usable data outputs such as metrics, predictive rules, device, environment, behavioral, optimizers, real-time or near real-time device, environment, behavioral, optimizers, and/or any combination thereof, wherein the apparatuses and systems and/or interfaces and methods implementing them (1) gather activity and/or interaction data from humans, animals, devices under that control of humans and/or animals, and/or devices under control of artificial intelligent (AI) algorithms and or routines interacting with devices, real world environments, virtual environments, and/or mixed real world or virtual (computer generated—CG) environments, (2) analyze of the collected/capture data, (3) generate metrics based on the data, (4) generate predictive rules from the data, (5) generate classification behavioral patterns, (6) generate of data derived information from data analytics and/or data mining, or (7) any mixture or combination thereof.

Embodiments of the disclosure provide systems and/or apparatuses including: (a) a monitoring subsystem including one or more sensors such as cameras, motion sensors, biometric sensors, biokinetic sensors, environmental sensors, e.g., sensors monitoring temperature, pressure, humidity, weather, air quality, location, chemicals, any other environment property, and/or any combination thereof, wherein the output is in a temporal stamped format, (b) a processing subsystem including one or more processing units, one or more processing systems, one or more distributed processing systems, and/or one or more distributing processing environments, and (c) an interface subsystem including one or more user interfaces having one or more human, animal, and/or artificial intelligent (AI) cognizable output devices such as audio output devices, visual output devices, audiovisual output devices, haptic or touch sensitive output devices, other output devices, or any combination thereof. The monitoring subsystem is configured to: (f) collect and/or capture monitored data from the sensors, (g) analyze of the data, (h) predict human, animal, and/or devices under that control of a human and/or animal activities and/or interactions based on the data, (i) produce metrics based on the data, (j) produce predictive metrics and/or behavioral patterns based on the data, and (k) output the metrics and/or behavioral patterns.

### Data

Embodiments of the present disclosure also provide collecting and/or capturing data from the monitoring subsystem comprising real-time or near real-time temporal correlated data of humans, animals, and/or devices under the control of humans, animals, artificial intelligent (AI) device control algorithms, etc. monitoring human, animal, human/animal/AI controlled device, etc. activities and/or interactions with (a) real world items and/or features/elements/portions/parts thereof, (b) real world environments and/or features/elements/portions/parts thereof, (c) virtual items and/or features/elements/portions/parts thereof, (d) virtual environments and/or features/elements/portions/parts thereof, and/or (e) mixed items and/or environments comprising combinations of real world items and/or features/elements/portions/parts thereof and virtual items and/or features/elements/portions/parts thereof, real world environments and/or features/elements/portions/parts and virtual environments and/or features/elements/portions/parts.

The real world items and/or features/elements/portions/parts thereof and/or environments and/or features/elements/portions/parts thereof including stores, malls, shopping centers, consumer products, cars, sports arenas, houses, apartments, villages, cities, states, countries, rivers, streams, lakes, seas, oceans, skies, horizons, stars, planets, etc., commercial facilities, transportation systems such as roads, highways, interstate highways, rail roads, etc., humans, animals, plants, any other real world item and/or environment and/or element or part thereof.

The virtual items and/or features/elements/portions/parts thereof and/or environments and/or features/elements/portions/parts thereof including computer generated (CG) simulated real world objects and/or environments and/or CG imaginative objects and/or environments. The mixed items and/or features/elements/portions/parts thereof and/or environments and/or features/elements/portions/parts thereof including any combination of (a) real world items and/or features/elements/portions/parts thereof and/or real world environments and/or features/elements/portions/parts thereof and GC items and/or features/elements/portions/parts thereof and (b) CG items and/or features/elements/portions/parts thereof and/or CG environments and/or features/elements/portions/parts thereof, i.e., mixed items comprise real world features/elements/portions/parts and CG features/elements/portions/parts.

The data comprises human, animal, and/or human/animal/AI controlled device movement or motion properties including (a) direction, velocity, and/or acceleration, (b) changes of direction, velocity, and/or acceleration, (c) profiles of motion direction, velocity, and/or acceleration, (d) pauses, stops, hesitations, gitters, fluctuations, etc., (e) changes of pauses, stops, hesitations, gitters, fluctuations, etc., (f) profiles of pauses, stops, hesitations, gitters, fluctuations, etc., (g) physical data, environmental data, astrological data, meteorological data, location data, etc., (h) changes of physical data, environmental data, astrological data, meteorological data, location data, etc., (i) profiles of physical data, environmental data, astrological data, meteorological data, location data, etc., and/or (j) any mixture or combination of these data.

### Data Analyses, Predictions, Classification, and Manipulations

Embodiments of the disclosure provide systems and methods implementing them including analyzing the collected/captured data and determining patterns, classifications, predictions, etc. using data analytics and data mining and using the patterns, classifications, predictions, etc., to update, modify, optimize, etc., the data collection/capture methodology and optimizing any feature that may be derived from the data analytics and data mining.

### Methods for Using the User Interface Apparatuses

Embodiments of the present disclosure provide methods implemented on a processing unit including the step of capturing biometric data via the biometric sensors and/or kinetic/motion data via the motion sensors and/or biokinetic data via the bio-kinetic sensors and creating a unique kinetic or biokinetic user identifier. One, some or all of the biometric sensors and/or the motion sensors may be the same or different.

### Metrics and KPIs

Embodiments of this disclosure may include creating metrics and/or key performance indicators (KPIs), or any other quantifiable value or indicator derived from gathered/collected/captured activity and/or interaction data or historical gathered/collected/captured data.

### QIVX Platform

Embodiments of this disclosure may include apparatuses and/or system and interfaces and/or methods implementing them, configured to satisfactorily implement the QIVX platform. The apparatuses and/or system and interfaces and/or methods implementing them are configured to: (1) add any media to any media (including hyperlinks to local and cloud assets); (2) create interactive environments including interactive content instead of non-interactive content such as videos on social media platforms; and (3) provide authoring tools to modify the created interactive environments and/or content for use on non-mobile, mobile, and/or wearable electronic devices, wherein the interactive environments and/or content may be derived from a real world environments and/or content, virtual reality environments and/or content, mixed reality environments and/or content, and/or any combination thereof. The interactive environments and/or content provided experiences derived from metaverse materials and wherein the assets (interactive or not) may be used and re-used in non-mobile, mobile, and/or wearable electronic devices.

apparatuses and/or system and interfaces and/or methods implementing them comprise: (1) a viewer to watch and interact with these new rich interactive experiences; (2) nn authoring tool to make the content; (3) a marketplace where the content may be sold or given away for free (with or without advertising), or free with subscription models, such as enterprise based subscription models and/or consumer/social subscription models; (4) an analysis tool referred to above that gives user confidences, metrics, and/or KPIs as part of the apparatuses and/or system and interfaces and/or methods implementing them for content interaction; and (5) one or more advertising metrics and/or KPIs that may be integrated into the advertising models in the marketplace, but may also be a stand-alone product that may used under license for websites, applications (apps), and/or for the Metaverse (XR/Digital world).

Not only may the environments and/or content be interacted with, but user activity and interaction becomes part of the gathered/collected/captured activity and interaction data and used in data monitoring, data collection, data analysis, data storage, and data retrieval. The apparatuses and/or system and interfaces and/or methods implementing them are also configured to: monitor, gather/collect/capture, analyze, store, and retrieve user-to-user activity and interaction data as multiple uses interactive with the environments and/or content. The data will also be used in all aspects of data analysis to produce metrics, KPIs, rules, any other activity predictive formats, and/or any combination thereof. The apparatuses and/or system and interfaces and/or methods implementing them are also configured to: modify, add, delete, change, alter, and/or any combination thereof all aspects of the environments and/or content to produce modified environments and/or content and to store the modified environments and/or content. The apparatuses and/or system and interfaces and/or methods implementing them are also configured to: monitor, gather/collect/capture, analyze, store, and retrieve all data produced by user interactions with the modified environments and/or content. Of course, the apparatuses and/or system and interfaces and/or methods implementing them may be configured to: replace or update the environments and/or content with the modified environments and/or content or create separate environments and/or content for different classes of users or for different end-users. This platform will allow users to interact in the virtual marketplace, or even in a real trade show or any setting, where any device that can measure interactions between the two can be used to share data, such as business cards, shared apps, locations, etc.

This platform may also include an element of the Integrated Services Digital Network (iCDN), training routines, and/or platform sharing routines.

Embodiments of the apparatuses and/or system and interfaces and/or methods implementing them may be used in XR environments, using glasses, cameras, or devices to measure product placement in stores, in crowd interest for band members on a stage, in in theater content, or for any other environment and/or content specific format. The apparatuses and/or system and interfaces and/or methods implementing them may be used as a stand-alone confidence metric for any kind of training environment, or operational environment like a manufacturing line, a special operation mission, a food processing facility, a service industry, a firefighter moving through a smoke-filled room, an active shooter situation, any other facility or situation for which the apparatuses and/or system and interfaces and/or methods implementing them may be used.

In all cases, the apparatuses and/or system and interfaces and/or methods implementing them may be used to measure probabilities, interests, confidences, likelyhoods, any other measure, metric, and/or KPI derived from dynamic data in real-time or near real-time, and may or may not be coupled with the analysis assemblies or subsystems such as AI, ML, CV, neural networking and learning, etc.

The QIVX platform may be used for training, operations intelligence, and for sharing ideas and stories or anything in between or combination thereof. The QIVX platform may be web based, cloud-based, stand alone, a hybrid cloud/server/web/network/edge/local system, or any combination thereof. The user may be a creator/maker (i.e., an author is one who authors the content), a viewer who experiences the authored content, an observer (one who observes the author, viewer, or both), or any other perspective of person, system, or thing that is engaged, using or viewing the Product. A base layer of media (Canvas; plural=Canvasses) is used, such as 360 video, 2D video, image, text document, audio file, PowerPoint (presentation medium), or even a digital medium that is volumetric or 2D and has virtual components (VR, AR, MR, or XR of any type). One or more Canvas media can be used, and sequentially or simultaneously (or a combination). Other content (Assets) can be added easily in a digital layer that is associated with base layer, and is typically associated with specific locations, zones, attributes and/or times of the base layer. One or more Assets can be used, and sequentially or simultaneously (or a combination—they can be used both sequentially or simultaneously based on the User's choices and intent). The relationships between the Assets and Canvas can be displayed or represented visually, audibly, tactilely, or in any other way, or may not be made know to the User or observer. The User and/or Author can interact using the QI technology (predictive of user intent, intelligent object/content/data response, confidence measurements in real-time and on-going), so speed and ease of creating content and consuming content is increased, and better understood (activates the middle-brain area to allow us to understand in space-time, pattern recognition, and how we perceive things, etc.). As the user is interacting with this rich story/experience in 2D/3D or any other medium, interactions may be guided or determined by the user, or a combination of these. Content can be dynamically added, modified or removed throughout. Navigation through lessons, classes, experiences, users, or any part of the DB can be done. Advertising (Confidence Metrics) can be used throughout to gauge users' interests, confidence, and other metrics. Interactions may be through mouse cursor, touch, touchless, gaze (head/eye/both), peripheral vision, etc. The Canvas, Assets, Metrics, iCDN (intelligent relationships and content/data system) and any combination can be moved to any other accepting platform or nD experience, so they can be reused without having to be re-made. The core engine analytics can be vector-based, linear or polynomial regression, or any other type of algorithms that can produce similar or like kinds of data, intent, results, and interactions. Created content can be shared off-line, on-line, or a hybrid of these. Content can be shared at a cost (E-commerce platform can be included on the platform/system), for free, or supported by Advertising, monthly payments (subscription), or any other means, and with real or crypto currencies. Content can be secured as NFTs or any other combination of current or future data/transaction/payment systems.

### Data Mining and Data Analytics

Embodiments of this disclosure relates to data mining all data collected and/or captured via the apparatuses and systems and method implementing them and interfaces implementing them. The data mining includes data classification, data clustering, data regression, data outlier detection, sequential data pattern recognition, prediction methods based on the data, and/or rule associations based on the data. Data mining may include: (1) building up an understanding of amount and types of data; (2) choosing and creating a data set to be mined; (3) preprocessing and cleansing the data; (4) transforming the data set if needed; (5) prediction and description of the type of data mining methodology to be used such as classification, regression, clustering, etc.; (6) selecting the data mining algorithm; (7) utilizing the data mining algorithm; (8) evaluating or assessing and interpreting the mined patterns, rules, and reliability to the objective characterized in the first step and consider the preprocessing steps focusing on the comprehensibility and utility of the induced model for overall feedback and discovery for data mining results; and (9) using the discovered knowledge to update data collection/capture, update sensor placement, update data analytics, update data mining, update tasks, update task content, update environmental content, update any other feature for which the data may be used.

Data mining and data analytics are two major methodologies used to analyze collected and generally databased data. Again, data mining concerns extracting data through finding patterns, cleaning, designing models and creating tests via database management, machine learning and statistics concepts. Data Mining can transform raw data into useful information.

Data mining generally includes various techniques, tools, and techniques including (1) data cleaning—converting all collected data into a specific standard format for simple processing and analysis incorporating identification and correction of errors, finding the missing values, removing duplicates, etc.; (2) artificial intelligence—algorithms to perform analytical activities such as planning, learning, and problem-solving; (3) association rule—market basket analysis to determine relationship between different dataset variables; (4) clustering—splitting huge set of data into smaller segments or subsets called clusters; (5) classification—assigning categories or classes to a data collection to get more analysis and prediction; (6) data analytics—evaluate data, find patterns, and generate statistics; (7) data warehousing—collecting and storing business data that helps in quick decision-making purposes; (8) regression—predicting numeric ranges of numeric values; and (9) any combination of these processes.

Data analytics includes evaluating data using analytical and logical concepts to gain insight into humans, animals, and devices under control of humans, animals, and/or AI algorithms. In particular, data analytics includes extracting, collecting, and/or capturing raw data using the apparatuses and systems of this disclosure. The routines include utilizing data transformations, data organization and data modeling to achieve suitable data outputs both qualitative and quantitative. The routines may be tailored to the needs of the consumer of the technology.

Data analytics includes various phases including (1) data discovery—analyze data and investigate problems associated with the data to develop a context and understanding of the data and its potential uses; (2) data preparation—performing various tasks such as extracting, transforming and updating data into so called sandboxes depending the desired output; (3) model planning—determine particular processes and techniques required to build a specific model and to learn about the relationships between variables and choose the most suitable models for the desired output metrics; (4) model building—create different data sets for testing, production, and/or training; (5) communicate results—interact with consumers of the output to determine if the metrics meet their needs need further refinement; and (6) operationalize—deliver the optimized metrics to the consumer.

### Sensor Functioning

The biometric sensors are designed to capture biometric data including, without limitation, external data, internal data, or mixtures and combinations thereof. The external data include external whole body data, external body part data, or mixtures and combinations thereof. The internal data include internal whole body data, internal body part data, or mixtures and combinations thereof. Exemplary examples of external whole body data include height, weight, posture, size, location, structure, form, orientation, texture, color, coloring, features, ratio of body parts, location of body parts, forms of body parts, structures of body parts, brain waves, brain wave patterns, temperature distributions, aura data, bioelectric and/or biomagnetic data, other external whole body data, or mixtures and combinations thereof. Exemplary examples of external body part data include, without limitation, body part shape, size, location, structure, form, orientation, texture, color, coloring, features, etc., auditory data, retinal data, finger print data, palm print data, other external body part data, or mixtures and combinations thereof. Exemplary examples of internal whole body data include skeletal data, blood circulation data, muscular data, EEG data, EKG data, ratio of internal body parts, location of internal body parts, forms of internal body parts, structures of internal body parts, other internal whole body data, or mixtures and combinations thereof. Exemplary examples of internal body part data include, without limitation, internal body part shape, size, location, structure, form, orientation, texture, color, coloring, features, etc., other internal body part data, or mixtures and combinations thereof.

The biometric data may be 1D biometric data, 2D biometric data, and/or 3D biometric data. The 1D biometric data may be linear data, non-linear, and/or curvilinear data derived from at least one body part. The body parts may include a body structure, a facial structure, a hand structure, a finger structure, a joint structure, an arm structure, a leg structure, a nose structure, an eye structure, an ear structure, any other body structure (internal and/or external), or mixtures and combinations thereof. The 2D biometric data may include surface structural data derived from body parts including whole body structure, facial structure, hand structure, arm structure, leg structure, nose structure, eye structure, ear structure, joint structure, internal organ structure such as vocal chord motion, blood flow motion, etc., any other body structure, or mixtures and combinations thereof. The 3D biometric data may include volume structures derived from body parts including body structure, facial structure, hand structure, arm structure, leg structure, nose structure, eye structure, ear structure, joint structure, internal organ structure such as vocal chord motion, blood flow motion, etc., any other body structure, or mixtures and combinations thereof. The biometric data may also include internal structure, fluid flow data, electrical data, chemical data, and/or any other data derived from sonic generators and sonic sensors, ultrasound generators and ultrasound sensors, X-ray generators and X-ray sensors, optical generators and optical sensors, or other penetrating generators and associated sensors.

The motion sensors are designed to capture kinetic or motion data associated with movement of an entity, one or more body parts, or one or more devices under the control of an entity (human or animal or robot), where kinetic data may include, without limitation, eye motion data, finger motion data, hand motion data, arm motion data, leg motion data, head motion data, whole body motion data, other body part motion data, or mixtures and combinations thereof. Similarly to the biometric data, the kinetic data may be 1D, 2D, 3D or mixtures and combinations thereof. The kinetic data is used to construct unique kinetic IDs such as user signatures, user names, passwords, identifiers, verifiers, and/or authenticators. These unique kinetic IDs may be used to access any other system including the control systems of this disclosure. The kinetic or motion data to be captured may be a user predefined movement or sequence of movements, a system predetermined movement or sequence of movements derived from a user's routine interaction user with the systems, or a system dynamic movement or sequence of movement derived dynamically via user interaction with the systems. This kinetic data or any combination of these kinetic data may be used to create or construct the kinetic IDs of this disclosure.

The systems and methods of this disclosure may be used to create or construct unique kinetic and/or biokinetic IDs such as signatures, user names, passwords, identifiers, verifiers, and/or authenticators for accessing control system including security systems such as electronic key lock systems, electro-mechanical locking systems, sensor systems, program element security systems and activation systems, virtual and augmented reality systems (VR/AR), wearable device systems, software systems, elements of software systems, other security systems, or mixtures and combinations thereof. Such security devices may include separate sensors or sensor arrays. Thus, an active pad sensor may be used not only to capture kinetic data via sensed motion, but may also be used to capture biometric data such as an image or images of finger or hand prints, while an optical sensor may also capture other types of biometric data such as a retinal scan.

The systems and methods of this disclosure may also include biometric sensing units and associated software such as finger print readers, hand print readers, other biometric reader, bio-kinetic readers, biomedical readers, ocular readers, chemical readers, chemical marker readers, retinal readers, voice recognition devices, or mixtures and combinations thereof. The systems and methods utilize the biometric data in combination with kinetic data and/or biokinetic data to construct unique kinetic and/or biokinetic IDs that are used to access electronic security systems, key locks, any other type of mechanical, software, and/or virtual locking mechanisms, or mixtures or combinations thereof. Such security devices may include separate sensors or may use the motion sensors. Thus, an active pad sensor may be used not only to sense motion, but may also be able to process a finger print or hand print to produce a bio-kinetic signature, identifier, and/or authenticator, while an optical sensor may also support a retinal scan function. The term biokinetic IDs such as signatures, user names, passwords, identifiers, verifiers, and/or authenticators means that the signatures, user names, passwords, identifiers, verifiers, and/or authenticators are construct or comprise at least one biometric attribute coupled with at least one user specific motion attribute. The biometric attributes include, without limitation, shape of the hand, fingers, EMF attributes, optical attributes, acoustic attributes, and/or any other wave and/or associated noise interference pattern attributes associated with the biology or combination of biology and sensor, such as eddy or noise EMF currents associated with static or dynamic kinetic or biometric data or events.

Biokinetic sensors may be designed and may function in different ways. Biokinetic sensors may be capable of capturing biometric data (i.e., biometrics refers to technologies that measure and analyze human body characteristics including DNA, fingerprints, retinas, irises, voice patterns, facial patterns, and hand measurements, etc.) and kinetic or motion data including kinetic data from one or a plurality of body part movements and/or from whole body movements. Thus, a fingerprint or skeletal dimension combined with user specific motion data may be used to construct more secure IDs such as signatures, user names, passwords, identifiers, verifiers, and/or authenticators than IDs based solely on biometric data such as fingerprint, voice print, retina scan, and/or other biometric data. This data may also be captures in more than one forma at once; an example being the emf signature of a finger or hand, and also the center of mass data captured simultaneously of the same or the like, then compared, creating a unique biometric identifier. By adding the kinetic component of one or more of these identifiers, a more secure verification can be made. A relationship constant or ration can also be determined between these, creating yet another unique identifier.

In certain embodiments, the systems or methods of this disclosure may capture additional biometric data such as a pulse, an oxygen content, and/or other physiological measurements coupled with user specific kinetic motion data such as rolling a finger or hand. The systems and methods then utilize this additional biometric data in combination with kinetic and/or biokinetic data with the addition of other biometric data to construct more secure IDs such as signatures, user names, passwords, identifiers, verifiers, and/or authenticators to access a residential security system, a commercial security system, a software application such as a banking software, communication software, unlocking mobile devices or programs in touch or touchless environments (including AR/VR environments) or any other software application that requires user identification, verification, and/or authentication. These unique kinetic IDs and/or biokinetic IDs may also be used for electronic vaults such as bank vaults, residential vaults, commercial vaults, etc., other devices that require identification, verification, and/or authentication than using just biometric data alone or motion data alone. For example, taking a retinal scan and moving (simultaneously or sequentially) the eye in a certain way or in combinations of movements may cause the systems or methods to construct new and more secure identifiers, verifiers, controllers, and/or authenticators than identifiers, verifiers, and/or authenticators based solely on a retinal scan. The biometric data and the motion or kinetic data may be captured in any order, simultaneously or sequentially. The kinetic or motion may be a singular movement, a sequence of movements, a plurality of predetermined movements, or a pattern of movements.

Other embodiments of the systems and methods of this disclosure relate to the use of capacitive, acoustic, or other sensors, which are capable of capturing body specific metrics or biometric data such as skeletal dimensions of a finger, etc. The systems and methods of this disclosure then coupled this biometric data with kinetic or motion data to construct unique biokinetic IDs such as signatures, user names, passwords, identifiers, verifiers, and/or authenticators. For examples, putting two fingers, a finger and a thumb, or any combination of body parts together and moving them in a specific manner may be used to construct unique kinetic and/or biokinetic IDs such as signatures, user names, passwords, identifiers, verifiers, and/or authenticators, where these IDs have improved security relative to signatures, user names, passwords, identifiers, verifiers, and/or authenticators constructed using biometric data alone. For example, the kinetic or motion data may involve moving two fingers together showing a relative differentiation between body parts for use in constructing unique kinetic and/or biokinetic signatures, user names, passwords, identifiers, verifiers, and/or authenticators. For example, the kinetic or motion data may involve moving three fingers random manner or in a predetermined manner to construct unique kinetic IDs and/or biokinetic IDs. Another example, the kinetic or motion data may include a simple swiping motion or a simple gesture such as an up, down or up/down movement to construct unique kinetic IDs and/or biokinetic IDs.

In other embodiments, the systems and methods may also use linear and/or non-linear velocity, linear and/or non-linear acceleration, changes of velocity or acceleration, which are vector quantities or changes in vector quantities and include a time dimension, where this data may be used to construct unique kinetic IDs. In certain embodiments, the captured kinetic data may be compared in whole or part of kinetic data stored in a database or a look-up table to identify the user or to determine the proper user identity or to activate a control system of this disclosure or any other system that requires unique IDs. In other embodiments, the IDs may be may even more unique by capturing multi-directional gestures coupled with biometric data, where the gestures or kinetic data and the biometric data may be compared in whole or part to kinetic data and biometric data stored in a database or a look-up table. In other embodiments, the unique IDs may also incorporate real-time analysis of user movement and movements, where slight differences in speed, direction or acceleration of the body part(s) being sensed along with the biometric data associated with body parts, or any combination of these. In other embodiments, the unique IDs may also incorporate multiple instances of real-time motion analytics, whether in combination or sequentially, may be used as well. In other embodiments, the unique IDs may also incorporate hovers, pauses, holds, and/or timed holds.

In other embodiments, the systems and methods for producing unique IDs may capture a movement pattern or a plurality of movement patterns, where each pattern may include a wave pattern, a pattern of predetermined movements, a pattern of user defined movements, a pattern of movement displayed in a mirrored format, which may be user defined, predetermined, or dynamic. For instance, one or more sensors may capture data including two fingers held tightly together and gaps between the tightly held fingers may be seen by one or more sensors. In certain embodiments, the systems and methods may use waveform interference and/or phase patterns to improve or amplify not only the uniqueness of the gaps between the fingers, but also the uniqueness of the fingers. The systems and methods may then use this data to construct unique biokinetic IDs do to the inclusion of the interference patterns. In certain embodiments, one or more sensors capture the waveforms and/or interference patterns to add further uniqueness to the biokinetic IDs of this disclosure. By capturing data over a time period, even very short period of time (e.g., time periods having a duration between about 1 ns (very short) and about 10 s (fairly long), but longer and shorter time periods may be used), differences in the waveform and/or interference patterns over the time period such as shifts in constructive and destructive interferences, the biokinetic IDs may be made even more secure against copying, counterfeiting, etc. In an similar manner, the systems and methods may capture biokinetic data of a finger at rest as a finger of a living being is never fully at rest over time, where small movements do to blood flow, nerve firings, heartbeats, breathing, any other cause of small movements, and combinations thereof. The biokinetic data may comprise interference patterns, movement patterns, any other time varying pattern represent patterns unique to an entity. In this way, even data that would appear at first blush to be purely biometric, now becomes biokinetic do to the inclusion of macro kinetic data and/or micro kinetic data to produce biokinetic data. The kinetic data and/or biokinetic data may be used by the systems and methods to construct or create unique kinetic and biokinetic IDs. In other embodiments, so call “noise” associated with sensing and capturing movement of a body or body part or associated with sensing and capturing biometric data or associated with sensing and capturing biokinetic data (internal and external data) may be used by the systems and methods to construct or create unique biometric, kinetic and/or biokinetic IDs including contributions from the noise. This noise may also be compared to the biometric, kinetic, or biokinetic data and compared, creating a unique relational data to each other, this being another unique identifier that may be used in combination with the other data, or by itself to create a unique identifier or data metric.

While the kinetic data may include very precise and often time consuming data collection/capture sequences, the systems and methods may also collect/capture whole body and/or body part movement to construct unique kinetic and/or biokinetic IDs. It is believed that movement of a whole body or a body part may require less precise sensors or less time to capture data unique to a given user.

In other examples, the kinetic and/or biokinetic IDs of this disclosure may include data from different sources: 1) kinetic or motion data including simply motion data such as direction, velocity, acceleration, etc., compound or complex motion data such as combinations of direction, velocity, acceleration, gestures, etc., motion change data such as changes in direction, velocity of motion, acceleration, gestures, etc. over time, or mixtures and combinations thereof, (2) biometric data including verbal, touch, facial expressions, etc., or mixtures and combinations thereof, and/or 3) biokinetic data including body motion data, body part motion data, body motion and body biometric data, body part motion and body part biometric data, etc., or mixtures and combinations thereof. The systems and methods may utilize these data to construct unique kinetic and/or biokinetic IDs, i.e., kinetic and/or biokinetic IDs are unique to a particular entity—human or animal.

Not only may the kinetic, biometric and/or biokinetic data be used to produce unique kinetic and/or biokinetic IDs such as kinetic and/or biokinetic signatures, signals, verifiers, identifiers, and/or authenticators for security purposes, these kinetic and/or biokinetic IDs may be used to access systems of this disclosure or other systems requiring unique identifiers. Additionally, the kinetic, biometric and/or biokinetic data may be used by the control systems of this disclosure to generate command and control for actuating, adjusting, scrolling, attribute control, selection, and other uses. By adding user specific kinetic, biometric and/or biokinetic data, the same motions performed by one person may cause a different result compared to another persons as aspects of the user specific data will be unique to each user.

### Control Systems

Embodiments of the present disclosure broadly relate to control systems for controlling real and/or virtual objects such as mechanical devices, electrical devices, electromechanical devices, appliances, software programs, software routines, software objects, or other real or virtual objects, where the systems include at least one motion sensor, data from a sensor capable of sensing motion, at least one processing unit or a sensor/processing combined unit, and optionally at least one user interface. The motion sensors detect movement within sensing zones, areas, and/or volumes and produce output signals of the sensed movement. The processing units receive the output signals and convert the output signals into control and/or command functions for controlling one real and/or virtual object or a plurality of real and/or virtual objects. The control functions include scroll functions, select functions, attribute functions, simultaneous select and scroll functions, simultaneous select and activate functions, simultaneous select and attribute activate functions, simultaneous select and attribute control functions, simultaneous select, activate, and attribute control functions, and mixtures or combination thereof. The systems may also include remote control units. The systems of this disclosure may also include security units and associated software such as finger print readers, hand print readers, biometric reader, bio-kinetic readers, biomedical readers, retinal readers, voice recognition devices, gesture recognition readers, other electronic security systems, key locks, any other type of mechanical locking mechanism, or mixtures or combinations thereof. Such security devices may include separate sensors or may use the motion sensors. Thus, an active pad sensor may be used not only to sense motion, but may also be able to process a finger print or hand print image, or bio-kinetic print, image or pattern, while an optical sensor may also support a retinal, facial, finger, palm, or other body part scan functions. The term “bio-kinetic” means that the movement of a user is specific to that user, especially when considering the shape of the hand, fingers, or body parts used by the motion sensor to detect movement, and the unique EMF, optical, acoustic, and/or any other wave interference patterns associated with the biology and movement of the user.

Embodiments of the present disclosure broadly relate to at least one user interface to allow the system to interact with an animal and/or a human and/or robot or robotic systems based on sensed motion.

Embodiments of the present disclosure broadly relate to control systems for controlling real and/or virtual objects such as electrical devices, appliances, software programs, software routines, software objects, sensors, projected objects, or other real or virtual objects, where the systems includes at least one motion sensor or data from a motion sensor, at least one processing unit, and at least one user interface. The motion sensors detect movement or motion within one or a plurality of sensing zones, areas, and/or volumes associated with the sensors, and the motion sensors produce output signals of the sensed movement. The processing units receive output signals from the motion sensors and convert the output signals into control and/or command functions for controlling one real and/or virtual object or a plurality of real and/or virtual objects. Of course, the motion sensors and processing units may be combined into single units sometimes referred to as sensor/processing units. The control and/or command functions include scroll functions, select functions, attribute functions, simultaneous select and scroll functions, simultaneous select and activate functions, simultaneous select and attribute activate functions, simultaneous select and attribute control functions, simultaneous select, activate functions and attribute control functions, simultaneous activate and attribute control functions or any combination thereof. The systems may also include remote units. The systems of this disclosure may also include security units and associated software such as finger print readers, hand print readers, biometric readers, bio-kinetic readers, biomedical readers, EMF detection units, optical detection units, acoustic detection units, audible detection units, or other type of wave form readers, retinal readers, voice recognition devices, other electronic security systems, key locks, any other type of mechanical locking mechanism, or mixtures or combinations thereof. Such security devices may include separate sensors or may use the motion sensors. Thus, an active pad sensor may be used not only to sense motion, but also to able to process a finger print or hand print image, while an optical sensor may also support a retinal scan function, or an acoustic sensor may be able to detect the motions as well as voice commands, or a combination thereof.

Embodiments of the present disclosure broadly relate to control systems for real and/or virtual objects such as electrical devices, appliances, software programs, software routines, software objects, or other real or virtual objects, where the systems include at least one remote control device including at least one motion sensor, at least one processing unit, and at least one user interface, or a unit or units that provide these functions. The motion sensor(s) detect movement or motion within sensing zones, areas, and/or volumes and produce output signals of the sensed movement or motion. The processing units receive output signals from the sensors and convert the output signals into control and/or command functions for controlling one real and/or virtual object or a plurality of real and/or virtual objects. The control and/or command functions include scroll functions, select functions, attribute functions, simultaneous select and scroll functions, simultaneous select and activate functions, simultaneous select and attribute activate functions, simultaneous select and attribute control functions, simultaneous select, activate functions and attribute control functions, and/or simultaneous activate and attribute control functions or any combination thereof. The systems may also include remote units. The system of this disclosure may also include security units and associated software such as finger print readers, hand print readers, biometric readers, bio-kinetic readers, biomedical readers, EMF detection units, optical detection units, acoustic detection units, audible detection units, or other type of wave form readers, retinal readers, voice recognition devices, other electronic security systems, key locks, any other type of mechanical locking mechanism, or mixtures or combinations thereof. Such security devices may include separate sensors or may use the motion sensors. Thus, an active pad sensor may be used not only to sense motion, but also to able to process a finger print or hand print image, while an optical sensor may also support a retinal scan function.

The systems of this disclosure allow users to control real and/or virtual objects such as electrical devices, appliances, software programs, software routines, software objects, sensors, or other real or virtual objects based solely on movement detected with the motion sensing zones of the motion sensors without invoking any hard selection protocol, such as a mouse click or double click, touch or double touch of a pad, or any other hard selection process, though these hard selections may also be incorporated into systems. The systems simply track movement or motion in the sensing zone, converting the sensed movement or motion into output signals that are processed into command and/or control function(s) for controlling devices, appliances, software programs, and/or real or virtual objects. The motion sensors and/or processing units are capable of discerning attributes of the sensed motion including direction, velocity, and/or acceleration, sensed changes in direction, velocity, and/or acceleration, or rates of change in direction, velocity, and/or acceleration. These attributes generally only trigger a command and/or control function, if the sensed motion satisfies software thresholds for movement or motion direction, movement or motion velocity, movement or motion acceleration and/or changes in movement direction, velocity, and/or acceleration and/or rates of change in direction, rates of change in linear and/or angular velocity, rates of change of linear and/or angular acceleration, and/or mixtures or combinations thereof. Although the movement or motion may be in any direction, have any velocity, and/or have any acceleration within the sensing zones, changes in direction, velocity, and/or acceleration of movement or motion are subject to the motion sensors and/or processing unit's ability to discriminate there between. The discrimination criteria may be no discrimination (all motion generates an output signal), may be preset, may be manually adjusted or may be automatically adjust depending on the sensing zones, the type of motion being sensed, the surrounding (noise, interference, ambient light, temperature, sound changes, etc.), or other conditions that could affect the motion sensors and/or the processing unit by design or inadvertently. Thus, when a user or robot or robotic system moves, moves a body part, moves a sensor or sensor/processing unit or moves an object under user control within one or more sensing zones, the movement and attributes thereof including at least direction, linear and/or angular velocity, linear and/or angular acceleration and/or changes in direction, linear and/or angular velocity, and/or linear and/or angular acceleration including stops and times holds are sensed. The sensed movement or motion is then converted by the processing units into command and control function as set forth above.

Embodiments of the systems of this disclosure include motion sensors that are capable of detecting movement or motion in one dimension, two dimensions, and/or three dimensions including over time and in different conditions. For example, the motion sensors may be capable of detecting motion in x, y, and/or z axes or equivalent systems such as areas on a surface (such a the skin motions of the pad area of a finger tip), volumes in a space, volumes in a liquid, volumes in a gas, cylindrical coordinates, spherical coordinates, radial coordinates, and/or any other coordinate system for detecting movement in three directions, or along vectors or other motion paths. The motion sensors are also capable of determining changes in movement or motions in one dimension (velocity and/or acceleration), two dimension (direction, area, velocity and/or acceleration), and/or three dimension (direction, area, volume, velocity and/or acceleration). The sensors may also be capable of determining different motions over different time spans and areas/volumes of space, combinations of inputs such as audible, tactile, environmental and other waveforms, and combinations thereof. The changes in movement may be changes in direction, changes in velocity, changes in acceleration and/or mixtures of changes in direction, changes in velocity or changes in acceleration and/or rates of change in direction, rates of change in velocity, rates of change of acceleration, and/or mixtures or combinations thereof, including from multiple motion sensors, sensors with motion sensing ability, or multiple sensor outputs, where the velocity and/or acceleration may be linear, angular or mixtures and combinations thereof, especially when movement or motion is detected by two or more motion sensors or two or more sensor outputs. The movement or motion detected by the sensor(s) is(are) used by one or move processing units to convert the sensed motion into appropriate command and control functions as set forth herein.

In certain embodiments, the systems of this disclosure may also include security detectors and security software to limit access to motion detector output(s), the processing unit(s), and/or the real or virtual object(s) under the control of the processing unit(s). In other embodiments, the systems of this disclosure include wireless receivers and/or transceivers capable of determining all or part of the controllable real and/or virtual objects within the range of the receivers and/or transceivers in the system. Thus, the systems are capable of polling a zone to determine numbers and types of all controllable objects within the scanning zone of the receivers and/or transceivers associated with the systems. Thus, if the systems are portable, the systems will poll their surroundings in order to determine the numbers and types of controllable objects, where the polling may be continuous, periodic, and/or intermittent. These objects, whether virtual or real, may also be used as a sensor array, creating a dynamic sensor for the user to control these and other real and/or virtual objects. The motion sensors are capable of sensing movement of a body (e.g., animal or human), a part of an animal or human (e.g., legs, arms, hands, fingers, feet, toes, eyes, mouth, etc.), and/or an object under control of an animal or human (wands, lights, sticks, phones, mobile devices, wheel chairs, canes, laser pointers, location devices, locating devices, etc.), and robots and/or robotic systems that take the place of animals or humans. Another example of this would be to sense if multiple objects, such as people in a public assembly change their rate of walking (a change of acceleration or velocity is sensed) in an egress corridor, thus, indicating a panic situation, whereby additional egress doors are automatically opened, additional egress directional signage may also be illuminated, and/or voice commands may be activated, with or without other types of sensors being made active.

A timed hold in front of a sensor may be used to activate different functions, e.g., for a sensor on a wall, holding a finger or object briefly in front of sensor causes lights to be adjusted to a preset level, causes TV and/or stereo equipment to be activated, and/or causes security systems to come on line or be activated, or begins a scroll function through submenus or subroutines. While, continuing to hold, begins a bright/dim cycle that ends, when the hand or other body part is removed. Alternatively, the timed hold causes an attribute value to change, e.g., if the attribute is at its maximum value, a timed hold would cause the attribute value to decrease at a predetermined rate, until the body part or object is removed from or within the active zone. If the attribute value is at its minimum value, then a timed hold would cause the attribute value to increase at a predetermined rate, until the body part or object is removed from or within the active zone. If the value is somewhere in the middle, then the software may allow random selection or may select the direction, velocity, acceleration, changes in these motion properties or rates of changes in these motion properties that may allow maximum control. Of course the interface may allow for the direction, velocity, acceleration, changes in these motion properties, or rates of changes of these motion properties to be determined by the initial direction of motion, while the timed hold would continue to change the attribute value until the body part or object is removed from or within the active zone. A stoppage of motion may be included, such as in the example of a user using a scroll wheel motion with a body part, whereby a list is scrolled through on a display. Once a stoppage of circular motion occurs, a linear scroll function begins, and remains so until a circular motion begins, at which point a circular scroll function remains in effect until stoppage of this kind of motion occurs. This change of direction may be performed with different parts of the body and not just one part as well sequentially or simultaneously. In this way, a change of direction, and/or a change of speed (change in acceleration) alone has caused a change in selection of control functions and/or attribute controls. In the circular scroll function, an increase in acceleration might cause the list to not only accelerate in the scroll speed, but also cause the font size to appear smaller, while a decrease in acceleration might cause the scroll speed to decelerate and the font size to increase. Another example might be that as a user moves towards a virtual or real object, the object would move towards the user based upon the user's rate of acceleration; i.e., as the user moves faster towards the object, the object would move faster towards the user, or would change color based upon the change of speed and/or direction of the user. The term “brief” or “briefly” means that the timed hold or cessation of movement occurs for a period to time of less than a second. In certain embodiments, the term “brief” or “briefly” means for a period of time of less than 2.5 seconds. In other embodiments, the term “brief” or “briefly” means for a period of time of less than 5 seconds. In other embodiments, the term “brief” or “briefly” means for a period of time of less than 7.5 seconds. In other embodiments, the term “brief” or “briefly” means for a period of time of less than 10 seconds. In other embodiments, the term “brief” or “briefly” means for a period of time of less than 15 seconds. In other embodiments, the term “brief” or “briefly” means for a period of time of less than 20 seconds. In other embodiments, the term “brief” or “briefly” means for a period of time of less than 30 seconds.

All that is required in order for the systems of the disclosure of operate properly is that the software must be able to determine when to transition from one command format, such as scrolling through a list to selecting a member from the list has occurred do to a change in a direction, velocity, or acceleration of motion, changes in these motion properties, and/or rates of changes of these motion properties sensed by the systems. Thus, the difference in the direction, velocity, acceleration, and/or changes thereof and/or rates of changes thereof must be sufficient to allow the software to make such a determination (i.e., a discernible change in motion direction, velocity, and/or acceleration), without frustrating the user because the direction, velocity, and/or acceleration change routines do not permit sufficient angular and/or distance deviation from a given direction before changing from one command format to another, i.e., changing from a list scroll function to a select and attribute value adjustment function associated with a member of the list. Although the angle deviation can be any value, the value is may be about ±1° from the initial direction or about ±2.5° from the initial direction or about ±5° from the initial direction, or about ±10° from the initial direction or about ±15° from the initial direction. For systems set to run on orthogonal directions, e.g., x and y or x, y and z, the deviation can be as great as about ±45° or about ±35° or about ±25° or about ±15° or about ±5° or about ±2.5° or about ±1°. Alternatively, movement in a given direction within an angle deviation of ±x̊ will result in the control of a single device, while movement in a direction half way between two devices within an angle deviation of ±x̊ will result in the control of both devices, where the magnitude of value change may be the same or less than that for a single device and where the value of x will depend on the number of device directions active, but in certain embodiments, will be less than or equal to ¼ of the angle separating adjacent devices. For example, if four devices are located at +x, −x, +y and −y from a center of the an active sensing zone, movement in a 45° angle relative to +x and +y would adjust the attribute of both the +x and +y device simultaneously, at a single device rate or at half a single device rate or at any other predetermined rate of attribute value change, or all four devices may be decreased or increased collectively and proportionately to the distance from the user's coordinates(s) and the change in direction coupled with velocity, acceleration, changes in these motion properties, and/or rates of changes in these motion properties. In another example, changes in speed of one cm per second, or combinations of speed change and angular changes as described above will provide enough change in acceleration that the output command or control of the object(s) will occur as desired. In another example, the distance moved by itself, or in combination with other motion attributes will provide enough change to provide the output command or control of object(s). The systems of the present disclosures may also include gesture processing. For example, the systems of this disclosure will be able to sense a start pose, a motion, and an end pose, where the sensed gesture may be referenced to a list of gestures stored in a look-up table. It should be noted that a gesture in the form of this disclosure may contain all the elements listed herein (i.e., any motion or movement, changes in direction of motion or movement, velocity and/or acceleration of the motion or movement) and may also include the sensing of a change of in any of these motion properties to provide a different output based upon differences in the motion properties associated with a given gesture. For example, if the pattern of motion incorporated in the gesture, say the moving of a fist or pointed finger in a circular clock-wise direction causes a command of “choose all” or “play all” from a list of objects to be issues, speeding up the circular motion of the hand or finger while making the circular motion (increases in angular motion—velocity or acceleration) may provide a different command to be issued, such as “choose all but increase the lighting magnitude as well” or “play all but play in a different order”. In this way, a change of linear and/or angular velocity and/or acceleration could be used as a gestural command or a series of gestures, as well as a motion-based commands where selections, controls and commands are given when a change in motion properties are made, or where any combination of gestures and motions of these is made.

For purposes of measuring acceleration or changes in velocity, an accelerometer may be used. An accelerometer is a device that measures “proper acceleration”. Proper acceleration is physical acceleration (i.e., measurable acceleration as by an accelerometer) experienced by an object and is the acceleration felt by occupants associated with an accelerating object, and which is described as a G-force, which is not a force, but rather an acceleration. For the purposes of this disclosure, an accelerometer, therefore, is a device that measures acceleration and changes in acceleration by any means.

Velocity and acceleration are vector quantities, consisting of magnitude (amount) and direction (linear and non-linear). Distance is typically a product of velocity and time, and traveling a distance can always be expressed in terms of velocity, acceleration and time, where a change, measurement or threshold of distance traveled can be expressed as a threshold of velocity and or time criteria. Acceleration is typically thought of as a change in velocity, when the direction of velocity remains the same. However, acceleration also occurs when the velocity is constant, but the direction of the velocity changes, such as when a car makes a turn or a satellite orbits the earth. If a car's velocity remains constant, but the radius is continuously reduced in a turn, the force resulting from the acceleration increases. This force is called G-force. Acceleration rate may change, such as when a satellite keeps its same orbit with reference to the earth, but increases or decreases its speed along that orbit in order to be moved to a different location at a different time.

Typically, acceleration is expressed mathematically by a=dv/dt or a=d²x/dt²−a change of velocity with respect to time, while velocity is express mathematically by v=dx/dt−a change in distance with respect to time. If a motion sensor is capable of sensing velocity and/or acceleration, then the output of such a device, which may be used for command and control function generation and determination, would include sampling to measure units of average velocity and/or accelerations over a given time or as close to instantaneous velocity and/or accelerations as possible. These changes may also be used for command and control function generation and determination including all acceptable command and control functions. It should be noted that average or instantaneous accelerations or velocities may be used to determine states or rates of change of motion, or may be used to provide multiple or different attribute or command functions concurrently or in a compounded manner. These capabilities are more simply visualized by saying when an acceleration value, as measured by an accelerometer, is sensed, a command may be issued, either in real-time, or as an average of change over time (avg da/dt), or as an “acceleration gesture” where an acceleration has been sensed and incorporated into the table values relevant to pose-movement-pose then look-up table value recognized and command sent, as is the way gestures are defined. Gestures are currently defined as pose, then a movement, then a pose as measured over a given time, which is then paired with a look-up table to see if the values match, and if they do, a command is issued. A velocity gesture and an acceleration gesture would include the ability to incorporate velocity or changes in velocity or acceleration or changes in acceleration as sensed and identified between the poses, offering a much more powerful and natural identifier of gestures, as well as a more secure gesture where desired. In fact, the addition of changes in motion properties during a gesture can be used to greatly expand the number of gesture and the richness of gesture processing and on-the-fly gesture modification during processing so that the look-up table would identify the “basic” gesture type and the system would then invoke routines to augment the basic response in a pre-determined or adaptive manner.

Embodiments of this disclosure relate to methods that are capable of measuring a person, a person's body part(s), or object(s) under the control of a person moving in a continuous direction, but undergoing a change in velocity in such a manner that a sensor is capable of discerning the change in velocity represented by Av or dv or acc. Once a change in velocity is sensed by the sensor, the sensor output is forwarded to a processing unit that issues a command function in response to the sensor output, where the command function comprises functions previously disclosed. These process may occur simultaneously where capabilities to do so exist or multiple instances of these processes may occur simultaneously or sequentially, such as with the capabilities of Quantum Processors. The communication may be wired or wireless, if wired, the communication may be electrical, optical, sonic, or the like, if the communication is wireless, the communication may be: 1) light, light waveforms, or pulsed light transmissions such as Rf, microwave, infra-red (IR), visible, ultraviolet, or other light communication formats, 2) acoustic, audile, sonic, or acoustic waveforms such as ultrasound or other sonic communication formats, or 3) any other type of wireless communication format. The processing unit includes an object list having an object identifier for each object and an object specific attribute list for each object having one or a plurality of attributes, where each object specific attribute has an attribute identifier.

The systems and methods are disclosed herein where command functions for selection and/or control of real and/or virtual objects may be generated based on a change in velocity at constant direction, a change in direction at constant velocity, a change in both direction and velocity, a change in a rate of velocity, a change in a rate of acceleration, and/or a change of distance within a velocity or acceleration. Once detected by a detector or sensor, these changes may be used by a processing unit to issue commands for controlling real and/or virtual objects. A selection or combination scroll, selection, and attribute selection may occur upon the first movement. Such motion may be associated with doors opening and closing in any direction, golf swings, virtual or real world games, light moving ahead of a runner, but staying with a walker, or any other motion having compound properties such as direction, velocity, acceleration, and changes in any one or all of these primary properties; thus, direction, velocity, and acceleration may be considered primary motion properties, while changes in these primary properties may be considered secondary motion properties. The system may then be capable of differentially handling of primary and secondary motion properties. Thus, the primary properties may cause primary functions to be issued, while secondary properties may cause primary function to be issued, but may also cause the modification of primary function and/or secondary functions to be issued. For example, if a primary function comprises a predetermined selection format, the secondary motion properties may expand or contract the selection format.

In another example of this primary/secondary format for causing the system to generate command functions may involve an object display. Thus, by moving the object in a direction away from the user's eyes, the state of the display may change, such as from a graphic to a combination graphic and text, to a text display only, while moving side to side or moving a finger or eyes from side to side could scroll the displayed objects or change the font or graphic size, while moving the head to a different position in space might reveal or control selections, attributes, and/or submenus of the object. Thus, these changes in motions may be discrete, compounded, or include changes in velocity, acceleration and rates of these changes to provide different results for the user. These examples illustrate two concepts: 1) the ability to have compound motions which provide different results than the motions separately or sequentially, and (2) the ability to change states or attributes, such as graphics to text solely or in combination with single or compound motions, or with multiple inputs, such as verbal, touch, facial expressions, or bio-kinetically, all working together to give different results, or to provide the same results in different ways.

It must be recognized that the present disclosure while based on the use of sensed velocity, acceleration, and changes and rates of changes in these properties to effect control of real world objects and/or virtual objects, the present disclosure may also use other properties of the sensed motion in combination with sensed velocity, acceleration, and changes in these properties to effect control of real world and/or virtual objects, where the other properties include direction and change in direction of motion, where the motion has a constant velocity. For example, if the motion sensor(s) senses velocity, acceleration, direction, changes in direction, changes in velocity, changes in acceleration, changes in distance, and/or combinations thereof that is used for primary control of the objects via motion of a primary sensed human, animal, part thereof, real world object under the control of a human or animal, or robots under control of the human or animal, then sensing motion of a second body part may be used to confirm primary selection protocols or may be used to fine tune the selected command and control function. Thus, if the selection is for a group of objects, then the secondary motion may be used to differentially control object attributes to achieve a desired final state of the objects.

For example, suppose the apparatuses of this disclosure control lighting in a building. There are banks of lights on or in all four walls (recessed or mounted) and on or in the ceiling (recessed or mounted). The user has already selected and activated lights from a selection menu using motion to activate the apparatus and motion to select and activate the lights from a list of selectable menu items such as sound system, lights, cameras, video system, etc. Now that lights have been selected from the menu, movement to the right would select and activate the lights on the right wall. Movement straight down would turn all of the lights of the right wall down—dim the lights. Movement straight up would turn all of the lights on the right wall up—brighten. The velocity of the movement down or up would control the rate that the lights were dimmed or brighten. Stopping movement would stop the adjustment or removing the body, body part or object under the user control within the motion sensing area would stop the adjustment. Using a time component would provide even more control possibilities, providing distance thresholds (a product of speed and time).

For even more sophisticated control using motion properties, the user may move within the motion sensor active area to map out a downward concave arc, which would cause the lights on the right wall to dim proportionally to the arc distance from the lights. Thus, the right lights would be more dimmed in the center of the wall and less dimmed toward the ends of the wall.

Alternatively, if the movement was convex downward, then the light would dim with the center being dimmed the least and the ends the most. Concave up and convex up would cause differential brightening of the lights in accord with the nature of the curve.

Now, the apparatus may also use the velocity of the movement of the mapping out the concave or convex movement to further change the dimming or brightening of the lights. Using velocity, starting off slowly and increasing speed in a downward motion would cause the lights on the wall to be dimmed more as the motion moved down. Thus, the lights at one end of the wall would be dimmed less than the lights at the other end of the wall.

Now, suppose that the motion is a S-shape, then the light would be dimmed or brightened in a S-shaped configuration. Again, velocity may be used to change the amount of dimming or brightening in different lights simply by changing the velocity of movement. Thus, by slowing the movement, those lights would be dimmed or brightened less than when the movement is speed up. By changing the rate of velocity—acceleration—further refinements of the lighting configuration may be obtained. Again, adding a time component to the velocity or acceleration would provide even more possibilities.

Now suppose that all the lights in the room have been selected, then circular or spiral motion would permit the user to adjust all of the lights, with direction, velocity and acceleration properties being used to dim and/or brighten all the lights in accord with the movement relative to the lights in the room. For the ceiling lights, the circular motion may move up or down in the z direction to affect the luminosity of the ceiling lights. Thus, through the sensing of motion or movement within an active sensor zone—area and especially volume, a user can use simple or complex motion to differentially control large numbers of devices simultaneously.

This differential control through the use of sensed complex motion permits a user to nearly instantaneously change lighting configurations, sound configurations, TV configurations, or any configuration of systems having a plurality of devices being simultaneously controlled or of a single system having a plurality of objects or attributes capable of simultaneous control. For examples, in a computer game including large numbers of virtual objects such as troops, tanks, airplanes, etc., sensed complex motion would permit the user to quickly deploy, redeploy, rearrangement, manipulated and generally quickly reconfigure all controllable objects and/or attributes by simply conforming the movement of the objects to the movement of the user sensed by the motion detector. This same differential device and/or object control would find utility in military and law enforcement, where command personnel by motion or movement within a sensing zone of a motion sensor quickly deploy, redeploy, rearrangement, manipulated and generally quickly reconfigure all assets to address a rapidly changing situation.

Embodiments of systems of this disclosure include a motion sensor or sensor array or data from a motion sensor or sensor array, where each sensor includes an active zone and where each sensor senses movement, movement direction, movement velocity, and/or movement acceleration, and/or changes in movement direction, changes in movement velocity, and/or changes in movement acceleration, and/or changes in a rate of a change in direction, changes in a rate of a change in velocity and/or changes in a rate of a change in acceleration, and/or component or components thereof within the active zone by one or a plurality of body parts or objects and produces an output signal. The systems also include at least one processing unit including communication software and hardware, where the processing units convert the output signal or signals from the motion sensor or sensors into command and control functions, and one or a plurality of real objects and/or virtual objects in communication with the processing units. The command and control functions comprise at least (1) a scroll function or a plurality of scroll functions, (2) a select function or a plurality of select functions, (3) an attribute function or plurality of attribute functions, (4) an attribute control function or a plurality of attribute control functions, or (5) a simultaneous control function. The simultaneous control function includes (a) a select function or a plurality of select functions and a scroll function or a plurality of scroll functions, (b) a select function or a plurality of select functions and an activate function or a plurality of activate functions, and (c) a select function or a plurality of select functions and an attribute control function or a plurality of attribute control functions. The processing unit or units (1) processes a scroll function or a plurality of scroll functions, (2) selects and processes a scroll function or a plurality of scroll functions, (3) selects and activates an object or a plurality of objects in communication with the processing unit, or (4) selects and activates an attribute or a plurality of attributes associated with an object or a plurality of objects in communication with the processing unit or units, or any combination thereof. The objects comprise mechanical devices, electromechanical devices, electrical devices, electrical systems, sensors, hardware devices, hardware systems, environmental devices and systems, energy and energy distribution devices and systems, software systems, software programs, software elements, software objects, AR objects, VR objects, AR elements, VR elements, or combinations thereof. The attributes comprise adjustable attributes associated with the devices, systems, programs and/or objects. In certain embodiments, the sensor(s) is(are) capable of discerning a change in movement, velocity and/or acceleration of ±5%. In other embodiments, the sensor(s) is(are) capable of discerning a change in movement, velocity and/or acceleration of ±10°. In other embodiments, the system further comprising a remote control unit or remote control system in communication with the processing unit to provide remote control of the processing unit and all real and/or virtual objects under the control of the processing unit. In other embodiments, the motion sensor is selected from the group consisting of digital cameras, optical scanners, optical roller ball devices, touch pads, inductive pads, capacitive pads, holographic devices, laser tracking devices, thermal devices, touch or touchless sensors, acoustic devices, and any other device capable of sensing motion, waveform changes and derivatives, arrays of such devices, and mixtures and combinations thereof. In other embodiments, the objects include environmental controls, lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical or manufacturing plant control systems, computer operating systems and other software systems, remote control systems, mobile devices, electrical systems, sensors, hardware devices, hardware systems, environmental devices and systems, energy and energy distribution devices and systems, software programs, software elements, or objects or mixtures and combinations thereof.

Embodiments of methods of this disclosure for controlling objects include the step of sensing movement, movement direction, movement velocity, and/or movement acceleration, and/or changes in movement direction, changes in movement velocity, and/or changes in movement acceleration, and/or changes in a rate of a change in direction, changes in a rate of a change in velocity and/or changes in a rate of a change in acceleration within the active zone by one or a plurality of body parts or objects within an active sensing zone of a motion sensor or within active sensing zones of an array of motion sensors. The methods also include the step of producing an output signal or a plurality of output signals from the sensor or sensors and converting the output signal or signals into a command function or a plurality of command functions. The command and control functions comprise at least (1) a scroll function or a plurality of scroll functions, (2) a select function or a plurality of select functions, (3) an attribute function or plurality of attribute functions, (4) an attribute control function or a plurality of attribute control functions, or (5) a simultaneous control function. The simultaneous control function includes (a) a select function or a plurality of select functions and a scroll function or a plurality of scroll functions, (b) a select function or a plurality of select functions and an activate function or a plurality of activate functions, and (c) a select function or a plurality of select functions and an attribute control function or a plurality of attribute control functions or any combination thereof. In certain embodiments, the objects comprise mechanical devices, electromechanical devices, electrical devices, electrical systems, sensors, hardware devices, hardware systems, environmental devices and systems, energy and energy distribution devices and systems, AR systems, VR systems, AR objects, VR objects, AR elements, VR elements, software systems, software programs, software objects, or combinations thereof. In other embodiments, the attributes comprise adjustable attributes associated with the devices, systems, programs and/or objects. In other embodiments, the timed hold is brief or the brief cessation of movement causing the attribute to be adjusted to a preset level, causing a selection to be made, causing a scroll function to be implemented, or a combination thereof. In other embodiments, the timed hold is continued causing the attribute to undergo a high value/low value cycle or predetermined attribute changes that ends when the hold is removed. In other embodiments, the timed hold causes an attribute value to change so that (1) if the attribute is at its maximum value, the timed hold causes the attribute value to decrease at a predetermined rate, until the timed hold is removed, (2) if the attribute value is at its minimum value, then the timed hold causes the attribute value to increase at a predetermined rate, until the timed hold is removed, (3) if the attribute value is not the maximum or minimum value, then the timed hold causes randomly selects the rate and direction of attribute value change or changes the attribute to allow maximum control, or (4) the timed hold causes a continuous change in the attribute value or scroll function in a direction of the initial motion until the timed hold is removed. In other embodiments, the motion sensor is selected from the group consisting of sensors of any kind including digital cameras, optical scanners, optical roller ball devices, touch pads, inductive pads, capacitive pads, holographic devices, laser tracking devices, thermal devices, touch or touchless sensors, acoustic devices, and any other device capable of sensing motion or changes in any waveform do to motion or arrays of such devices, and mixtures and combinations thereof. In other embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, computer operating systems and other software systems, remote control systems, sensors, or mixtures and combinations thereof.

Embodiments of this disclosure relate to methods for controlling objects include sensing motion including motion properties within an active sensing zone of a motion sensor, where the motion properties include a direction, a velocity, an acceleration, a change in direction, a change in velocity, a change in acceleration, a rate of change of direction, a rate of change of velocity, a rate of change of acceleration, a time and motion property, stops, holds, timed holds, or mixtures and combinations thereof. The methods also include producing an output signal or a plurality of output signals corresponding to the sensed motion and converting the output signal or signals via a processing unit in communication with the motion sensor into a command function or a plurality of command functions. The command functions include a scroll function, a select function, an attribute function, an attribute control function, a simultaneous control function, or mixtures and combinations thereof. The simultaneous control functions include a select and scroll function, a select, scroll and activate function, a select, scroll, activate, and attribute control function, a select and activate function, a select and attribute control function, a select, active, and attribute control function, or mixtures or combinations thereof. The methods also include processing the command function or the command functions, where the command function or the command functions include: (1) processing a scroll function, (2) selecting and processing a scroll function, (3) selecting and activating an object or a plurality of objects in communication with the processing unit, (4) selecting and activating an attribute or a plurality of attributes associated with the object or the plurality of objects in communication with the processing unit, (5) selecting, activating an object or a plurality of objects in communication with the processing unit, and activating an attribute or a plurality of attributes associated with the object or the plurality of objects in communication with the processing unit, or mixtures and combinations thereof.

In certain embodiments, the objects comprise real world objects, virtual objects and mixtures or combinations thereof, where the real world objects include physical, mechanical, electro-mechanical, magnetic, electro-magnetic, electrical, or electronic devices or any other real world device that can be controlled by a processing unit, and the virtual objects include any construct generated in a virtual world or by a computer and displayed by a display device and that are capable of being controlled by a processing unit including software programs, and elements that are seen or not seen. In other embodiments, the attributes comprise activatable, executable and/or adjustable attributes associated with the objects. In other embodiments, changes in motion properties are changes discernible by the motion sensors and/or the processing units. In other embodiments, the motion sensor is selected from the group consisting of digital cameras, optical scanners, optical sensors, optical roller ball devices, touch pads, inductive pads, capacitive pads, holographic devices, laser tracking devices, thermal devices, any other device capable of sensing motion, arrays of motion sensors, and mixtures or combinations thereof. In other embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, computer operating systems, systems, graphics systems, business software systems, word processor systems, internet browsers, accounting systems, vehicle systems, military systems, control systems, other software systems, programs, and/or elements, remote control systems, or mixtures and combinations thereof. In other embodiments, if the timed hold is brief, then the processing unit causes an attribute to be adjusted to a preset level. In other embodiments, if the timed hold is continued, then the processing unit causes an attribute to undergo a high value/low value cycle that ends when the hold is removed. In other embodiments, the timed hold causes an attribute value to change so that (1) if the attribute is at its maximum value, the timed hold causes the attribute value to decrease at a predetermined rate, until the timed hold is removed, (2) if the attribute value is at its minimum value, then the timed hold causes the attribute value to increase at a predetermined rate, until the timed hold is removed, (3) if the attribute value is not the maximum or minimum value, then the timed hold causes randomly selects the rate and direction of attribute value change, causes the attribute to be controlled at a pre-determined rate and type, or changes the attribute to allow maximum control, or (4) the timed hold causes a continuous change in the attribute value in a direction of the initial motion until the timed hold is removed.

Embodiments of this disclosure relate to methods for controlling real world objects include sensing motion including motion properties within an active sensing zone of a motion sensor, where the motion properties include a direction, a velocity, an acceleration, a change in direction, a change in velocity, a change in acceleration, a rate of change of direction, a rate of change of velocity, a rate of change of acceleration, stops, holds, timed holds, or mixtures and combinations thereof. The methods also include producing an output signal or a plurality of output signals corresponding to the sensed motion and converting the output signal or signals via a processing unit in communication with the motion sensor into a command function or a plurality of command functions. The command functions include a scroll function, a select function, an attribute function, an attribute control function, a simultaneous control function, or mixtures and combinations thereof. The simultaneous control functions include a select and scroll function, a select, scroll and activate function, a select, scroll, activate, and attribute control function, a select and activate function, a select and attribute control function, a select, active, and attribute control function, or mixtures or combinations thereof. The methods also include (1) processing a scroll function, (2) selecting and processing a scroll function, (3) selecting and activating an object or a plurality of objects in communication with the processing unit, (4) selecting and activating an attribute or a plurality of attributes associated with the object or the plurality of objects in communication with the processing unit, or (5) selecting, activating an object or a plurality of objects in communication with the processing unit, and activating an attribute or a plurality of attributes associated with the object or the plurality of objects in communication with the processing unit.

In certain embodiments, the objects comprise real world objects and mixtures or combinations thereof, where the real world objects include physical, mechanical, electro-mechanical, magnetic, electro-magnetic, electrical, or electronic devices or any other real world device that can be controlled by a processing unit or units. In other embodiments, the attributes comprise activateable, executable and/or adjustable attributes associated with the objects. In other embodiments, changes in motion properties are changes discernible by the motion sensors and/or the processing units. In other embodiments, the motion sensor is selected from the group consisting of digital cameras, optical scanners, optical sensors, optical roller ball devices, touch pads, inductive pads, capacitive pads, holographic devices, laser tracking devices, thermal devices, waveform sensors, any other device capable of sensing motion, arrays of motion sensors, and mixtures or combinations thereof. In other embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, remote control systems, software systems, software programs, software elements, or mixtures and combinations thereof.

Embodiments of this disclosure relate to methods for controlling virtual objects, virtual reality (VR) objects, and/or augmented reality (AR) objects include sensing motion including motion properties within an active sensing zone of a motion sensor, where the motion properties include a direction, a velocity, an acceleration, a change in direction, a change in velocity, a change in acceleration, a rate of change of direction, a rate of change of velocity, a rate of change of acceleration, stops, holds, timed holds, time elements (providing for changes in distance by changes in velocity/acceleration and time), or mixtures and combinations thereof. The methods also include producing an output signal or a plurality of output signals corresponding to the sensed motion and converting the output signal or signals via a processing unit in communication with the motion sensor into a command function or a plurality of command functions. The command functions include a scroll function, a select function, an attribute function, an attribute control function, a simultaneous control function, or mixtures and combinations thereof. The simultaneous control functions include a select and scroll function, a select, scroll and activate function, a select, scroll, activate, and attribute control function, a select and activate function, a select and attribute control function, a select, active, and attribute control function, or mixtures or combinations thereof. The methods also include (1) processing a scroll function, (2) selecting and processing a scroll function, (3) selecting and activating an object or a plurality of objects in communication with the processing unit, (4) selecting and activating an attribute or a plurality of attributes associated with the object or the plurality of objects in communication with the processing unit, or (5) selecting, activating an object or a plurality of objects in communication with the processing unit, and activating an attribute or a plurality of attributes associated with the object or the plurality of objects in communication with the processing unit.

In certain embodiments, the objects comprise virtual objects, virtual reality (VR) objects, and/or augmented reality (AR) objects and mixtures or combinations thereof, where the virtual objects include any construct generated in a virtual world or by a computer and displayed by a display device and that are capable of being controlled by a processing unit. In other embodiments, the attributes comprise activatable, executable and/or adjustable attributes associated with the objects. In other embodiments, changes in motion properties are changes discernible by the motion sensors and/or the processing units. In other embodiments, the motion sensor is selected from the group consisting of digital cameras, optical scanners, optical sensors, optical roller ball devices, touch pads, inductive pads, capacitive pads, holographic devices, laser tracking devices, thermal devices, waveform sensors, neural sensors, any other device capable of sensing motion, arrays of motion sensors, and mixtures or combinations thereof. In other embodiments, the software products include computer operating systems, graphics systems, business software systems, word processor systems, internet browsers, accounting systems, military systems, control systems, other software systems, software objects, software elements, or mixtures and combinations thereof.

Embodiments of this disclosure relate to systems and apparatuses for controlling objects include one or a plurality of motion sensor including an active zone, where the sensor senses motion including motion properties within an active sensing zone of a motion sensor, where the motion properties include a direction, a velocity, an acceleration, a change in direction, a change in velocity, a change in acceleration, a rate of change of direction, a rate of change of velocity, a rate of change of acceleration, stops, holds, timed holds, or mixtures and combinations thereof to produce an output signal or a plurality of output signals. The systems and apparatuses also include one or a plurality of processing unit including communication software and hardware, where the processing unit or units convert the outputs into command and control functions, and one or a plurality of controllable objects in communication with the processing unit or units. The command functions include a scroll function, a select function, an attribute function, an attribute control function, a simultaneous control function, or mixtures and combinations thereof. The simultaneous control functions include a select and scroll function, a select, scroll and activate function, a select, scroll, activate, and attribute control function, a select and activate function, a select and attribute control function, a select, active, and attribute control function, or mixtures or combinations thereof. The processing unit or units (1) process scroll functions, (2) select and process scroll functions, (3) select and activate one controllable object or a plurality of controllable objects in communication with the processing unit, (4) select and activate one controllable attribute or a plurality of controllable attributes associated with the controllable objects in communication with the processing unit, or (5) select, activate an object or a plurality of objects in communication with the processing unit, and activate an attribute or a plurality of attributes associated with the object or the plurality of objects in communication with the processing unit.

In certain embodiments, the objects comprise real world objects, virtual objects and mixtures or combinations thereof, where the real world objects include physical, mechanical, electro-mechanical, magnetic, electro-magnetic, electrical, or electronic devices or any other real world device that can be controlled by a processing unit and the virtual objects include any construct generated in a virtual world or by a computer and displayed by a display device and that are capable of being controlled by a processing unit. In other embodiments, the attributes comprise activatable, executable and/or adjustable attributes associated with the objects. In other embodiments, changes in motion properties are changes discernible by the motion sensors and/or the processing units. In other embodiments, the motion sensor is selected from the group consisting of digital cameras, optical scanners, optical roller ball devices, touch pads, inductive pads, capacitive pads, holographic devices, laser tracking devices, thermal devices, accelerometers, any other device capable of sensing motion, arrays of motion sensors, and mixtures or combinations thereof. In other embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, computer operating systems, systems, graphics systems, business software systems, word processor systems, internet browsers, accounting systems, military systems, control systems, other software systems, remote control systems, or mixtures and combinations thereof. In other embodiments, the sensor and/or the processing unit are capable of discerning a change in direction of motion of ±15°. In other embodiments, the sensor and/or the processing unit are capable of discerning a change in direction of motion of ±10°. In other embodiments, the sensor and/or the processing unit are capable of discerning a change in direction of motion of ±5°. In other embodiments, the systems and apparatuses further include a remote control unit in communication with the processing unit to provide remote control of the processing unit and the objects in communication with the processing unit.

Embodiments of this disclosure relate to systems and apparatuses for controlling real world objects include data from one or more sensors, one or a plurality of motion sensor including an active zone, where the sensor senses motion including motion properties within an active sensing zone of a motion sensor, where the motion properties include a direction, a velocity, an acceleration, a change in direction, a change in velocity, a change in acceleration, a rate of change of direction, a rate of change of velocity, a rate of change of acceleration, stops, holds, timed holds, or mixtures and combinations thereof. The systems and apparatuses also include one or a plurality of processing unit or data from one or more processing units including communication software and hardware, where the unit converts the output into command and control functions, and one or a plurality of controllable objects in communication with the processing unit. The command functions include a scroll function, a select function, an attribute function, an attribute control function, a simultaneous control function, or mixtures and combinations thereof. The simultaneous control functions include a select and scroll function, a select, scroll and activate function, a select, scroll, activate, and attribute control function, a select and activate function, a select and attribute control function, a select, active, and attribute control function, or mixtures or combinations thereof. The processing unit or units (1) process scroll functions, (2) select and process scroll functions, (3) select and activate one controllable object or a plurality of controllable objects in communication with the processing unit, (4) select and activate one controllable attribute or a plurality of controllable attributes associated with the controllable objects in communication with the processing unit, or (5) select, activate an object or a plurality of objects in communication with the processing unit, and activate an attribute or a plurality of attributes associated with the object or the plurality of objects in communication with the processing unit, or (6) any combination thereof.

In certain embodiments, the objects comprise real world objects and mixtures or combinations thereof, where the real world objects include physical, mechanical, electro-mechanical, magnetic, electro-magnetic, electrical, or electronic devices or any other real world device that can be controlled by a processing unit. In other embodiments, the attributes comprise activatable, executable and/or adjustable attributes associated with the objects. In other embodiments, changes in motion properties are changes discernible by the motion sensors and/or the processing units. In certain embodiments, the motion sensor is selected from the group consisting of digital cameras, optical scanners, optical roller ball devices, touch pads, inductive pads, capacitive pads, holographic devices, laser tracking devices, thermal devices, any other device capable of sensing motion, arrays of motion sensors, and mixtures or combinations thereof. In certain embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, remote control systems, or mixtures and combinations thereof. In certain embodiments, the sensor and/or the processing unit are capable of discerning a change in direction of motion of ±15°. In certain embodiments, the sensor and/or the processing unit are capable of discerning a change in direction of motion of ±10°. In certain embodiments, the sensor and/or the processing unit are capable of discerning a change in direction of motion of ±5°. In certain embodiments, the methods further include a remote control unit in communication with the processing unit to provide remote control of the processing unit and the objects in communication with the processing unit.

Embodiments of this disclosure relate to systems and apparatuses for controlling virtual objects include data from one or more sensors, one or a plurality of motion sensor including an active zone, where the sensor senses motion including motion properties within an active sensing zone of a motion sensor, where the motion properties include a direction, a velocity, an acceleration, a change in direction, a change in velocity, a change in acceleration, a rate of change of direction, a rate of change of velocity, a rate of change of acceleration, stops, holds, timed holds, or mixtures and combinations thereof. The systems and apparatuses also include one or a plurality of processing unit or data from one or more processing units including communication software and hardware, where the unit converts the output into command and control functions, and one or a plurality of controllable objects in communication with the processing unit or units. The command functions include a scroll function, a select function, an attribute function, an attribute control function, a simultaneous control function, or mixtures and combinations thereof. The simultaneous control functions include a select and scroll function, a select, scroll and activate function, a select, scroll, activate, and attribute control function, a select and activate function, a select and attribute control function, a select, active, and attribute control function, or mixtures or combinations thereof. The processing unit or units (1) process scroll functions, (2) select and process scroll functions, (3) select and activate one controllable object or a plurality of controllable objects in communication with the processing unit, (4) select and activate one controllable attribute or a plurality of controllable attributes associated with the controllable objects in communication with the processing unit, or (5) select, activate an object or a plurality of objects in communication with the processing unit, and activate an attribute or a plurality of attributes associated with the object or the plurality of objects in communication with the processing unit.

In certain embodiments, the objects comprise virtual objects and mixtures or combinations thereof, where the virtual objects include any construct generated in a virtual world or by a computer and displayed by a display device and that are capable of being controlled by a processing unit. In other embodiments, the attributes comprise activatable, executable and/or adjustable attributes associated with the objects. In other embodiments, the objects comprise combinations of real and virtual objects and/or attributes. In other embodiments, changes in motion properties are changes discernible by the motion sensors and/or the processing units. In other embodiments, the sensor and/or the processing unit are capable of discerning a change in direction of motion of ±15°. In other embodiments, the sensor and/or the processing unit are capable of discerning a change in direction of motion of ±10°. In other embodiments, the sensor and/or the processing unit are capable of discerning a change in direction of motion of ±5°. In other embodiments, systems and apparatuses further include a remote control unit in communication with the processing unit to provide remote control of the processing unit and the objects in communication with the processing unit. In other embodiments, the motion sensor is selected from the group consisting of digital cameras, optical scanners, optical roller ball devices, touch pads, inductive pads, capacitive pads, holographic devices, laser tracking devices, thermal devices, any other device capable of sensing motion, arrays of motion sensors, and mixtures or combinations thereof. In other embodiments, the software products include computer operating systems, graphics systems, business software systems, word processor systems, internet browsers, accounting systems, military systems, control systems, or mixtures and combinations thereof.

The unique identifiers of this disclosure may include kinetic aspects and/or biometric aspects. These aspects may be collected and/or captured simultaneously and/or sequentially. Thus, the systems of this disclosure may collect and/or capture kinetic, biometric, and/or biokinetic data or any sequential or simultaneous combination of these as the user operates the interface. For example, the systems may collect and/or capture motion (kinetic) data and/or biokinetic data (mixture of kinetic data and biometric data), while a user is navigating through a menu. This data may be used in the construction of the identifiers of this disclosure, where motion data associated with use of the interfaces of this disclosure are used to enhance the uniqueness of the identifiers. Thus, motion of a user using the interfaces of this disclosure such as slight differences in a roll of a finger or fingers, an inclination of a wrist, a facial expression, etc. may be used to construct unique kinetic and/or biokinetic identifiers instead of using the more common aspects of biometrics such as a finger print, retinal scans, etc. For examples, differences in motion dynamics such as jitters, shaking, or other “noise” aspects of motion of a user interacting with the interfaces of this disclosure may be used to construct unique identifiers as these dynamic aspects of a user motion are unique to the user, again improving the uniqueness of the identifiers of this disclosure.

In certain embodiments, the identifiers of this disclosure are constructed from the dynamic nature of movements of a user interacting with the system independent of biometric data associated the user. Obviously, the motion is associated with movement of some real entity, entity part, and/or object sensed by a sensor, a sensing device or data generated by a sensor or sensing device. Thus, by collecting and/or capturing the dynamic motion associated with a user's interaction with the interfaces, a unique user identifier may be constructed using only the nature of the user's movements associated with using the interfaces of this disclosure. In fact, a person's biometric data may be realized by evaluating the size and type of motion made, where the roll of a finger while drawing circle may be used to deduce the size and length of the finger, wrist and even arm, thus providing a unique identifier(s) of the user. In other embodiments, the identifiers of this disclosure are constructed from both the dynamic nature of the user movements associated with using the interfaces of this disclosure and from user specific biometric data. Thus, the systems of this disclosure may be used to construct unique kinetic identifiers (user specific movement), to construct unique biokinetic identifiers, to construct unique identifiers that include combinations of: (1) a unique kinetic identifier and a unique biokinetic identifier, (2) a unique kinetic identifier and a unique biometric identifier, (3) a unique biokinetic identifier and a unique biometric identifier, or (4) a unique biokinetic identifier, a unique kinetic identifier, and a unique biometric identifier.

In certain embodiments, the systems of this disclosure collect and/or capture dynamic movement and/or motion data of a user using a mouse to control a cursor or data associated with movement and/or motion on a touch screen or pad to construct unique kinetic identifiers. The systems may also combine this kinetic data with biometric data to form unique biokinetic identifiers. Thus, by collecting and/or capturing data associated with using a mouse to move a cursor or using a finger to moving across a touch screen or touch pad, the data contains unique features of the way a user uses the mouse device or passes a finger across the touch screen or touch pad. The data includes direction, speed, acceleration, changes in direction, changes in velocity, changes in acceleration, time associated with changes in direction, velocity, acceleration, and/or distance traveled. In certain embodiments, the motion is collected and/or captured in a designated zone. Thus, the specific mannerisms of a user moving a cursor may be used to construct unique identifiers for security or signature verification. In other embodiments, interaction of the user's motion of a finger or mouse with kinetic objects or objects with dynamic or static attributes further provides identifiers for security or verification.

In certain embodiments, the systems collect and/or capture motion data associated with opening a program or program component using a gesture or a manner in which the user opens a program or program components including, without limitation, direction, velocity, acceleration, changes in direction, velocity and/or acceleration, variation in the smoothness of the motions, timing associated with the motion components to identify unique characteristics associated with how the user moves in opening a program or a program component. For example, the user may make a check mark motion in a unique and discernible manner, i.e., the motion is unique relative to other users that move in a similar manner. The uniqueness of the motion may be enhanced by collecting and/or capturing data associated with the manner a user moves a cursor or a finger over (a) a certain section of an icon, (b) near, next to or proximate the icon, (c) a specific edge(s), (d) near, next to, or proximate a certain side(s), or (e) a mixture or combination of such movements. The uniqueness may be further enhanced by collecting and/or capturing motion as the icon or program begins to open or respond; for example, as the cursor (or finger or remote controlled object) is moved over a log-in button on a screen, the button might expand in size, and as it expands, or after it gets to a designated size, another motion is made in a designated area of the object, or towards a corner (for example) as the object is enlarging or after it enlarges, then this may be equivalent to a two stage verification based on motion.

The specific area of the icon or screen may be highlighted and/or designated by objects, colors, sounds, shapes, etc. or combinations of such attributes. So as a user moves, the cursor over a “login” button, the login button may expand in size, then having the user delay to provide time to activate the signature/authentication process. Once the object stopped expanding (taking milliseconds to seconds normally), then the cursor may be moved towards or to a designated area/object/attribute in a linear way/direction or a non-linear way/direction, or around one or more objects, creating a curvilinear or other type of 2D or 3D motion. The motion or path may also include mouse clicks, taps on a screen with one or more touch points, double mouse clicks or touches on a screen, motions in 3D space, such as pumping motions, etc. The motion of the cursor to, on or in proximity to an object may cause an attribute change of the object, then clicking or touching and dragging a cursor (creating a motion—cursor of finger motion may be kept unseen as well) may be used in conjunction with the motion, and a release of the mouse button or touch off event or motion in a different direction may be used in conjunction with the motion on or about the object to further provide a unique signature. The attribute of the expanding object may be replaced by color changes, sounds or any other attribute or combination of attributes.

By the same token, asking a user to follow or replicate an animated motion with a cursor, and collecting and/or capturing user data as the user replicates the animated motion, where the data includes motion direction, distance, velocity, angle, acceleration, timing, and/or changes in the variables. This data would provide unique data for each user so that each user may be differentiated therefrom. This unique data may then be used to construct a unique biokinetic and/or kinetic identifier. The data may be 2D, 3D or a combination of motion is 2D and/or 3D environments. For example, the systems may display a specific movement of a body or body part, which the user mimics or replicates. The systems then collect and/or capture the user's replication of the specific movement data. The data includes kinetic data, biometric data, and/or biokinetic data. The kinetic data include, without limitation, distance, direction, velocity, angle, acceleration, timing, and/or changes in these variables. The biometric data include, without limitation, external body and body part data (e.g., external organ shape, size, coloration, structure, and/or texture, finger prints, palm prints, retinal scans, vein distribution data, EKG data, EEG data, etc.), internal body or body part data (e.g., internal organ shape, size, coloration, structure, and/or texture, finger prints, palm prints, retinal scans, vein distribution data, X-ray data, MRI data, ultrasonic data, EMF data, etc.) and/or object and object part data (e.g., internal and/or external, shape, size, coloration, structure, and/or texture, finger prints, palm prints, retinal scans, vein distribution data, X-ray data, MRI data, ultrasonic data, EMF data, etc.). The data may then be used to construct unique biometric, kinetic, and/or biokinetic identifiers. The animated movement may also be changed, and move at different speeds based on randomly generated patterns, with different speed elements and timed holds or acceleration differences to provide security measures and unique transactional information for each transaction, meaning not only unique user identification, but also every transaction having its own unique signature. Another example would be in an AR/VR environment. A virtual ball may be tossed to a user. Not only is the way the user catches the virtual ball be unique to the user (such as with one hand, two hands, hands behind the ball, on top and below, etc.), but the size of the hands, fingers, and the unique relationship between a motion based catch and biometrics is virtually impossible to duplicate. Even just a snapshot or still picture of this action would provide enough unique information to provide unique identifier.

By performing replications of animated movements several times (same or different movements), the identifier uniqueness may be enhanced, which would in turn enhance the unique verification of the user based on the kinetic or biokinetic identifier. Two frames (images) in a row provides two instances of a multi-verification process that, to the user, required no memorization and would be unique. The same process may be used with a mouse and cursor or touch based system, where providing an animated object and determining the unique way a user would “catch” the object with a cursor (changes of direction, speed, acceleration, timing, etc.) to construct a unique identifier. Multiple instances of motions, snapshots and gestures may be used in combination for extremely unique and discrete kinetic/biokinetic identifiers. In fact, by collecting and/or capturing how the user continues to make slight changes in biometric, kinetic, and/or biokinetic data, the systems may be able to predict changes in the user behavior further improving the uniqueness of the identifiers of this disclosure or provide biometric data, kinetic data, and/or biokinetic data that would match the user's unique physical, emotional, environmental, mental, neurological and physiological state over time. The animated paths may be defined by any function, combination of functions, intersections of function(s), function-line intercept, or any combination of combined function values prescribing intersection points with the user's motions, or may be chosen as random points in area or space. Using contextual or temporal data in conjunction with these techniques would further provide data for user or transactional or event verification and uniqueness.

In another embodiment, the systems of this disclosure construct a unique identifier from a user's interaction with the system using only a cursor. For examples, a user moves the cursor towards a log-in object. As the cursor moves, the object changes attribute (size, color, animation, etc.), then the user moves the cursor towards a designated corner of the log-in object associated with a log-in button. The user then activates the button, which may be performed solely by motion, and uses the cursor to sign within a signature field. The systems store the signature and data associated with all of the movement of the cursor in conjunction with moving towards the log-in object, selecting the log-in object, activating the log-in button, and signing within the signature field. The motion or movement data includes the trajectory information such as direction, velocity, acceleration, contact area, pressure distribution of contact area, and/or changes and/or fluctuations in any of these any of these terms.

### Example of Data Captures

For biometric identifiers using apparatuses having touch sensitive motion sensors, the systems and methods of this disclosure may capture biometric data including finger print data, thumb print data, palm print data, and/or data associated with any parts thereof. In certain embodiments, this biometric data may be coupled with pressure distribution data. In other embodiments, this biometric data may be coupled with temperature distribution data. In certain embodiments, the systems and methods of this disclosure may use the biometric print data to construct biometric identifiers. In other embodiments, the systems and methods of this disclosure may use the biometric print data and the pressure distribution or the temperature distribution data to construct or generate a biometric identifier. In other embodiments, the systems and methods of this disclosure may use the biometric print data and the pressure distribution and the temperature distribution data to construct or generate a biometric identifier.

For kinetic identifiers, the systems and methods of this disclosure may capture the above data over time, where the capture time frame may be a short time frame data capture, a medium time frame data capture, a long time frame, and/or a very long time frame data capture as those terms are described herein, so that kinetic identifiers may be constructed from changes in print data such as flattening of print elements, rocking of print elements, or other movements of the finger, thumb, palm and/or part thereof within in the capture time frame. In other embodiments, the systems and methods of this disclosure may capture changes in the pressure distribution data and changes in the temperature distribution data. If the touch device also has ultrasound sensors capable of transmitting and detecting ultrasonic waves, then the biometric and kinetic data may include internal structural feature data and blood blow data, blood flow pattern data, changes in internal data, or other internal data over short, medium, long, and/or very long time frame data collections. For biokinetic identifiers, the systems and methods of this disclosure may simultaneously capture the above referenced biometric data and kinetic data as well as other biokinetic data depending on sensor, sensors, array, and/or array and sensor configurations. The systems and methods of this disclosure may then construct biokinetic identifiers from any combination of the biometric data, the kinetic data and/or the biokinetic data.

For optical, audio, or other non touch devices, the systems and methods of this disclosure may capture biometric data such as external body and/or body part data including shape, size, relative relationships between one or more body parts, and/or, if the sensor configuration admits internal data capture, then internal body part structural data may be captured or collected and used to construct biometric identifiers. For kinetic identifiers, the systems and methods of this disclosure may capture the biometric features changing over short, medium, long, and/or very long time frame data captures. For biokinetic identifies, the systems and methods of this disclosure may capture biokinetic data using the sensor or the sensor configuration. The systems and methods of this disclosure may then use these data to construct biometric identifiers, kinetic identifier, and/or biokinetic identifiers.

For gestures based or predetermined, predefined, or on the fly movement pattern systems and methods, the systems and methods of this disclosure may capture biometric data associated with a gesture or a pattern and the biometric data may be used to construct biometric identifiers. In other embodiments, the systems and methods of this disclosure may capture kinetic data associated with changes associated with the gesture or the pattern and the kinetic data may be sued to construct kinetic identifiers. In other embodiments, the systems and methods of this disclosure may capture biokinetic data associated with the gesture or the pattern and the biokinetic data may be used to construct biokinetic identifiers The systems and methods of this disclosure may construct identifiers including body and/or body part biometric data, body and/or body part kinetic data, and/or body and/or body part biokinetic data. The kinetic data may include fluctuation data, trajectory data, relative fluctuation data, and/or relative trajectory data. The biometric data may include gap data, interference pattern data, relative position data, any other biometric data associated with gesture or pattern movement. The biokinetic data may include any combination of the biometric data and kinetic data as well as the biokinetic data.

In other embodiments, the biometric data, the kinetic data and/or the biokinetic data may be associated with different type of movement patterns and/or trajectories carried out by the user. These movement patterns and/or trajectories may be predetermined, predefined, or dynamic—on-the-fly—based on the interaction of the user with the apparatuses or systems of this disclosure. For example, the systems, apparatuses, and/or methods of this disclosure may be configured to capture these data types based on a data capture of movement of a body and/or a body part and/or an object under control of an entity within an active zone of one or more sensors and/or sensor arrays as the body and/or body part undergoes a normal movement within the active zones. The movement may be over a short distance, a medium distance, or a long distance, where a short distance is a travel distance of less than about 25% of the area or volume of the zones, a medium distance is a travel distance of greater than 25% and less than about 75% of the area or volume of the zones, and the long distance is a travel distance of more than 75% of the area or volume of the zones. Of course, it should be recognized that the short, medium, and long distance may be defined differently provided that they are scaled relative to the extent of the zone of each of the sensors or sensor arrays.

In other embodiments, the threshold movement for activating the systems and apparatuses of this disclosure may be determined by a movement of a body and/or a body part and/or an object under control of an entity within an active zone of one or more sensors and/or sensor arrays as the body and/or body part. The movement may be at a velocity for a period of time or over a distance sufficient to meet the movement threshold for each sensor or sensor array. The movement may be a short distance, a medium distance, or a long distance, where a short distance is a travel distance or velocity times time of less than about 5% of the area or volume of the zones, a medium distance is a travel distance or velocity times time of greater than 5% and less than about 10% of the area or volume of the zones, and the long distance is a travel distance or velocity times time of more than 10% of the area or volume of the zones, where the time duration are sufficient to meet the distance criteria at the sensed velocity. Of course, it should be recognized that the short, medium, and long distance or velocity times time may be defined differently provided that they are scaled relative to the extent of the zone of each of the sensors or sensor arrays.

### Other Embodiments

Embodiments of this disclosure broadly relate to methods comprising: receiving first input at a computing device, the first input corresponding to first movement in a virtual reality (VR) or augmented reality (AR) environment; initiating at a display device, display of a first menu in response to the first input, the first menu including a plurality of selectable items; receiving second input during display of the first menu, the second input corresponding to a selection of a particular selectable item of the plurality of selectable items; and initiating, at the display device, display of an indication that the particular selectable item has been selected. In certain embodiments, at least one of the first input or the second input corresponds to movement of a hand, an arm, a finger, a leg, and/or a foot. In other embodiments, at least one of the first input or the second input correspond to eye movement or an eye gaze. In other embodiments, the first movement in the VR or AR environment comprises movement of a virtual object or a cursor in the VR or AR environment. In other embodiments, the second input indicates second movement in a particular direction in the VR or AR environment, and further comprising determining, based on the particular direction, that the second input corresponds to the selection of the particular selectable item. In other embodiments, methods further comprise initiating execution of an application corresponding to the particular selectable item. In other embodiments, methods further comprising initiating display of a second menu corresponding to the particular selectable item. In other embodiments, the second menu includes a second plurality of selectable items. In other embodiments, the display device is integrated into the computing device. In other embodiments, the computing device comprises a VR or AR headset. In other embodiments, the display device is external to and coupled to the computing device.

Embodiments of this disclosure broadly relate to apparatuses comprising: an interface configured to: receive first input at corresponding to first movement in a virtual reality (VR) or augmented reality (AR) environment; and receiving second input corresponding to a selection of a particular selectable item of a plurality of selectable items; and a processor configured to: initiating at a display device, display of a first menu in response to the first input, the first menu including the plurality of selectable items; and initiate, at the display device, display of an indication that the particular selectable item has been selected. In certain embodiments, the apparatus further comprises the display device. In other embodiments, the first input and the second input are received from the same input device. In certain embodiments, the apparatus further comprises the input device. In other embodiments, the input device comprises an eye tracking device or a motion sensor. In other embodiments, the first input is received from a first input device and wherein the second input is received from a second input device that is distinct from the first input device.

Embodiments of this disclosure broadly relate to methods comprising: receiving first input at a touchscreen of a mobile device; displaying a first menu on the touchscreen in response to the first input, the first menu including a plurality of selectable items; receiving, at the touchscreen while the first menu is displayed on the touchscreen, second input corresponding to movement in a particular direction; and determining, based on the particular direction, that the second input corresponds to a selection of a particular selectable item of the plurality of selectable items. In other embodiments, the first input corresponds to movement in a first direction. In other embodiments, the first direction differs from the particular direction. In other embodiments, the first input is received at a particular location of the touchscreen that is designated for menu navigation input. In other embodiments, the first input ends at a first location of the touchscreen, wherein displaying the first menu includes displaying each of the plurality of selectable items, and wherein the movement corresponding to the second input ends at a second location of the touchscreen that is substantially collinear with the first location and the particular selectable item. In other embodiments, the second location is between the first location and the particular selectable item. In other embodiments, the methods further comprises displaying, at the touchscreen, movement of the particular selectable item towards the second location in response to the second input. In other embodiments, the methods further comprises launching an application corresponding to the particular selectable item. In other embodiments, the methods further comprises displaying a second menu on the touchscreen in response to the selection of the particular selectable item. In other embodiments, the first input and the second input are based on contact between a human finger and the touchscreen, and wherein the movement corresponding to the second input comprises movement of the human finger from a first location on the touchscreen to a second location of the touchscreen.

Embodiments of this disclosure broadly relate to mobile devices comprising: a touchscreen; and a processor configured to: responsive to first input at the touchscreen, initiate display of a first menu on the touchscreen, the first menu including a plurality of selectable items; and responsive to second input corresponding to movement in a particular direction while the first menu is displayed on the touchscreen, determine based on the particular direction that the second input corresponds to a selection of a particular selectable item of the plurality of selectable items. In other embodiments, the touchscreen and the processor are integrated into a mobile phone. In other embodiments, the touchscreen and the processor are integrated into a tablet computer. In other embodiments, the touchscreen and the processor are integrated into a wearable device.

Embodiments of this disclosure broadly relate to methods of implemented on an apparatus comprising at least one sensor or at least one sensor array, at least one processing unit, and at least one user interface, where each sensor has an active zone, where the sensors and/or sensor arrays are biokinetic, kinetic, and/or biometric, or producing unique identifiers, where the method comprises: detecting biometric properties and/or movement or motion by one or more of the sensors and/or sensor arrays, testing the biometric properties and/or detected movement to determine if the detected biometric properties and/or movement meet or exceed biometric properties and/or movement threshold criteria, if the detected biometric properties and/or movement fail the biometric properties and/or movement test, then control is transferred back to the detecting step, if the biometric properties and/or movement or motion pass the biometric properties and/or movement test, capturing sensor data, where the sensor data include kinetic data, biokinetic data, biometric data, or mixtures and combinations thereof, generating a user specific identifier, where the user specific identifier including biometric data only, kinetic data only, biokinetic data only, or any combination of two or more of the data types, and setting the generated user specific identifier for use in a user verification interface, program, website, or other verification system. In other embodiments, the methods further comprise testing the generated user specific identifier in a uniqueness test, if the generated user specific identifier fails the uniqueness test, then control is transferred back to creating step, if the generated user specific identifier passes the uniqueness test, setting the generated user specific identifier for use in a user verification interface, program, website, or other verification system. In other embodiments, the methods further comprise storing the captured data in a database associated with the processing unit. In other embodiments, the methods further comprise sensing a motion within an active sensing zone of one or more of the motion sensors, producing an output signal based on the sensed motion, converting, via a processing unit in communication with the motion sensor and configure to control one object or a plurality of objects, the output signal into a scroll command; processing the scroll command, the scroll command corresponding to traversal through a list or menu based on the motion, wherein the object or the plurality of objects comprise electrical devices, software systems, software products, or combinations thereof and wherein adjustable attributes are associated with the object or the plurality of objects, selecting and opening an object requiring a user specific identifier, sending a user specific identifier to the object, and activating the object based on the sent user specific identifier. In other embodiments, the methods further comprise logging out of the object, sensing a motion within an active sensing zone of a motion sensor, producing an output signal based on the sensed motion, converting, via a processing unit in communication with the motion sensor, the output signal into a select command; processing the select command comprising selecting a particular object from a plurality of objects based on the motion, wherein the particular object comprises an electrical devices, a software system, a software product, a list, a menu, or a combination thereof, and wherein adjustable attributes are associated with the particular object, selecting and opening an object requiring a user specific identifier, sending a user specific identifier to the object, and activating the object based on the sent user specific identifier. In other embodiments, the methods further comprise sensing a motion within an active sensing zone of a motion sensor, producing an output signal based on the sensed motion, converting, via a processing unit in communication with the motion sensor, the output signal into a select command; processing the select command comprising selecting a particular object from a plurality of objects based on the motion, wherein the particular object comprises an electrical devices, a software system, a software product, a list, a menu, or a combination thereof, and wherein adjustable attributes are associated with the particular object, selecting and opening an object requiring a user specific identifier, sending a user specific identifier to the object, and activating the object based on the sent user specific identifier. In other embodiments, the methods further comprise logging out of the object, sensing a motion within an active sensing zone of a motion sensor, producing an output signal based on the sensed motion, converting, via a processing unit in communication with the motion sensor, the output signal into a select command; processing the select command comprising selecting a particular object from a plurality of objects based on the motion, selecting and opening the object requiring the user specific identifier, sending the user specific identifier to the object, and activating the object based on the sent user specific identifier. In other embodiments, the activating step includes: detecting a touch on a touch sensitive sensor or touch screen, or detecting movement within an active zone of one or more sensors, or detecting a sound, or detecting a change in a value of any other sensor or sensor array, or any combination thereof. In other embodiments, the detected value exceeds a threshold value. In other embodiments, the identifier comprises a signature, a user name, a password, a verifier, an authenticator, or any other user unique identifier. In other embodiments, the user specific identifier comprises a biometric user specific identifier. In other embodiments, the user specific identifier comprises a kinetic user specific identifier. In other embodiments, the user specific identifier comprises a biokinetic user specific identifier comprising (a) user specific biokinetic data, (b) a mixture or combination of user specific biometric data and user specific kinetic data, or (c) a mixture or combination of user specific biometric data, user specific kinetic data, and user specific biokinetic data.

Embodiments of this disclosure broadly relate to systems of producing unique identifiers comprising at least one sensor or at least one sensor array, at least one processing unit, and at least one user interface, where each sensor has an active zone, where each sensor comprises a biokinetic sensor, a kinetic sensor, and/or a biometric sensor, where each sensor measures biokinetic data, kinetic data, and/or biometric data, where the processing unit captures biokinetic data, kinetic data, and/or biometric data exceeding a threshold value for each sensor, where the processing unit generates a user specific identifier including biometric data only, kinetic data only, biokinetic data only, or any combination of two or more of the data types, where the processing unit tests the user specific identifier to insure the user specific identifier passes a uniqueness test, where the processing unit sets the user specific identifier for use in a user verification interface, program, website, or other verification system.

Embodiments of this disclosure broadly relate to methods comprising detecting biometric properties and/or movement or motion by one or more of the sensors and/or sensor arrays, testing the detected biometric properties and/or movement to determine if the detected biometric properties and/or movement meet or exceed biometric properties and/or movement threshold criteria, if the detected biometric properties and/or movement fail the biometric properties and/or movement test, then control is transferred back to the detecting step, if the biometric properties and/or movement or motion pass the biometric properties and/or movement test, capturing sensor data, where the sensor data include kinetic data, biokinetic data, biometric data, or mixtures and combinations thereof, generating a user specific identifier, where the user specific identifier including biometric data only, kinetic data only, biokinetic data only, or any combination of two or more of the data types, setting the generated user specific identifier for use in a user verification interface, program, website, or other verification system, logging into a virtual reality (VR) or augmented reality (AR) environment using the user specific identifier, receiving first input at a computing device, the first input corresponding to first movement in a virtual reality (VR) or augmented reality (AR) environment; initiating at a display device, display of a first menu in response to the first input, the first menu including a plurality of selectable items; receiving second input during display of the first menu, the second input corresponding to a selection of a particular selectable item of the plurality of selectable items; and initiating, at the display device, display of an indication that the particular selectable item has been selected. In other embodiments, at least one of the first input or the second input corresponds to movement of a hand, an arm, a finger, a leg, or a foot, and/or wherein at least one of the first input or the second input correspond to eye movement or an eye gaze. In other embodiments, the first movement in the VR or AR environment comprises movement of a virtual object or a cursor in the VR or AR environment and/or wherein the second input indicates second movement in a particular direction in the VR or AR environment, and further comprising determining, based on the particular direction, that the second input corresponds to the selection of the particular selectable item. In other embodiments, the methods further comprise initiating execution of an application corresponding to the particular selectable item, and/or initiating display of a second menu corresponding to the particular selectable item. In other embodiments, the second menu includes a second plurality of selectable items, or the display device is integrated into the computing device, or the computing device comprises a VR or AR headset or the display device is external to and coupled to the computing device.

Embodiments of this disclosure broadly relate to apparatuses comprising: an interface configured to: detect biometric properties and/or movement or motion by one or more of the sensors and/or sensor arrays; testing the detected biometric properties and/or movement to determine if the detected biometric properties and/or movement meet or exceed biometric properties and/or movement threshold criteria; if the detected biometric properties and/or movement fail the biometric properties and/or movement test, then control is transferred back to the detecting step; if the biometric properties and/or movement or motion pass the biometric properties and/or movement test, capturing sensor data, where the sensor data include kinetic data, biokinetic data, biometric data, or mixtures and combinations thereof; and the processor configured to: generate a user specific identifier, where the user specific identifier including biometric data only, kinetic data only, biokinetic data only, or any combination of two or more of the data types; set the generated user specific identifier for use in a virtual reality (VR) or augmented reality (AR) environment; and log in to the virtual reality (VR) or augmented reality (AR) environment using the user specific identifier. In other embodiments, the interface is further configured to: receive first input at corresponding to first movement in a virtual reality (VR) or augmented reality (AR) environment; and receive second input corresponding to a selection of a particular selectable item of a plurality of selectable items; and the processor is further configured to: initiate at a display device, display of a first menu in response to the first input, the first menu including the plurality of selectable items; and initiate, at the display device, display of an indication that the particular selectable item has been selected. In other embodiments, apparatuses further comprise: the display device, and/or wherein the first input and the second input are received from the same input device and the apparatus further comprises the input device. In other embodiments, the input device comprises an eye tracking device or a motion sensor. In other embodiments, the first input is received from a first input device and wherein the second input is received from a second input device that is distinct from the first input device.

Embodiments of this disclosure broadly relate to methods comprising: detecting biometric properties and/or movement or motion by one or more of the sensors and/or sensor arrays associated with a touchscreen of a mobile device, testing the detected biometric properties and/or movement to determine if the detected biometric properties and/or movement meet or exceed biometric properties and/or movement threshold criteria, if the detected biometric properties and/or movement fail the biometric properties and/or movement test, then control is transferred back to the detecting step, if the biometric properties and/or movement or motion pass the biometric properties and/or movement test, capturing sensor data, where the sensor data include kinetic data, biokinetic data, biometric data, or mixtures and combinations thereof, generating a user specific identifier, where the user specific identifier including biometric data only, kinetic data only, biokinetic data only, or any combination of two or more of the data types, setting the generated user specific identifier for use in a user verification interface, program, website, or other verification system, logging into a virtual reality (VR) or augmented reality (AR) environment using the user specific identifier, receiving first input at the touchscreen of the mobile device; displaying a first menu on the touchscreen in response to the first input, the first menu including a plurality of selectable items; receiving, at the touchscreen while the first menu is displayed on the touchscreen, second input corresponding to movement in a particular direction; and determining, based on the particular direction, that the second input corresponds to a selection of a particular selectable item of the plurality of selectable items. In other embodiments, the first input corresponds to movement in a first direction and/or wherein the first direction differs from the particular direction and/or wherein the first input is received at a particular location of the touchscreen that is designated for menu navigation input and/or wherein the first input ends at a first location of the touchscreen, wherein displaying the first menu includes displaying each of the plurality of selectable items, and wherein the movement corresponding to the second input ends at a second location of the touchscreen that is substantially collinear with the first location and the particular selectable item, and/or wherein the second location is between the first location and the particular selectable item. In other embodiments, the methods further comprise: displaying, at the touchscreen, movement of the particular selectable item towards the second location in response to the second input, and/or launching an application corresponding to the particular selectable item, and/or displaying a second menu on the touchscreen in response to the selection of the particular selectable item. In other embodiments, the first input and the second input are based on contact between a human finger and the touchscreen, and wherein the movement corresponding to the second input comprises movement of the human finger from a first location on the touchscreen to a second location of the touchscreen.

Embodiments of this disclosure broadly relate to mobile devices comprising: a touchscreen; and a processor configured to: detect biometric properties and/or movement or motion by one or more of the sensors and/or sensor arrays associated with the mobile device and/or the touchscreen; test the detected biometric properties and/or movement to determine if the detected biometric properties and/or movement meet or exceed biometric properties and/or movement threshold criteria; if the detected biometric properties and/or movement fail the biometric properties and/or movement test, then control is transferred back to the detect biometric properties and/or movement; if the biometric properties and/or movement or motion pass the biometric properties and/or movement test, capturing sensor data, where the sensor data include kinetic data, biokinetic data, biometric data, or mixtures and combinations thereof; and generate a user specific identifier, where the user specific identifier including biometric data only, kinetic data only, biokinetic data only, or any combination of two or more of the data types; set the generated user specific identifier for use in a virtual reality (VR) or augmented reality (AR) environment; and log in to the virtual reality (VR) or augmented reality (AR) environment using the user specific identifier. In other embodiments, the processor is further configured to be: responsive to first input at the touchscreen, initiate display of a first menu on the touchscreen, the first menu including a plurality of selectable items; and responsive to second input corresponding to movement in a particular direction while the first menu is displayed on the touchscreen, determine based on the particular direction that the second input corresponds to a selection of a particular selectable item of the plurality of selectable items. In other embodiments, the touchscreen and the processor are integrated into a mobile phone, or wherein the touchscreen and the processor are integrated into a tablet computer, or the touchscreen and the processor are integrated into a wearable device.

### Suitable Components for Use in the Invention

The motion sensors may also be used in conjunction with displays, keyboards, touch pads, touchless pads, sensors of any type, or other devices associated with a computer, a notebook computer, a drawing tablet, any other mobile or stationary device, VR systems, devices, objects, and/or elements, and/or AR systems, devices, objects, and/or elements. The motion sensors may be optical sensors, acoustic sensors, thermal sensors, optoacoustic sensors, acoustic devices, accelerometers, velocity sensors, waveform sensors, any other sensor that senses movement or changes in movement, or mixtures or combinations thereof. The sensors may be digital, analog or a combination of digital and analog. For camera and/or video systems, the systems may sense motion (kinetic) data and/or biometric data within a zone, area or volume in front of the lens. Optical sensors may operate in any region of the electromagnetic spectrum and may detect any waveform or waveform type including, without limitation, RF, microwave, near IR, IR, far IR, visible, UV or mixtures or combinations thereof. Acoustic sensor may operate over the entire sonic range which includes the human audio range, animal audio ranges, or combinations thereof. EMF sensors may be used and operate in any region of a discernable wavelength or magnitude where motion or biometric data may be discerned. Moreover, LCD screen(s) may be incorporated to identify which devices are chosen or the temperature setting, etc. Moreover, the interface may project a virtual, virtual reality, and/or augmented reality and sense motion within the projected image and invoke actions based on the sensed motion. The motion sensor associated with the interfaces of this disclosure can also be acoustic motion sensor using any acceptable region of the sound spectrum. A volume of a liquid or gas, where a user's body part or object under the control of a user may be immersed, may be used, where sensors associated with the liquid or gas can discern motion. Any sensor being able to discern differences in transverse, longitudinal, pulse, compression or any other waveform could be used to discern motion and any sensor measuring gravitational, magnetic, electro-magnetic, or electrical changes relating to motion or contact while moving (resistive and capacitive screens) could be used. Of course, the interfaces can include mixtures or combinations of any known or yet to be invented motion sensors. Exemplary examples of motion sensing apparatus include, without limitation, motion sensors of any form such as digital cameras, optical scanners, optical roller ball devices, touch pads, inductive pads, capacitive pads, holographic devices, laser tracking devices, thermal devices, EMF sensors, wave form sensors, any other device capable of sensing motion, changes in EMF, changes in wave form, or the like or arrays of such devices or mixtures or combinations thereof.

The biometric sensors for use in the present disclosure include, without limitation, finger print scanners, palm print scanners, retinal scanners, optical sensors, capacitive sensors, thermal sensors, electric field sensors (eField or EMF), ultrasound sensors, neural or neurological sensors, piezoelectric sensors, other type of biometric sensors, or mixtures and combinations thereof. These sensors are capable of capturing biometric data including external and/or internal body part shapes, body part features, body part textures, body part patterns, relative spacing between body parts, and/or any other body part attribute.

The biokinetic sensors for use in the present disclosure include, without limitation, any motion sensor or biometric sensor that is capable of acquiring both biometric data and motion data simultaneously, sequentially, periodically, and/or intermittently.

Suitable physical mechanical, electro-mechanical, magnetic, electro-magnetic, electrical, or electronic devices, hardware devices, appliances, and/or any other real world device that can be controlled by a processing unit include, without limitation, any electrical and/or hardware device or appliance having attributes which can be controlled by a switch, a joy stick or similar type controller, or software program or object. Exemplary examples of such attributes include, without limitation, ON, OFF, intensity and/or amplitude, impedance, capacitance, inductance, software attributes, lists or submenus of software programs or objects, or any other controllable electrical and/or electro-mechanical function and/or attribute of the device. Exemplary examples of devices include, without limitation, environmental controls, building systems and controls, lighting devices such as indoor and/or outdoor lights or light fixtures, cameras, ovens (conventional, convection, microwave, and/or etc.), dishwashers, stoves, sound systems, mobile devices, display systems (TVs, VCRs, DVDs, cable boxes, satellite boxes, and/or etc.), alarm systems, control systems, air conditioning systems (air conditions and heaters), energy management systems, medical devices, vehicles, robots, robotic control systems, UAV, equipment and machinery control systems, hot and cold water supply devices, air conditioning system, heating systems, fuel delivery systems, energy management systems, product delivery systems, ventilation systems, air handling systems, computers and computer systems, chemical plant control systems, manufacturing plant control systems, computer operating systems and other software systems, programs, routines, objects, and/or elements, AR systems, VR systems, remote control systems, or the like or mixtures or combinations thereof.

Suitable software systems, software products, and/or software objects that are amenable to control by the interface of this disclosure include, without limitation, any analog or digital processing unit or units having single or a plurality of software products installed thereon and where each software product has one or more adjustable attributes associated therewith, or singular software programs or systems with one or more adjustable attributes, menus, lists or other functions or display outputs. Exemplary examples of such software products include, without limitation, operating systems, graphics systems, business software systems, word processor systems, business systems, online merchandising, online merchandising systems, purchasing and business transaction systems, databases, software programs and applications, augmented reality (AR) systems, virtual reality (VR) systems, internet browsers, accounting systems, military systems, control systems, or the like, or mixtures or combinations thereof. Software objects generally refer to all components within a software system or product that are controllable by at least one processing unit.

Suitable processing units for use in the present disclosure include, without limitation, digital processing units (DPUs), analog processing units (APUs), any other technology that can receive motion sensor output and generate command and/or control functions for objects under the control of the processing unit, or mixtures and combinations thereof.

Suitable digital processing units (DPUs) include, without limitation, any digital processing unit capable of accepting input from a plurality of devices and converting at least some of the input into output designed to select and/or control attributes of one or more of the devices. Exemplary examples of such DPUs include, without limitation, microprocessor, microcontrollers, or the like manufactured by Intel, Motorola, Eriksson, HP, Samsung, Hitachi, NRC, Applied Materials, AMD, Cyrix, Sun Microsystem, Philips, National Semiconductor, Qualcomm, or any other manufacture of microprocessors or microcontrollers.

Suitable analog processing units (APUs) include, without limitation, any analog processing unit capable of accepting input from a plurality of devices and converting at least some of the input into output designed to control attributes of one or more of the devices. Such analog devices are available from manufacturers such as Analog Devices Inc.

Suitable motion sensing apparatus include, without limitation, motion sensors of any form such as digital cameras, optical scanners, optical roller ball devices, touch pads, inductive pads, capacitive pads, holographic devices, laser tracking devices, thermal devices, EMF sensors, wave form sensors, particles sensors, any other device capable of sensing motion, changes in EMF, changes in wave form, or the like or arrays of such devices or mixtures or combinations thereof.

Suitable smart mobile devices include, without limitation, smart phones, tablets, notebooks, desktops, watches, wearable smart devices, or any other type of mobile smart device. Exemplary smart phone, table, notebook, watches, wearable smart devices, or other similar device manufacturers include, without limitation, ACER, ALCATEL, ALLVIEW, AMAZON, AMOI, APPLE, ARCHOS, ASUS, AT&T, BENEFON, BENQ, BENQ-SIEMENS, BIRD, BLACKBERRY, BLU, BOSCH, BQ, CASIO, CAT, CELKON, CHEA, COOLPAD, DELL, EMPORIA, ENERGIZER, ERICSSON, ETEN, FUJITSU SIEMENS, GARMIN-ASUS, GIGABYTE, GIONEE, GOOGLE, HAIER, HP, HTC, HUAWEI, I-MATE, I-MOBILE, ICEMOBILE, INNOSTREAM, INQ, INTEX, JOLLA, KARBONN, KYOCERA, LAVA, LEECO, LENOVO, LG, MAXON, MAXWEST, MEIZU, MICROMAX, MICROSOFT, MITAC, MITSUBISHI, MODU, MOTOROLA, MWG, NEC, NEONODE, NIU, NOKIA, NVIDIA, O2, ONEPLUS, OPPO, ORANGE, PALM, PANASONIC, PANTECH, PARLA, PHILIPS, PLUM, POSH, PRESTIGIO, QMOBILE, QTEK, QUALCOM, SAGEM, SAMSUNG, SENDO, SEWON, SHARP, SIEMENS, SONIM, SONY, SONY ERICSSON, SPICE, T-MOBILE, TEL.ME, TELIT, THURAYA, TOSHIBA, UNNECTO, VERTU, VERYKOOL, VIVO, VK MOBILE, VODAFONE, WIKO, WND, XCUTE, XIAOMI, XOLO, YEZZ, YOTA, YU, and ZTE. It should be recognized that all of these mobile smart devices including a processing unit (often times more than one), memory, communication hardware and software, a rechargeable power supply, and at least one human cognizable output device, where the output device may to be audio, visual and/or audio visual.

Suitable non-mobile, computer and server devices include, without limitation, such devices manufactured by @Xi Computer Corporation, @Xi Computer, ABS Computer Technologies (Parent: Newegg), Acer, Gateway, Packard Bell, ADEK Industrial Computers, Advent, Amiga, Inc., A-EON Technology, ACube Systems Srl, Hyperion Entertainment, Agilent, Aigo, AMD, Aleutia, Alienware (Parent: Dell), AMAX Information Technologies, Ankermann, AORUS, AOpen, Apple, Arnouse Digital Devices Corp (ADDC), ASRock, Asus, AVADirect, AXIOO International, BenQ, Biostar, BOXX Technologies, Inc., Chassis Plans, Chillblast, Chip PC, Clevo, Sager Notebook Computers, Cray, Crystal Group, Cybernet Computer Inc., Compal, Cooler Master, CyberPower PC, Cybertron PC, Dell, Wyse Technology, DFI, Digital Storm, Doel (computer), Elitegroup Computer Systems (ECS), Evans & Sutherland, Everex, EVGA, Falcon Northwest, FIC, Fujitsu, Fusion Red, Foxconn, Founder Technology, Getac, Gigabyte, Gradiente, Groupe Bull, Grundig (Parent: Argelik), Hasee, Hewlett-Packard (HP), Compaq, Hitachi, HTC, Hyundai, IBM, IBuyPower, Intel, Inventec, In-Win, Ironside, Itautec, IGEL, Jetta International, Kohjinsha, Kontron AG, LanFirePC, Lanix, Lanner Electronics, LanSlide Gaming PCs, Lenovo, Medion, LG, LiteOn, Maingear, MDG Computers, Meebox, Mesh Computers, Micron, Microsoft, Micro-Star International (MSI), Micro Center, MiTAC, Motion Computing, Motorola, NComputing, NCR, NEC, NUDT, NVIDIA, NZXT, Olidata, Olivetti, Oracle, Origin PC, Panasonic, Positivo Informitica, Psychsoftpc, Puget Systems, Quanta Computer, RCA, Razer, RoseWill, Samsung, Sapphire Technology, Sharp Corporation, Shuttle, SGI, Siragon, Sony, StealthMachines, Supermicro, Systemax, System76, T-Platforms, TabletKiosk, Tadpole Computer, Tatung, Toshiba, Tyan, Unisys, V3 Gaming PC, Velocity Micro, Overdrive PC, Vestel, Venom, VIA Technologies, ViewSonic, Viglen, Virus Computers Inc., Vizio, VT Miltope, Wistron, Wortmann, Xidax, Zelybron, Zombie PC, and Zoostorm, and Zotac. It should be recognized that all of these computer and services including at least one processing unit (often times many processing units), memory, storage devices, communication hardware and software, a power supply, and at least one human cognizable output device, where the output device may to be audio, visual and/or audio visual. It should be recognized that these systems may be in communication with processing units of vehicles (land, air or sea, manned or unmanned) or integrated into the processing units of vehicles (land, air or sea, manned or unmanned).

Suitable biometric measurements include, without limitation, external and internal organ structure, placement, relative placement, gaps between body parts such as gaps between fingers and toes held in a specific orientation, organ shape, size, texture, coloring, color patterns, etc., circulatory system (veins, arteries, capillaries, etc.) shapes, sizes, structures, patterns, etc., any other biometric measure, or mixtures and combinations thereof.

Suitable kinetic measurements include, without limitation, (a) body movements characteristics—how the body moves generally or moves according to a specific set or pattern of movements, (b) body part movement characteristics—how the body part moves generally or moves according to a specific set or pattern of movements, (c) breathing patterns and/or changes in breathing patterns, (d) skin temperature distributions and/or changes in the temperature distribution over time, (e) blood flow patterns and/or changes in blood flow patterns, (f) skin characteristics such as texture, coloring, etc., and/or changes in skin characteristics, (g) body, body part, organ (internal and/or external) movements over short, medium, long, and/or very long time frames (short time frames range between 1 nanosecond and 1 microsecond, medium time frames range between 1 microsecond and 1 millisecond, and long time frames range between 1 millisecond and 1 second) such as eye flutters, skin fluctuations, facial tremors, hand tremors, rapid eye movement, other types of rapid body part movements, or combinations thereof, (h) movement patterns associated with one or more body parts and/or movement patterns of one body part relative to other body parts, (i) movement trajectories associated with one or more body parts and/or movement trajectories of one body part relative to other body parts either dynamically or associated with a predetermined, predefined, or mirrored set of movements, (j) blob data fluctuations associated with one or more body parts and/or movement patterns or trajectories of one body part relative to other body parts either dynamically or associated with a predetermined, predefined, or mirrored set of movements, (k) any other kinetic movements of the body, body parts, organs (internal or external), etc., (1) any movement of an object under control of a user, and (m) mixtures or combinations thereof.

Suitable biokinetic measurements include, without limitation, any combination of biometric measurements and kinetic measurements and biokinetic measurements.

### DETAILED DESCRIPTION OF DRAWINGS OF THIS INVENTION

### Illustration of Data Collection/Capture of Displayed Objects

Referring now to FIGS. 1A-CV, a sequence of screen images displayed on a display field or window generally 100, of a display device of an apparatus illustrating functioning of the apparatus.

Looking at FIGS. 1A-E, a sequence of screen images showing a cursor 102 moving towards a level 1 object 104 and displaying a real-time percentage value 106 of a motion measure based on the motion properties of the cursor 102, wherein the motion properties include at least distance from the object, direction towards the object, velocity towards the object, acceleration towards object, pauses, stops, etc., or any mixture or combination thereof. As the cursor 102 is moved towards the object 104, the value 106 increases. Once the value 106 attained a certain or threshold value, any subobjects associated with the object 104 will appear tightly clustered about the object 104 as shown in FIG. 1F. Here, the object 104 has five level 2 objects 108a-e and associated percentage values 110a-e.

Looking at FIGS. 1G-L, these figures illustrate the activation of level 2 objects 108a-e and their associated metric values 110a-e during initial level 1 object 104 children display and selection and activation.

Looking at FIGS. 1M-AG, these figures illustrate the selection and activation of level 3 objects 112aa-ab and associated percentage values 114aa-ab associated with the level 2 object 108a.

Looking at FIGS. 1AH-AW, these figures illustrate the selection and activation of level 3 objects 112ba-bb and associated percentage values 114ba-bb associated with the level 2 object 108b.

Looking at FIGS. 1AX-BN, these figures illustrate the selection and activation of level 3 objects 112ca-cc and associated percentage values 114ca-cc associated with the level 2 object 108c.

Looking at FIGS. 1BO-BX, these figures illustrate the selection and activation of level 3 objects 112da-db and associated percentage values 114da-db associated with the level 2 object 108d.

Looking at FIGS. 1BY-CA, these figures illustrate the selection and activation of level 3 objects 112ca-cc and associated percentage values 114ca-cc associated with the level 2 object 108c.

Looking at FIGS. 1CB-CD, these figures illustrate the selection and activation of level 3 objects 112da-db and associated percentage values 114da-db associated with the level 2 object 108d.

Looking at FIGS. 1CE-CQ, these figures illustrate the selection and activation of level 3 objects 112ea-eb and associated percentage values 114ea-eb associated with the level 2 object 108e.

Looking at FIG. 1CR, this figure illustrates a return to the activation of level 2 objects 108a-e and their associated metric values 110a-e during initial level 1 object 104 children display and selection and activation.

Looking at FIGS. 1CS-CV, these figures illustrate the selection and activation of level 3 objects 112ca-cc and associated percentage values 114ca-cc associated with the level 2 object 108c.

The same methodology may be used in any computer environment using pointer type input devices, optical type input devices, acoustic input devices, EMF input devices, other input devices, or any combination thereof. Such environments would include applications based on observing interactions with real world environments in real-time, observing interaction with virtual environments in real-time, and/or observing interactions with mixed real world and virtual (CG) environments in real-time and using the data to optimize, predict, classify, etc. the environments and/or applications.

### Illustration of Data Collection/Capture of People Shopping in Supermarket

Referring now to FIG. 2A, an embodiment of a supermarket, generally 200, including doors 202, check out counters 204a-d, long product cabinets 206a-h with isles interposed therebetween or between a cabinet (206a&h) and the outer walls 208, and short refrigerated cabinets 210a-d. The supermarket 200 also includes a sensor gathering/collection/capturing apparatus 212 including sensors 1-19 located so that data acquisition is optimal. The sensors 1-19 are in bidirectional communication with the sensor gathering/collection/capturing apparatus 212 via communication pathways 214 and may be motion sensor, cameras, 360 degree cameras, thermal sensors, infrared sensors, infrared cameras, pressure sensors disposed in the isles, any other sensor capable of detecting motion, and/or any combination thereof. The communication pathways 214 are only shown in FIG. 2A do decrease viewability of shoppers in FIGS. 2B-H.

FIGS. 2B-H illustrate the supermarket 200 opening for business and the sensor gathering/collection/capturing apparatus 212 collecting data as customers enter, move through, shop for products, check out, and leave the supermarket 200. The data gathered/collected/captured by the sensor gathering/collection/capturing apparatus 212 include, without limitation, the manner in which customers shop; how they proceed through the isles; when and how they select products; which products they select; which products the pick up and examine; how changes in the lay out of products and isles will affect customer shopping, how coupons affect customer shopping, how sales affect customer shopping, how personal shopper interfere with customer shopping, how product placement affects customer shopping, how different type of check out formats affects customers shopping, how shop lifters may be better identified, how supermarket personnel affect customer shopping, any other custom, supermarket, supermarket personnel data, and any combination thereof. FIGS. 2B-H do not show the real-time or near real-time percentage data that is shown in FIGS. 1A-1CV as that data was collected for interaction with certain display objects.

The data analytics and mining subsystem associated with the sensor gathering/collection/capturing apparatus 212 may then be used to optimize: isle placement, optimize food placement, a frequency of product reorganization, customer shopping satisfaction, optimize product placement, product selection, product profitability, activities that affect product selection, activities that affect product placement, customer flow dynamics through the supermarket, optimize other activities that affect customer shopping experience in the supermarket, and/or any combination thereof.

As described in FIGS. 1A-1CV, real-time or near real-time customer data gathered/collected/captured by the sensor gathering/collection/capturing apparatus 212 as customer shop in the supermarket over time. The gathered/collected/captured data may be expressed as percentage of time spent: shopping, in each isle, picking out products, viewing products, examining products, interacting with personnel, trying to find a particular product, looking at coupons, looking at sales items, bending down to pick up products, reaching to pick up products, doing any other activity in the supermarket, and/or any combination thereof.

The data analytics and mining subsystem associated with the sensor gathering/collection/capturing apparatus 212 may then use all the gather/collected/captured data to generate metrics for isle placement, product placement, check out counter or unit placement, supermarket design, customer classifications, customer shopping habits, any other metric, and/or any combination thereof. The customer classification may include customer classes including, without limitation, frequent customers, one time customers, customers that select and purchase different numbers of products, customers that spend different amounts of time looking at products before selecting and purchasing products, customers that spend different amounts of time selecting and purchasing products, customers that select and purchase the same or similar set of products each time they come, customers that select and purchase different products each time they come, customers divided by gender, customers divided by behavior, customers divided by ethnicity, customers divided by appearance, customers divided by any other measurable characteristic, attribute, and/or any combination thereof.

Of course, the same data collection/capturing and data analysis methodology may be used in any shopping environment, sports environment, entertainment environment, military deployment and exercise environment, real world training environment, virtual training environment, mixed real and virtual training environment, and/or any other environment that would benefit from real-time data collection/capture and data analytics and mining directed to understanding interaction patterns with the environments and determining patterns, predictive rules, classifications of interaction patterns and predictive rules, etc. to modify, alter, change, etc. resulting in the global design optimization, feature design optimization, on the fly design optimization and/or any other type of environment feature reconfiguration, modification and/or optimization based on the real-time data collection/capture and analysis.

### EMBODIMENTS OF THE DISCLOSURE

Embodiment 1. An apparatus comprising:
one or more processing assemblies;
one or more monitoring assemblies;
one or more data gathering/collection/capturing assemblies;
one or more data analysis assemblies; and
one or more data storage and retrieval assemblies,
wherein the assemblies may operate in real-time or near real-time.
Embodiment 2. The apparatus of Embodiment 1, wherein the one or more processing assemblies includes comprising one or more electronic devices, one or more processing units, one or more processing systems, one or more distributed processing systems, one or more distributing processing environments, and/or any combination thereof.
Embodiment 3. The apparatus of Embodiment 2, wherein the one or more electronic devices, the one or more processing units, the one or more processing systems, the one or more distributed processing systems, and the one or more distributing processing environments include one or more processing units, one or more memory units, one or more storage devices, one or more input devices, one or more output devices, an operating system or structure, software and configuration-based protocols and/or elements, communication software and hardware, and routines for implementing the apparatus.
Embodiment 4. The apparatus of Embodiment 1, wherein the one or more monitoring assemblies comprises the one or more sensors.
Embodiment 5. The apparatus of Embodiment 4, wherein the one or more sensors comprise one or more cameras, one or more motion sensors, one or more biometric sensors, one or more biokinetic sensors, one or more environmental sensors, one or more field sensors, one or more brain wave sensors, and/or any combination thereof.
Embodiment 6. The apparatus of Embodiment 5, wherein the one or more environmental sensors include one or more temperature sensors, one or more pressure sensors, one or more humidity sensors, one or more weather or meteorological sensors, one or more air quality sensors, one or more chemical sensors, one or more infrared sensors, one or more UV sensors, one or more X-ray sensors, one or more high energy particle sensors, one or more radiation sensors, any other environmental sensor, and/or any combination thereof.
Embodiment 7. The apparatus of Embodiment 6, wherein the one or more monitoring assemblies are configured to:
monitor activities and interactions.
Embodiment 8. The apparatus of Embodiment 7, wherein the activities and interactions comprise actions and/or interactions of one or more humans, one or more animals, one or more robots, one or more devices under the control of a human or an animal, one or more detectable fields, any other activity and/or interaction, and/or any combination thereof with one or more humans, one or more animals, one or more robots, one or more devices under the control of a human or an animal, one or more detectable fields, one or more real objects, one or more virtual objects, one or more imaginary entities, one or more real environments, one or more virtual reality environments, one or more mixed real and virtual reality environments, any other real or virtual item or object, and/or any combination thereof.
Embodiment 9. The apparatus of Embodiment 1, wherein one or more data gathering/collecting/capturing assemblies comprise elements of the one or more processing assemblies capable of gathering, collecting, and/or capturing monitored activity and interaction data.
Embodiment 10. The apparatus of Embodiment 9, wherein the one or more data gathering/collecting/capturing assemblies are configured to:
gather, collect, and/or capture monitored activity and interaction data.
Embodiment 11. The apparatus of Embodiment 10, wherein the gathered/collected/captured data is gathered/collected/captured continuously, semi-continuously, intermittently, on command, and/or any combination of this sequentially or simultaneously.
Embodiment 12. The apparatus of Embodiment 1, wherein the one or more data analysis assemblies comprise one or more data analytic software routines, data mining software routines, one or more artificial intellect software routines, one or more metric generation software routines, one or more rules generation software routines, any other software routine used in data analysis, and/or any combination thereof.
Embodiment 13. The apparatus of Embodiment 12, wherein the one or more data analysis assemblies are configured to:
analyze the gathered/collected/captured data, and
produce usable output data.
Embodiment 14. The apparatus of Embodiment 13, wherein the usable output data includes metrics and rules.
Embodiment 15. The apparatus of Embodiment 14, wherein the rules include predictive rules, behavioral rules, forecasting rules, any other type of informational rules derived from the gathered/collected/captured data, and/or any combination thereof.
Embodiment 16. The apparatus of 15, wherein the one or more data analysis assemblies are configured to:
produce optimized environments, real-time or near real-time environments, predictive environments, behavioral environments, forecasting environments, any other type of environments derived from the gathered/collected/captured data, the metrics, and rules, and/or any combination thereof.
Embodiment 17. The apparatus of Embodiment 16, wherein the one or more data analysis assemblies are configured to:
predict human, animal, and/or devices under that control of a human and/or animal activities and/or interactions based on the gathered/collected/captured data,
generate metrics based on the gathered/collected/captured data,
generate rules based on the gathered/collected/captured data,
generate predictive metrics, rules, and/or patterns based on the data, and
output the metrics, rules, and/or behavioral patterns to one or more databases.
Embodiment 18. The apparatus of Embodiment 1, wherein the one or more data storage and retrieval assemblies comprise one or more databases, one or more data storage structures, any other data storage system, and/or any combination thereof.
Embodiment 19. The apparatus of Embodiment 18, wherein the one or more data storage and retrieval assemblies are configured to:
store the gathered/collected/captured data and the data analyses, and
allow the retrieval of the gathered/collected/captured data and the data analyses.
Embodiment 20. A system comprising:
one or more processing subsystems;
one or more monitoring subsystems;
one or more data gathering/collection/capturing subsystems;
one or more data analysis subsystems; and
one or more data storage and retrieval subsystems
wherein the subsystems may operate in real-time or near real-time.
Embodiment 21. The system of Embodiment 20, wherein the one or more processing subsystems includes comprising one or more electronic devices, one or more processing units, one or more processing systems, one or more distributed processing systems, one or more distributing processing environments, and/or any combination thereof.
Embodiment 22. The system of Embodiment 21, wherein the one or more electronic devices, the one or more processing units, the one or more processing systems, the one or more distributed processing systems, and the one or more distributing processing environments include one or more processing units, one or more memory units, one or more storage devices, one or more input devices, one or more output devices, an operating system or structure, software and configuration-based protocols and/or elements, communication software and hardware, and routines for implementing the system.
Embodiment 23. The system of Embodiment 20, wherein the one or more monitoring subsystems comprises the one or more sensors.
Embodiment 24. The system of Embodiment 23, wherein the one or more sensors comprise one or more cameras, one or more motion sensors, one or more biometric sensors, one or more biokinetic sensors, one or more environmental sensors, one or more field sensors, one or more brain wave sensors, and/or any combination thereof.
Embodiment 25. The system of Embodiment 24, wherein the one or more environmental sensors include one or more temperature sensors, one or more pressure sensors, one or more humidity sensors, one or more weather or meteorological sensors, one or more air quality sensors, one or more chemical sensors, one or more infrared sensors, one or more UV sensors, one or more X-ray sensors, one or more high energy particle sensors, one or more radiation sensors, any other environmental sensor, and/or any combination thereof.
Embodiment 26. The system of Embodiment 25, wherein the one or more monitoring subsystems are configured to:
monitor activities and interactions.
Embodiment 27. The system of Embodiment 26, wherein the activities and interactions comprise actions and/or interactions of one or more humans, one or more animals, one or more robots, one or more devices under the control of a human or an animal, one or more detectable fields, any other activity and/or interaction, and/or any combination thereof with one or more humans, one or more animals, one or more robots, one or more devices under the control of a human or an animal, one or more detectable fields, one or more real objects, one or more virtual objects, one or more imaginary entities, one or more real environments, one or more virtual reality environments, one or more mixed real and virtual reality environments, any other real or virtual item or object, and/or any combination thereof.
Embodiment 28. The system of Embodiment 20, wherein one or more data gathering/collecting/capturing subsystems comprise elements of the one or more processing assemblies capable of gathering, collecting, and/or capturing monitored activity and interaction data.
Embodiment 29. The system of Embodiment 28, wherein the one or more data gathering/collecting/capturing subsystems are configured to:
gather, collect, and/or capture monitored activity and interaction data.
Embodiment 30. The system of Embodiment 29, wherein the gathered/collected/captured data is gathered/collected/captured continuously, semi-continuously, intermittently, on command, and/or any combination of this sequentially or simultaneously.
Embodiment 31. The system of Embodiment 20, wherein the one or more data analysis subsystems comprise one or more data analytic software routines, data mining software routines, one or more artificial intellect software routines, one or more metric generation software routines, one or more rules generation software routines, any other software routine used in data analysis, and/or any combination thereof.
Embodiment 32. The system of Embodiment 31, wherein the one or more data analysis subsystems are configured to:
analyze the gathered/collected/captured data, and
produce usable output data.
Embodiment 33. The system of Embodiment 32, wherein the usable output data includes metrics and rules.
Embodiment 34. The system of Embodiment 33, wherein the rules include predictive rules, behavioral rules, forecasting rules, any other type of informational rules derived from the gathered/collected/captured data, and/or any combination thereof.
Embodiment 35. The system of 34, wherein the one or more data analysis subsystems are configured to:
produce optimized environments, real-time or near real-time environments, predictive environments, behavioral environments, forecasting environments, any other type of environments derived from the gathered/collected/captured data, the metrics, and rules, and/or any combination thereof.
Embodiment 36. The system of Embodiment 35, wherein the one or more data analysis subsystems are further configured to:
predict human, animal, and/or devices under that control of a human and/or animal activities and/or interactions based on the gathered/collected/captured data,
generate metrics based on the gathered/collected/captured data,
generate rules based on the gathered/collected/captured data,
generate predictive metrics, rules, and/or patterns based on the data, and
output the metrics, rules, and/or behavioral patterns to one or more databases.
Embodiment 37. The system of Embodiment 20, wherein the one or more data storage and retrieval subsystems comprise one or more databases, one or more data storage structures, any other data storage system, and/or any combination thereof.
Embodiment 38. The system of Embodiment 37, wherein the one or more data storage and retrieval subsystems are configured to:
store the gathered/collected/captured data and the data analyses, and
allow the retrieval of the gathered/collected/captured data and the data analyses.
Embodiment 39. An interface implemented on an apparatus comprising: one or more processing assemblies, one or more monitoring assemblies, one or more data gathering/collection/capturing assemblies, one or more data analysis assemblies; and one or more data storage and retrieval assemblies, the interface configured to:
monitor activities and interactions;
gather, collect, and/or capture monitored activity and interaction data;
analyze the gathered/collected/captured data;
produce usable output data;
store the gathered/collected/captured data and the data analyses;
retrieve the the gathered/collected/captured data and the data analyses,
wherein the above features may operate in real-time or near real-time.
Embodiment 40. The interface of Embodiment 39, wherein the one or more processing subsystems includes comprising one or more electronic devices, one or more processing units, one or more processing systems, one or more distributed processing systems, one or more distributing processing environments, and/or any combination thereof.
Embodiment 41. The interface of Embodiment 40, wherein the one or more electronic devices, the one or more processing units, the one or more processing systems, the one or more distributed processing systems, and the one or more distributing processing environments include one or more processing units, one or more memory units, one or more storage devices, one or more input devices, one or more output devices, an operating system or structure, software and configuration-based protocols and/or elements, communication software and hardware, and routines for implementing the system.
Embodiment 42. The interface of Embodiment 39, wherein the one or more monitoring subsystems comprises the one or more sensors.
Embodiment 43. The interface of Embodiment 42, wherein the one or more sensors comprise one or more cameras, one or more motion sensors, one or more biometric sensors, one or more biokinetic sensors, one or more environmental sensors, one or more field sensors, one or more brain wave sensors, and/or any combination thereof.
Embodiment 44. The interface of Embodiment 43, wherein the one or more environmental sensors include one or more temperature sensors, one or more pressure sensors, one or more humidity sensors, one or more weather or meteorological sensors, one or more air quality sensors, one or more chemical sensors, one or more infrared sensors, one or more UV sensors, one or more X-ray sensors, one or more high energy particle sensors, one or more radiation sensors, any other environmental sensor, and/or any combination thereof.
Embodiment 45. The interface of Embodiment 39, wherein the activities and interactions comprise actions and/or interactions of one or more humans, one or more animals, one or more robots, one or more devices under the control of a human or an animal, one or more detectable fields, any other activity and/or interaction, and/or any combination thereof with one or more humans, one or more animals, one or more robots, one or more devices under the control of a human or an animal, one or more detectable fields, one or more real objects, one or more virtual objects, one or more imaginary entities, one or more real environments, one or more virtual reality environments, one or more mixed real and virtual reality environments, any other real or virtual item or object, and/or any combination thereof.
Embodiment 46. The interface of Embodiment 39, wherein one or more data gathering/collecting/capturing subsystems comprise elements of the one or more processing assemblies capable of gathering, collecting, and/or capturing monitored activity and interaction data.
Embodiment 47. The interface of Embodiment 39, wherein the gathered/collected/captured data is gathered/collected/captured continuously, semi-continuously, intermittently, on command, and/or any combination of this sequentially or simultaneously.
Embodiment 48. The interface of Embodiment 39, wherein the one or more data analysis subsystems comprise one or more data analytic software routines, data mining software routines, one or more artificial intellect software routines, one or more metric generation software routines, one or more rules generation software routines, any other software routine used in data analysis, and/or any combination thereof.
Embodiment 49. The interface of Embodiment 39, wherein the usable output data includes metrics and rules.
Embodiment 50. The interface of Embodiment 49, wherein the rules include predictive rules, behavioral rules, forecasting rules, any other type of informational rules derived from the gathered/collected/captured data, and/or any combination thereof.
Embodiment 51. The interface of 39, wherein the interface further configured to:
produce optimized environments, real-time or near real-time environments, predictive environments, behavioral environments, forecasting environments, any other type of environments derived from the gathered/collected/captured data, the metrics, and rules, and/or any combination thereof.
Embodiment 52. The interface of Embodiment 51, wherein the interface further configured to:
predict human, animal, and/or devices under that control of a human and/or animal activities and/or interactions based on the gathered/collected/captured data,
generate metrics based on the gathered/collected/captured data,
generate rules based on the gathered/collected/captured data,
generate predictive metrics, rules, and/or patterns based on the data, and
output the metrics, rules, and/or behavioral patterns to one or more databases.
Embodiment 53. The interface of Embodiment 39, wherein the one or more data storage and retrieval subsystems comprise one or more databases, one or more data storage structures, any other data storage system, and/or any combination thereof.
Embodiment 54. A method implemented on an apparatus comprising: one or more processing assemblies, one or more monitoring assemblies, one or more data gathering/collection/capturing assemblies, one or more data analysis assemblies; and one or more data storage and retrieval assemblies, the method comprising:
monitoring activities and interactions;
gathering, collecting, and/or capturing monitored activity and interaction data;
analyzing the gathered/collected/captured data;
producing usable output data;
storing the gathered/collected/captured data and the data analyses;
modifying one, some, or all of the gathered/collected/captured data and the usable output data to produce modified gathered/collected/captured data and modified usable output data;
retrieving the gathered/collected/captured data, the data analyses, the modified gathered/collected/captured data, and/or the modified usable output data; and
repeating one, some, or all of the above steps,
wherein the above steps may occur in real-time or near real-time.
Embodiment 55. The method of Embodiment 54, wherein, in the implementation, the one or more processing subsystems includes comprising one or more electronic devices, one or more processing units, one or more processing systems, one or more distributed processing systems, one or more distributing processing environments, and/or any combination thereof.
Embodiment 56. The method of Embodiment 55, wherein, in the implementation, the one or more electronic devices, the one or more processing units, the one or more processing systems, the one or more distributed processing systems, and the one or more distributing processing environments include one or more processing units, one or more memory units, one or more storage devices, one or more input devices, one or more output devices, an operating system or structure, software and configuration-based protocols and/or elements, communication software and hardware, and routines for implementing the system.
Embodiment 57. The method of Embodiment 45, wherein, in the monitoring, the one or more monitoring subsystems comprises the one or more sensors.
Embodiment 58. The method of Embodiment 57, wherein, in the monitoring, the one or more sensors comprise one or more cameras, one or more motion sensors, one or more biometric sensors, one or more biokinetic sensors, one or more environmental sensors, one or more field sensors, one or more brain wave sensors, and/or any combination thereof.
Embodiment 59. The method of Embodiment 58, wherein, in the monitoring, the one or more environmental sensors include one or more temperature sensors, one or more pressure sensors, one or more humidity sensors, one or more weather or meteorological sensors, one or more air quality sensors, one or more chemical sensors, one or more infrared sensors, one or more UV sensors, one or more X-ray sensors, one or more high energy particle sensors, one or more radiation sensors, any other environmental sensor, and/or any combination thereof.
Embodiment 60. The method of Embodiment 54, wherein, in the monitoring, the activities and interactions comprise actions and/or interactions of one or more humans, one or more animals, one or more robots, one or more devices under the control of a human or an animal, one or more detectable fields, any other activity and/or interaction, and/or any combination thereof with one or more humans, one or more animals, one or more robots, one or more devices under the control of a human or an animal, one or more detectable fields, one or more real objects, one or more virtual objects, one or more imaginary entities, one or more real environments, one or more virtual reality environments, one or more mixed real and virtual reality environments, any other real or virtual item or object, and/or any combination thereof.
Embodiment 61. The method of Embodiment 54, wherein, in the gathering/collecting/capturing, the one or more data gathering/collecting/capturing subsystems comprise elements of the one or more processing assemblies capable of gathering, collecting, and/or capturing monitored activity and interaction data.
Embodiment 62. The method of Embodiment 61, wherein, in the gathering/collecting/capturing, the gathered/collected/captured data is gathered/collected/captured continuously, semi-continuously, intermittently, on command, and/or any combination of this sequentially or simultaneously.
Embodiment 63. The method of Embodiment 54, wherein the one or more data analysis subsystems comprise one or more data analytic software routines, data mining software routines, one or more artificial intellect software routines, one or more metric generation software routines, one or more rules generation software routines, any other software routine used in data analysis, and/or any combination thereof.
Embodiment 64. The method of Embodiment 63, wherein, in the producing, the usable output data includes metrics and rules.
Embodiment 65. The method of Embodiment 64, wherein, in the producing, the rules include predictive rules, behavioral rules, forecasting rules, any other type of informational rules derived from the gathered/collected/captured data, and/or any combination thereof.
Embodiment 66. The method of 65, the method further comprising:
producing optimized environments, real-time or near real-time environments, predictive environments, behavioral environments, forecasting environments, any other type of environments derived from the gathered/collected/captured data, the metrics, and rules, and/or any combination thereof.
Embodiment 67. The method of Embodiment 66, the method further comprising:
predicting human, animal, and/or devices under that control of a human and/or animal activities and/or interactions based on the gathered/collected/captured data,
generating metrics based on the gathered/collected/captured data,
generating rules based on the gathered/collected/captured data,
generating predictive metrics, rules, and/or patterns based on the data, and
outputting the metrics, rules, and/or behavioral patterns to one or more databases.
Embodiment 68. The method of Embodiment 54, wherein the one or more data storage and retrieval subsystems comprise one or more databases, one or more data storage structures, any other data storage system, and/or any combination thereof.
Embodiment 69. A system comprising:
one or more processing assemblies includes comprising one or more electronic devices, one or more processing units, one or more processing systems, one or more distributed processing systems, one or more distributing processing environments, and/or any combination thereof;
the system configured to:
   gather, collect, and/or capture activity and/or interaction data from humans, animals, devices under that control of humans and/or animals, and/or devices under control of artificial intelligent (AI) algorithms and/or routines interacting with devices, real world environments, virtual reality (VR) environments, and/or mixed real world or virtual reality (AR, MR, and/or XR) environments;
   analyze of the gathered/collected/captured data;
   generate metrics based on the gathered/collected/captured data;
   generate predictive rules, behavioral rules, forecasting rules, or any other type of informational rules derived from the gathered/collected/captured;
   generate classification predictive, behavioral, forecasting patterns derived from the gathered/collected/captured data and/or the predictive rules, behavioral rules, forecasting rules, any other type of informational rules derived from the gathered/collected/captured, and/or any combination thereof;
   generate optimized environments, real-time or near real-time environments, predictive environments, behavioral environments, forecasting environments, or any other type of environments derived from the gathered/collected/captured data and/or the predictive rules, behavioral rules, forecasting rules, any other type of informational rules derived from the gathered/collected/captured, and/or any combination thereof;
   generate of data analytics and/or data mining information derived from the gathered/collected/captured data, the predictive rules, behavioral rules, forecasting rules, or any other type of informational rules, and/or the optimized environments, real-time or near real-time environments, predictive environments, behavioral environments, forecasting environments, or any other type of environments derived from the gathered/collected/captured; and
   repeat any mixture or combination thereof,
   wherein the above features may occur in real-time or near real-time.
Embodiment 70. The system of Embodiment 69, wherein the one or more electronic devices, one or more processing units, one or more processing systems, one or more distributed processing systems, and one or more distributing processing environments include one or more processing units, one or more memory units, one or more storage devices, one or more input devices, one or more output devices, an operating system or structure, software and configuration-based protocols and/or elements, communication software and hardware, and routines for implementing the system.
Embodiment 71. An interface implemented on an apparatus comprising: one or more processing assemblies, one or more monitoring assemblies, one or more data gathering/collection/capturing assemblies, one or more data analysis assemblies; and one or more data storage and retrieval assemblies, the interface configured to:
generate optimized environments, real-time or near real-time environments, predictive environments, behavioral environments, forecasting environments, any other type of environments, and/or combinations thereof derived from gathered/collected/captured data, historical data, metrics, KPIs, predictive rules, behavioral rules, forecasting rules, any other type of informational rules derived from the gathered/collected/captured, and/or any combination thereof;
generate of data analytics and/or data mining data and/or information derived from gathered/collected/captured data, historical data, metrics, KPIs, predictive rules, behavioral rules, forecasting rules, any other type of informational rules derived from the gathered/collected/captured, and/or any combination thereof, and/or the optimized environments, the real-time or near real-time environments, the predictive environments, behavioral environments, the forecasting environments, any other type of environments derived from the gathered/collected/captured, and/or any combination thereof;
store all of the data, data analyses, data analytics, data mining results, and optimized environments;
retrieve any of stored data, data analyses, data analytics, data mining results, and
optimized environments;
modify any aspect of the stored data, data analyses, data analytics, data mining results, and optimized environments;
store all of the modified data, data analyses, data analytics, data mining results, and
environments; and
repeat one, some, or all of the above,
wherein the above features may occur in real-time or near real-time.
Embodiment 72. A method implemented on an apparatus comprising: one or more processing assemblies, one or more monitoring assemblies, one or more data gathering/collection/capturing assemblies, one or more data analysis assemblies; and one or more data storage and retrieval assemblies, the method comprising:
monitoring human, animal, human/animal/AI controlled device, and/or any combination thereof activities and/or interactions with: (1) real world items and/or features/elements/portions/parts thereof, (2) real world environments and/or features/elements/portions/parts thereof, (3) virtual items and/or features/elements/portions/parts thereof, (4) virtual environments and/or features/elements/portions/parts thereof, and/or (5) mixed items and/or environments comprising combinations of real world items and/or features/elements/portions/parts thereof and virtual items and/or features/elements/portions/parts thereof, real world environments and/or features/elements/portions/parts and virtual environments and/or features/elements/portions/parts;
gathering, collecting, and/or capturing data from the monitoring subsystem, wherein the data comprise real-time or near real-time temporal correlated data of humans, animals, devices under the control of humans, animals, artificial intelligent (AI) device control algorithms, and/or any combination thereof;
generating optimized environments, real-time or near real-time environments, predictive environments, behavioral environments, forecasting environments, any other type of environments, and/or combinations thereof derived from gathered/collected/captured data, historical data, metrics, KPIs, predictive rules, behavioral rules, forecasting rules, any other type of informational rules derived from the gathered/collected/captured, and/or any combination thereof;
generating of data analytics and/or data mining data and/or information derived from gathered/collected/captured data, historical data, metrics, KPIs, predictive rules, behavioral rules, forecasting rules, any other type of informational rules derived from the gathered/collected/captured, and/or any combination thereof, and/or the optimized environments, the real-time or near real-time environments, the predictive environments, behavioral environments, the forecasting environments, any other type of environments derived from the gathered/collected/captured, and/or any combination thereof;
storing all of the data, data analyses, data analytics, data mining results, and optimized environments;
retrieving any of stored data, data analyses, data analytics, data mining results, and
optimized environments;
modifying any aspect of the stored data, data analyses, data analytics, data mining results, and optimized environments;
storing all of the modified data, data analyses, data analytics, data mining results, and
environments; and
repeating one, some, or all of the above steps,
wherein the above step may occur in real-time or near real-time.
Embodiment 73. The method of Embodiment 72, wherein the real world items and/or features/elements/portions/parts thereof and/or environments and/or features/elements/portions/parts thereof including stores, malls, shopping centers, consumer products, cars, sports arenas, houses, apartments, villages, cities, states, countries, rivers, streams, lakes, seas, oceans, skies, horizons, stars, planets, etc., commercial facilities, transportation systems such as roads, highways, interstate highways, rail roads, etc., humans, animals, plants, any other real world item and/or environment and/or element or part thereof.
Embodiment 74. The method of Embodiment 72, wherein the virtual items and/or features/elements/portions/parts thereof and/or environments and/or features/elements/portions/parts thereof including computer generated (CG) simulated real world objects and/or environments and/or CG imaginative objects and/or environments. The mixed items and/or features/elements/portions/parts thereof and/or environments and/or features/elements/portions/parts thereof including any combination of: (a) real world items and/or features/elements/portions/parts thereof and/or real world environments and/or features/elements/portions/parts thereof and GC items and/or features/elements/portions/parts thereof and (b) CG items and/or features/elements/portions/parts thereof and/or CG environments and/or features/elements/portions/parts thereof, i.e., mixed items comprise real world features/elements/portions/parts and CG features/elements/portions/parts.
Embodiment 75. The method of Embodiment 72, wherein the data comprises human, animal, and/or human/animal/AI controlled device movement or motion properties including: (1) direction, velocity, and/or acceleration, (2) changes of direction, velocity, and/or acceleration, (3) profiles of motion direction, velocity, and/or acceleration, (4) pauses, stops, hesitations, gitters, fluctuations, etc., (5) changes of pauses, stops, hesitations, gitters, fluctuations, etc., (6) profiles of pauses, stops, hesitations, gitters, fluctuations, etc., (7) physical data, environmental data, astrological data, meteorological data, location data, etc., (8) changes of physical data, environmental data, astrological data, meteorological data, location data, any other data, and/or any combination thereof, (9) profiles of physical data, environmental data, astrological data, meteorological data, location data, etc., and/or (10) any mixture or combination of these data, wherein the above features may occur in real-time or near real-time.
Embodiment 76. An apparatus or system and interface or method implementing them, the apparatus or system configured to:
analyze gathered/collected/captured data and
determine patterns, classifications, predictions, metrics, KPIs, rules, and/or combinations thereof using data analytics and data mining;
update, modify, and/or optimize the gathered/collected/captured data subsystem, the patterns, classifications, predictions, metrics, KPIs, rules, and/or combinations thereof; and
optimize one, some, or all of any feature that may be derived from the data analytics and data mining,
wherein the above features may occur in real-time or near real-time

### Apparatuses and Systems

Embodiment 77. An apparatus or system and interface or method implementing them, the apparatus or system comprising:
a processing subsystem including one or more electronic devices, one or more processing units, one or more processing systems, one or more distributed processing systems, one or more distributing processing environments, and/or any combination thereof configured to implement the apparatus, system, interface, or method;
a data monitoring/gathering/collection/capture subsystem configured to monitor, gather, collect, and/or capture activity and interaction data from humans, animals, devices under the control of humans and/or animals, devices under control of artificial intelligent (AI) algorithms or routines interacting with devices, real world environments, virtual reality environments, and/or mixed reality environments, and/or any combination thereof;
a data analysis subsystem configured to:
   analyze the collected data;
   produce usable collected data outputs including metrics derived from the collected data and/or historical data, KPIs derived from the collected data and/or historical data, rules derived from the collected data and/or historical data, other predictive models derived from the collected data and/or historical data, and/or any combination thereof;
      use data analytics and/or data mining to produce real-time or near real-time interactive environments, predictive interactive environments, behavioral interactive environments, other types of interactive environments, and/or any combination thereof derived from the collected data, the historical data, metrics, the KPIs, the rules, the predictive models, and/or historical data;
      optimize the real-time or near real-time interactive environments, the predictive interactive environments, the behavioral interactive environments, the other types of interactive environments, and/or any combination thereof;
      generate behavioral patterns derived from the collected data, the historical data, metrics, the KPIs, the rules, the predictive models, historical data, the interactive environments, and/or the optimized interactive environments;
      classify the behavioral patterns in one or more classes;
      store the collected data, the historical data, metrics, the KPIs, the rules, the predictive models, historical data, the interactive environments, the optimized interactive environments, the behavioral patterns and/or the classification;
      modify one, some, or all of the collected data, the historical data, the metrics, the KPIs, the rules, the predictive models, the interactive environments, the optimized interactive environments, the behavioral patterns and/or the classification based on user activity and interaction with the interactive environments;
      store the modified collected data, the modified historical data, the modified metrics, the modified KPIs, the modified rules, the modified predictive models, the modified interactive environments, the modified optimized interactive environments, the modified behavioral patterns and/or the modified classification;
      retrieve any of the the collected data, the historical data, the metrics, the KPIs, the rules, the predictive models, the interactive environments, the optimized interactive environments, the behavioral patterns, the classification based on user activity and interaction with the interactive environments, the modified collected data, the modified historical data, the modified metrics, the modified KPIs, the modified rules, the modified predictive models, the modified interactive environments, the modified optimized interactive environments, the modified behavioral patterns and/or the modified classification; and
   repeat any of the above,
   wherein the above features may occur in real-time or near real-time.
Embodiment 78. An apparatus or system and interface or method implementing them, the apparatus or system comprising:
a processing subsystem including one or more processing units, one or more processing systems, one or more distributed processing systems, and/or one or more distributing processing environments;
a monitoring subsystem including one or more sensors such as cameras, motion sensors, biometric sensors, biokinetic sensors, environmental sensors, and/or any combination thereof;
user interface subsystem including one or more user interfaces having one or more human, animal, and/or artificial intelligent (AI) cognizable output devices such as audio output devices, visual output devices, audiovisual output devices, haptic or touch sensitive output devices, other output devices, or any combination thereof;
a data gathering, collecting and/or capturing subsystem configured to gather, collect, and capture data from the monitoring subsystem;
a data analyze subsystem configured to analyze the gathered/collected/captured data and historical gathered/collected/captured data;
a data analytics subsystem configured to produce metrics, KPIS, rules, and/or any combination thereof derived from the gathered/collected/captured data and the historical gathered/collected/captured data;
a data storage subsystem configured to store the gathered/collected/captured data, the data analyses, and the data analytics; and
a data retrieval subsystem configured to retrieve the gathered/collected/captured data, the historical gathered/collected/captured data, and the data analyses, the data analytics,
wherein the above features may occur in real-time or near real-time.
Embodiment 79. An apparatus or system and interface or method implementing them, the apparatus or system configured to:
gather, collect, and/or capture data from the monitoring subsystem comprising real-time or near real-time temporal correlated data of humans, animals, and/or devices under the control of humans, animals, artificial intelligent (AI) device control algorithms,
monitor human, animal, human/animal/AI controlled device, etc. activities and/or interactions with (a) real world items and/or features/elements/portions/parts thereof, (b) real world environments and/or features/elements/portions/parts thereof, (c) virtual items and/or features/elements/portions/parts thereof, (d) virtual environments and/or features/elements/portions/parts thereof, and/or (e) mixed items and/or environments comprising combinations of real world items and/or features/elements/portions/parts thereof and virtual items and/or features/elements/portions/parts thereof, real world environments and/or features/elements/portions/parts and virtual environments and/or features/elements/portions/parts;
gather, collect, and/or capture activity and interaction data from humans, animals, devices under the control of humans and/or animals, devices under control of artificial intelligent (AI) algorithms or routines interacting with devices, real world environments, virtual reality environments, and/or mixed reality environments, and/or any combination thereof;
analyze the collected data;
produce usable collected data outputs including metrics derived from the collected data and/or historical data, KPIs derived from the collected data and/or historical data, rules derived from the collected data and/or historical data, other predictive models derived from the collected data and/or historical data, and/or any combination thereof;
use data analytics and/or data mining to produce real-time or near real-time interactive environments, predictive interactive environments, behavioral interactive environments, other types of interactive environments, and/or any combination thereof derived from the collected data, the historical data, metrics, the KPIs, the rules, the predictive models, and/or historical data;
optimize the real-time or near real-time interactive environments, the predictive interactive environments, the behavioral interactive environments, the other types of interactive environments, and/or any combination thereof;
generate behavioral patterns derived from the collected data, the historical data, metrics, the KPIs, the rules, the predictive models, historical data, the interactive environments, and/or the optimized interactive environments;
classify the behavioral patterns in one or more classes;
store the collected data, the historical data, metrics, the KPIs, the rules, the predictive models, historical data, the interactive environments, the optimized interactive environments, the behavioral patterns and/or the classification;
modify one, some, or all of the collected data, the historical data, the metrics, the KPIs, the rules, the predictive models, the interactive environments, the optimized interactive environments, the behavioral patterns and/or the classification based on user activity and interaction with the interactive environments;
store the modified collected data, the modified historical data, the modified metrics, the modified KPIs, the modified rules, the modified predictive models, the modified interactive environments, the modified optimized interactive environments, the modified behavioral patterns and/or the modified classification;
retrieve any of the the collected data, the historical data, the metrics, the KPIs, the rules, the predictive models, the interactive environments, the optimized interactive environments, the behavioral patterns, the classification based on user activity and interaction with the interactive environments, the modified collected data, the modified historical data, the modified metrics, the modified KPIs, the modified rules, the modified predictive models, the modified interactive environments, the modified optimized interactive environments, the modified behavioral patterns and/or the modified classification; and
repeat any of the above,
wherein the above features may occur in real-time or near real-time.
Embodiment 80. The method of Embodiment 79, wherein the real world items and/or features/elements/portions/parts thereof and/or environments and/or features/elements/portions/parts thereof including stores, malls, shopping centers, consumer products, cars, sports arenas, houses, apartments, villages, cities, states, countries, rivers, streams, lakes, seas, oceans, skies, horizons, stars, planets, etc., commercial facilities, transportation systems such as roads, highways, interstate highways, rail roads, etc., humans, animals, plants, any other real world item and/or environment and/or element or part thereof.
Embodiment 81. The method of Embodiment 80, wherein the virtual items and/or features/elements/portions/parts thereof and/or environments and/or features/elements/portions/parts thereof including computer generated (CG) simulated real world objects and/or environments and/or CG imaginative objects and/or environments. The mixed items and/or features/elements/portions/parts thereof and/or environments and/or features/elements/portions/parts thereof including any combination of (a) real world items and/or features/elements/portions/parts thereof and/or real world environments and/or features/elements/portions/parts thereof and GC items and/or features/elements/portions/parts thereof and (b) CG items and/or features/elements/portions/parts thereof and/or CG environments and/or features/elements/portions/parts thereof and/or mixed items comprise real world features/elements/portions/parts and CG features/elements/portions/parts.
Embodiment 82. The method of Embodiment 81, wherein the data comprises human, animal, and/or human/animal/AI controlled device movement or motion properties including (a) direction, velocity, and/or acceleration, (b) changes of direction, velocity, and/or acceleration, (c) profiles of motion direction, velocity, and/or acceleration, (d) pauses, stops, hesitations, gitters, fluctuations, and/or any combination, (e) changes of pauses, stops, hesitations, gitters, fluctuations, etc., (f) profiles of pauses, stops, hesitations, gitters, fluctuations, etc., (g) physical data, environmental data, astrological data, meteorological data, location data, etc., (h) changes of physical data, environmental data, astrological data, meteorological data, location data, etc., (i) profiles of physical data, environmental data, astrological data, meteorological data, location data, etc., and/or (j) any mixture or combination of these data.
Embodiment 83. The apparatus/system/interface/method of any of the previous Embodiments, wherein data mining subsystem includes data classification, data clustering, data regression, data outlier detection, sequential data pattern recognition, prediction methods based on the data, and/or rule associations based on the data, and/or any combination thereof.
The apparatus/system/interface/method of any of the previous Embodiments, wherein data mining subsystem further includes: (1) building up an understanding of amount and types of data; (2) choosing and creating a data set to be mined; (3) preprocessing and cleansing the data; (4) transforming the data set if needed; (5) prediction and description of the type of data mining methodology to be used such as classification, regression, clustering, etc.; (6) selecting the data mining algorithm; (7) utilizing the data mining algorithm; (8) evaluating or assessing and interpreting the mined patterns, rules, and reliability to the objective characterized in the first step and consider the preprocessing steps focusing on the comprehensibility and utility of the induced model for overall feedback and discovery for data mining results; and (9) using the discovered knowledge to update data collection/capture, update sensor placement, update data analytics, update data mining, update tasks, update task content, update environmental content, update any other feature for which the data may be used.
Embodiment 84. The apparatus/system/interface/method of any of the previous Embodiments, wherein data mining subsystem wherein the data mining and data analytics are two major methodologies used to analyze collected and generally databased data. Again, data mining concerns extracting data through finding patterns, cleaning, designing models and creating tests via database management, machine learning and statistics concepts. Data Mining can transform raw data into useful information.
Embodiment 85. The apparatus/system/interface/method of any of the previous Embodiments, wherein data mining subsystem wherein the data mining generally includes various techniques, tools, and techniques including (1) data cleaning—converting all collected data into a specific standard format for simple processing and analysis incorporating identification and correction of errors, finding the missing values, removing duplicates, etc.; (2) artificial intelligence—algorithms to perform analytical activities such as planning, learning, and problem-solving; (3) association rule—market basket analysis to determine relationship between different dataset variables; (4) clustering—splitting huge set of data into smaller segments or subsets called clusters; (5) classification—assigning categories or classes to a data collection to get more analysis and prediction; (6) data analytics—evaluate data, find patterns, and generate statistics; (7) data warehousing—collecting and storing business data that helps in quick decision-making purposes; (8) regression—predicting numeric ranges of numeric values; and (9) any combination of these processes.
Embodiment 86. The apparatus/system/interface/method of any of the previous Embodiments, wherein data mining subsystem wherein the analytics includes evaluating data using analytical and logical concepts to gain insight into humans, animals, and devices under control of humans, animals, and/or AI algorithms. In particular, data analytics includes extracting, collecting, and/or capturing raw data using the apparatuses and systems of this disclosure. The routines include utilizing data transformations, data organization and data modeling to achieve suitable data outputs both qualitative and quantitative. The routines may be tailored to the needs of the consumer of the technology.
Embodiment 87. The apparatus/system/interface/method of any of the previous Embodiments, wherein data mining subsystem wherein the analytics includes various phases including (1) data discovery—analyze data and investigate problems associated with the data to develop a context and understanding of the data and its potential uses; (2) data preparation—performing various tasks such as extracting, transforming and updating data into so called sandboxes depending the desired output; (3) model planning—determine particular processes and techniques required to build a specific model and to learn about the relationships between variables and choose the most suitable models for the desired output metrics; (4) model building—create different data sets for testing, production, and/or training; (5) communicate results—interact with consumers of the output to determine if the metrics meet their needs need further refinement; and (6) operationalize—deliver the optimized metrics to the consumer.
Embodiment 88. The apparatus/system/interface/method of any of the previous Embodiments, wherein the biometric sensors are designed to capture biometric data including, without limitation, external data, internal data, or mixtures and combinations thereof.
Embodiment 89. The apparatus/system/interface/method of any of the previous Embodiments, wherein the external data include external whole body data, external body part data, or mixtures and combinations thereof.
Embodiment 90. The apparatus/system/interface/method of any of the previous Embodiments, wherein the internal data include internal whole body data, internal body part data, or mixtures and combinations thereof.
Embodiment 91. The apparatus/system/interface/method of any of the previous Embodiments, wherein the external whole body data include height, weight, posture, size, location, structure, form, orientation, texture, color, coloring, features, ratio of body parts, location of body parts, forms of body parts, structures of body parts, brain waves, brain wave patterns, temperature distributions, aura data, bioelectric and/or biomagnetic data, other external whole body data, or mixtures and combinations thereof.
Embodiment 92. The apparatus/system/interface/method of any of the previous Embodiments, wherein the external body part data include, without limitation, body part shape, size, location, structure, form, orientation, texture, color, coloring, features, etc., auditory data, retinal data, finger print data, palm print data, other external body part data, or mixtures and combinations thereof. Exemplary examples of internal whole body data include skeletal data, blood circulation data, muscular data, EEG data, EKG data, ratio of internal body parts, location of internal body parts, forms of internal body parts, structures of internal body parts, other internal whole body data, or mixtures and combinations thereof. Exemplary examples of internal body part data include, without limitation, internal body part shape, size, location, structure, form, orientation, texture, color, coloring, features, etc., other internal body part data, or mixtures and combinations thereof.
Embodiment 93. The apparatus/system/interface/method of any of the previous Embodiments, wherein the biometric data may be 1D biometric data, 2D biometric data, and/or 3D biometric data.
Embodiment 94. The apparatus/system/interface/method of any of the previous Embodiments, wherein the 1D biometric data may be linear data, non-linear, and/or curvilinear data derived from at least one body part. The body parts may include a body structure, a facial structure, a hand structure, a finger structure, a joint structure, an arm structure, a leg structure, a nose structure, an eye structure, an ear structure, any other body structure (internal and/or external), or mixtures and combinations thereof.
Embodiment 95. The apparatus/system/interface/method of any of the previous Embodiments, wherein the 2D biometric data may include surface structural data derived from body parts including whole body structure, facial structure, hand structure, arm structure, leg structure, nose structure, eye structure, ear structure, joint structure, internal organ structure such as vocal chord motion, blood flow motion, etc., any other body structure, or mixtures and combinations thereof.
Embodiment 96. The apparatus/system/interface/method of any of the previous Embodiments, wherein the 3D biometric data may include volume structures derived from body parts including body structure, facial structure, hand structure, arm structure, leg structure, nose structure, eye structure, ear structure, joint structure, internal organ structure such as vocal chord motion, blood flow motion, etc., any other body structure, or mixtures and combinations thereof.
Embodiment 97. The apparatus/system/interface/method of any of the previous Embodiments, wherein the biometric data may also include internal structure, fluid flow data, electrical data, chemical data, and/or any other data derived from sonic generators and sonic sensors, ultrasound generators and ultrasound sensors, X-ray generators and X-ray sensors, optical generators and optical sensors, or other penetrating generators and associated sensors.

### CLOSING PARAGRAPH

All references cited herein are incorporated by reference. Although the invention has been disclosed with reference to its embodiments, from reading this description those of skill in the art may appreciate changes and modification that may be made which do not depart from the scope and spirit of the invention as described above and claimed hereafter.

We claim:

1. An apparatus comprising:
one or more processing assemblies are configured to implement the apparatus;
one or more monitoring assemblies are configured to monitor user activities and interactions;
one or more data gathering/collection/capturing assemblies are configured to gather, collect, and/or capture monitored user activity and interaction data;
one or more data analysis assemblies are configured to analyze gathered, collected, and/or captured user activity and interaction data; and
one or more data storage and retrieval assemblies,
wherein the assemblies may operate in real-time or near real-time.

2. The apparatus of claim 1, wherein:
the one or more processing assemblies includes comprising one or more electronic devices, one or more processing units, one or more processing systems, one or more distributed processing systems, one or more distributing processing environments, and/or any combination thereof; and
the one or more monitoring assemblies comprises the one or more sensors.

3. The apparatus of claim 2, wherein:
the one or more electronic devices, the one or more processing units, the one or more processing systems, the one or more distributed processing systems, and the one or more distributing processing environments include one or more processing units, one or more memory units, one or more storage devices, one or more input devices, one or more output devices, an operating system or structure, software and configuration-based protocols and/or elements, communication software and hardware, and routines for implementing the apparatus; and
the one or more sensors comprise one or more cameras, one or more motion sensors, one or more biometric sensors, one or more biokinetic sensors, one or more environmental sensors, one or more field sensors, one or more brain wave sensors, and/or any combination thereof.

4. The apparatus of claim 3, wherein the one or more environmental sensors include one or more temperature sensors, one or more pressure sensors, one or more humidity sensors, one or more weather or meteorological sensors, one or more air quality sensors, one or more chemical sensors, one or more infrared sensors, one or more UV sensors, one or more X-ray sensors, one or more high energy particle sensors, one or more radiation sensors, any other environmental sensor, and/or any combination thereof.

5. The apparatus of claim 1, wherein:
the monitored user activities and interactions comprise actions and/or interactions of one or more humans, one or more animals, one or more robots, one or more devices under the control of a human or an animal, one or more detectable fields, any other activity and/or interaction, and/or any combination thereof with one or more humans, one or more animals, one or more robots, one or more devices under the control of a human or an animal, one or more detectable fields, one or more real objects, one or more virtual objects, one or more imaginary entities, one or more real environments, one or more virtual reality environments, one or more mixed real and virtual reality environments, any other real or virtual item or object, and/or any combination thereof; and
the gathered/collected/captured user activity and interaction data comprise monitored user activities and interactions.

6. The apparatus of claim 1, wherein the gathered/collected/captured data may be gathered/collected/captured continuously, semi-continuously, intermittently, on command, and/or any combination of this sequentially or simultaneously.

7. The apparatus of claim 1, wherein the one or more data analysis assemblies comprise one or more data analytic software routines, data mining software routines, one or more artificial intellect software routines, one or more metric generation software routines, one or more rules generation software routines, any other software routine used in data analysis, and/or any combination thereof.

8. The apparatus of claim 1, wherein the one or more data analysis assemblies are further configured to:
produce usable output data.

9. The apparatus of claim 8, wherein the usable output data comprises metrics, key performance indicators (KPIs), rules, and/or any combination thereof.

10. The apparatus of claim 9, wherein the rules include predictive rules, behavioral rules, forecasting rules, any other type of informational rules derived from the gathered/collected/captured data, and/or any combination thereof.

11. The apparatus of claim 1, wherein the one or more data analysis assemblies are further configured to:
produce optimized environments, real-time or near real-time environments, predictive environments, behavioral environments, forecasting environments, any other type of environments derived from the gathered/collected/captured data, the metrics, and rules, and/or any combination thereof.

12. The apparatus of claim 1, wherein the one or more data analysis assemblies are further configured to:
predict human, animal, and/or devices under that control of a human and/or animal activities and/or interactions based on the gathered/collected/captured data,
generate metrics based on the gathered/collected/captured data,
generate rules based on the gathered/collected/captured data,
generate predictive metrics, rules, and/or patterns based on the data, and
output the metrics, rules, and/or behavioral patterns to one or more databases.

13. The apparatus of claim 1, wherein the one or more data storage and retrieval assemblies comprise one or more databases, one or more data storage structures, any other data storage system, and/or any combination thereof.

14. The apparatus of claim 1, wherein the one or more data storage and retrieval assemblies are further configured to:
store the gathered/collected/captured data and the data analyses, and
allow the retrieval of the gathered/collected/captured data and the data analyses.

15. An interface implemented on an apparatus comprising: one or more processing assemblies, one or more monitoring assemblies, one or more data gathering/collection/capturing assemblies, one or more data analysis assemblies; and one or more data storage and retrieval assemblies, the interface configured to:
monitor activities and interactions;
gather, collect, and/or capture monitored activity and interaction data;
analyze the gathered/collected/captured data;
produce usable output data;
store the gathered/collected/captured data and the data analyses;
retrieve the the gathered/collected/captured data and the data analyses,
wherein the above features may operate in real-time or near real-time.

16. The apparatus of claim 15, wherein the one or more processing subsystems includes one or more electronic devices, one or more processing units, one or more processing systems, one or more distributed processing systems, one or more distributing processing environments, and/or any combination thereof.

17. The apparatus of claim 16, wherein the one or more electronic devices, the one or more processing units, the one or more processing systems, the one or more distributed processing systems, and the one or more distributing processing environments include one or more processing units, one or more memory units, one or more storage devices, one or more input devices, one or more output devices, an operating system or structure, software and configuration-based protocols and/or elements, communication software and hardware, and routines for implementing the system.

18. The apparatus of claim 15, wherein the one or more monitoring subsystems comprises the one or more sensors.

19. The apparatus of claim 18, wherein the one or more sensors comprise one or more cameras, one or more motion sensors, one or more biometric sensors, one or more biokinetic sensors, one or more environmental sensors, one or more field sensors, one or more brain wave sensors, and/or any combination thereof.

20. The apparatus of claim 19, wherein the one or more environmental sensors include one or more temperature sensors, one or more pressure sensors, one or more humidity sensors, one or more weather or meteorological sensors, one or more air quality sensors, one or more chemical sensors, one or more infrared sensors, one or more UV sensors, one or more X-ray sensors, one or more high energy particle sensors, one or more radiation sensors, any other environmental sensor, and/or any combination thereof.

21. The apparatus of claim 15, wherein:
the activities and interactions comprise actions and/or interactions of one or more humans, one or more animals, one or more robots, one or more devices under the control of a human or an animal, one or more detectable fields, any other activity and/or interaction, and/or any combination thereof with one or more humans, one or more animals, one or more robots, one or more devices under the control of a human or an animal, one or more detectable fields, one or more real objects, one or more virtual objects, one or more imaginary entities, one or more real environments, one or more virtual reality environments, one or more mixed real and virtual reality environments, any other real or virtual item or object, and/or any combination thereof; and
the gathered/collected/captured monitored activity and interaction data comprise monitored user activities and interactions.

22. The apparatus of claim 21, wherein the gathered/collected/captured monitored activity and interaction data may be gathered/collected/captured continuously, semi-continuously, intermittently, on command, and/or any combination of this sequentially or simultaneously.

23. The apparatus of claim 15, wherein the one or more data analysis subsystems comprise one or more data analytic software routines, data mining software routines, one or more artificial intellect software routines, one or more metric generation software routines, one or more rules generation software routines, any other software routine used in data analysis, and/or any combination thereof.

24. The apparatus of claim 23, wherein the usable output data includes metrics and rules.

25. The apparatus of claim 24, wherein the rules include predictive rules, behavioral rules, forecasting rules, any other type of informational rules derived from the gathered/collected/captured data, and/or any combination thereof.

26. The apparatus of claim 15, wherein the interface further configured to:
produce optimized environments, real-time or near real-time environments, predictive environments, behavioral environments, forecasting environments, any other type of environments derived from the gathered/collected/captured data, the metrics, and rules, and/or any combination thereof.

27. The apparatus of claim 15, wherein the interface further configured to:
predict human, animal, and/or devices under that control of a human and/or animal activities and/or interactions based on the gathered/collected/captured data,
generate metrics based on the gathered/collected/captured data,
generate rules based on the gathered/collected/captured data,
generate predictive metrics, rules, and/or patterns based on the data, and
output the metrics, rules, and/or behavioral patterns to one or more databases.

28. The apparatus of claim 15, wherein the one or more data storage and retrieval subsystems comprise one or more databases, one or more data storage structures, any other data storage system, and/or any combination thereof.

29. A method implemented on an apparatus comprising: one or more processing assemblies, one or more monitoring assemblies, one or more data gathering/collection/capturing assemblies, one or more data analysis assemblies; and one or more data storage and retrieval assemblies, the method comprising:
monitoring activities and interactions;
gathering, collecting, and/or capturing monitored activity and interaction data;
analyzing the gathered/collected/captured data;
producing usable output data;
storing the gathered/collected/captured data and the data analyses;
modifying one, some, or all of the gathered/collected/captured data and the usable output data to produce modified gathered/collected/captured data and modified usable output data;
retrieving the gathered/collected/captured data, the data analyses, the modified gathered/collected/captured data, and/or the modified usable output data; and
repeating one, some, or all of the above steps,
wherein the above steps may occur in real-time or near real-time.

30. The method of claim 29, wherein, in the implementation, the one or more processing subsystems includes comprising one or more electronic devices, one or more processing units, one or more processing systems, one or more distributed processing systems, one or more distributing processing environments, and/or any combination thereof.

31. The method of claim 29, wherein, in the implementation, the one or more electronic devices, the one or more processing units, the one or more processing systems, the one or more distributed processing systems, and the one or more distributing processing environments include one or more processing units, one or more memory units, one or more storage devices, one or more input devices, one or more output devices, an operating system or structure, software and configuration-based protocols and/or elements, communication software and hardware, and routines for implementing the system.

32. The method of claim 31, wherein, in the monitoring, the one or more monitoring subsystems comprises the one or more sensors.

33. The method of claim 32, wherein, in the monitoring, the one or more sensors comprise one or more cameras, one or more motion sensors, one or more biometric sensors, one or more biokinetic sensors, one or more environmental sensors, one or more field sensors, one or more brain wave sensors, and/or any combination thereof.

34. The method of claim 33, wherein, in the monitoring, the one or more environmental sensors include one or more temperature sensors, one or more pressure sensors, one or more humidity sensors, one or more weather or meteorological sensors, one or more air quality sensors, one or more chemical sensors, one or more infrared sensors, one or more UV sensors, one or more X-ray sensors, one or more high energy particle sensors, one or more radiation sensors, any other environmental sensor, and/or any combination thereof.

35. The method of claim 29, wherein, in the monitoring:
the activities and interactions comprise actions and/or interactions of one or more humans, one or more animals, one or more robots, one or more devices under the control of a human or an animal, one or more detectable fields, any other activity and/or interaction, and/or any combination thereof with one or more humans, one or more animals, one or more robots, one or more devices under the control of a human or an animal, one or more detectable fields, one or more real objects, one or more virtual objects, one or more imaginary entities, one or more real environments, one or more virtual reality environments, one or more mixed real and virtual reality environments, any other real or virtual item or object, and/or any combination thereof, and
the gathered/collected/captured monitored activity and interaction data comprise monitored user activities and interactions.

36. The method of claim 29, wherein, in the gathering/collecting/capturing, the gathered/collected/captured data may be gathered/collected/captured continuously, semi-continuously, intermittently, on command, and/or any combination of this sequentially or simultaneously.

37. The method of claim 29, wherein, in the analyzing, the one or more data analysis subsystems comprise one or more data analytic software routines, data mining software routines, one or more artificial intellect software routines, one or more metric generation software routines, one or more rules generation software routines, any other software routine used in data analysis, and/or any combination thereof.

38. The method of claim 29, wherein, in the producing, the usable output data includes metrics, KPIs, and rules.

39. The method of claim 38, wherein, in the producing, the rules include predictive rules, behavioral rules, forecasting rules, any other type of informational rules derived from the gathered/collected/captured data, and/or any combination thereof.

40. The method of claim 29, further comprising:
producing optimized environments, real-time or near real-time environments, predictive environments, behavioral environments, forecasting environments, any other type of environments derived from the gathered/collected/captured data, the metrics, and rules, and/or any combination thereof.

41. The method of claim 29, further comprising:
predicting human, animal, and/or devices under that control of a human and/or animal activities and/or interactions based on the gathered/collected/captured data,
generating metrics based on the gathered/collected/captured data,
generating rules based on the gathered/collected/captured data,
generating predictive metrics, rules, and/or patterns based on the data, and
outputting the metrics, rules, and/or behavioral patterns to one or more databases.

42. The method of claim 29, wherein the one or more data storage and retrieval subsystems comprise one or more databases, one or more data storage structures, any other data storage system, and/or any combination thereof.
